(19) United States
(12) Patent Application Publication
(10) Pub. No.: US 2026/0299604 A1
(43) Pub. Date: Oct. 1, 2026

(54) HOME APPLIANCE ROBOTIC SYSTEM, A TANDEM OF A ROBOTIC PARKING STATION AND A ROAMING DEVICE

(71) Applicant: Ali Ebrahimi Afrouzi, Henderson, NV (US)

(72) Inventor: Ali Ebrahimi Afrouzi, Henderson, NV (US)

(73) Assignee: AI Incorporated, Toronto (CA)

(21) Appl. No.: 19/336,987

(22) Filed: Sep. 23, 2025

Related U.S. Application Data
(60) Provisional application No. 63/721,677, filed on Nov. 18, 2024.
(60) Provisional application No. 63/751,183, filed on Jan. 29, 2025.
(60) Provisional application No. 63/764,831, filed on Feb. 28, 2025.
(60) Provisional application No. 63/789,988, filed on Apr. 16, 2025.
(60) Provisional application No. 63/807,041, filed on May 16, 2025.
(60) Provisional application No. 63/816,947, filed on Jun. 3, 2025.
(60) Provisional application No. 63/879,088, filed on Sep. 10, 2025.
(60) Provisional application No. 63/885,356, filed on Sep. 21, 2025.

(51) Int. Cl. G05D 1/648; A47L 11/40; G05D 101/15; G05D 105/10; G05D 107/40; G05D 109/10; G05D 111/10; G05D 111/30

(52) U.S. Cl. CPC G05D 1/648; A47L 11/4011; A47L 2201/022; A47L 2201/024; A47L 2201/04; G05D 2101/15; G05D 2105/10; G05D 2107/40; G05D 2109/10; G05D 2111/17; G05D 2111/32

(57) ABSTRACT

A home appliance system for autonomously cleaning surfaces of an environment, comprising: a robotic stationary device, comprising: a frame structure; at least one sensor; at least one actuator; a processor; a dust intake port, vacuum motor, exhaust, filter, dustbag, and charging contacts; at least a component configured for attaching to a permanent water supply; a memory storing instructions that, when executed by the processor, effectuate operations comprising: actuating, with the processor, at least a motor to autonomously supply water to a robotic roaming device; a robotic roaming device, comprising: a chassis; a set of wheels; a motor; at least one sensor; at least one actuator; a navigation component; a processor; a first set of components for a first data communication mechanism; a second set of components for a second data communication mechanism; a memory storing instructions that, when executed by the processor, effectuate operations comprising: receiving and transmitting data from and to the robotic stationary device with the first data communication mechanism; receiving and transmitting data from and to a wireless network connected to the internet with the second data communication mechanism.

### CROSS-REFERENCE TO RELATED APPLICATIONS

This application claims the benefit of the U.S. Provisional Patent Application Nos. 63/721,677, filed on Nov. 18, 2024, 63/764,831, filed on Feb. 28, 2025, 63/751,183, filed on Jan. 29, 2025, 63/789,988, filed on Apr. 16, 2025, 63/674,733, filed on Jul. 23, 2024, 63/807,041, filed on May 16, 2025, 63/816,947, filed on Jun. 3, 2025, 63/879,088, filed on Sep. 10, 2025, and 63/885,356, filed Sep. 21, 2025, each of which is hereby incorporated herein by reference.

In this patent, certain U.S. patents, U.S. patent applications, or other materials (e.g., articles) have been incorporated by reference. Specifically, U.S. Pat. Nos. 10/452,071, 10/788,836, 11/449,061, 11/927,965, 12/235,659, 12/256,883, 11/864,715, 11/058,268, 10/292,553, 10/239,370, 10/766,324, 11/499,832, 11/835,343, 11/656,082, 11/435,192, 11/215,461, 10/809,071, and 17/240,211, U.S. Non-Provisional application Ser. Nos. 15/410,624, 16/504,012, 19/065,936, 19/015,623, 63/619,191, 63/617,669, 14/885,064, 16/186,499, 14/970,791, 16/375,968, 15/673,176, 16/058,026, 17/160,859, 16/353,006, 10/496,262, 12/093,520, 15/949,708, 15/272,752, 18/239,134, 17/878,725, 16/418,988, 15/981,643, 15/986,670, 15/048,827, 14/948,620, 16/185,000, 16/297,508, 16/509,099, 15/425,130, 15/955,344, 15/955,480, 16/554,040, 15/410,624, 16/504,012, 16/353,019, 17/127,849, 18/667,997, 18/612,966, 16/163,541, 16/851,614, 16/418,988, 16/048,185, 16/048,179, 16/594,923, 17/142,909, 16/920,328, 16/163,562, 16/597,945, 16/724,328, 16/163,508, 16/542,287, 17/159,970, 15/243,783, 15/954,335, 17/316/006, 15/954,410, 16/832,221, 15/224,442, 15/674,310, 17/071,424, 15/447,122, 16/393,921, 16/932,495, 17/242,020, 15/683,255, 16/880,644, 15/257,798, 16/525,137, 18/526,723, 19/171,743, 18/132,882, 11/274,929, 15/442,992, 16/832,180, 16/570,242, 16/995,500, 16/995,480, 17/196,732, 15/976,853, 17/109,868, 16/219,647, 15/017,901, 17/021,175, 14/673,633, 15/676,888, 14/817,952, 15/619,449, 16/198,393, 18/912,455, 17/240,211, 16/851,614, 15/673,176, 16/058,026, 14/922,143, 15/878,228, and 16/440,904, and U.S. Provisional Application Nos. 63/619,191 and 63/617,669, are hereby incorporated by reference. The text of such U.S. patents, U.S. patent applications, and other materials is, however, only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

### FIELD OF THE DISCLOSURE

The disclosure relates to a system of two robotic devices, a robotic parking station device and a robotic roaming device with a toolkit for being installed as an integrated appliance with connection to a plumbing system and sewerage system.

### BACKGROUND OF THE INVENTION

Conventional robotic appliances, such as robotic vacuum cleaners, mops, and other mobile service devices, generally operate as a stand-alone unit with a specified purpose. While these devices may include docking stations or charging stations, they often lack a fully integrated service infrastructure that allows customization and/or to interface directly with the plumbing or sewer systems of the home or any environment. As a result, such robotic devices are restricted in their ability to perform automated or autonomous tasks that are related to water supply, waste disposal, and other fluid-handling requirements. Existing mobile robotic cleaning devices typically require manual intervention by a human or user for tasks such as refilling water tanks, emptying wastewater containers, or replacing tool attachments. This not only reduces the level of automation but also increases the burden and limits the efficiency of the devices in large-scale or high-frequency cleaning conditions. Additionally, the lack of an integrated docking system with plumbing connectivity limits the ability of such robotic devices to conduct thorough self-maintenance or self-cleaning tasks, such as rinsing, disinfection, or tool replacement.

To address these limitations, the invention introduces a robotic appliance system that combines a robotic parking station with a mobile roaming robotic device equipped with a toolkit, wherein the parking station may be connected to available plumbing and sewer systems. Such a system would enable automatic refilling of cleaning liquids and direct disposal of waste, thereby providing a higher level of autonomy and efficiency compared to conventional robotic appliances.

### SUMMARY

The following presents a simplified summary of some embodiments of the techniques described herein in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented below.

Some embodiments provide a home appliance system for autonomously cleaning surfaces of a home environment, comprising: a robotic stationary device, comprising: a frame structure; at least one sensor; at least one actuator; a processor; a dust intake port, a vacuum motor, an exhaust, a filter, a dustbag, and charging contacts; at least a component configured for attaching to a permanent water supply of the home environment; a memory storing instructions that, when executed by the processor of the robotic stationary device, effectuate operations comprising: actuating, with the processor of the robotic stationary device, at least a motor of the robotic stationary device to autonomously supply water to a robotic roaming device; a robotic roaming device, comprising: a chassis; a set of wheels; a motor to drive the set of wheels; at least one sensor; at least one actuator; a component for navigation; a processor; a first set of components for a first data communication mechanism; a second set of components for a second data communication mechanism, different from the first data communication mechanism; a memory storing instructions that, when executed by the processor of the robotic roaming device, effectuate operations comprising: receiving and transmitting data from and to the robotic stationary device with the first data communication mechanism; receiving and transmitting data from and to a wireless network connected to the internet with the second data communication mechanism; wherein the home appliance system is configured to autonomously clean at least one component of itself with an actuated rubbing motion between a component of the robotic stationary device and a component of the robotic roaming device.

### BRIEF DESCRIPTION OF DRAWINGS

FIGS. 1A-1C illustrate a robot cleaner with wheels with a roller brush system, according to some embodiments.

FIGS. 2A and 2B illustrate a robot cleaner with wheels with a roller brush system, according to some embodiments.

FIG. 3 illustrates how each side of brushes are controlled by a separate motor and gearbox, according to some embodiments.

FIGS. 4A-4C illustrate a robot vacuum with a dual brush system, according to some embodiments.

FIG. 5 illustrates the single motor connection to the brush module, according to some embodiments.

FIGS. 6A and 6B illustrate a robot vacuum with a dual brush system, according to some embodiments.

FIG. 7 illustrates how each side of the brushes with twisted flaps are controlled by a separate motor and gearbox, according to some embodiments.

FIGS. 8A and 8B illustrate a robot vacuum cleaner with a single brush, according to some embodiments.

FIGS. 9A and 9B illustrate a robot vacuum cleaner with a single brush with twisted flaps, according to some embodiments.

FIGS. 10A and 10B illustrate a robot vacuum cleaner with a dual brush system, according to some embodiments.

FIGS. 11A-11F illustrate a built-in station system for a robotic vacuum cleaner and a hand held vacuum cleaner, according to some embodiments.

FIGS. 12A-12C illustrate a stand-alone station with an auto emptying mechanism for a robotic vacuum, according to some embodiments.

FIGS. 13A-13C illustrate a stand-alone station with an auto emptying mechanism for a handheld vacuum, according to some embodiments.

FIG. 14 illustrates how the two stations are modular and can be stacked on top of each other, according to some embodiments.

FIG. 15 illustrates a station forming a single unit that performs independently from each other, according to some embodiments.

FIG. 16 illustrates a station with an auto-empty mechanism for both a robot vacuum and a handheld vacuum, according to some embodiments.

FIG. 17A illustrates how the air intake from a handheld vacuum, according to some embodiments.

FIG. 17B illustrates how the air intake from a robot vacuum, according to some embodiments.

FIG. 18A illustrates a robot vacuum station with an auto-empty mechanism, according to some embodiments.

FIG. 18B illustrates the position of the robot on the station during the charging/self-empty and cleaning session, according to some embodiments.

FIG. 18C is the side view of the station and robot vacuum, according to some embodiments.

FIG. 19 illustrates an alternative embodiment of the station, according to some embodiments.

FIG. 20 demonstrates how a stand-alone station can be converted to a connected station, according to some embodiments.

FIGS. 21A-22B illustrate different components of a connection kit, according to some embodiments.

FIGS. 23A and 23B illustrate the auto-empty and auto-refill station and the connection kit, according to some embodiments.

FIG. 24 illustrates a robot vacuum and its rotation axis, according to some embodiments.

FIG. 25 illustrates an upright polymorphic cleaner with a vacuum and sweeper head, according to some embodiments.

FIGS. 26-31 illustrate an embodiment with a process of removing or cleaning the sweeper roller brush and blades, according to some embodiments.

FIGS. 32 and 33 illustrate a upright vacuum cleaner with a rolling mop, according to some embodiments.

FIG. 34 illustrates the upright polymorphic cleaner with a mopping head comprising a set of spinning disk mops, according to some embodiments.

FIG. 35 illustrates a simple charging station with an auto-empty feature for an upright vacuum and mop, according to some embodiments.

FIGS. 36-39 illustrate an upright vacuum cleaner positioned over a charging station with auto-empty, auto-refill, and auto-clean features for an upright vacuum cleaner and mop, according to some embodiments.

FIGS. 40A and 40B illustrate a kit to connect the station in FIG. 37 directly to the house plumbing system, according to some embodiments.

FIGS. 41A and 41B demonstrate how the kit from FIG. 39 replaces the water containers of the parking platform from FIG. 13 to directly connect it to the plumbing system, according to some embodiments.

FIG. 42 illustrates an appliance comprising a parking platform with a set of robotic functions for an upright polymorphic cleaner and a self-propelling polymorphic cleaner, according to some embodiments.

FIG. 43 illustrates a robotic vacuum cleaner equipped with a robotic arm, according to some embodiments.

FIG. 44 illustrates a robotic arm equipped with a suction tube as an extension of a robotic cleaner at work, according to some embodiments.

FIG. 45 illustrates a robotic vacuum cleaner equipped with a robotic arm that may decide to take action based on objects it recognizes, according to embodiments.

FIG. 46 illustrates an example of a robotic vacuum cleaner with a robotic arm, according to some embodiments.

FIGS. 47A and 47B illustrate a robotic vacuum cleaner equipped with one or more solid state LiDARs, according to some embodiments.

FIG. 48 illustrates a robotic vacuum vacuum cleaner and its components, according to some embodiments.

FIG. 49 illustrates a lifting mechanism of components of a robotic vacuum cleaner, according to some embodiments.

FIG. 50 illustrates an example of a lifting mechanism, according to some embodiments.

FIG. 51 illustrates a robot vacuum cleaner equipped with a microphone array, according to some embodiments.

FIGS. 52A and 52B illustrate a robot vacuum cleaner with a vacuum module separated from a navigation module, according to some embodiments.

FIGS. 53A and 53B illustrate different components of a vacuum module, according to some embodiments.

FIG. 54 illustrates a vacuum module serving different purposes by attaching the vacuum module to various cleaning devices, according to some embodiments.

FIG. 55 illustrates different components of a navigation and mapping module, according to some embodiments.

FIG. 56 illustrates a charging and auto-empty station which docks and charges a robotic vacuum cleaner equipped with vacuum and navigation modules, according to some embodiments.

FIG. 57 illustrates a vacuum module with its components where the module is shared between a station and a stick vacuum, according to some embodiments.

FIG. 58 illustrates how an attachment of a vacuum module to a station and a stick vacuum, according to some embodiments.

FIG. 59 illustrates a robotic vacuum cleaner equipped with a lifting mechanism, according to some embodiments.

FIG. 60 illustrates components of the lifting mechanism, according to some embodiments.

FIGS. 61 and 62 illustrate different states of the lifting mechanism, according to some embodiments.

FIG. 63 illustrates a robotic vacuum cleaner equipped with a zip chain actuator mechanism in different types of wheels, according to some embodiments.

FIG. 64 illustrates a robotic vacuum cleaner in normal state and a lifted state, according to some embodiments.

FIG. 65 illustrates different components of a zip chain actuator mechanism, according to some embodiments.

FIG. 66 illustrates a zip chain actuator in two states, according to some embodiments.

FIG. 67A-67F demonstrates sequential positions of a robotic vacuum cleaner using a lifting mechanism, according to some embodiments.

FIGS. 68A and 68B demonstrate a process of combining information from different combinations of sources, according to embodiments.

FIG. 69 demonstrates a process of combining information with local and remote sources, according to embodiments.

FIG. 70 demonstrates incorporation weight assignment of received information during a combination process, according to embodiments.

FIG. 71 demonstrates other arbitrating cases with data having different resolution, or a different kind, according to embodiments.

FIG. 72 demonstrates a credibility hierarchy of different types of data when combining data from two devices, according to embodiments.

FIGS. 73A-73D demonstrate separation of position and bearing into two different data structures, according to embodiments.

FIGS. 74A and 74B illustrate adaptive resolution selection and obstacle avoidance for inter robot communication, according to some embodiments.

FIGS. 75A and 75B illustrate systems and subsystems operations, according to some embodiments.

FIG. 76 illustrates a system with two sets of wide field of view (FOV) sensors, according to some embodiments.

FIGS. 77-79 illustrate a multientry computing system, according to some embodiments.

FIG. 80 demonstrates a robotic device equipped with an IR sensor and identifying objects and floor planes within an image, according to some embodiments.

FIG. 81 illustrates a multientry computing system, according to some embodiments.

FIG. 82 illustrates various representations of subsystems, according to some embodiments.

FIG. 83 illustrates a block diagram illustrating an AI-based sensor perception and decision-making system, according to some embodiments.

FIG. 84 illustrates scenarios for synthetic and individual decision-making in navigation tasks, including escaping routines, obstacle handling, corner negotiation, and acceleration speed adjustment, according to some embodiments.

FIGS. 85 and 86 illustrate components of a vehicle-based object detection and localization system, according to some embodiments.

FIGS. 87 and 88 illustrate diagrams showing data processing, transmitting, and mapping for localization, according to some embodiments.

FIGS. 89-92 illustrate examples of adjustments in sensor-camera configurations to capture near and far distances, according to some embodiments.

FIGS. 93-96 illustrate methods and examples in exploration in coverage tasks by a robotic device, exemplified by point-to-point movement using SLAM, according to some embodiments.

FIGS. 97A-101 illustrate schematic diagrams of sensor-based image processing and spatial analysis for mapping, depth perception, region segmentation, and light-based measurement, according to some embodiments.

FIGS. 102-106 illustrate examples and system configurations involving projection-camera interaction, scene illumination, extracted feature projection and 2D-to-3D transformation in an imaging system, according to some embodiments.

FIGS. 107-112 illustrate diagrams of processing occurring in actuation, sensing, and storing in a cloud, according to some embodiments.

FIGS. 113-116 illustrate schematic diagrams of an example, processing, and methods for continuous wave intensity modulation, according to some embodiments.

FIG. 117 illustrates a schematic diagram of a variational encoder, according to some embodiments.

FIGS. 118 and 119 illustrate schematic diagrams of methods to combat overfitting, according to some embodiments.

FIGS. 120 and 121 illustrate extraction of a descriptor for a group of features and methods for alignment of maps, according to some embodiments.

FIGS. 122 and 123 illustrate communication and spatial-temporal triangulation for coordinate mapping in a robotic system, according to some embodiments.

FIG. 124 illustrates various configurations of robot arms, according to some embodiments.

FIGS. 125 and 126 illustrate position and space awareness, according to some embodiments.

FIG. 127 illustrates effects of non-bias acceleration errors, according to some embodiments.

FIG. 128 illustrates a schematic diagram for determining an environment based on image analysis, according to some embodiments.

FIG. 129 illustrates a schematic diagram of a method involving a variational encoder, according to some embodiments.

FIGS. 130 and 131 illustrate the use of sensing priors for future runs to determine the topology of workspaces, according to some embodiments.

FIGS. 132-134 illustrate workspace boundary training and local mapping, according to some embodiments.

FIG. 135 illustrates a self-cleaning robot equipped with a handle and sensors, according to some embodiments.

FIG. 136 illustrates a robotic device with a local IR sensor detecting a presence of obstacles or with a local significant range reading, according to some embodiments.

FIG. 137 demonstrates a robotic device implementing consecutive runs to collect data, swarm points or microsegment trajectories, according to some embodiments.

FIGS. 138-140 demonstrate image processing to look for features in sliding windows, according to some embodiments.

FIG. 141 shows an illustration of materials exhibiting photon absorption and electron-hole pair recombination, according to some embodiments.

FIGS. 142-144 demonstrate a multilayer CMOS image sensor, according to some embodiments.

FIG. 145 demonstrates signal attenuation in waveforms as achieved by an avalanche photosensitive diode, according to some embodiments.

FIGS. 146-149 illustrate obstacle detection with light detector and ranger (LiDAR) coupled with an illuminator, according to some embodiments.

FIG. 150 demonstrates collaboration of robots in a shared workspace, according to some embodiments.

FIGS. 151-156C demonstrate examples of collaborative Artificial Intelligence (AI) and/or simultaneous localization and mapping (SLAM), according to some embodiments.

FIGS. 157A-159 demonstrate various illustrations of image sensor set-up and their mechanisms, according to some embodiments.

FIGS. 160A-160C demonstrate boundary boxes in an environment and their mechanisms, according to some embodiments.

FIGS. 161-163 demonstrate monitoring of fine optical flow, according to some embodiments.

FIGS. 164A-166C demonstrate an optical system, according to some embodiments.

FIG. 167 illustrates a perspective and top view of a robot wherein a temporal data source is placed in front of the robot and is aligned with the direction of the movement of the robot, according to some embodiments.

FIGS. 168A-173 demonstrate how sensors of a robot capture points to a wall in relation with a direction of the movements of the robot.

FIGS. 174-176 demonstrate a robot doing coastal navigation, according to some embodiments.

FIGS. 177 and 178 illustrate how a fringe protector tape covers carpet fringes, according to some embodiments.

FIG. 179 illustrates a three-layer fabric consisting of non-woven-fabric, melt-blown fiber and activated carbon cloth which is used for odor filtering vacuum cleaner dust bags, according to some embodiments.

FIGS. 180-185 illustrate a stick mop and vacuum with a 2-in-1 water tank, and their mechanisms, according to some embodiments

FIGS. 186-189 illustrate a robotic vacuum charging station with a 2 in 1 water tank in perspective view, front and side views, according to some embodiments.

FIGS. 190-194 illustrate different stages of the 2-in-1 water tank and their various mechanisms, according to some embodiments.

FIGS. 195A-196B illustrates a reusable dust bag in various perspectives, according to some embodiments.

FIG. 197 illustrates a corresponding protrusion to the cut on the dust bag's sliding card, on the side of the station, according to some embodiments.

FIG. 198 demonstrates how combining additive chemicals with bio-sourced material can enhance material properties, according to some embodiments.

FIG. 199 demonstrates how low molecular weight Bio-polymer chains can be linked together, according to some embodiments.

FIGS. 200 and 201 illustrate schematic diagrams illustrating processes for training and utilizing a graph neural network model, according to some embodiments.

### DETAILED DESCRIPTION OF SOME EMBODIMENTS

The present invention will now be described in detail with reference to a few embodiments thereof as illustrated in the accompanying drawings. In the following description, numerous specific details are set forth in order to provide a thorough understanding of the present inventions. It will be apparent, however, to one skilled in the art, that the present invention may be practiced without some or all of these specific details. In other instances, well-known process steps and/or structures have not been described in detail in order not to unnecessarily obscure the present invention. Further, it should be emphasized that several inventive techniques are described, and embodiments are not limited to systems implementing all of those techniques, as various cost and engineering trade-offs may warrant systems that only afford a subset of the benefits described herein or that will be apparent to one of ordinary skill in the art.

The embodiment of the invention explained below describes a robotic system that enables autonomous floor cleaning in an indoor environment or workspace. The robotic system includes at least a robotic device that is stationary. In addition to the stationary robotic device, the system further comprises either a handheld roaming device that is roamed around or handheld by a user and may be placed back onto the stationary robotic device or an robotic roaming device comprising wheels that autonomously navigates the environment, performs a coverage routine, and cleans the surface as it covers surfaces of the environment and then parks into the stationary robotic device to remain parked until a next run, or to recharge or be serviced. In addition to the stationary robotic device, the system may comprise both of the one or more handheld roaming devices and one or more robotic roaming devices.

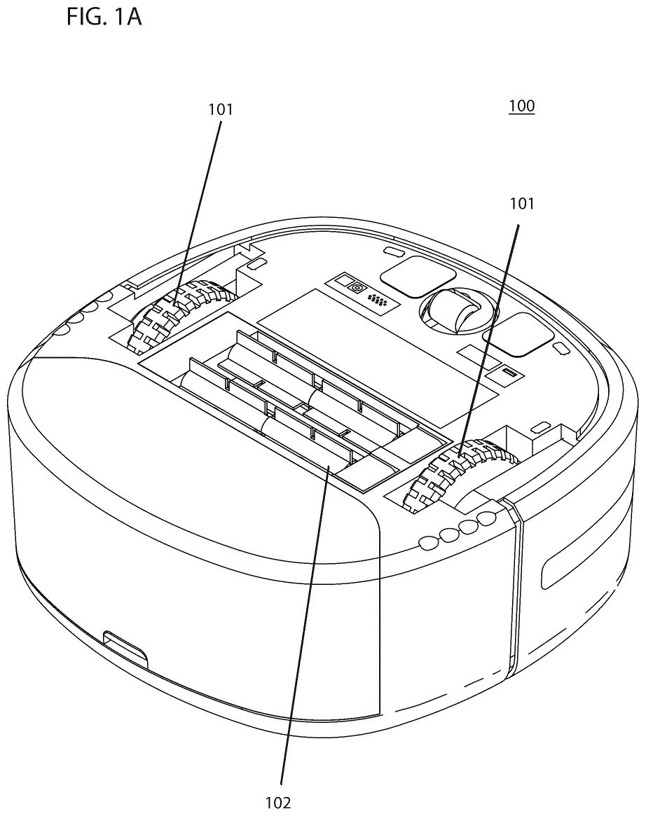

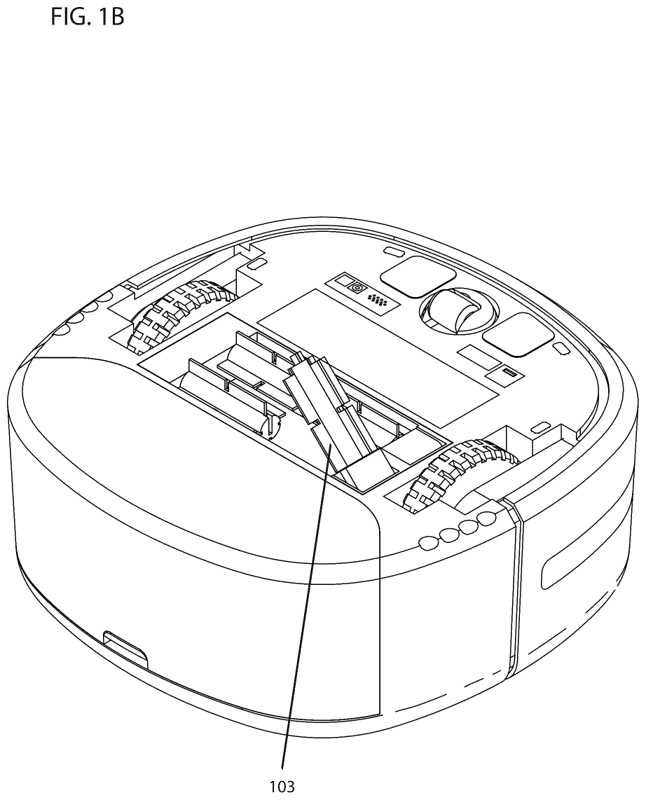

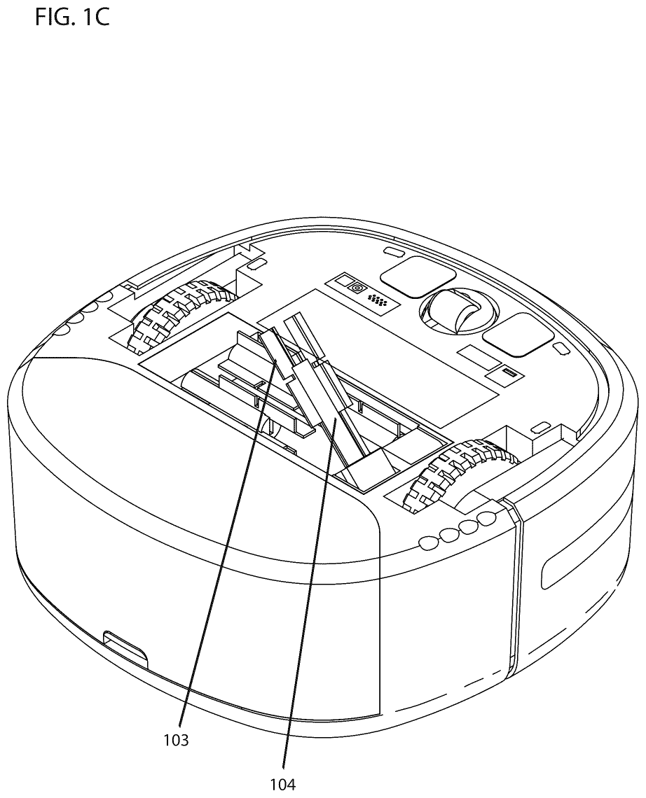

In some embodiments, a robotic roaming device 100 comprising wheels and a roller brush as illustrated in FIGS. 1A-1C, equipped with wheels 101 and equipped with a roller brush assembly 102. In some embodiments, rubber blades 103 of the roller brush are removable for cleaning purposes. In some embodiments, the rubber blades 103 are inserted on a roller 104 in a straight sliding fashion. In some embodiments, the rollers 104 are removably connected to one side of the housing of the roaming device.

The robotic roaming device may include, but is not limited to including, one or more of a casing, a chassis including a set of wheels, a motor to drive the wheels, a receiver that acquires signals transmitted from, for example, a transmitting beacon, a transmitter for transmitting signals, a processor, a memory storing instructions that when executed by the processor effectuates robotic operations, a controller, a plurality of sensors (e.g., tactile sensor, obstacle sensor, temperature sensor, imaging sensor, LIDAR sensor, camera, depth sensor, TOF sensor, TSSP sensor, optical tracking sensor, sonar sensor, ultrasound sensor, laser sensor, LED sensor, etc.), network or wireless communications, RF communications, power management such as a rechargeable battery, solar panels, or fuel, and one or more clock or synchronizing devices. In some cases, the robotic roaming device may include communication means such as Wi-Fi, Worldwide Interoperability for Microwave Access (WiMax), WiMax mobile, wireless, cellular, Bluetooth, RF, etc. In some cases, the robotic roaming device may support the use of a 360-degree spinning LIDAR and a depth camera with a limited field of view. In some cases, the robotic roaming device may support proprioceptive sensors (e.g., independently or in fusion), odometry devices, optical tracking sensors, smartphone inertial measurement units (IMU), and gyroscopes. In some cases, the robotic roaming device may include at least one cleaning tool (e.g., disinfectant sprayer, brush, mop, scrubber, steam mop, cleaning pad or cloth, ultraviolet (UV) sterilizer, etc.). The processor may, for example, receive and process data from internal or external sensors, execute commands based on data received, control motors such as wheel motors, map the environment, localize the robotic roaming device, determine division of the environment into zones, and determine movement paths. In some cases, where the processor of the robotic roaming device creates an accurate map of the environment, the map boundaries may be adjusted to keep the robotic roaming device from entering some areas. In some cases, the robotic roaming device may include a microcontroller on which computer code required for executing the methods and techniques described herein may be stored.

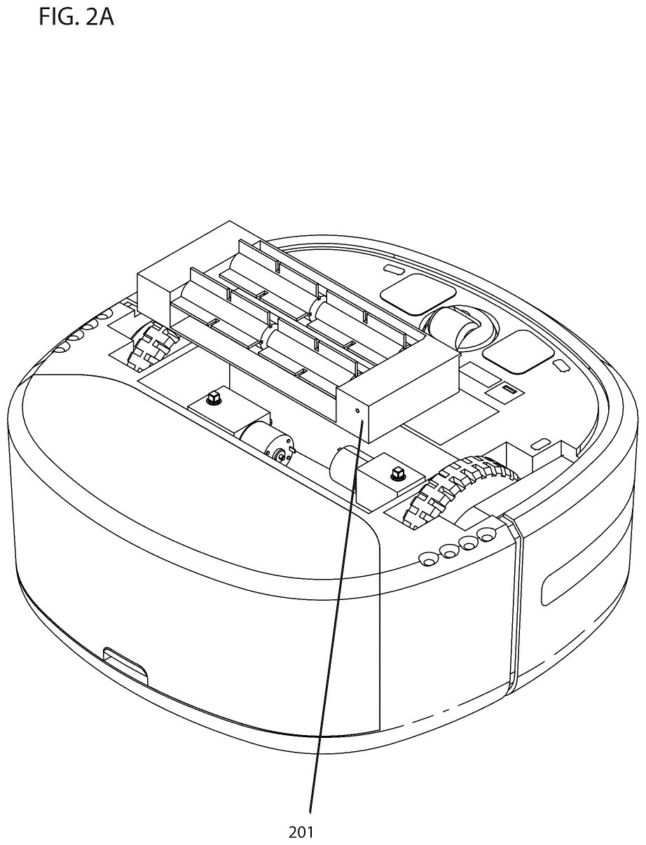

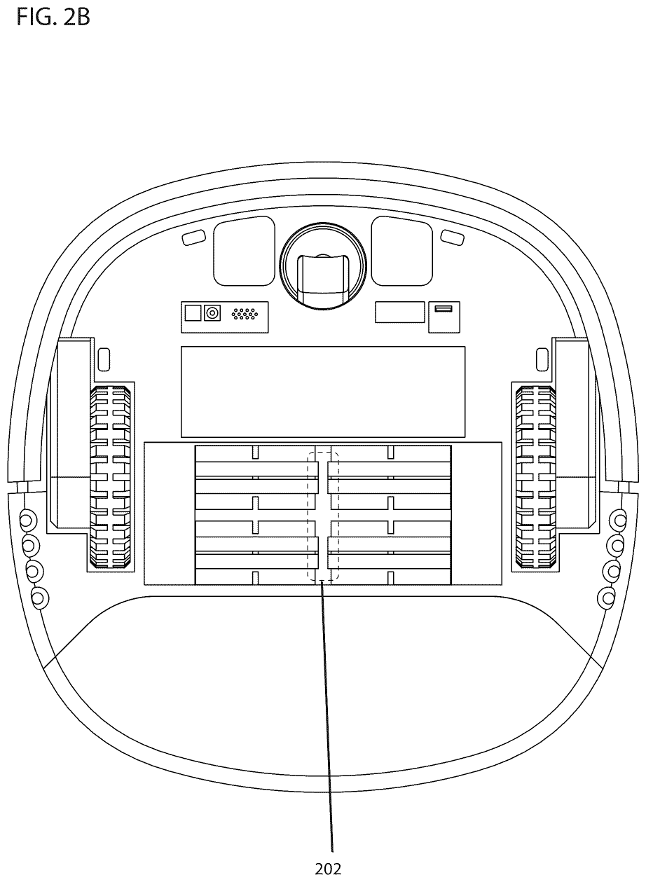

FIG. 2A illustrates the robotic cleaner with a removable roller brush housing 201. In some embodiments, the brush assembly of a robotic roaming device includes: the housing and brush rolls removably contained within the housing. In some embodiments, the brush assembly includes a housing and a pair of interleaved, counter-rotating brushes removably contained within the housing. In some embodiments, the brush assembly includes a brush guard having a number of brush guard bars, the brush guard bars positioned substantially perpendicular to the pair of counter-rotating brushes. FIG. 2B illustrates the robotic cleaner with the roller brush assembly with a gap 202 between the roller brushes. In some embodiments, a cleaning width of the cleaning robot comprises two portions, each cleaned with a roller connected to the housing from one end. In some embodiments, the two rollers may have a connection point between each other from the end that is not connected to the housing. In this embodiment, each roller brush is interlocked with the others during operation and can be disconnected for cleaning. This connection point may be in the middle of the housing and therefore in the middle of the brushing width. In some embodiments, where there is a connection point between the two brush rollers from the end that is not connected to the housing, each of the brush rolls can be disconnected from the middle connection point manually and reconnected. In some embodiments, disconnecting the two roller brushes from the connection point in the middle can be done while the end connected to the housing remains attached. In some other embodiments, there may be a gap 202 between the two rollers in the middle of the housing. In these embodiments, the brushing width of the robot consists of two portions, each of which is a roller connected to one side of the housing. As pieces or clumps of hair are sucked in and picked up by the brush, it tends to move in a spiral fashion around the brush shaft and usually tangles around the bristles and/or the rubber parts of the brush. Having the gap in the middle of the brush provides an opening for the vacuum to duck the hair in as the brush rotates. In some embodiments, the housing further includes cradles positioned along one end of the housing. In some embodiments, an end cap is positioned along the end of the housing. In some embodiments, the hollow core is a cylinder that is spun with a drive axle. In some embodiments, two rollers are counter-rotating and the blades are interleaved. For example, one of the two roller brushes rotates clockwise and the other counterclockwise. This guides the dust and debris to where the vacuum suction opening is located. In one example, one of the two roller brushes rotates intermittently, pausing at set intervals, while the other rotates continuously. In another example, one of the two roller brushes rotates inward toward the center of the robot, while the other rotates outward away from the center. In some embodiments, the opening of the vacuum suction is in the middle of the housing, and the rubber blades guide the dust and debris to the middle. In some embodiments, the opening of the vacuum suction is on a side of the housing, and the spiral arrangement of the blade guides dust and debris to the side where the opening is.

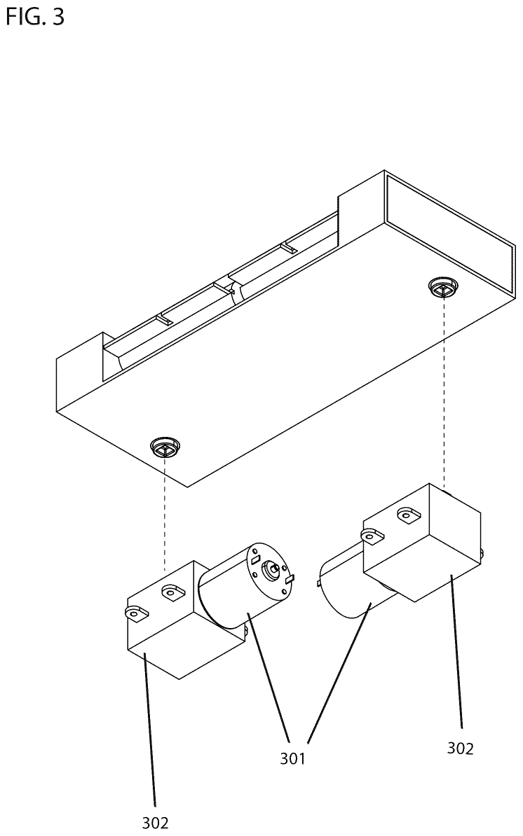

FIG. 3 illustrates each side of the brush being controlled by a separate motor 301 and gearbox 302. In some embodiments, the roller brush assembly has a gap between the right side and the left side of the brush. In this embodiment, each side is rotating using a different set of motor 301 and gearbox 302. The gap between the right side and the left side is to reduce the amount of tangled hair on the brush. In some embodiments, the gap is placed at the end of the brush, meaning the roller root (core) is only connected to the gearbox on one side, and there is a gap on the other side.

FIGS. 4A-4C illustrate a robot vacuum with a dual brush system where the brush rubber flaps are twisted. Similar to FIG. 1, the roller brushes are disjointed from the middle, and the rubber flaps are removable. In some embodiments, the rubber blades are slid onto the roller or core in a spiral fashion. In some embodiments, the rubber blades are an extension of the roller or core in such a way that the rubber blades are in a spiral fashion. In some embodiments, the direction of the twist on each side is mirrored. In this embodiment, the direction of the twist guides the dust and debris to be collected in the middle. This will be aligned with the placement of the vacuum suction opening. In some embodiments, the blades are in the form of a screw-type compressor with spirals that weave into each other. In some embodiments, the brush roll includes a hollow or semi-hollow core with two or more blades, each positioned along the hollow core. In some embodiments, the two or more blades along the hollow core are organized in a spiral path. In some embodiments, the blades are positioned equidistant from one another. In some embodiments, bristle rows are interleaved with blades. In some embodiments, the blades have a number of cutouts extending along their length. In some embodiments, the hollow root includes at least one key on one side of the hollow root for mating with a keyway along a drive axle. In some embodiments, the brush rolls or the blades are manufactured from a material selected from the group consisting of: a natural rubber, a polymeric compound, a siliconized polymeric compound, a flexible material, a semi-flexible material, and combinations thereof.

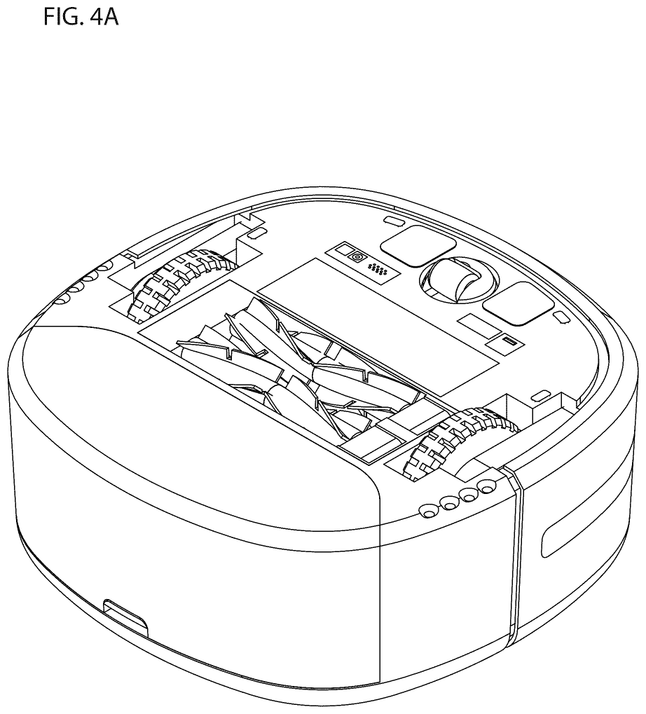

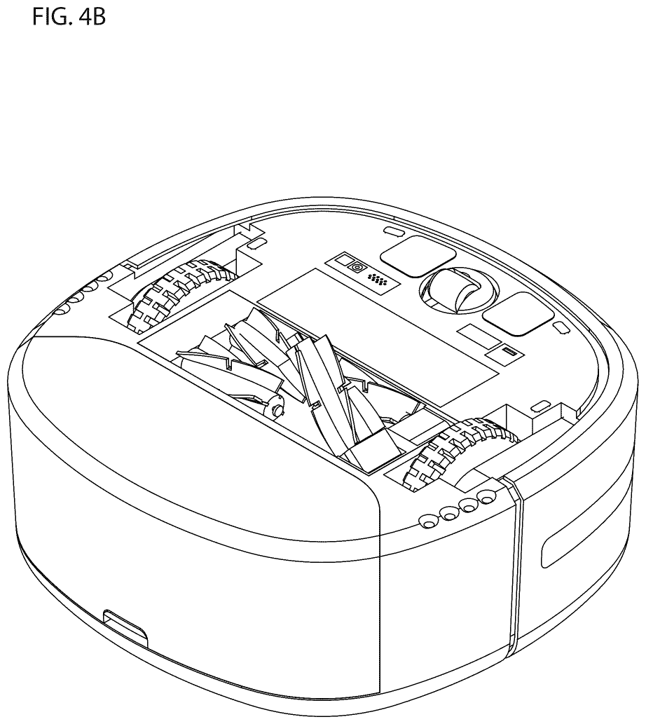

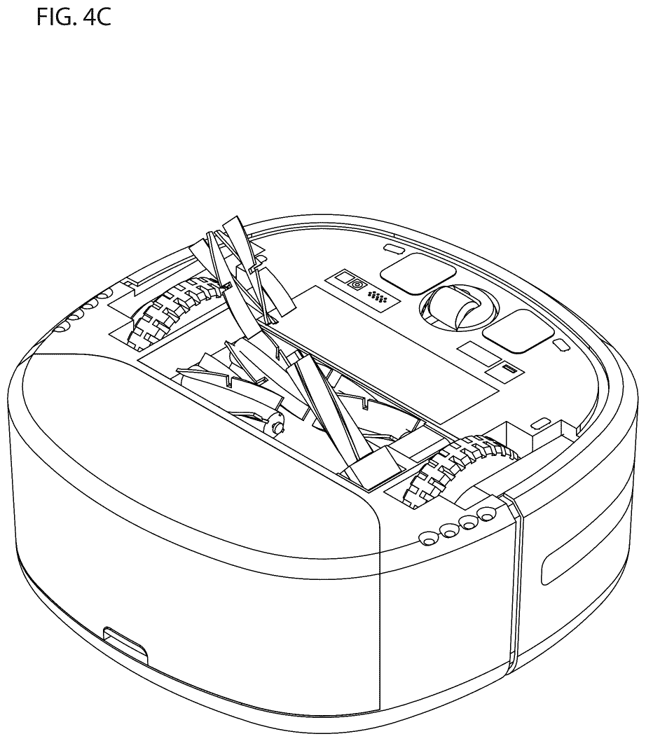

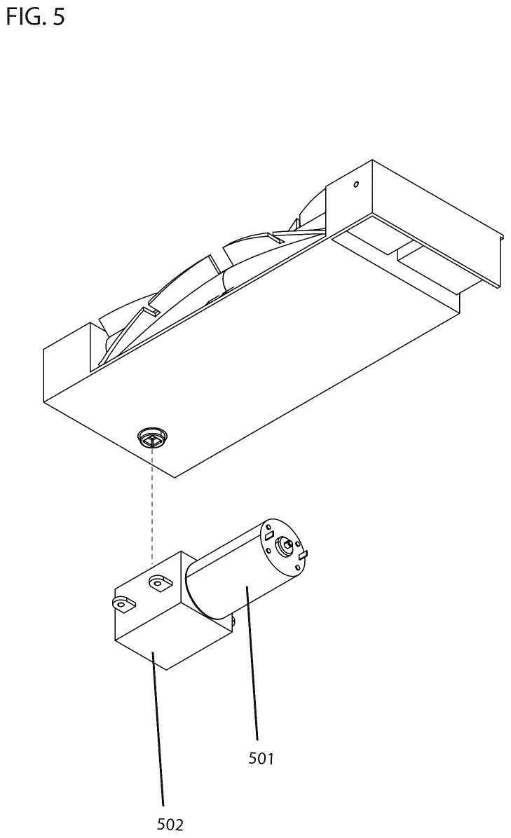

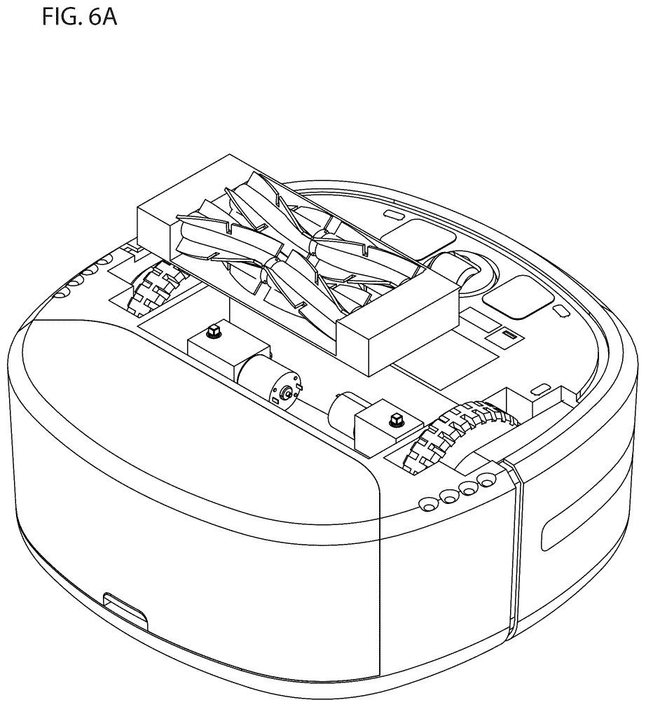

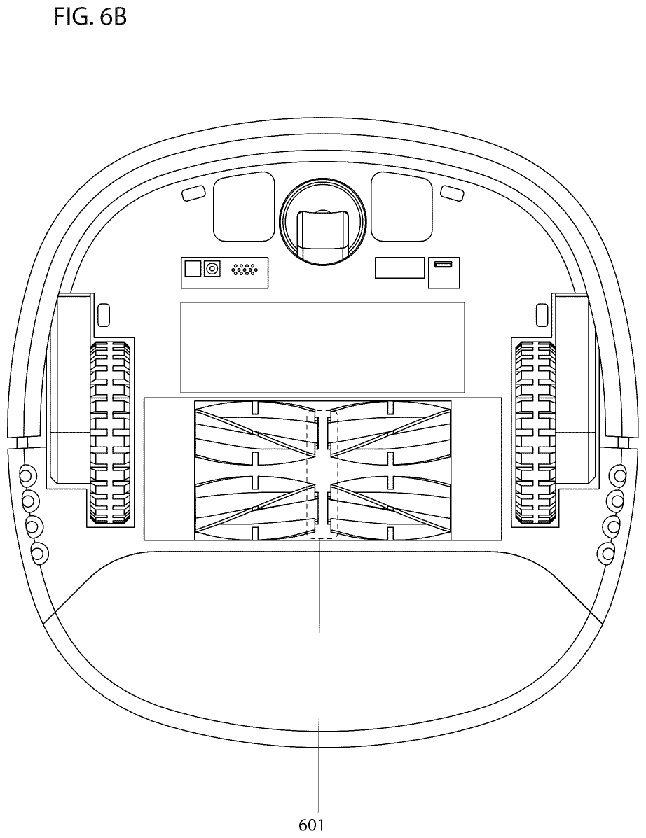

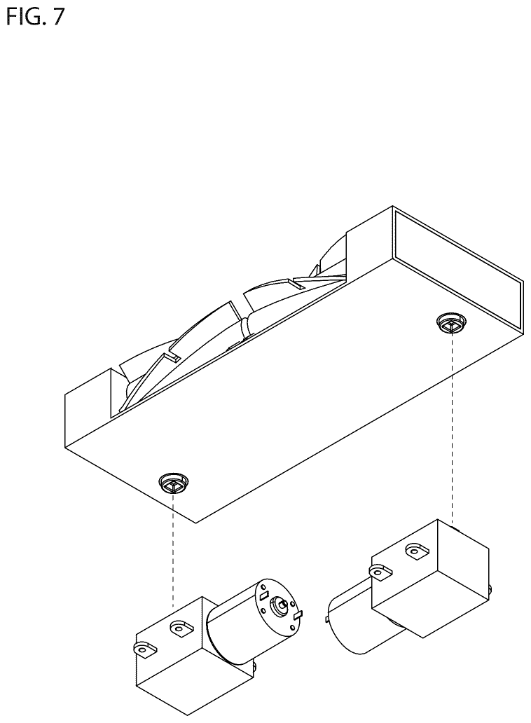

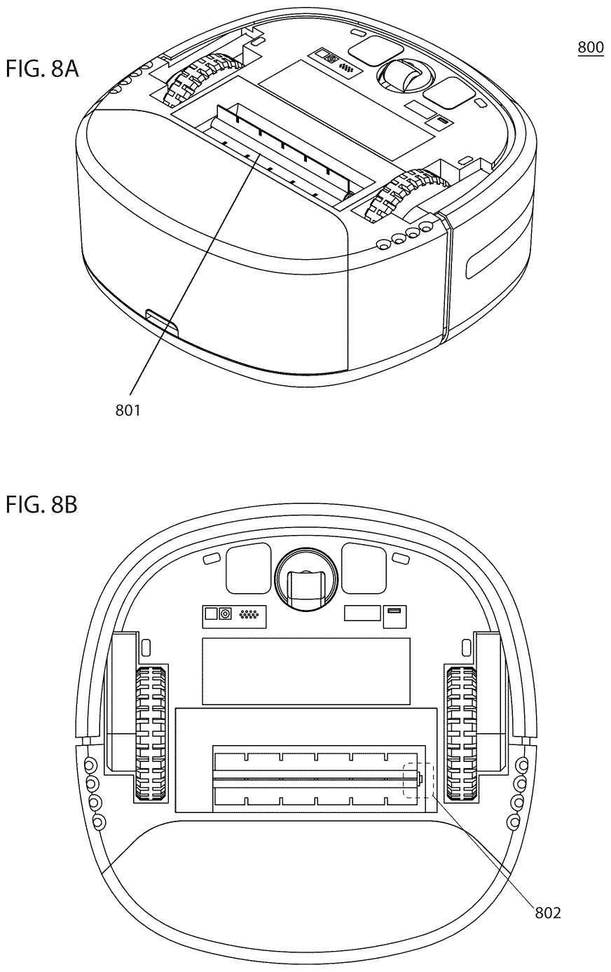

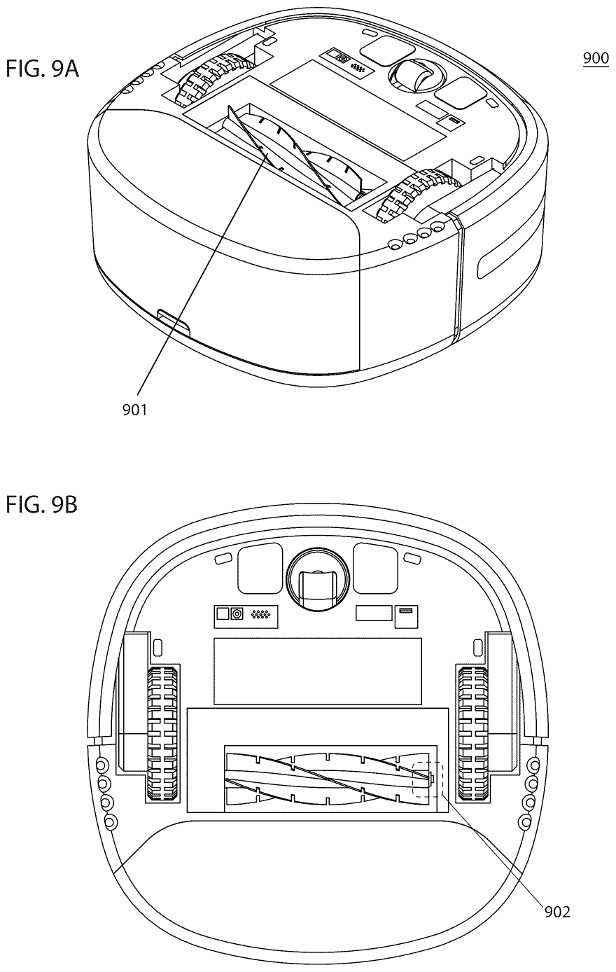

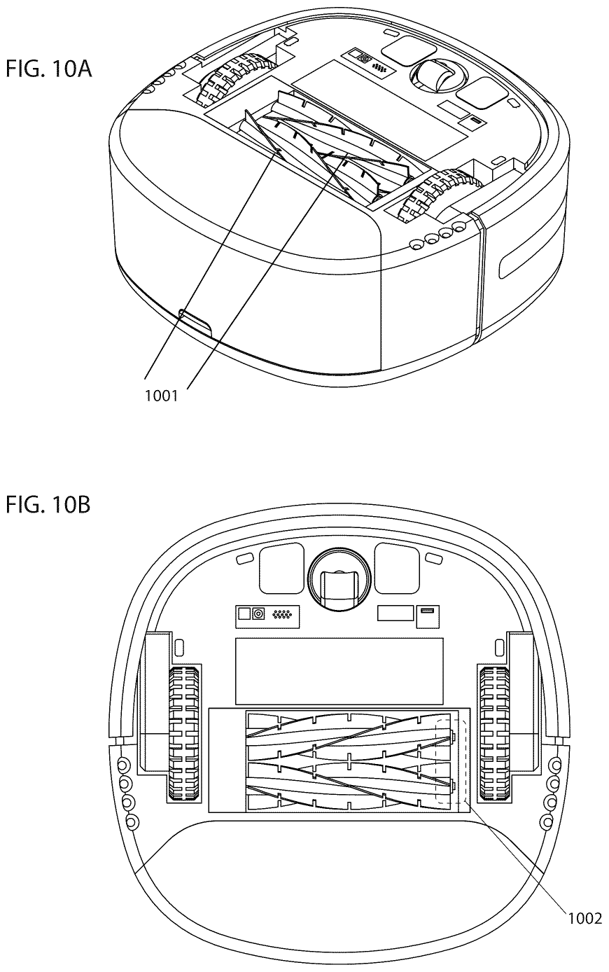

FIG. 5 illustrates a single motor 501 and gearbox 502 connection to the brush module of FIG. 4A. FIGS. 6A and 6B illustrate a robot vacuum with a dual brush system, where the brush rubber flaps are twisted and a gap 601 is present in the middle of each brush. FIG. 7 illustrates that each side of the brushes with twisted flaps is controlled by a separate motor and gearbox. FIGS. 8A and 8B illustrate a robot vacuum cleaner 800 with a single brush 801, where there is a gap 802 between one end of the brush and the body of the brush compartment. FIGS. 9A and 9B illustrate a robot vacuum cleaner 900 with a single brush 901 with twisted flaps where there is a gap 902 between one end of the brush and the body of the brush compartment. FIGS. 10A and 10B illustrate a robot vacuum cleaner with a dual brush system 1001, where there is a gap 1002 between one end of the brushes and the body of the brush compartment. In some embodiments, the direction of twist is mirrored between the two brushes, which guides dust and debris towards the open end of the brush. In some embodiments, brushes are connected from one end to minimize the chance of entanglement with hair, wires, earphones, etc., and allow for disentanglement without intervention. Brushes connected at one end further ease manual cleaning by allowing the user to pull entangled hair or wire from the open end. In some embodiments, settings of the brush can be adjusted, wherein the settings include a rotation speed of the brush.

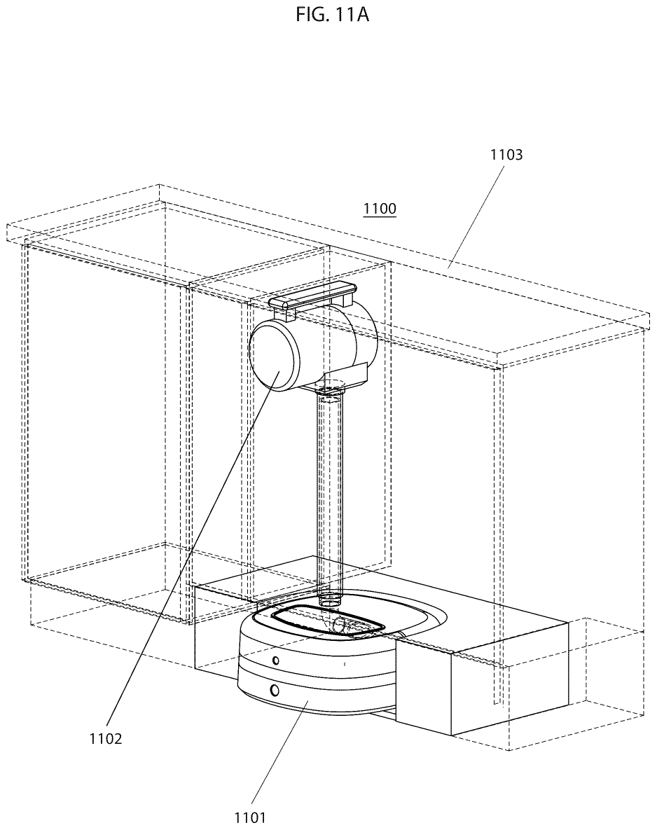

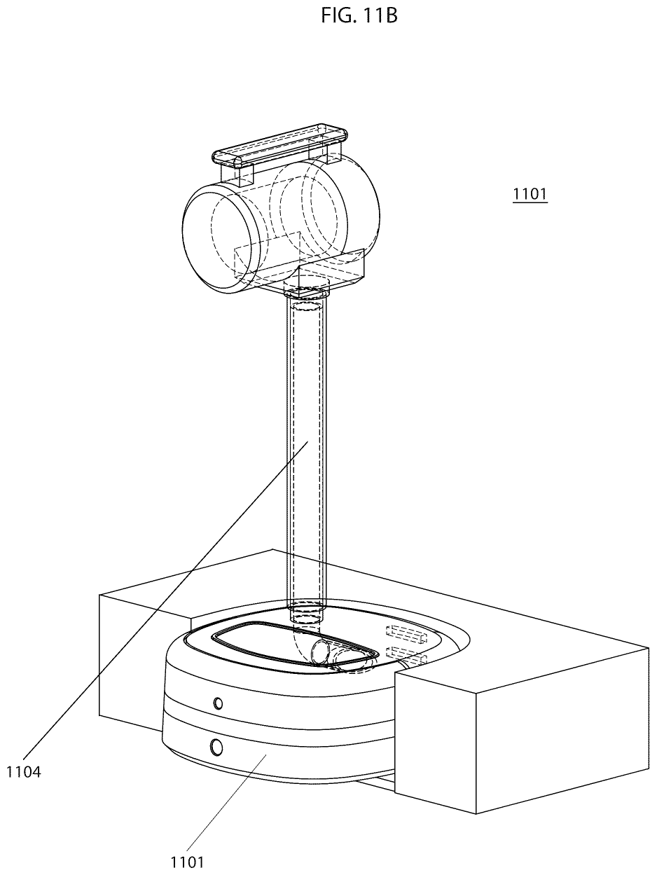

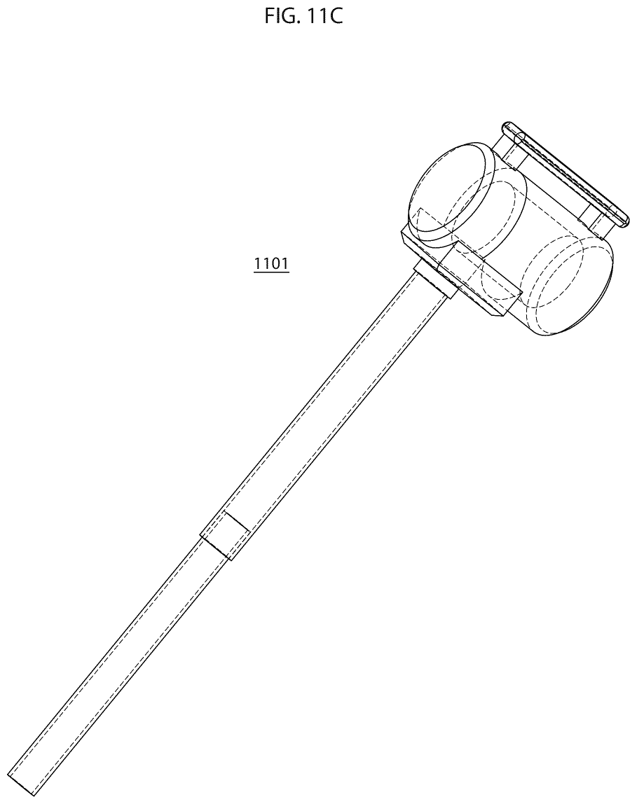

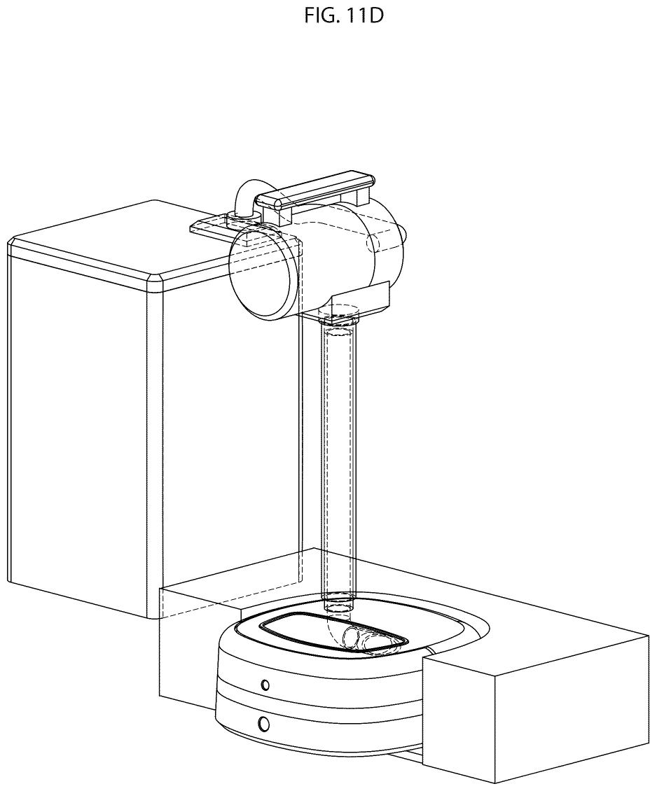

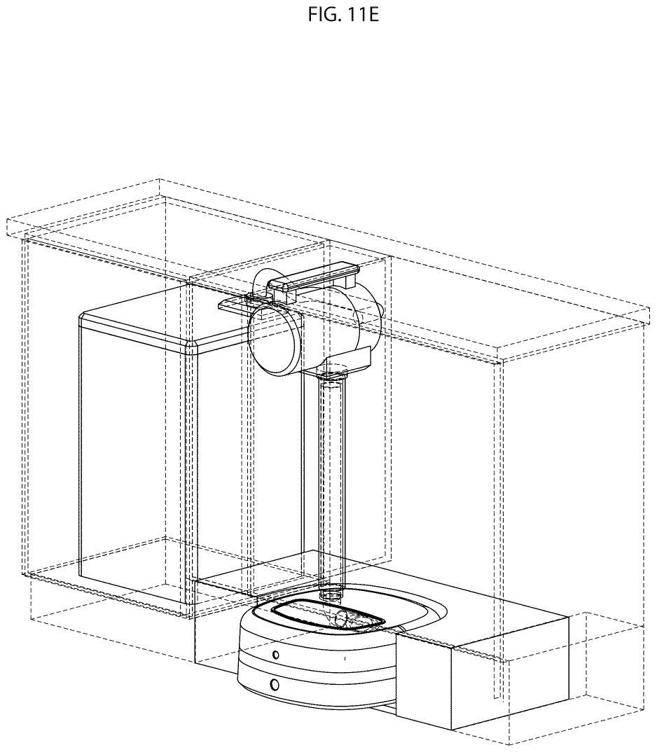

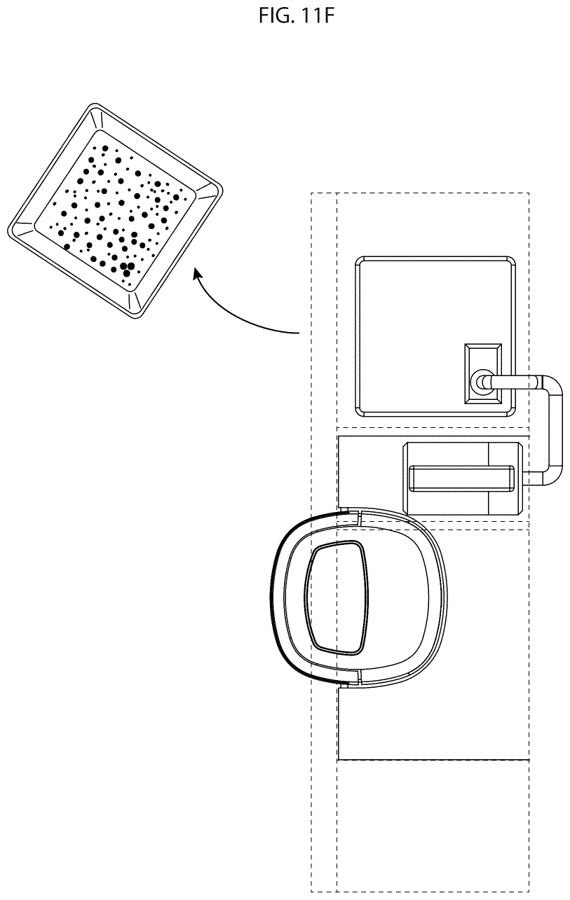

FIGS. 11A and 11B illustrate a built-in station system 1100 for a robotic vacuum cleaner 1101 and a handheld vacuum cleaner 1102, where the station is built into a cabinet system 1103 and is equipped with a self-emptying mechanism for both devices. The built-in station system comprises at least one stationary robotic device. In addition to the stationary robotic device, the system further comprises either a handheld roaming device that is roamed around by a user and can be placed back on the stationary robotic device or a robotic roaming device comprising wheels that autonomously navigates an environment, performs a coverage routine, and cleans a surface as it covers the surface and then parks into the stationary robotic device to remain parked until the next run, or to recharge or be serviced. In addition to the stationary robotic device, the system may comprise both one or more handheld roaming devices and the one or more robotic roaming devices. In some embodiments, the roaming device may be a handheld sweeping device with a brush roll, or a robotic sweeping device with one or more brushes. The handheld sweeping device or a robotic sweeping device may comprise a vacuum component to create negative air pressure and suction to lift the dirt and debris. In some embodiments, the roaming device may be a handheld washer device that applies clean fluid to the floor or to a roller and sucks dirt, debris, and waste liquid back. The robotic system may be installed in the environment as an appliance. In some embodiments, the robotic system may appear seamlessly integrated into the environment, much like kitchen appliances such as a dishwasher or stove are built into a kitchen. In some embodiments, the roaming handheld device is a handheld vacuum cleaner or a stick vacuum cleaner, and the robotic stationary device is a charging station. In some embodiments, the roaming handheld device is a handheld vacuum cleaner or a stick vacuum cleaner, and the robotic stationary device is a charging station with the capability to suck the dirt out of the handheld stick vacuum. In some embodiments, the robotic station provides services to other devices, which may be robotic or manual devices. In some embodiments, the robotic stationary device is equipped with a feature to initiate an auto-empty upon placement of the stick vacuum or the press of a button on the stick vacuum, a button on the robotic stationary device, or an application in a communication device. In some embodiments, the robotic stationary device is equipped with a feature to initiate an auto-empty according to a schedule provided. In some embodiments, the schedule is provided via an application in a communication device.

FIG. 11C illustrates the handheld device, which may be separated or removed from the built-in system and used for cleaning and then be placed back for charging or being cleaned. In some embodiments, the handheld device may be moved around by a user and placed back on the built-in station system. FIGS. 11D-11F illustrate that the handheld device and the robotic roaming device are connected to the stationary device of the built-in cabinet system. In some embodiments, the robotic system or a part of it (i.e., the stationary robotic device) is connected to the plumbing system of the house for a supply of clean water and is connected to the sewerage system for disposing of wastewater. In some embodiments of the robotic system, the stationary robotic device accommodates multiple cleaning devices: some are robotic, some are not robotic, and some are semi-robotic. For example, the stationary robotic device may provide service for a handheld cleaning device, such as a stick vacuum cleaner, stick mop, or stick steam mop as well as a multifunctional roaming robotic device.

Depending on the handheld device's functionality, the stationary robotic device provides robotic services when the handheld device is placed on it. For example, the stationary robotic device may clean the mopping pads of a handheld mop. In another example, the stationary robotic device may refill the water container of a handheld mopping device or a handheld steamer. In another example, the stationary robotic device may empty the dust collected by a stick vacuum into a dust bag or a larger dustbin on the stationary robotic device. In some embodiments, the stationary robotic device may compress the collected dust and debris. In another example, the stationary robotic device can wash (and/or dry) the mopping pad of a stick or handheld mopping device or fill its fluid reservoir with water or cleaning fluid. In another example, the stationary robotic device may recycle the wastewater into clean water and use the clean water for further use. It is not a requirement for this invention to have components that are shared among various tools of the system. For example, a handheld mopping device may have a stationary robotic device that refills the fluid of the handheld mopping tool automatically without having any vacuuming component or a roaming robotic component. Similarly, a handheld vacuuming tool may have a stationary robotic device that empties the dust and debris from the handheld vacuum or sweeper without having any mopping component or any roaming robotic component. In some embodiments, one stationary robotic device is used for a handheld vacuum and a roaming robot vacuum. In some embodiments, one stationary robotic device is used for a handheld mop and a roaming robot mop. In some embodiments, one stationary robotic device is used for a handheld vacuum and a roaming robot vacuum and mop. In some embodiments, one stationary robotic device is used for a handheld mop and a roaming robot mop and vacuum. In some embodiments, one stationary robotic device is used for a handheld steamer and a roaming robot mop, vacuum, and steamer. In some embodiments, one stationary robotic device is used for a handheld mop. In some embodiments, one stationary robotic device is used for a handheld vacuum. In some embodiments, one stationary robotic device is used for a handheld steamer.

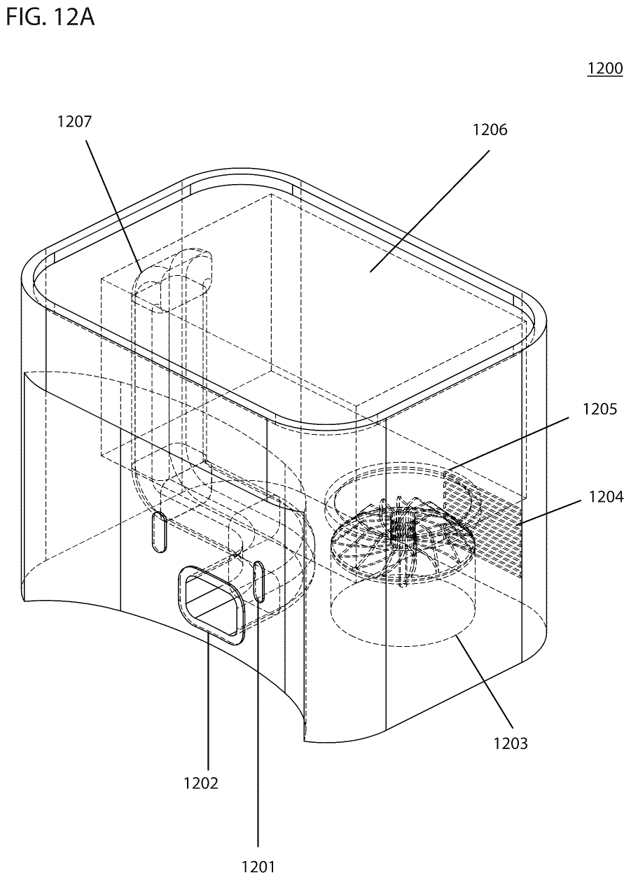

FIG. 12A illustrates a stand-alone station 1200 with an auto-emptying mechanism for a robotic vacuum. In some embodiments, the robotic system is stand-alone. The station comprises at least charging contacts 1201, dust intake port 1202, a vacuum motor 1203, an exhaust 1204, a filter 1205, a dustbag 1206, and a dustpipe 1207. For example, in this embodiment, the stationary robotic device of the robotic system is standalone such that the stationary robotic device is manually placed in a part of the house and the roaming device parks into the station or is placed onto the station for service, or to remain parked, placed, or docked until the next run. In these embodiments, there is no integration with the environment, and the stationary robotic device can be manually carried and placed in a different part of the house or environment. In this configuration, stationary does not suggest that the stationary robotic device is not movable. It merely suggests that it acts as a station, a dock, or a parking place. In some embodiments, the station is equipped with multiple components to support the operation and maintenance of a robotic vacuum. The charging contacts 1201 are configured to recharge the battery of the robotic vacuum during docking. In one example, the charging contacts are strategically positioned to ensure consistent electrical connectivity with the charging terminals of the robotic vacuum, enabling efficient energy transfer. The station also comprises a dust intake port 1202 designed to receive debris collected by the robotic vacuum. In some embodiments, the dust intake port is aligned with the dust outlet of the robotic vacuum, facilitating the transfer of dust and debris from the robotic vacuum to the station. To support the transfer process, the station includes a vacuum motor 1203 that generates the necessary suction to draw dust and debris through the intake port. In one example, the vacuum motor is designed to operate at variable speeds, optimizing suction based on the amount of debris being transferred. The exhaust 1204 is provided to expel air after debris has been collected. In some embodiments, the exhaust is equipped with noise-reduction features to minimize operational noise during use. A filter 1205 is included to capture fine particles and prevent them from being released back into the environment. In one example, the filter is a high-efficiency particulate air (HEPA) filter, ensuring filtration of allergens and fine dust. The station is further equipped with the dust bag 1206 to store collected debris. In some embodiments, the dustbag is replaceable and designed with a locking mechanism to securely contain debris and prevent accidental spillage during disposal.

The dust pipe 1207 is incorporated to connect the dust intake port to the dust bag. In some embodiments, the dirt and debris are emptied into a dust-collecting bag or a dust-collecting bin. The feature is enabled with a vacuum motor inside the stationary robotic device, and one or more dust paths, pipes, and gaskets. In some embodiments, the robotic stationary device comprises a filter. In some embodiments, the robotic stationary device comprises a dustbag that is treated with activated carbon or active charcoal. In some embodiments, the filter is HEPA. In some embodiments, the manual roaming device is a stick or handheld vacuum, and the dust container has an opening with a one-way spring-loaded latch such that when the handheld device is placed on the robotic stationary device, its container opening aligns with the station's dustpipe opening, and the dustpipe opening gasket seals the gap between them. In some embodiments, upon placement with a small force, an aperture opens. In some embodiments, the aperture is opened with a negative air pressure created by the suction motor on the robotic stationary device that opens the spring-loaded latch. Upon opening of the aperture, dust and debris are sucked in with the force from negative air pressure and flow through a pipe to reach the dustbag and remain trapped in it. Depending on the size and the frequency of use, the dust bag will be filled after several rounds, which in some embodiments is replaced manually and in other embodiments is replaced automatically.

FIGS. 12B and 12C illustrate a roaming device or a robotic vacuum parking or docking into the stationary station or robotic device. In some embodiments, the stationary robotic device provides services to the roaming device, such as a robotic vacuum, whether the roaming device is manual or a mobile robotic device. In some embodiments, the stationary robotic device can be described as a robotic parking station, a robotic docking station, a robotic service station, and the like, autonomously performing a series of tasks on the roaming device. In one example, the stationary robotic device may be integrated into the environment allowing for the roaming robotic device to leave the station, clean the surface and navigate back and park into the robotic station. In some embodiments, the roaming robotic device navigates the environment and cleans the floor surface as it moves on the floor. The roaming robotic device returns to the robotic parking station device where a series of services are performed on it by the robotic parking station device autonomously. In some embodiments, the services provided by the robotic station may comprise cleaning the cleaning tools that the roaming device engages with the floor to clean the floor whether manually or autonomously, recharging the battery of the roaming device, replenishing the supplies of the roaming device, and the like. In some embodiments, when the roaming device applies the cleaning tools or cleaning components to the floor to clean it, components of the cleaning tool or cleaning components absorb dirt and will be required to be cleaned before the next round of cleaning job. For example, one of the cleaning tools that the roaming device (whether handheld or robotic) applies to the floor is a mopping tool comprising a mopping pad component that either needs to be replaced before the next session or washed/cleaned. For example, the stationary robotic device may dispense cleaning fluid upon the user placing the manual roaming device on it and pressing against it. The stationary robotic device may have some stationary ridges that a mopping manual roaming device can be pressed against while the mopping components rotate and get cleaned. When the rotating mopping component is manually held against the stationary ridges and rotates, it gets cleaned as the cleaning fluid is dispensed. The stationary robotic device may then release heat and blow air to dry the mopping pad. Further, in another embodiment, the rotating mopping plate may have a lever or a mechanism to activate a component on the stationary robotic device to rotate or move to clean the stationary robotic device itself. In another example, the stationary robotic device may dispense cleaning fluid upon the robotic roaming device parking to get its mopping pads washed. The robotic roaming device may park from the front side or rear side. The robotic roaming device may have rotating plates that press against ridges on the stationary robotic device. In some embodiments, the stationary robotic device may have some stationary ridges as well as some moving components. The robotic roaming device may move itself by moving back and forth, moving a component up and down, or pressing down a component such as the mopping pad. When the rotating mopping component of the robotic roaming device rotates in the parked position, the mopping component is placed in an ideal position to rub against the stationary ridges. Cleaning fluid may be dispensed, and waste fluid may be collected automatically.

Heated air may be blown or ultraviolet UV-C may be applied to the cleaning plate to prevent bacteria from accumulating or building up. Further, in another embodiment, the rotating mopping plate may have a lever or a mechanism to engage with a component on the stationary robotic device to activate a movement which may be used to increase the scrubbing effect or may be used to clean the stationary robotic device after servicing the robotic roaming device.

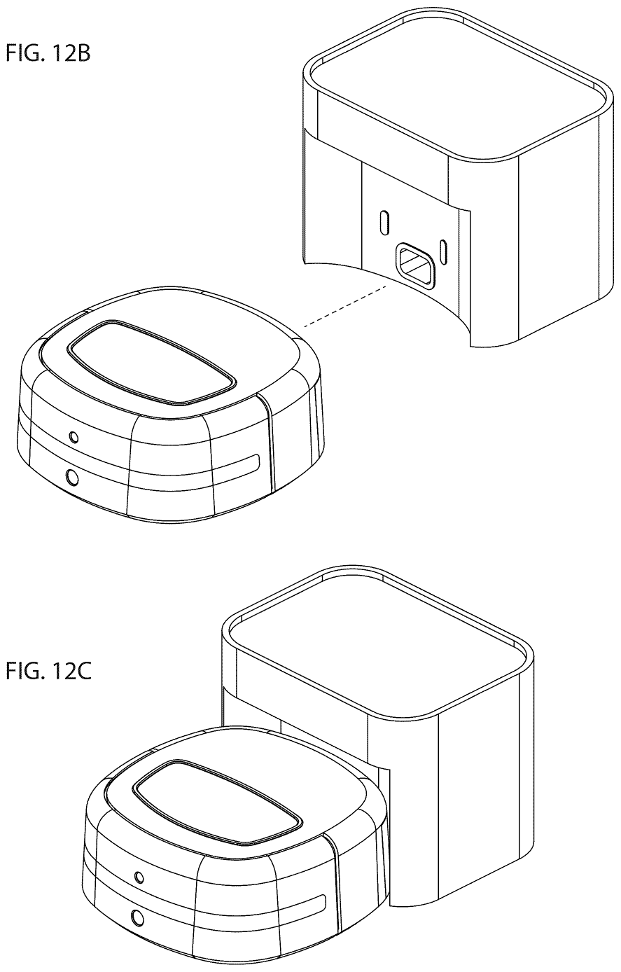

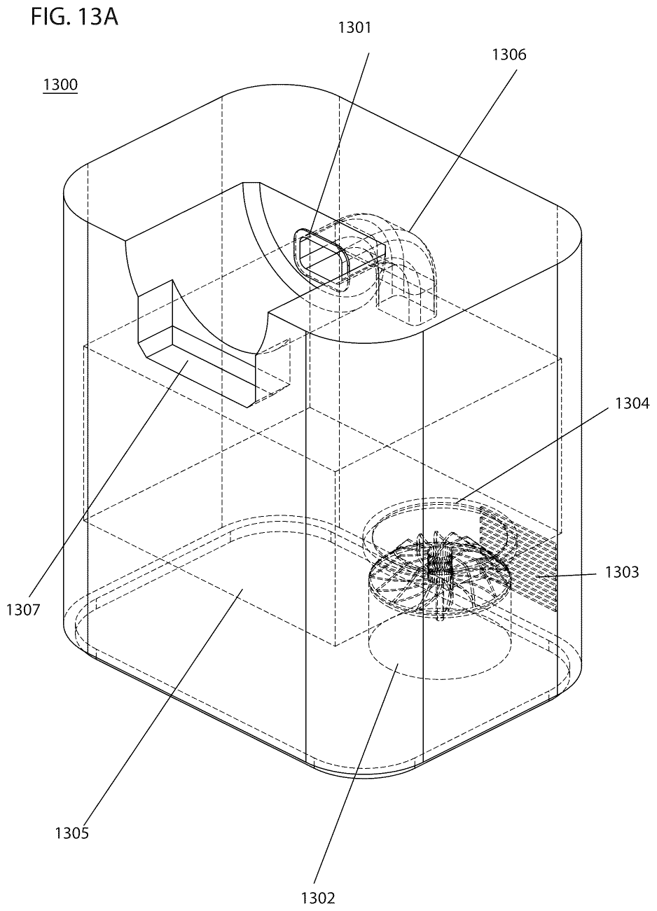

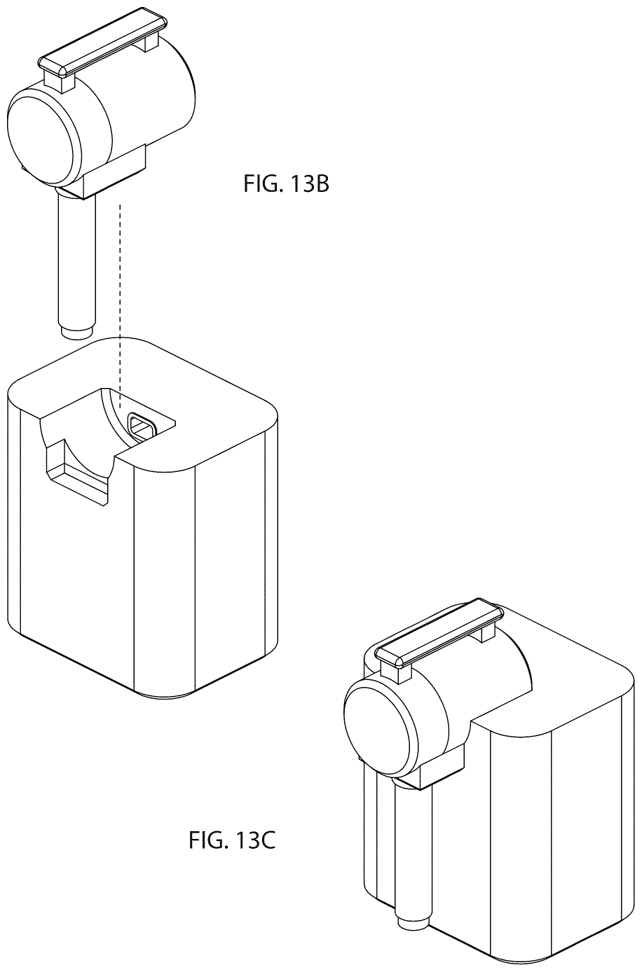

FIG. 13A illustrates a stand-alone station 1300 with an auto-emptying mechanism for a handheld vacuum. The station comprises at least dust intake port 1301, a vacuum motor 1302, an exhaust 1303, a filter 1304, a dustbag 1305, a dustpipe 1306, and charging contacts 1307. In some embodiments, a handheld vacuum cleaner has a charging station. In some embodiments, this charging station is equipped with an auto empty feature which empties the vacuum cleaner's container into the dust collecting bag. On the handheld vacuum side, the container has an opening with a one-way spring loaded latch. When the handheld vacuum cleaner is placed on the station, its container opening aligns with the station's dustpipe opening and the dustpipe opening gasket seals the gap between them. Then the vacuum motor on the station turns on which causes a suction force throughout the system. This suction force opens the spring-loaded latch and the dust and debris flow through the handheld vacuum container, to the dust pipe and will be trapped into the dustbag. Depending on the size and the frequency of use, the dust bag will be filled after several auto-empty rounds and has to be replaced. For example, a dust bin on the stationary robotic component can accommodate the dust and debris emptied from the robotic roaming device and the handheld device. This will allow the user to empty a single bin for maintenance rather than having to deal with emptying multiple dust bins. Similarly, a clean fluid tank can be shared to fill a handheld mop, a hand held steamer, or a robotic mop or steamer, or to wash components of the handheld mop, or to wash components of the stationary robotic device itself. Similarly, a wastewater tank may be used for storing water that is collected from various sources. Similarly, the same power source can be used to charge the battery of the handheld cleaning devices, roaming robotic devices, and power the stationary robotic device. Similarly, the same plumbing arrangement can be used to supply water for refilling all roaming cleaning devices (robotic or handheld), to wash certain components of the roaming cleaning devices (robotic or handheld), or further to wash certain components of the stationary robotic system. Similarly, the same connection to the sewerage system can be shared to dispose of waste water collected from all of the devices or used for all purposes. FIGS. 13B and 13C illustrate the handheld vacuum may be manually placed with the station.

FIG. 14 illustrates two stations being modular and can be stacked on top of each other. In some embodiments, the stationary robotic device or station may be designed to be modular such that the service provided by one module is used for more than one of the roaming devices, and even for itself. For example, the stationary robotic device may provide services for a handheld mop and a handheld vacuum. In some embodiments, the stationary robotic device may be designed to be modular such that the service is provided for a robotic roaming cleaning device and one or more handheld cleaning devices. In some embodiments, a robot vacuum station is stacked with a handheld vacuum station such that the handheld vacuum station is over the robot vacuum station. For example, a stationary robotic device may be designed such that servicing parts for handheld cleaners are stacked on top of the stationary robotic device, and servicing parts for robotic roaming cleaners are stacked on the bottom of the stationary robotic device or on the side. Any geometric configuration may be implemented. Any arrangement can be used to maximize efficiency and user experience. In some embodiments, a service-providing component of the robotic station device can be shared among more than one handheld vacuum cleaner or one or more handheld or roaming robotic cleaners.

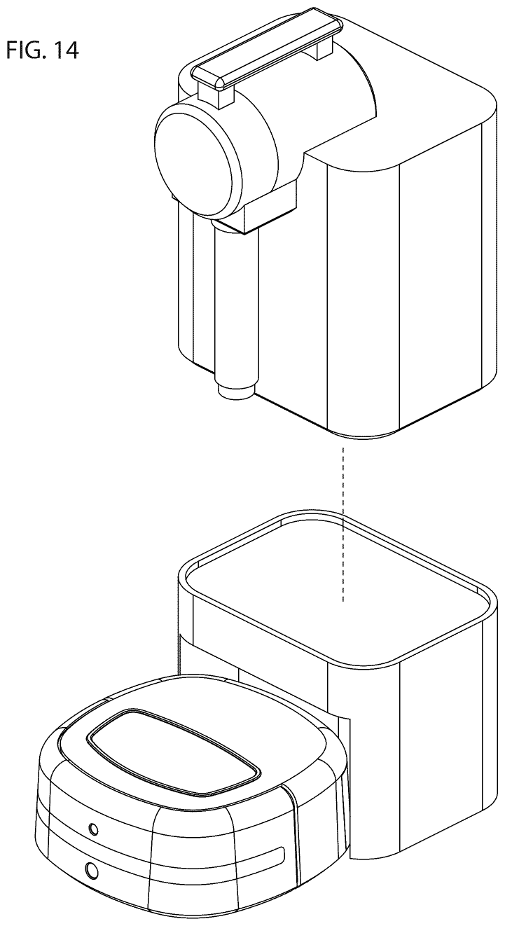

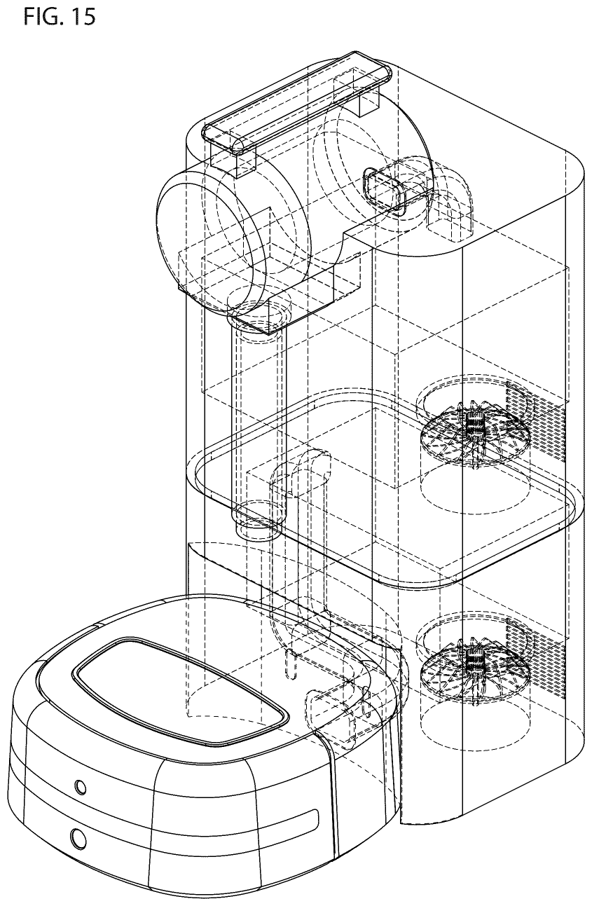

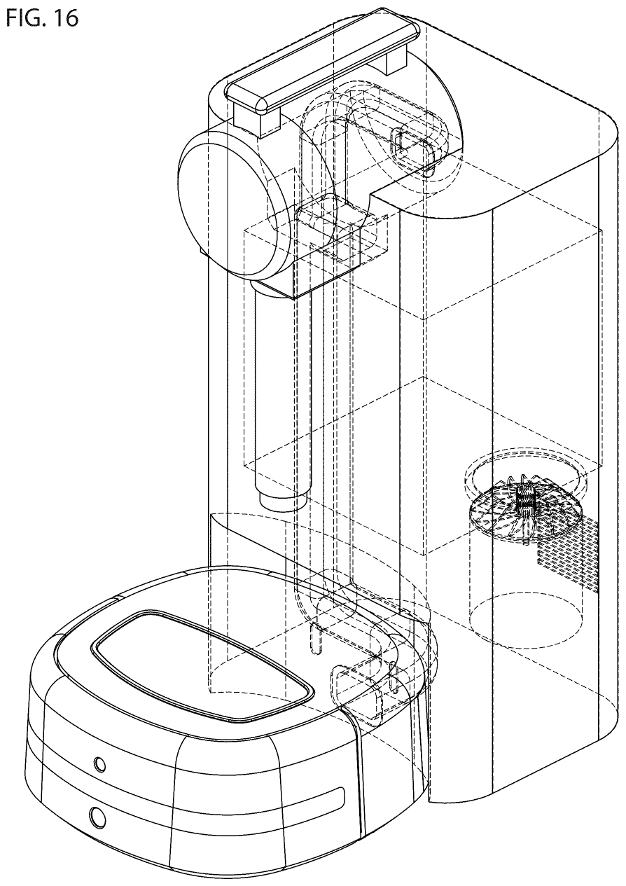

FIG. 15 illustrates stacked stations from a single unit and may perform independently from each other, while FIG. 16 illustrates a station with an auto-empty mechanism for both a robot vacuum and a handheld vacuum.

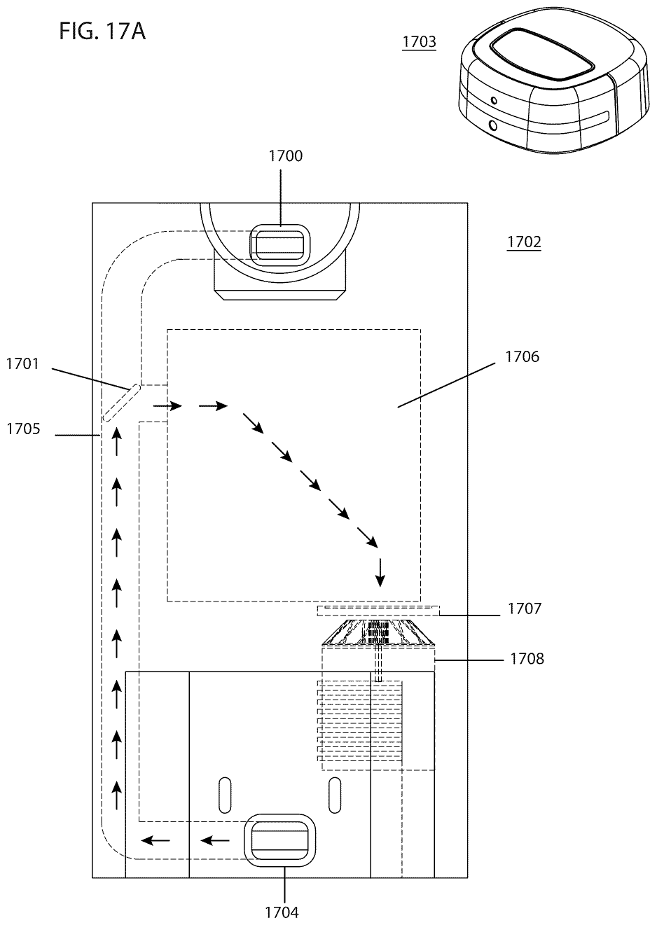

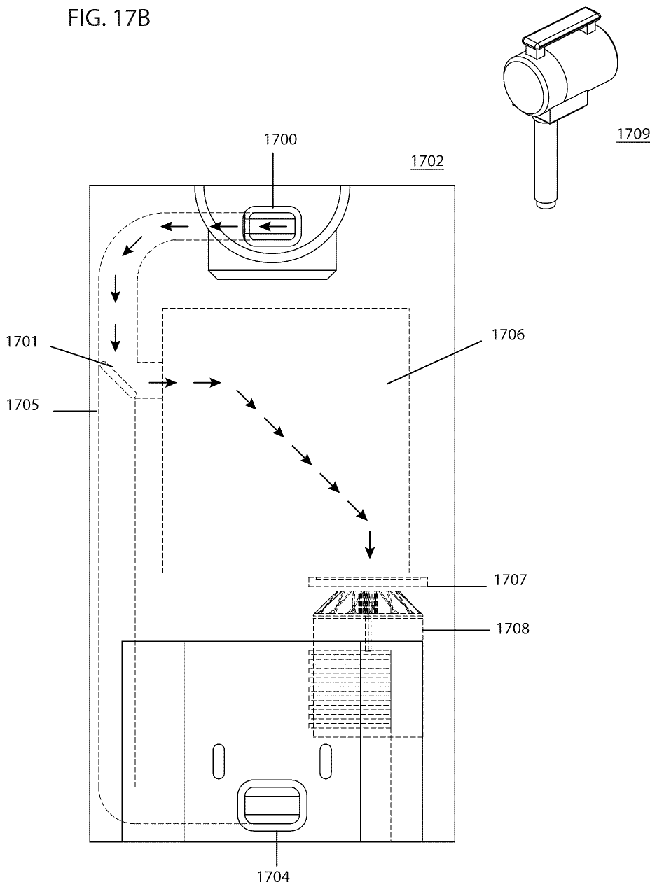

FIG. 17A illustrates a top dust intake port 1700 from a handheld vacuum is blocked by a pipe valve 1701 when a station 1702 is emptying a robot vacuum 1703. The station comprises a bottom dust intake port 1704 designed to receive debris from the robotic vacuum 1703, a dust pipe 1705 for channeling debris, a dust bag 2806 for securely storing collected debris, a filter 1707 to capture fine particles, and a vacuum motor 1708 to generate suction. FIG. 17B illustrates the bottom air intake port 1704 from the robot vacuum is blocked by the same pipe valve 1701 when the station 1702 is emptying the handheld vacuum 1709.

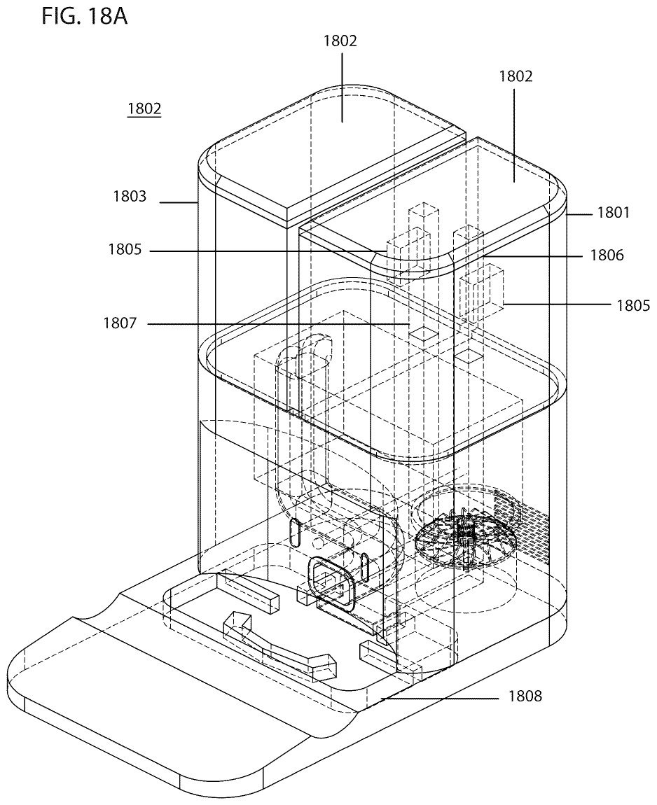

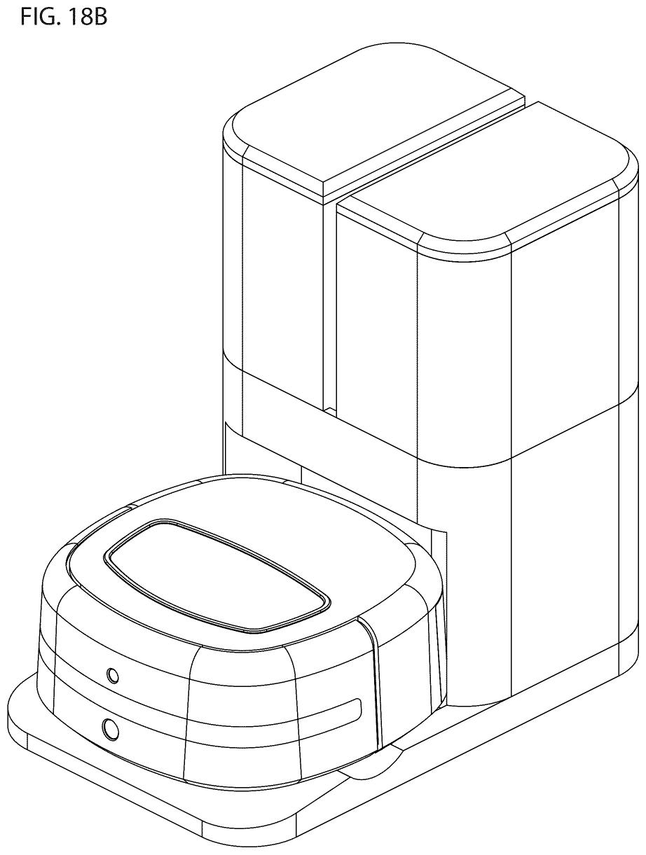

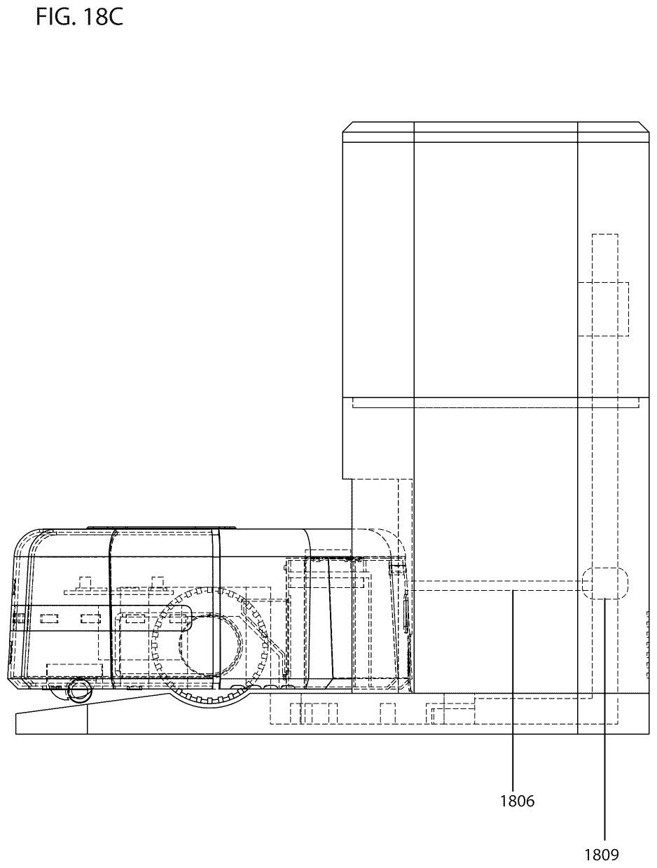

FIG. 18A illustrates a robot vacuum station 1800 with an auto-empty mechanism and an auto-refill and drain mechanism. Two water containers are placed on top of the station 1800, a clean water container 1801 with its lid 1802 which can be filled manually by a user, and a dirty water container 2903 with its lid 2904 for collecting waste or dirty water from a robot, cleaning the mop, or other cleaning devices. In some embodiments, the station 1800 comprises at least a pump 1805 within the clean water container which pumps clean water through a clean water pipe 1806, and a dirty water pipe 1807 that facilitates the transfer of waste or used water. In some embodiments, the vacuum station 1800 provides a cleaning tray 1808 at the base of the vacuum station. FIG. 18B illustrates a position of the robotic vacuum on the station during the charging or self-emptying and cleaning session. FIG. 18C is a side view of the station and the robotic vacuum, illustrating the water intake from the clean water container through a valve 1809 and the clean water pipe 1806 to a container of the robotic vacuum. In some embodiments, the device may have a wet mopping mechanism with a water container on the roaming robot. The station for said robot may have a mechanism to fill and drain the robot's container automatically. The auto-refill mechanism contains two separate containers on the station, one with a clean water supply for refilling the robot's water tank and cleaning the mopping pad, and the other for collecting dirty water from the robot (if the robot vacuums the dirty water from the floor) and collecting the water from cleaning the mopping pad. Once the robot is commanded to mop, the station pumps clean water from the clean water container into the robot's container, and the robot goes to mop the floor. After mopping is done and the robot returns to the station, a pump will drain what is collected in the robot's water container into the dirty water container. In some embodiments, water from the clean water container is used to clean the mopping pad or roller as well. This water, after cleaning, will be collected into the dirty water container. In some embodiments, a cleaning solution may be pumped into the robot's container along with clean water. In some embodiments, the robotic system or a part of it (i.e., the stationary robotic device) may have buckets to store clean water or cleaning fluid that are manually filled. In some embodiments, the robotic system or a part of it (i.e., the stationary robotic device) may have buckets to store wastewater or waste fluid that are manually emptied by the user. In some embodiments, the same single bucket has two compartments and the compartment sizes adjust with a separating mechanism that reacts depending on the proportionality of the clean liquid versus dirty liquid. This way the user has to deal with a single bucket starting with filling the bucket with clean fluid, and as clean fluid is depleted and waste water accumulates, the compartment sizes adjust to reduce the space for clean fluid and instead accommodate more space for waste fluid. When the bucket is filled with wastewater, the user empties the bucket manually. The same single bucket having two adjustable compartments can also be implemented on a manual roaming device and a robotic roaming device, such as a manual handheld floor washer or a mobile robotic floor washer. In both examples, the compartment sizes adjust with a separating mechanism that reacts depending on the proportionality of the clean liquid versus the dirty liquid. This saves space and allows the roaming device to be more compact.

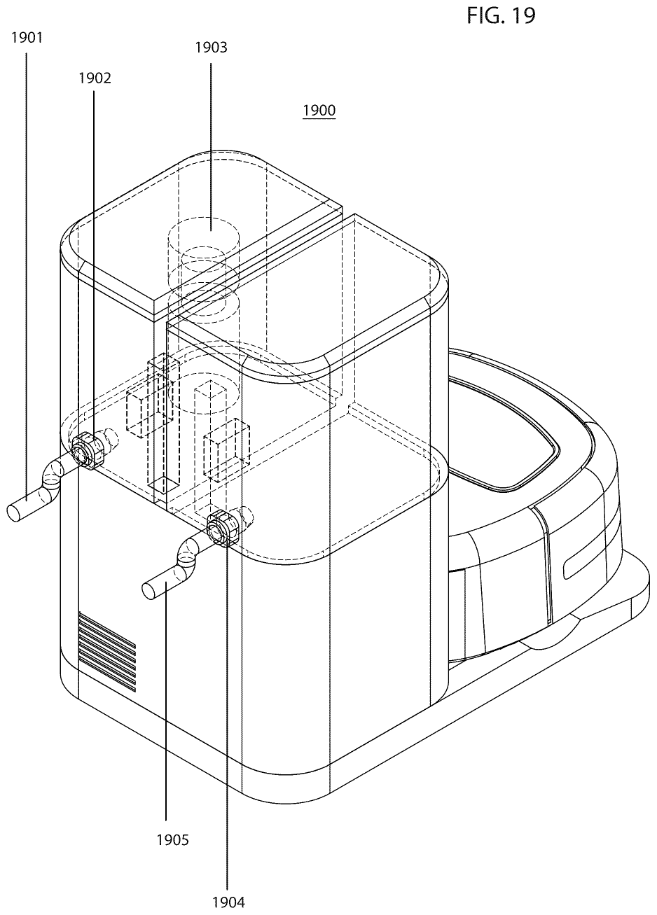

FIG. 19 illustrates an alternative embodiment of the station 1900 where the clean and dirty water containers are connected to the house plumbing system. In this system, water enters into the clean water container through a water inlet 1901 using a pressure valve 1902, the level of the water in the container is controlled by a floater 1903. Another valve 1904 is placed on the dirty water container which opens a drain 1905 after cleaning to drain the collected dirty water into the sewer system.

FIG. 20 demonstrates a stand-alone station converted to a connected station by replacing the container lids with a connection kit or tool kit. In some embodiments, the stand-alone robotic system may be converted into an integrated system with the use of a toolkit. In some embodiments, the toolkit may accompany the system at the time of purchase to provide an option and flexibility to the user to use the system in stand-alone form or in an integrated form as they choose. Alternatively, the toolkit may be purchased separately, allowing the user to choose the option of integrating the system with the plumbing and sewage system at a later time. It also helps to keep the cost of the system lower if integration with the environment is not needed.

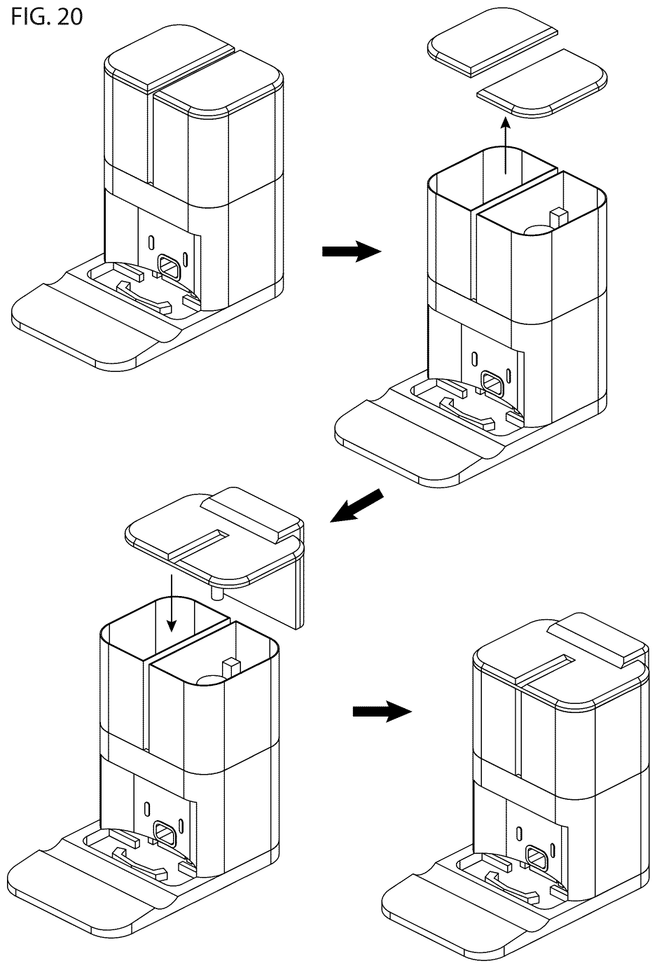

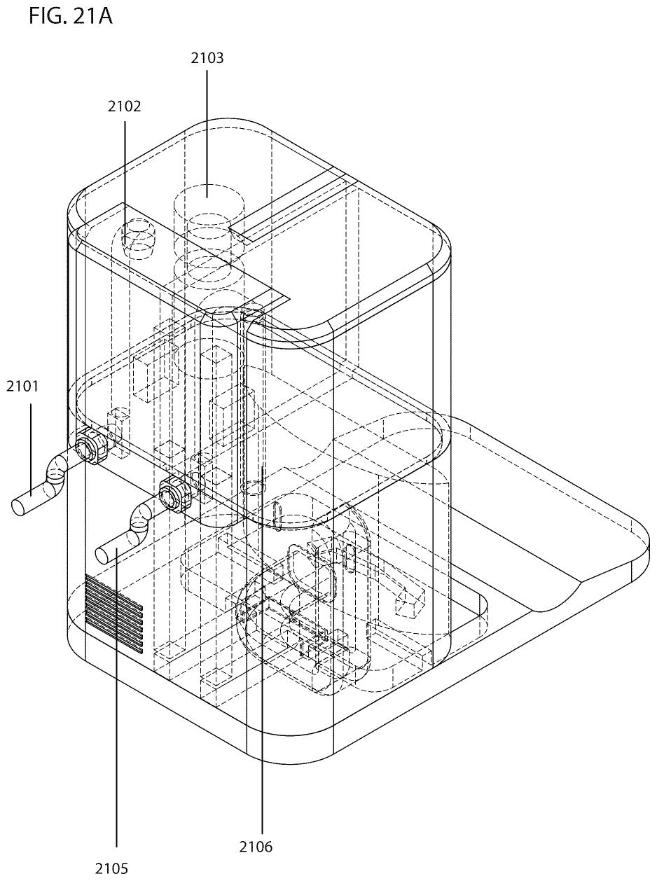

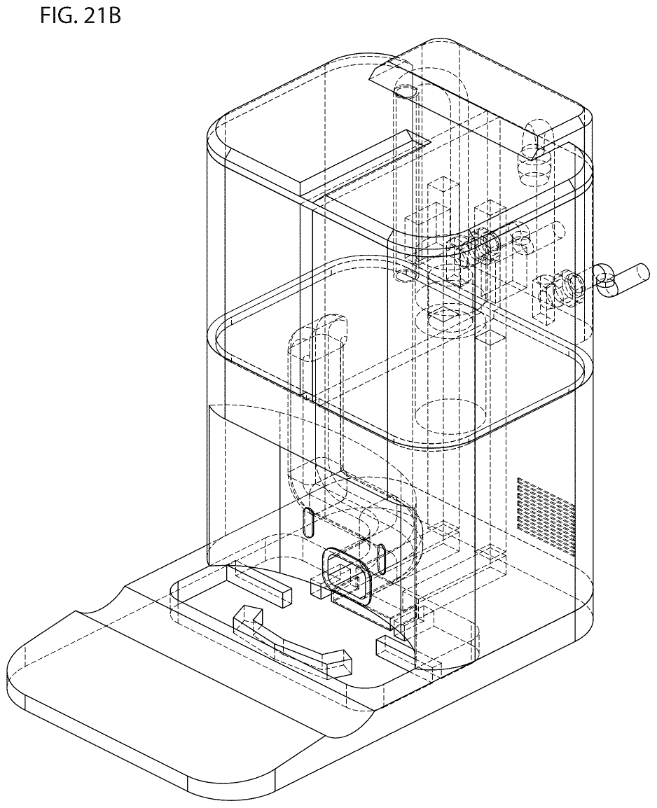

FIGS. 21A and 21B illustrate the connection kit as connected to the station. In some embodiments, water enters the clean water container through a water inlet 2101 using a pressure valve 2102, and the level of the water in the container is controlled by a floater 2103. In some embodiments, water is drained from the dirty water pipe 2106 within the dirty container of the station, and it is drained through the drain 2105 outside of the station, which is connected to the plumbing system of an environment.

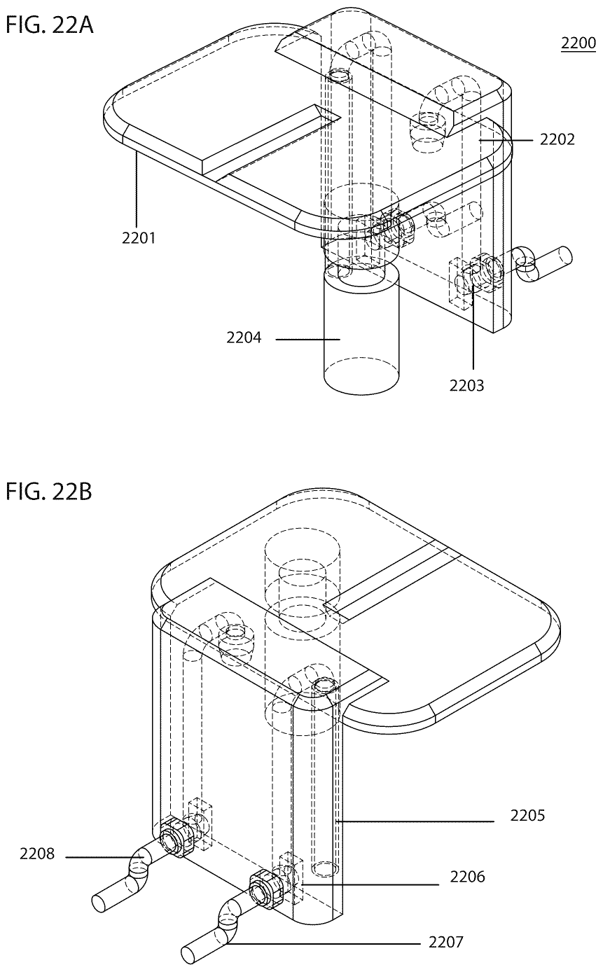

FIGS. 22A and 22B illustrate different components of the connection kit. Alternatively, a stand-alone station with auto refill and cleaning mechanisms can be converted to a connected station using a connection kit 2200. In this case, the top lids of water containers are replaced with the connection kit with a body 2201. The connection kit will then be connected to the house plumbing system. The connection kit consists of a water intake pipe 2202, which is connected from the plumbing system to the clean water container side. A pressure valve 3303 will stop when the clean water container is full, and a floater 2204 determines the water level of the clean water container. The floater 2204 controls the pressure valve 2203 either mechanically or electronically. On the dirty water container side, the connection kit has a drawing pipe 2205 stretched to the bottom of the container, a pump 2206 to drain the water upward, and a connection pipe 2207 from the kit to the sewer system. In some embodiments, there is also a connection pipe 2208 that connects the plumbing system to the connection kit for clean water. The connection kit may have an independent power source or may take its power from the station. In some embodiments, both clean and dirty water containers are connected to the house plumbing system. In this system, when the user commands the robot to mop, first, the clean water container on the station will be filled using an electric pump or a valve. The amount of water in the bucket can be measured by sensors or a simple floater. Then water will be pumped from the clean water container into the robot's container, and the robot starts to mop the floor. Once done or once the water in the robot's container runs out, the robot returns to the station. Similar to the previous example, dirty water from the robot and/or cleaning the mopping pad will be collected into the dirty water container, and then will be drained from there using a flush system or draining pump.

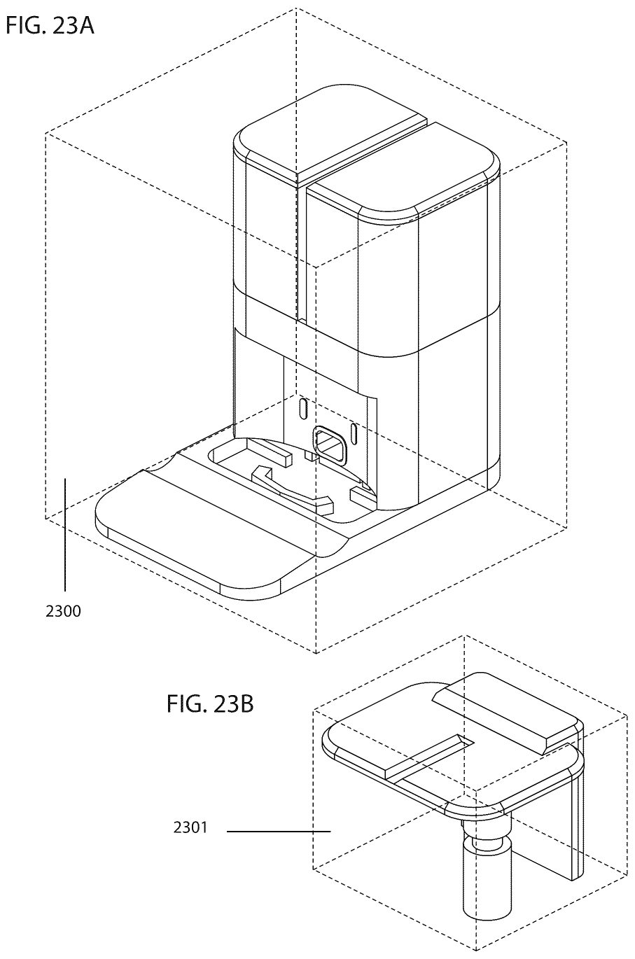

FIGS. 23A and 23B illustrate a station 2300 with an auto-emptying and auto-refill mechanism and a connection kit 2301. In some embodiments one emptying system on the robotic station device is used to empty the roaming robotic device and the handheld device into a shared dust bag or a shared container. In some embodiments of this system the dustpipe is branched into two pipes. One is for the roaming robotic device and one is for the handheld device. Once either of the devices are placed on the robotic station, the robotic station detects the type of the device and opens the correct branch of the dustpipe accordingly. It is also possible for the robotic station to perform the emptying in order. In some embodiments, the roaming robotic device may have a wet mopping mechanism with a water container on the roaming robotic device. The stationary robotic device may have a mechanism to fill and drain the robotic roaming device container automatically. The stationary robotic device may have a mechanism to fill and drain the robotic roaming device container automatically. The roaming robotic device may align itself autonomously with a particular direction for a particular service. In some embodiments, the stationary robotic device comprises two separate containers on the station, one with clean water supply and the other for collecting dirty water. In some embodiments, the stationary robotic device comprises a single container on the station that stores clean water and dirty water with a separation mechanism. In another embodiment, the single container has an adjustable space such that the container begins in a state that is filled with clean water and as clean water turns into waste water, the space that is freed up from the cleaning water being used, is now used to accommodate the wastewater that is produced. In some embodiments, once the roaming robotic device is commanded to mop, the station pumps clean water from the clean water container into the robot's container and the robot goes to mop the floor. This may be ideal for when the roaming robotic device is filled with hot water when the heating system is on the robotic stationary device. For example, a roaming robotic steaming device may be filled with hot water so the battery power required to generate steam on the roaming robotic device would be less. In some embodiments, once the roaming robotic device parks, the station pumps clean water from the clean water container into the robot's container and the robot will be ready to mop the floor when commanded to clean. In some embodiments, when a floor washing roaming robot completes its mission and parks into the robotic stations, a pump will drain what is collected on the roaming robot's waste water container into the waste water container of the robotic station. In some embodiments, water from the clean water container is used to clean the mopping pad or roller as well. In some embodiments, used or waste water after cleaning will be collected into the dirty water container. In some embodiments, a stationary robotic device may apply a detergent or cleaning solution with a pump into the roaming device's container along with clean water. In some embodiments, both clean and dirty water containers are connected to the house plumbing system. In some embodiments, the clean water container on the stationary robotic device will be filled using an electric pump, or a valve and maintained at a certain level. In some embodiments, the amount of water in the bucket can be measured by sensors or a simple floater. Then water will be pumped from the clean water container of the stationary robotic device into the roaming robotic device's container. Once done or once the clean water in the robotic roaming device's container runs out, the robotic roaming device returns to the stationary robotic device and parks to refill. In some embodiment, if the robotic roaming device is a floor washer with a mechanism to collect dirty water from the floor when washing the floor, the waste water will be pumped into the waste water container of the stationary robotic device, and then pumped into the sewerage system. In some embodiments, a flush system may be implemented to clean one of both of the containers.

FIG. 24 demonstrates a robot vacuum cleaner with a rotational axis 2400. In some embodiments, the cleaning tools on the manual roaming device may be a variety of tools with a variety of features, such as a scrubbing action, a vibration, a rotation, that are actuated to rub off the dirt more efficiently. Those cleaning tools may vibrate, oscillate, apply pressure, or actuate in a way that increases the efficiency of the cleaning. The axis of rotation may be parallel to the floor or normal to the floor. There may be one or more rotating components. The rotation of two rotating components may be in countering directions. Similarly, the cleaning tools on the robotic roaming device may be a variety of tools with a variety of features, such as a scrubbing action, a vibration, a rotation, that are actuated to rub off the dirt more efficiently. Those claiming tools may vibrate, oscillate, apply pressure, or actuate in a way that increases the efficiency of the cleaning. The axis of rotation may be parallel to the floor or normal to the floor. There may be one or more rotating components. The rotation of two rotating components may be in countering directions. Similarly, the cleaning tools on the stationary robotic device to clean the roaming device may be of various mechanisms to create a scrubbing action or cause a component of the robotic roaming device to rub against the robotic station and vice versa. The rubbing action may be created as a result of movement of at least one or more parts of the stationary robotic device alone, maybe created as a result of movement of parts of the roaming device (manual or robotics) alone, or a combination of them.

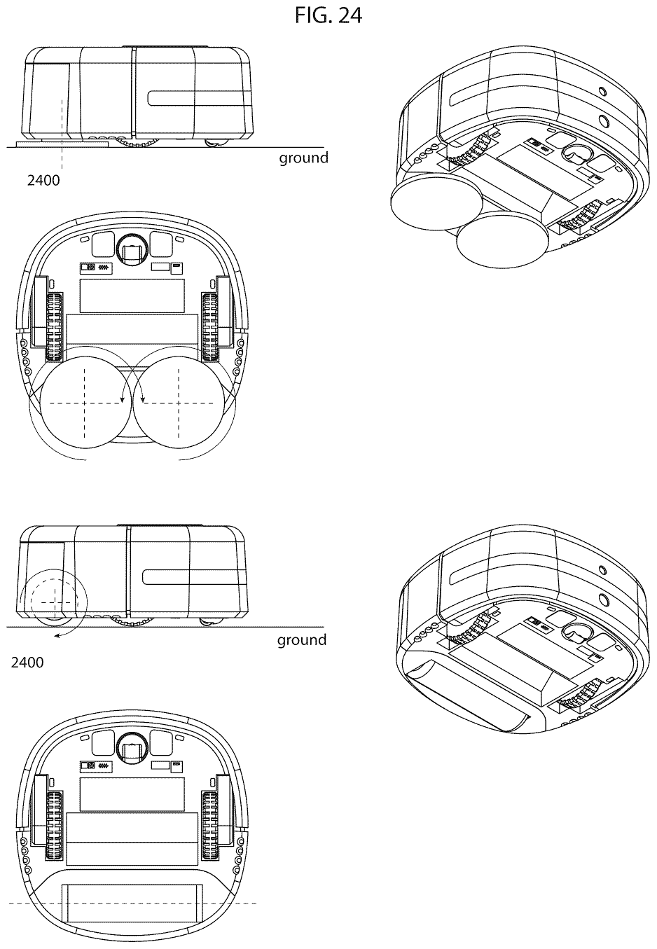

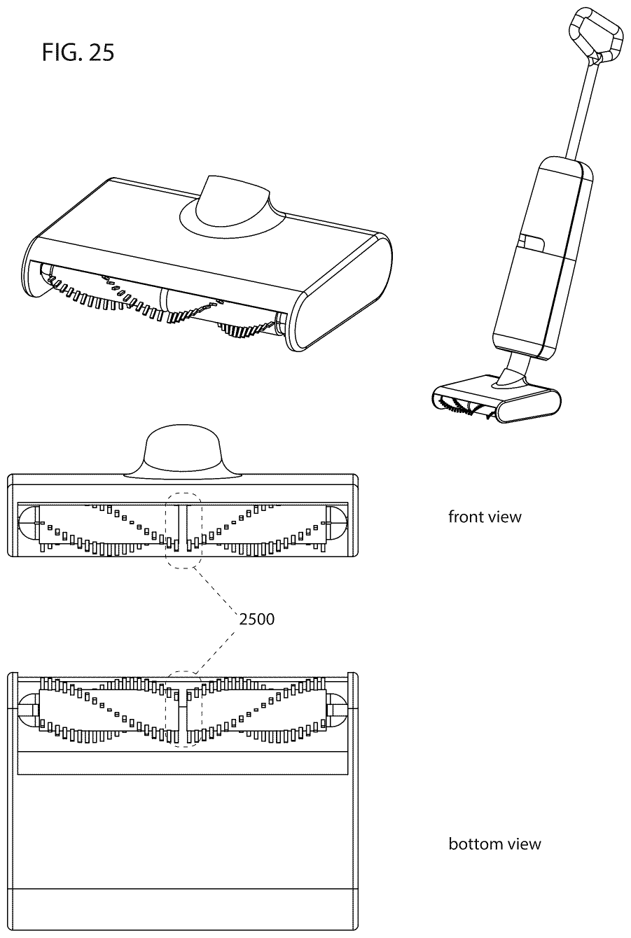

In some embodiments, a polymorphic upright cleaning device comprises a plurality of transformative cleaning heads, a parking platform with optional robotic service components and facilities, and one or more optional self-propelling components. FIG. 25 illustrates an embodiment of an upright polymorphic cleaner with a vacuum and sweeper head comprising a roller brush, wherein the roller brush has a gap 2500 positioned at the middle of its length dimension, which serves to reduce hair entanglement during operation as well as minimize the accumulation of hair in the central portion of the brush, thereby facilitating easier removal and maintenance of the roller brush. In some embodiments, the upright polymorphic cleaner has a body that encapsulates at least one motor, other cleaner components, and other actuation mechanisms that enable cleaning. The roller brush may be driven by the at least one motor or other actuation mechanisms to enhance cleaning efficiency, while other vacuum components assist in suctioning dirt and debris from the surface of the environment being cleaned. In some embodiments, the upright polymorphic cleaner has a handle that is ergonomically designed for grip, allowing users to maneuver the device comfortably during operation.

In some embodiments, the sweeper roller brush is designed for easy removal or cleaning through a hinged mechanism on each side, as shown in FIG. 26. The sweeper roller brush housing may include hinge connections that allow the sides to pivot outward, providing convenient access to the sweeper roller brush for maintenance. This configuration enables users to efficiently remove accumulated debris, hair, or other obstructions without requiring disassembly of the entire unit. In some embodiments, the hinges may incorporate locking mechanisms to ensure secure attachment during operation, while allowing quick release when cleaning is needed.

In some embodiments, an upright polymorphic cleaner includes a vacuum and sweeper head comprising a set of spiral rubber blades as illustrated in FIG. 27 which are configured to guide dirt and debris toward the center in a screw compression-like motion. This design enhances the efficiency of debris collection by directing particles toward the vacuum intake. Additionally, the roller brush is designed with hinged ends, allowing each side to pivot outward for easy removal and maintenance, wherein a gap 2700 is present to facilitate the removal. Once cleaned, the roller brush can be easily returned to its housing by pivoting the hinged ends back into place, where they securely lock into position to ensure stability during operation. This hinged mechanism not only facilitates quick cleaning but also helps reduce hair entanglement by minimizing the accumulation of strands along the roller. In some embodiments, the spiral rubber blades may be made of flexible yet durable materials to improve surface contact and optimize cleaning performance across various floor types of the floor surface of the environment.

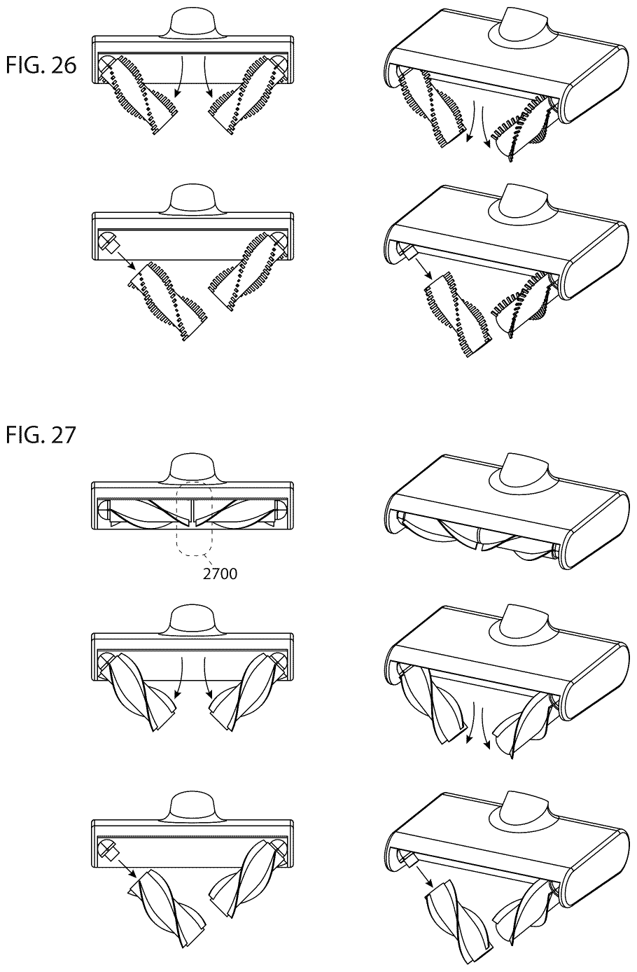

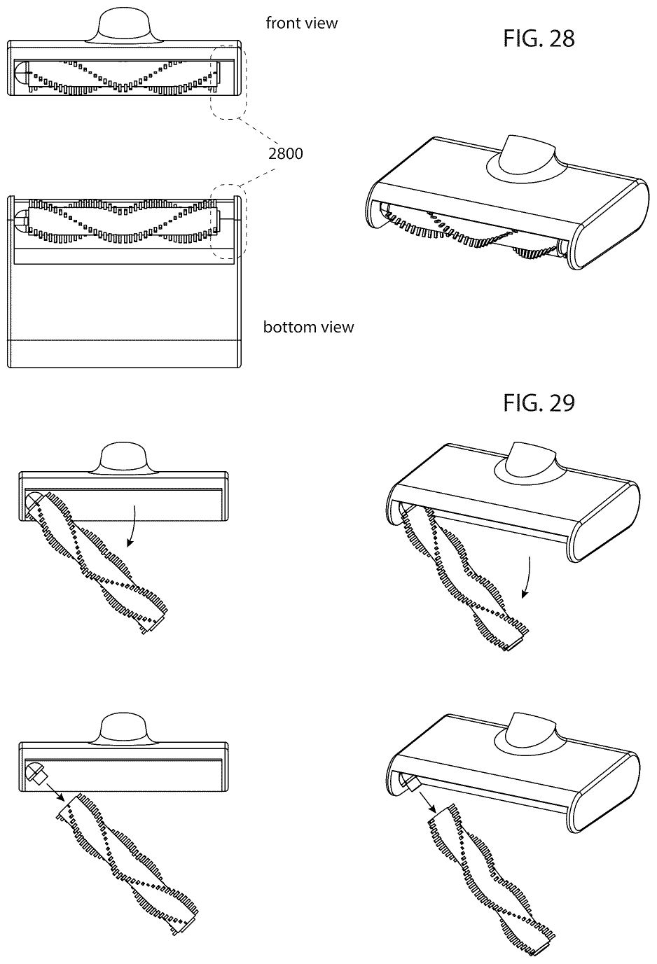

In some embodiments, an upright polymorphic cleaner includes a vacuum and sweeper head with a roller brush, where the roller is connected to the frame of the head from only one side as illustrated in FIG. 28. The opposite side of the roller connection features a gap 2800 designed to reduce hair entanglement and facilitate easy removal of accumulated debris. The roller brush incorporates a spiral arrangement of the roller brush, equipped with brush bristles, that efficiently guide dirt, debris, and hair away from the connection point and toward the gap. This strategic design minimizes blockages and enhances the effectiveness of the cleaning mechanism. Additionally, the suction hose is configured on the side where the gap 2800 is located, ensuring that collected debris is efficiently directed into the vacuum system.

FIG. 29 demonstrates a process of removing the roller brush. In some embodiments, the removal process of the roller brush is designed for user convenience. The roller can be detached from the frame by disengaging a single connection point, allowing for quick and easy maintenance. This feature enables users to efficiently clean or replace the roller brush without requiring extensive disassembly. In some embodiments, the connection mechanism may include a locking or latch system to ensure secure attachment during operation while allowing effortless removal when needed.

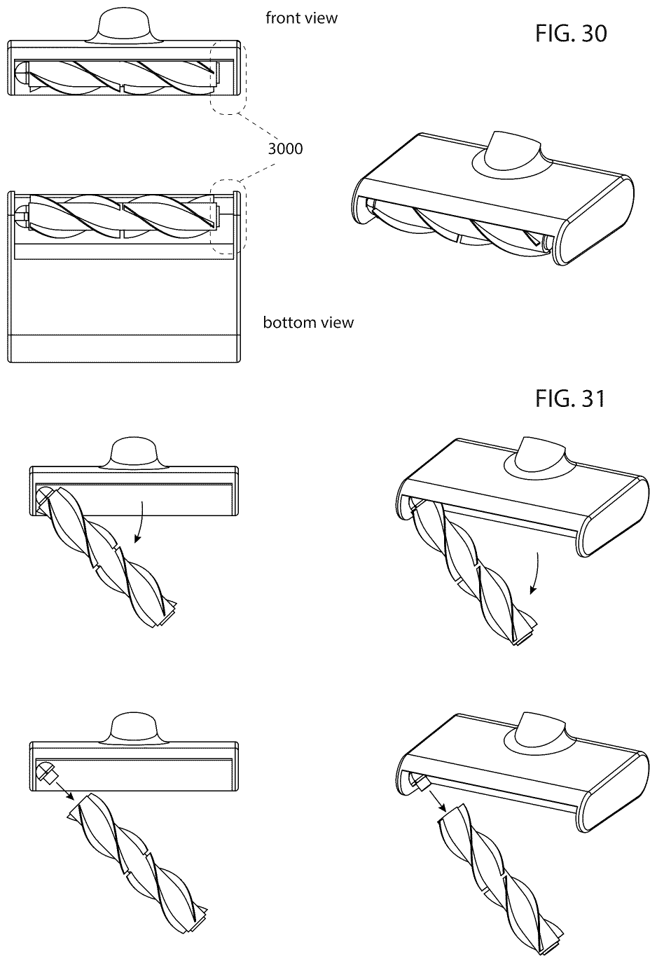

In some embodiments, an upright polymorphic cleaner includes a vacuum and sweeper head with a roller brush, where the roller is connected to the frame of the head from only one side. The opposite side of the roller connection features a gap 3000 designed to reduce hair entanglement and facilitate easy removal of accumulated debris. The roller brush is equipped with rubber blades as shown on FIG. 30 wherein the rubber blades are arranged in a spiral formation, with slits within the spiraling rubber blades to enhance airflow and prevent debris buildup. This configuration efficiently guides dirt, debris, and hair away from the connection point and toward the gap 3000, minimizing blockages and improving cleaning performance. Additionally, the suction hose is configured on the side where the gap is located, ensuring that collected debris is effectively directed into the vacuum system. FIG. 31 demonstrates a process of removing the spiral rubber brush. In some embodiments, the removal process of the roller brush equipped with the spiral rubber blades with slits is designed for user convenience. The roller can be detached from the frame by disengaging a single connection point, allowing for quick and easy maintenance. This feature enables users to efficiently clean or replace the roller brush without requiring extensive disassembly. In some implementations, the connection mechanism may include a locking or latch system to ensure secure attachment during operation while allowing effortless removal when needed.

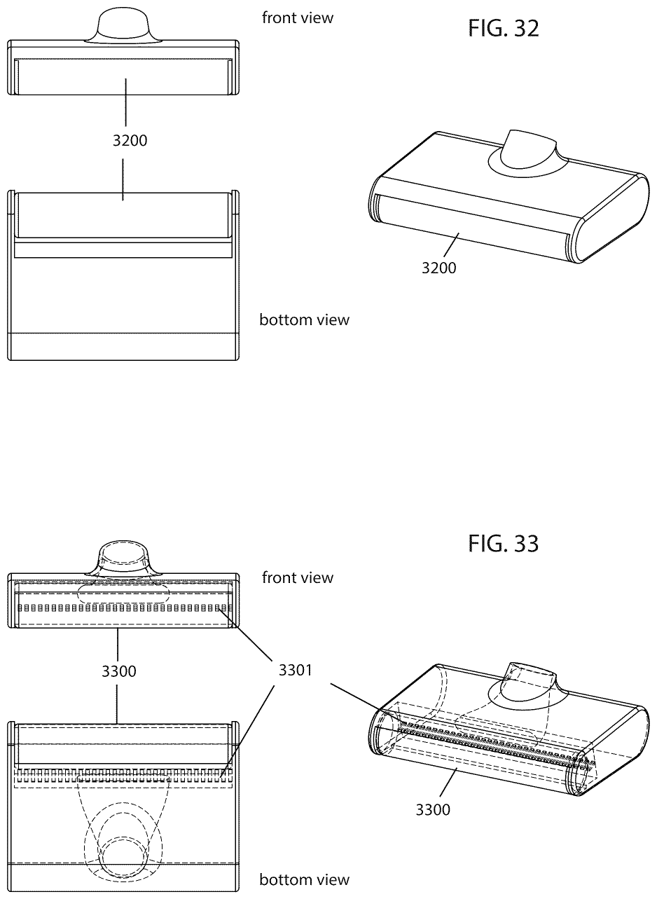

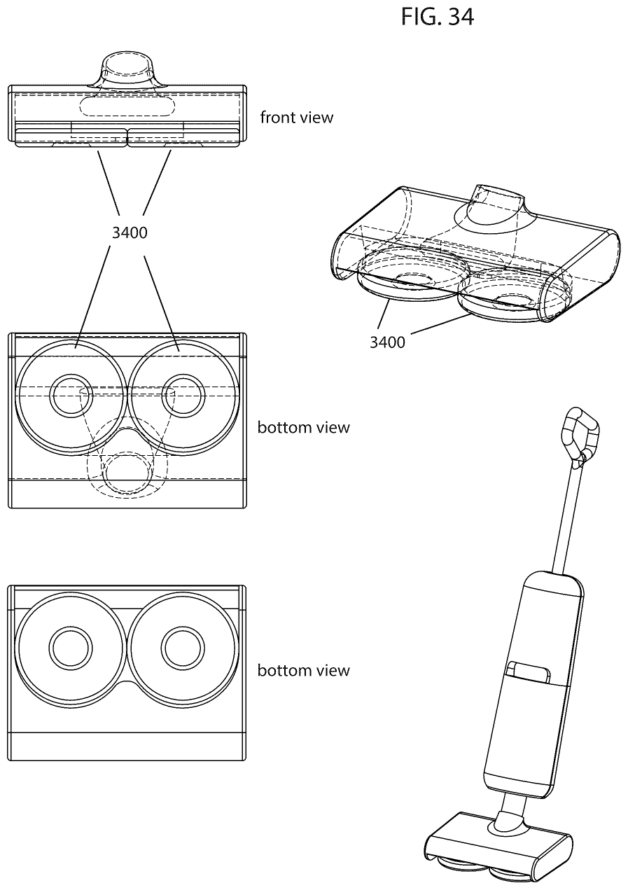

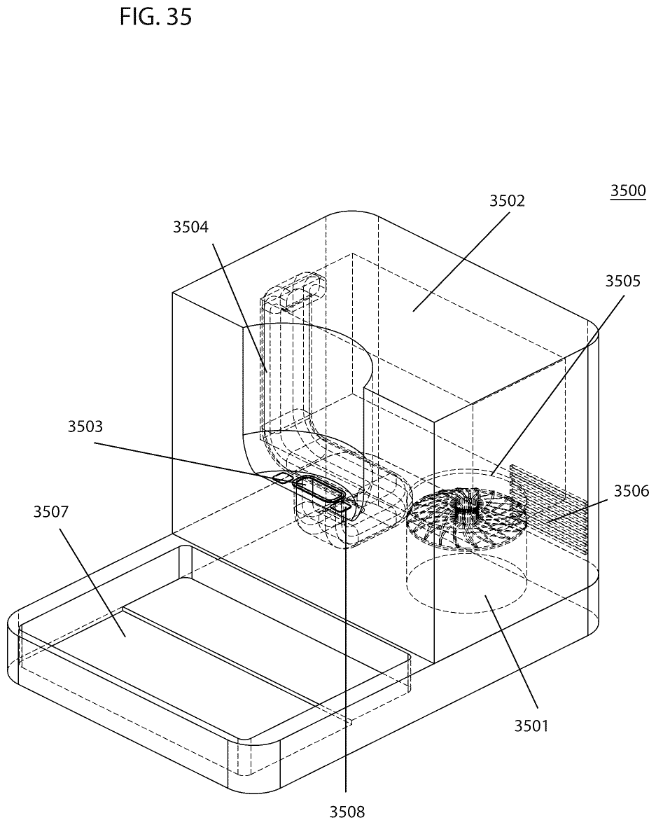

In some embodiments, an upright polymorphic cleaner includes a rolling mop configured for both wet and dry cleaning applications as illustrated in FIG. 32. The rolling mop is designed to rotate during operation, enhancing cleaning efficiency by continuously lifting and absorbing dirt, dust, and liquid from the surface. In some embodiments, the rolling mop may be made of absorbent microfiber or other high-performance cleaning materials to improve water retention and debris pickup. Additionally, the mop roller may incorporate a self-cleaning mechanism, such as a built-in scraper or wringer, to remove excess moisture and debris as it rotates.

In some embodiments, the rolling mop 3300 can be easily detached from the frame for cleaning or replacement as shown in FIG. 33. The connection mechanism may include a quick-release latch or hinge system, allowing for effortless removal and reattachment. In some embodiments, a built-in reservoir and dispensing system may be included to apply cleaning solution directly onto the surface, further enhancing the functionality of the upright polymorphic cleaner. In some embodiments, the rolling mop 3300 is within the housing and positioned behind the rolling mop is a stationary brush that engages with the rolling mop on each turn, effectively removing debris and preventing excessive buildup on the roller mop. This integrated cleaning mechanism enhances the mop's efficiency by maintaining optimal surface contact and preventing residue from redepositing onto the floor. In some embodiments, the upright vacuum cleaner with a rolling mop is equipped with a stationary brush 3301, which is positioned behind the rolling mop, that cleans the rolling mop or roller on each turn.

In some embodiments, an upright polymorphic cleaner includes a mopping head comprising a set of spinning disk mops designed for efficient wet and dry cleaning. The spinning disks rotate during operation, generating friction to loosen dirt and grime while evenly distributing cleaning solution across the surface. The rotation, speed, and pressure may be adjustable to accommodate different floor types of the surfaces of the environment and cleaning intensities desired by the user.

FIG. 34 illustrates an upright polymorphic cleaner with a mopping head comprising a set of spinning disk mops 3400. In some embodiments, the mopping head may include an integrated water dispensing and recovery system, ensuring a consistent supply of cleaning solution while simultaneously collecting excess moisture. In some implementations, the spinning disk mops may feature removable, washable pads made of microfiber or other high-absorbency materials to improve durability and ease of maintenance. Additionally, the mopping head may incorporate a quick-release mechanism, allowing users to easily replace or clean the mop pads as needed.

In some embodiments, a charging station 3500 for an upright vacuum and mop includes an auto-empty feature for convenient dust and debris disposal. The charging station 3500 is equipped with a vacuum motor 3501 that generates suction to automatically extract collected dirt and debris from the vacuum and mop into a dust bag 3502. A dust intake 3503 and a dust pipe facilitate 3504 the transfer of dirt and debris, while a filter 3505 captures fine particles before air is expelled through an exhaust 3506.

In some embodiments, the charging station 3500 includes a dip tray 3507 designed to collect excess moisture from the mop and prevent spillage of absorbed liquids, keeping the surrounding area clean and dry. While the upright vacuum is docked to the charging station, it simultaneously charges and empties the collected dirt and debris, ensuring it is ready for the next cleaning session without manual intervention. Charging contacts 3508 are integrated on the charging station to provide seamless power transfer. In some implementations, the dust bag 3502 and the filter 3505 may be designed for easy removal and replacement, providing a low-maintenance solution for users.

In some embodiments, the upright vacuum cleaner is positioned over the charging station in an upright orientation, maintaining a neat and clean design. When the user manually docks the upright vacuum cleaner onto the charging station, a securing mechanism ensures that it remains firmly in place while charging and emptying debris, providing a stable and reliable connection. This upright positioning not only optimizes space efficiency but also facilitates quick retrieval for use and effortless placement back onto the station for storage or charging.

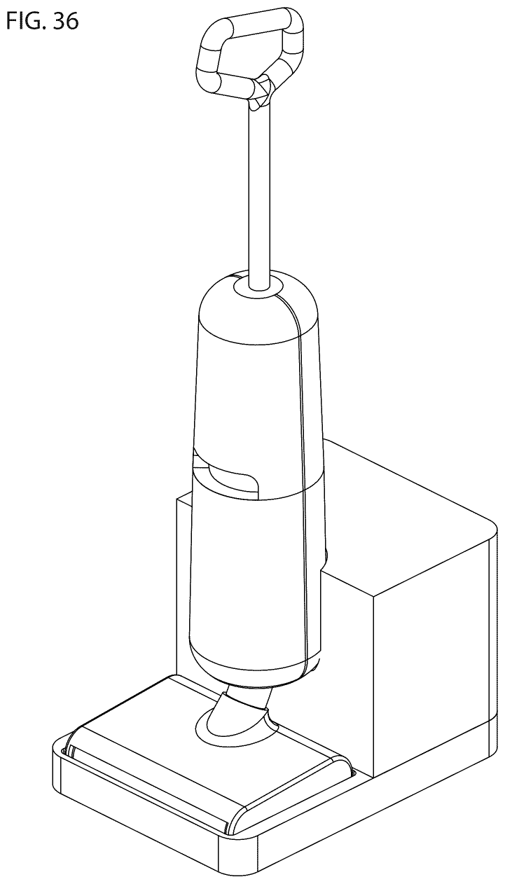

FIG. 36 illustrates an upright vacuum cleaner positioned over the charging station. In some embodiments, a charging station is configured with auto-empty, auto-refill, and auto-clean features for the upright vacuum cleaner and mop, enabling hands-free maintenance and ensuring optimal performance with minimal user intervention. The charging station operates through a series of integrated components that facilitate automated cleaning, debris disposal, and water management.

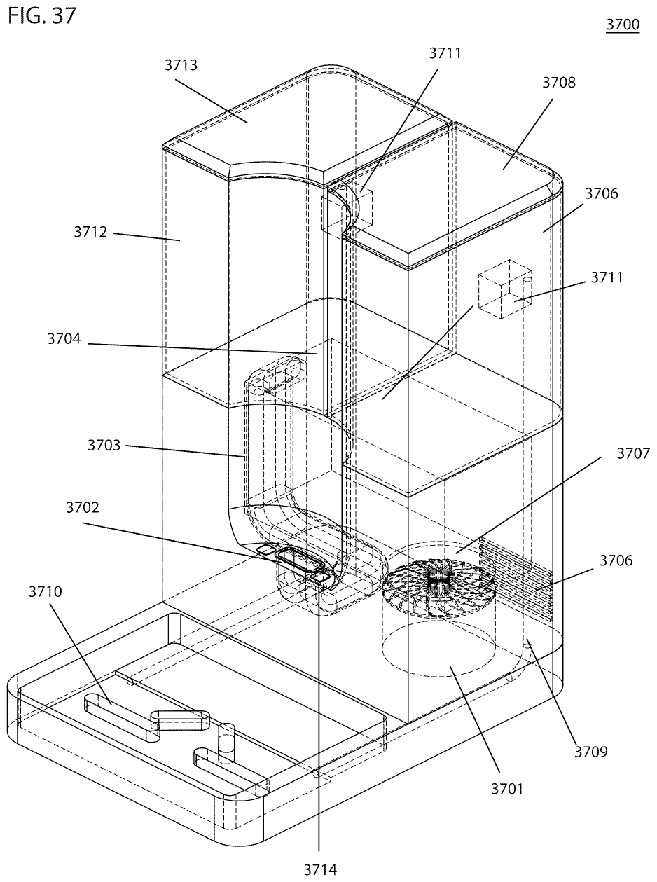

FIG. 37 illustrates a charging station 3700 with auto empty, auto refill, and auto clean features for an upright vacuum cleaner and mop. In some embodiments, when the upright vacuum cleaner and mop are docked, a vacuum motor 3701 activates to extract dust and debris from the device. The dust intake 3702 serves as the entry point for collected dirt, directing it through a dust pipe 3703 into a dust bag 3704, which securely contains the extracted debris for easy disposal. To maintain air quality, a filter 3705 captures fine dust particles before clean air is expelled through an exhaust 3706, preventing airborne contaminants from re-entering the environment. In some embodiments, for mop maintenance, the station initiates the cleaning process by dispensing water from the clean water container 3707, which is securely sealed with a clean water container lid 3708 to prevent contamination and evaporation. A water pipe 3709 delivers fresh water into a mop cleaning tray 3710, where the mop is rinsed to remove dirt and residue. To regulate water flow efficiently, one or more pumps 3711 control the release of clean water, ensuring an effective and controlled cleaning process. As the mop is cleaned, dirty water and any residual debris are collected in the dirty water container 3712, preventing cross-contamination with the clean water supply. A dirt water container lid 3713 ensures that wastewater is securely contained, reducing the risk of spills and leaks. Once the cleaning cycle is complete, the mop is left clean and ready for the next use. Charging contacts 3714 are integrated on the charging station to provide seamless power transfer while services are rendered to the docked upright vacuum cleaner and mop.

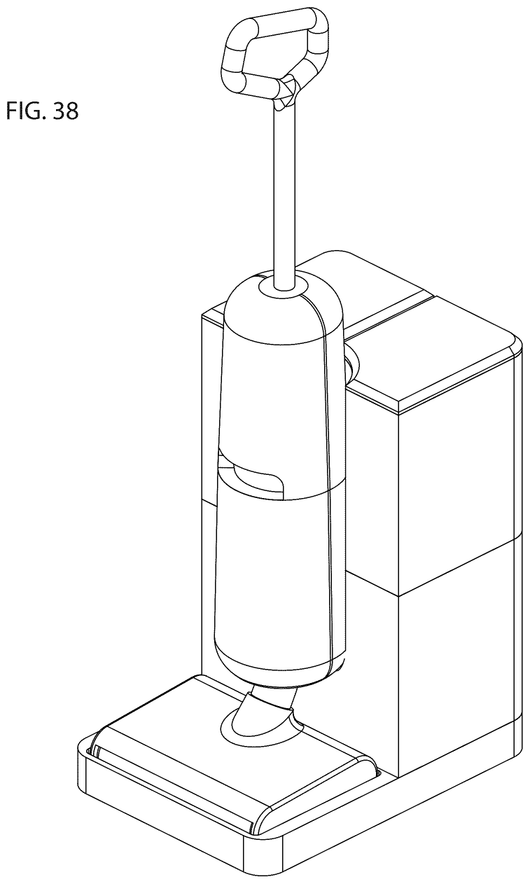

FIG. 38 illustrates an upright vacuum cleaner positioned over a charging station. In some embodiments, the upright vacuum cleaner is positioned over the charging station, which supports both vacuum and mop maintenance functions. When docked, the station facilitates automatic dust and debris extraction from the vacuum while also initiating the mop cleaning process. This dual functionality ensures that both cleaning components are maintained efficiently, with the vacuum being emptied and the mop being rinsed, refilled, and prepared for the next use.

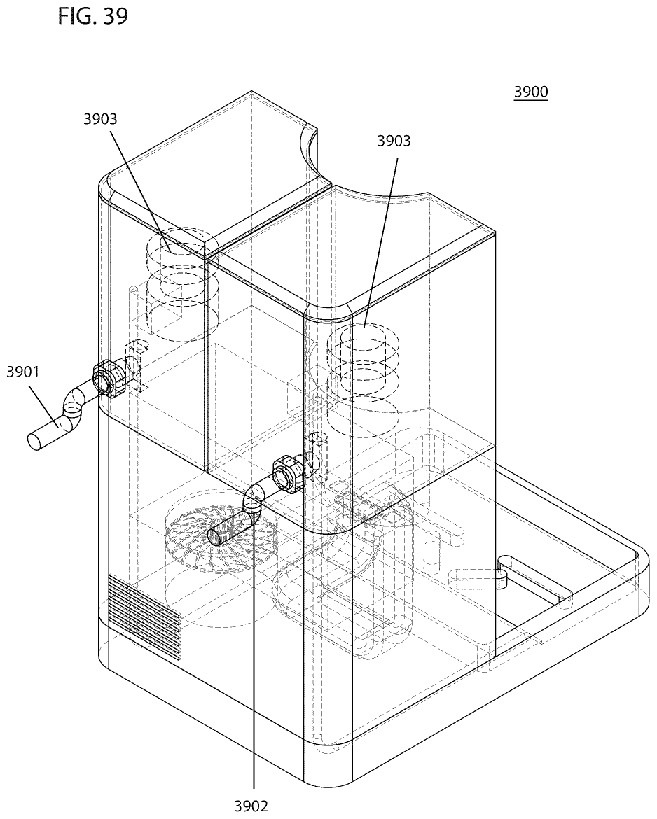

In some embodiments, a charging station 3900 with auto-empty, auto-refill, and auto-clean features for the upright vacuum cleaner and mop is integrated with the house plumbing system for fully automated maintenance as illustrated in FIG. 39. The clean water container is connected to the household water supply via an intake pipe 3901, allowing continuous refilling without manual intervention, while the dirty water container is linked to the sewer system through a drain pipe 3902 for automatic wastewater disposal. To regulate water levels and prevent overflow, floaters 3903 are installed within both the clean water and dirty water containers, ensuring precise control of water intake and drainage. This configuration of the charging station enables a seamless and efficient cleaning cycle, eliminating the need for users to manually refill or empty the water containers while maintaining optimal functionality of the vacuum and mop system.

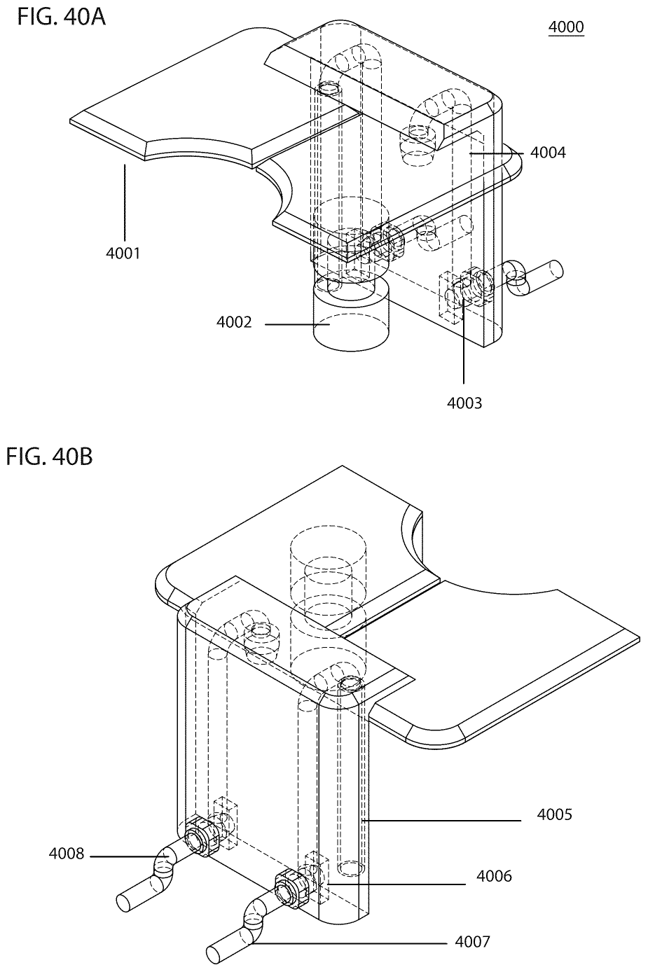

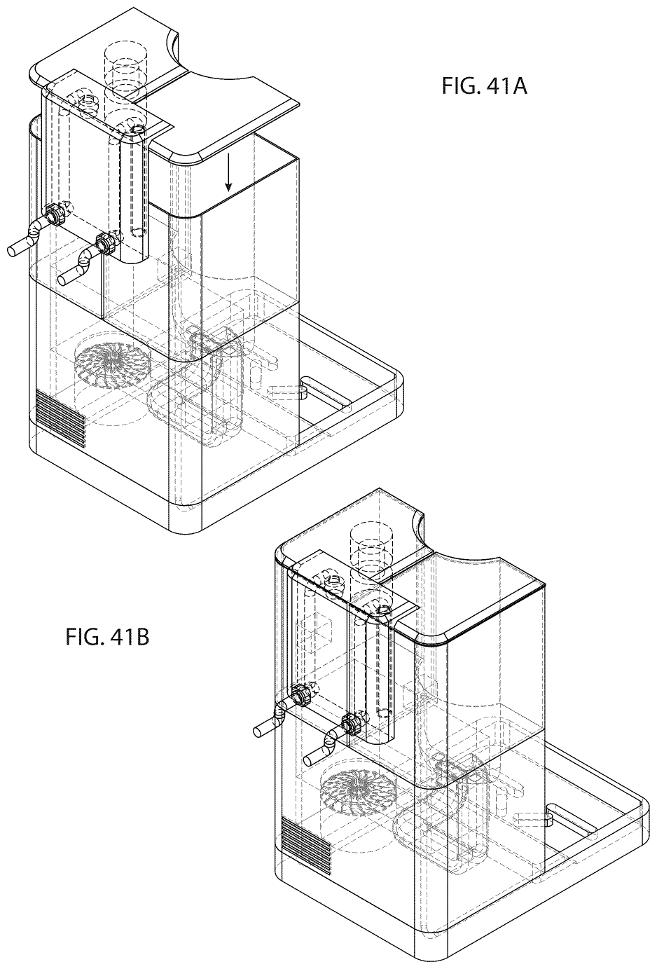

FIGS. 40A and 40B illustrate a kit 4000 to connect the station illustrated in FIG. 37 directly to the house plumbing system. In some embodiments, a kit 4000 is provided to connect the charging station directly to the house plumbing system, replacing the need for removable water containers. The kit 4000 includes a body or lid replacement 4001 equipped with a floater 4002, an inlet valve 4003, and a water intake pipe 4004, allowing the clean water container to be continuously refilled from the household water supply. Additionally, the kit features a drain system comprising a drainpipe 4005, a drain pump 4006, a pipe leading to the sewer system 4007, and a pipe connecting to the plumbing system 4008, enabling automatic wastewater disposal. FIGS. 41A and 41B demonstrate how the kit from FIGS. 40A and 40B replaces the water containers of the parking platform from FIG. 37 to directly connect it to the plumbing system. In some embodiments, the kit can be added later to further improve the versatility and functionality of the charging station, allowing users to upgrade from a manual refill and disposal system to a fully automated maintenance process. By integrating these components, the charging station operates seamlessly without requiring manual water refills or dirty water disposal, enhancing convenience and ensuring uninterrupted upkeep of the vacuum and mop. In some embodiments, a kit is designed to replace the water containers of the charging station, allowing direct connection to the household plumbing system. By integrating the kit, the clean water container is substituted with a continuous water supply through an inlet valve and water intake pipe, ensuring automatic refilling. Similarly, the dirty water container is replaced with a drainage system that includes a drainpipe and a pump-assisted connection to the sewer system for automated wastewater disposal. This modification eliminates the need for manual water refilling and emptying, enhancing the efficiency and convenience of the charging station while ensuring uninterrupted maintenance of the vacuum and mop.

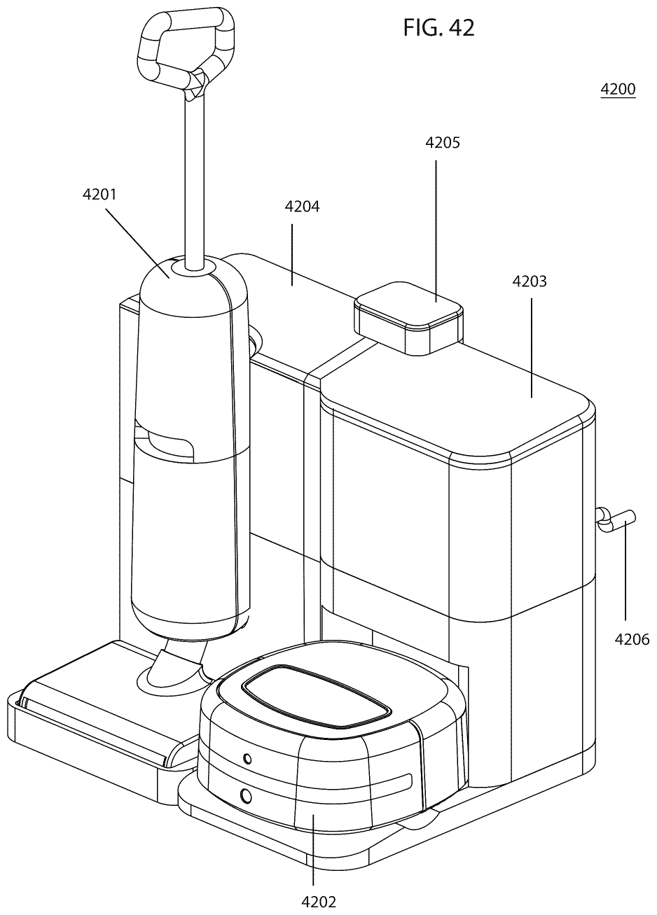

In some embodiments, an appliance includes a parking platform 4200 equipped with a set of robotic functions designed to support both an upright polymorphic cleaner 4201 and a self-propelling polymorphic cleaner 4202, as illustrated in FIG. 42, with auto empty, auto refill, and auto clean features. In some embodiments, the parking platform is also equipped with a clean water container 4203, dirty water container 4204, a detergent container 4205, and a connection pipe to the plumbing system 4206. The platform serves as a centralized maintenance hub, automating various cleaning and maintenance processes to ensure both devices remain in optimal working condition with minimal user intervention. In some embodiments, a parking platform with robotic capabilities may include wet and dry autonomous emptying, allowing the vacuum to dispose of collected debris and liquid waste efficiently. Additionally, the platform may facilitate the autonomous refilling of water and cleaning fluid, ensuring that both cleaners have a continuous supply for extended operation. This refilling process can be implemented with or without a direct connection to the household plumbing or sewerage system, providing flexibility based on user preference and installation requirements. In some embodiments, the platform supports autonomous cleaning of both the upright and self-propelling polymorphic cleaners, ensuring that dust, hair, and other residues are removed from key components such as rollers, mop pads or cloths, and filters. In some implementations, the system may also include a mechanism for swapping mopping pads, ensuring that fresh, clean pads are available for each cleaning session. By integrating these robotic functions, the parking platform enhances the efficiency, convenience, and longevity of both cleaning devices while minimizing manual maintenance tasks.

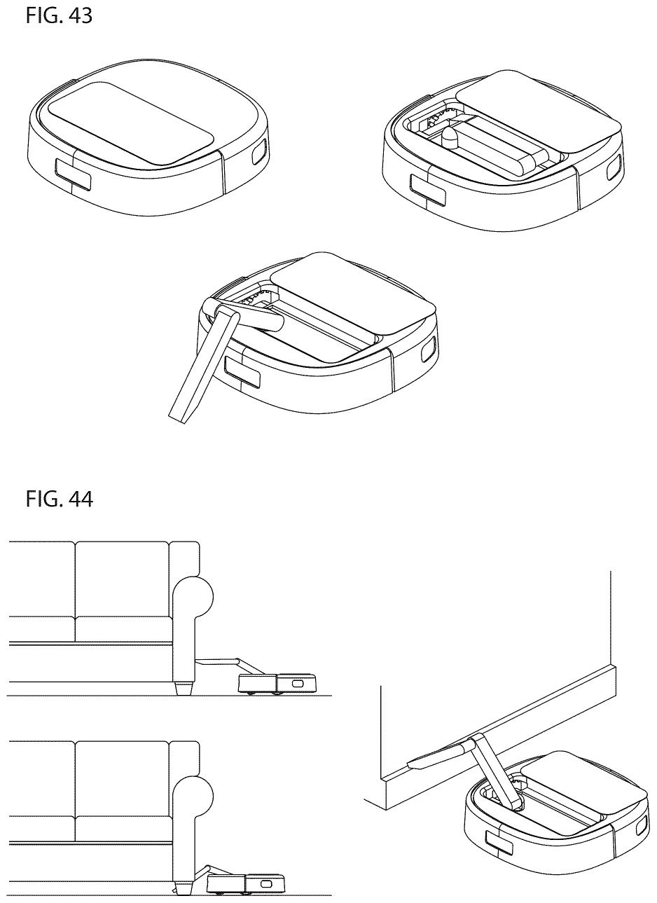

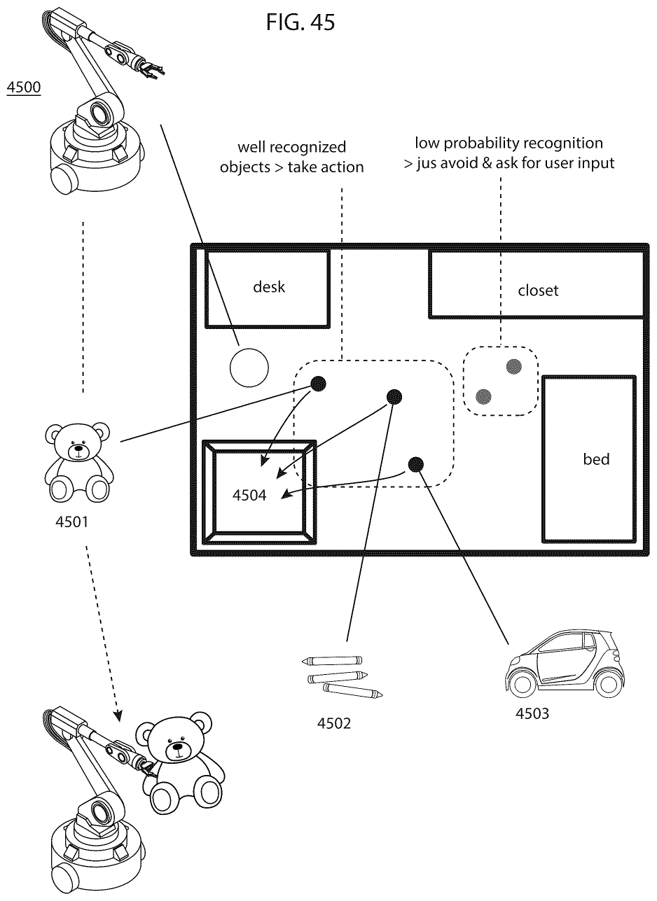

In some embodiments, the system may be included into a robotic vacuum cleaner, mobile robotic device or a robot. In some embodiments, the mobile robotic device is equipped with a robotic arm, as shown in an example in FIG. 43. In some embodiments, the robotic arm is able to access tight and hard to reach spaces, and spaces taller or shorter than the mobile device, as shown in FIG. 44. In some embodiments, the robot arm is equipped with a vacuum extension tube and can reach under hard to reach areas such as under sofas and tables, or even wall corners. In some embodiments, the robotic arm with vacuum module can be used to vacuum the bottom of the furniture, drapes and curtains, or top of the baseboards. In some embodiments, the robotic arm may be coupled with a sensor or vision system of the mobile robot device to recognize objects and manipulate objects based on data observed by the system. The robot may detect an object on its navigation path and make a decision based on the nature, type, or size of the object. For example, a robot may be equipped with an arm that can pick up and relocate small objects such as toys, socks or other objects identified by the robot. In order to pick up an object, parameters associated with the object may need to be determined. For example, for a robot with a robotic arm 4500, as illustrated in FIG. 45, a grip force to pick up a plush toy bear 4501, is different from a grip force to pick up a lego block with a slippery surface. It is also important to strategize a pick up from a point of the object so the pick up succeeds in fewer tries and the object does not drop while being transferred. In some embodiments, the object is placed on a temporary tray while the robot is moving to the destination. In some embodiments, the grip is held while the object is placed on the tray. In some embodiments, computationally realtime processing of images, and realtime actuation of the robotic arm, helps the robot take actions with agility. In some embodiments, the robot may put the identified objects, such as the plush toy bear 4501, crayons 4502, and a toy car 14503, to their predetermined locations, such as a box dedicated for the identified objects, and in this case, the toy box 4504. For example, the robot may pick up and put a sock into a laundry basket, a drawer, and the like. In another example, as shown in FIG. 46, the robot may pick up a shoe and place it on a shoe rack or near a shoe rack.

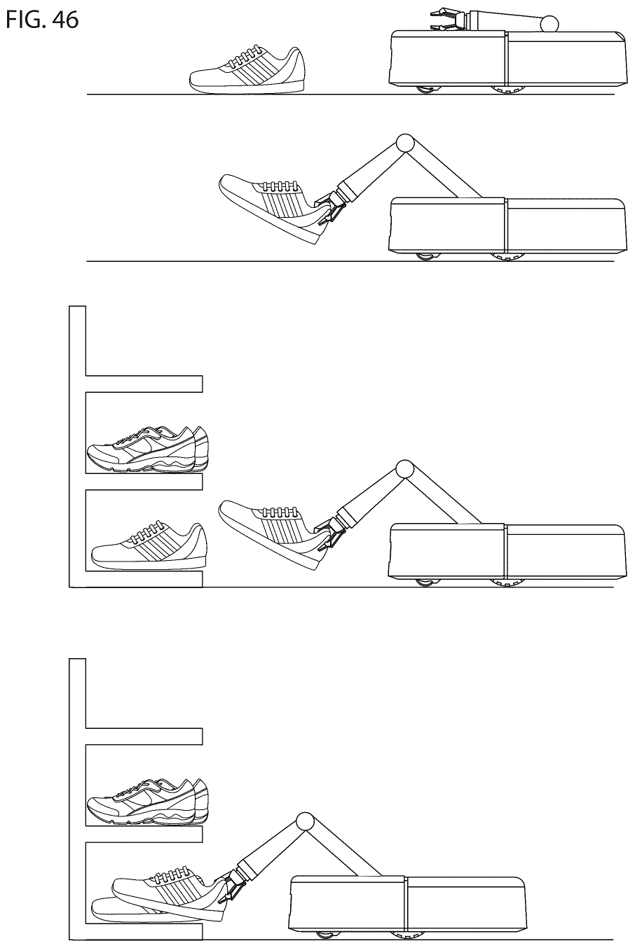

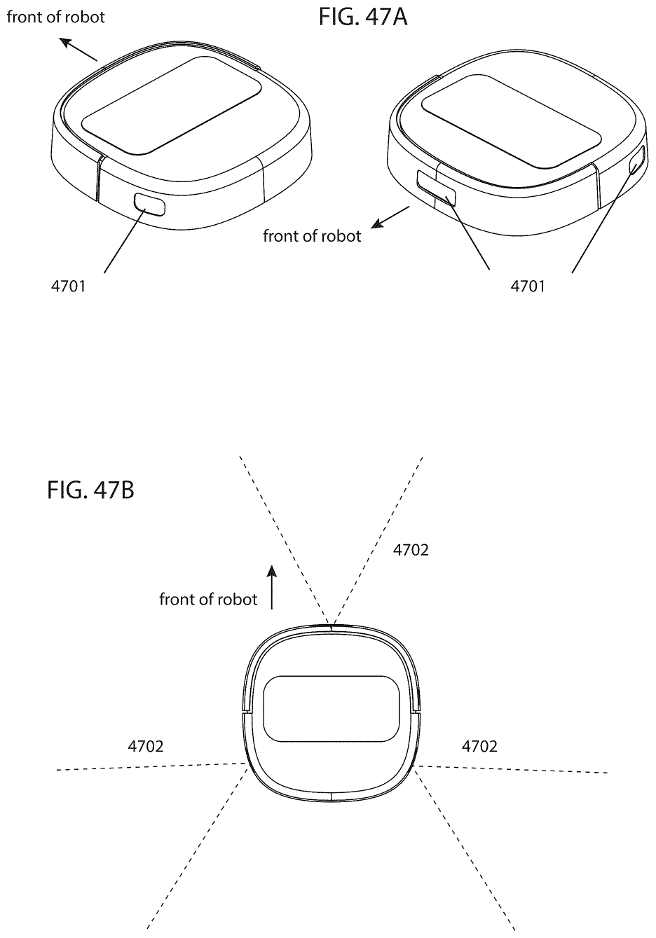

In some embodiments, the arm is equipped with a camera or a depth sensor or a combination of a plurality of sensors. In some embodiments, the arm may rely on a generic camera, a depth sensor, or a plurality of sensors that are provisioned on a chassis of the robot for various purposes, such as navigation. FIG. 47A shows the chassis of the robot is equipped with solid state LiDARs 4701 and FIG. 47B shows field of views (FOV) 4702 of the LiDARs on the chassis of the robot.

In some embodiments, when an object is recognized with low probability or low certainty, the robot may just avoid the object, may ask for a user input, or may move the object to a location designated to all unknown items, such as a box or a corner of a room. In some embodiments, a robot with an arm may be equipped with a plurality of compartments, a plurality of tools, or a plurality of extensions, which may be available on the robot and may be autonomously selected by the robot for the arm to be equipped with. In some embodiments, the plurality of compartments, the plurality of tools, or the plurality of extensions can be chosen, attached, swapped, or used by a user of the robotic device for various tasks. For example, various cleaning heads may be used for various cleaning purposes, which may be swapped autonomously or manually. In some embodiments, the plurality of compartments, the plurality of tools, the plurality of extensions, or cleaning heads, may be available for selection on a multi-use service station. In these embodiments, the robot goes to its station to choose, attach, and swap the proper compartment, tool, extension, or head. Further details of methods for adjusting the heading of a robot are described in U.S. Non-Provisional patents application Ser. Nos. 15/410,624 and 16/504,012, the entire contents of which are hereby incorporated by reference.

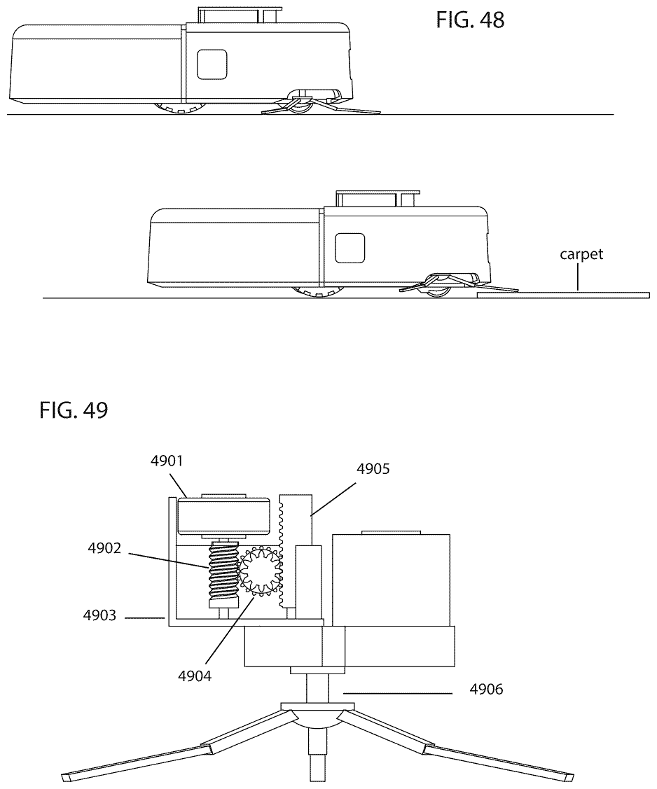

In some embodiments, the robotic arm may comprise soft material or soft grip tools. The soft robotic arm may be collapsable and activated by its limbs being inflated. In some embodiments, wheel modules may be attached to a lifting mechanism. Using this mechanism, the robot can push its chassis upward so it can traverse through uneven surfaces, door thresholds or even steps and stairs. In some embodiments, side brushes or, main brush modules may be lifted as explained in U.S. Pat. Nos. 10/452,071, 10/788,836, 11/449,061, 11/927,965, and 12/235,659, each of which is hereby incorporated by reference. In some embodiments, mopping modules may be lifted as explained in U.S. Pat. Nos. 12/256,883, 11/864,715, 11/058,268 and 10/292,553 and U.S. Non-Provisional patent application Ser. No. 19/065,936. For example, when the robot is transitioning from a hard surface (e.g., hardwood, stone, ceramic tiled floors, etc.) to a carpeted area the mopping attachments are lifted to avoid contacting the carpet, as illustrated in FIG. 48. In another example, when the robot approaches a carpet or a rug with longer strands (i.e., shag rugs), the robot may lift its brush compartments for better navigation and cleaning. The lifting movement, which is essentially a vertical movement, is achieved by attaching the components on a moving platform which moves using a push-pull stepper motor as explained in U.S. patent Ser. No. 12/256,883, and U.S. Non-Provisional patent application Ser. No. 19/015,623. FIG. 49 shows the different components which facilitates the lifting movement, including a stepper motor 4901, worm gear 4902, lifting platform 4903, super gear 4904, gear rack 4905, and an adjustable component (e.g., side brush) 4906. A push-pull stepper motor 4901 is a stepper motor combined with a set of gears converting precise rotary movement to precise linear movement.

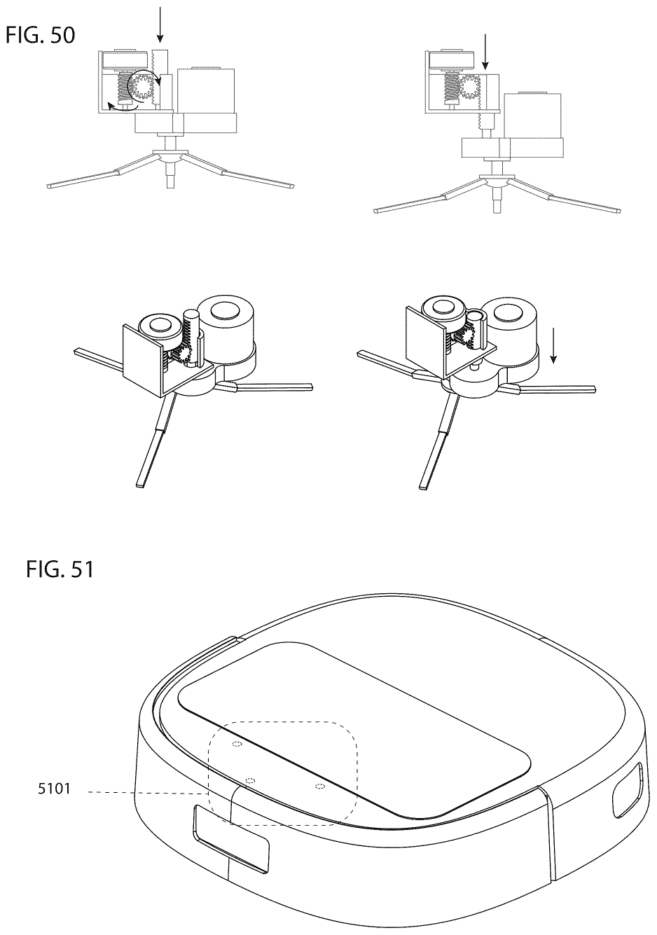

In some embodiments, the lifting mechanism, as illustrated in FIG. 50 may be similar to a folder arm which unfolds to push the chassis upward. In some embodiments, a scissor lift mechanism may be used to lift the chassis. In some embodiments, the wheel itself may be lifted to bypass an obstacle or an anomaly of the floor surface.

In some embodiments, a zip chain actuator may be used to lift a chassis of a mobile robotic device. In some embodiments, the zip chain actuators may: A) be controlled by a single motor and convert the rotary movement of the motor to linear (vertical) movement using the zip chain gears; B) pack a large range of vertical movement into a small vertical footprint which is beneficial to maintain the robot's low profile; and C) offer a large range of movement in vertical direction, which may be advantageous for some applications in comparison to scissor lift mechanisms. Depending on the application, a horizontal footprint for the moving parts may be utilized, which may be low and constant. In some embodiments, three or more zip chain mechanisms can control the height of three or more different drive wheels and caster wheels. In embodiments, the programming may be provisioned such that the robot can adjust these heights to climb a stair.

In addition to lifting the chassis, these lifting mechanisms may be used to tilt the robot towards the front or the back, which is helpful for the robot to transition over thicker carpets or put more pressure on the mopping module while it is in mopping mode. In some embodiments, these lifting mechanisms may be used for raising or lowering a mopping pad or cloth. Vertical movement of the mopping pad or cloth is also useful for applying downwards pressure onto the mopping pad or cloth when the mopping pad or cloth is engaged with the floor surface, such that the friction between the mopping cloth or pad and the floor surface increases. In some embodiments, the robot can be controlled directly using voice control. This may be in addition to voice control using home assistant devices or apps. In the setup, as shown in FIG. 51, an array of multi-directional microphones on the robot receive the command after the trigger voice. With a microphone array 5101, the robot is able to receive direct commands from a user, wherein the microphone array can process the directional voice by comparing the received signal frequency of each microphone. In some embodiments, components, such as a wheel, may be lifted upon a detection made by a vision sensor as explained U.S. Pat. Nos. 12/256,883, 10/239,370, 10/766,324, U.S. patent application Ser. No. 19/015,623, and U.S. Provisional Application Nos. 63/619,191 and 63/617,669.

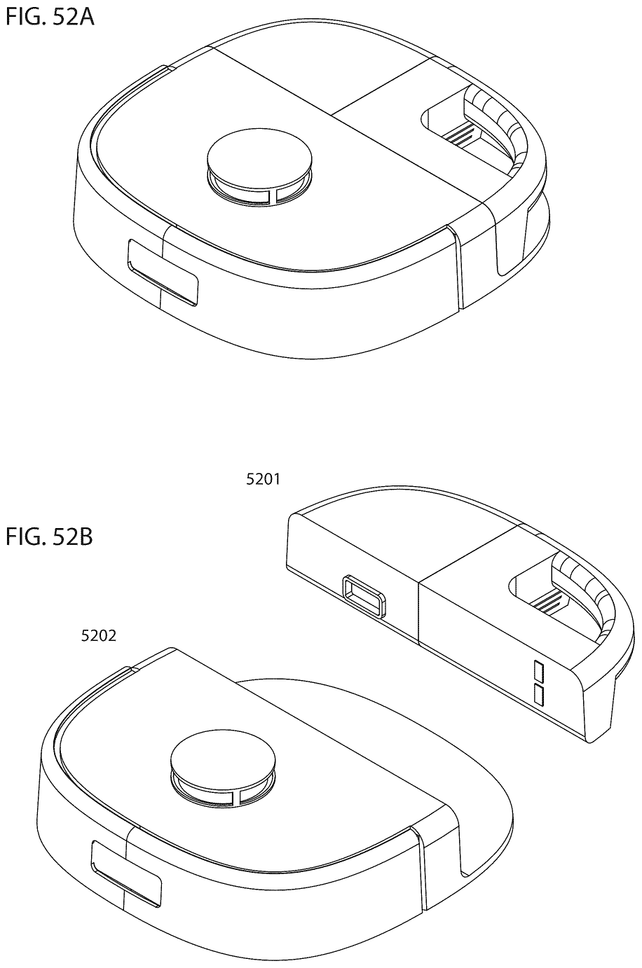

In some embodiments, mapping and navigation modules are physically and mechanically separated from a vacuum module of a robot, as illustrated in FIG. 52A. In these embodiments, as shown in FIG. 52B, the vacuum module 5201 can be used separately as a cordless vacuum or a smaller handheld vacuum using different attachments, as well as being placed on the robot's navigation module 5202 to form an autonomous robot vacuum.

In some embodiments, a robotic system enables autonomous floor cleaning in an indoor environment, with the system comprising at least one robotic device that is stationary. In addition to the stationary robotic device, the system further comprises either a handheld roaming device that is roamed around by a user and placed back on the stationary robotic device, or an robotic roaming device comprising wheels that autonomously navigates the environment, that performs a coverage routine and cleans the surface as it covers the surface and then parks into the stationary robotic device to remain parked until the next run, or to recharge or be serviced. In addition to the stationary robotic device, the system may comprise one or more handheld roaming devices and the one or more robotic roaming devices.

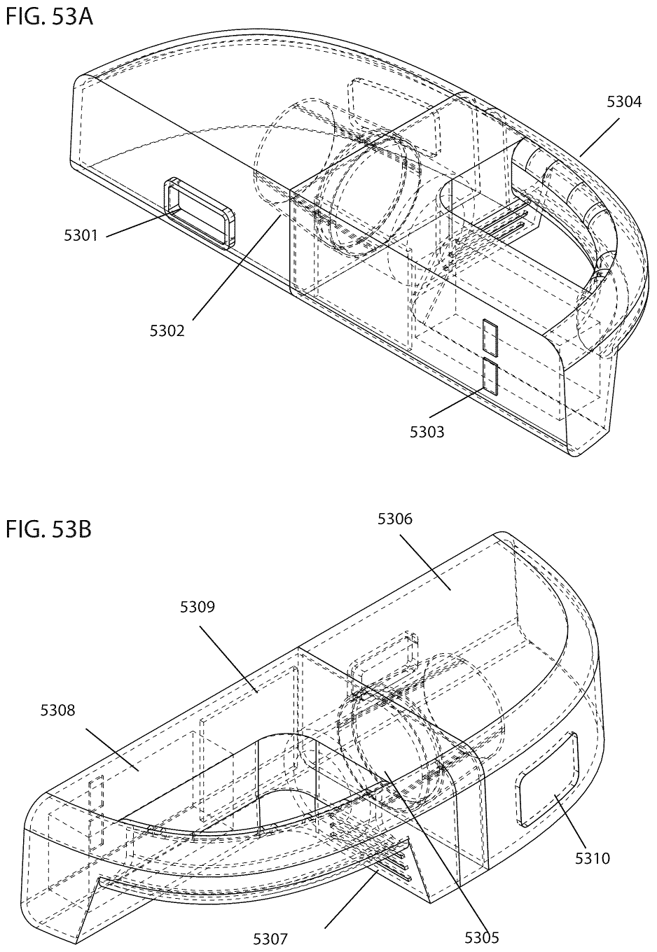

FIGS. 53A and 53B illustrate the embodiment of the dustbin module configured for use in an autonomous cleaning robot. FIG. 53A shows the vacuum module comprising the housing that encloses several functional components, facilitating the intake, filtration, collection, and disposal of dust, dirt, or debris. In some embodiments, the vacuum module includes a dust intake port 5301, configured to receive debris collected by the brush or cleaning tool coupled to the cleaning robot and by the suction mechanism. The incoming debris is directed through a series of filters 5302, which may include pre-filters and HEPA filters, to capture particulate matter and purify the air stream prior to exhaust. The dust intake is positioned at a front portion of the vacuum module to direct debris, dirt, and dust particles into a dustbin during cleaning operations. In embodiments, the vacuum module is equipped with one or more filters that are arranged downstream or connected with the dust intake to trap fine dust and prevent particles from being released back into an environment. In some embodiments, the model further includes electrical connections 5303 are positioned to be in contact within the cleaning robot. These electrical connections provide signal and power for monitoring status, triggering cleaning cycles, and enabling automatic or autonomous emptying mechanisms or protocols. The electrical connections are configured to couple with a navigation module, a docking station, or another robotic device for power transfer and communication. In some embodiments, a handle 5304 is disposed along the surface of the housing to facilitate manual removal of the module for maintenance and disposal of collected debris. In some embodiments, the handle is configured to allow removal, transport, or manual emptying of the vacuum module. In some embodiments, the housing may cover the top of the LIDAR and may include two or more pillars connecting the housing to the top of the chassis of the robot or a bottom portion of the housing. In FIG. 53B, internal components of the module are shown. The module includes a vacuum motor 5305 responsible for generating negative pressure to draw air and debris into a dustbin 5306 through the intake. In some embodiments, an exhaust 5307 is provided on the housing to release filtered air back into the environment. In some embodiments, the module further comprises a battery 5308 to power internal elements and a printed circuit board (PCB) and at least one processor 5309 to control vacuum operation, manage power efficiency, and communicate with the host cleaning robot system. In embodiments, the PCB and at least one processor are housed within the vacuum module to manage motor operation, power regulation, and suction control. The vacuum module also includes its own power supply, such as a rechargeable battery, enabling the vacuum module to operate independently of the navigation module. The PBC and the at least one processor coordinate vacuuming functions, while the navigation module has a separate set of power supply and PCB and processors to navigate and interpret the environment using its sensors. In some embodiments, an auto empty outlet 5310 is included to inference with a docking station or base station, allowing for periodic evaluation of collected debris without human intervention or was autonomously performed by the cleaning robot system. In some embodiments, both the vacuum module and the navigation module are designed to interface with the same or a common base or charging station. The base or charging station may provide charging for the battery of the vacuum module and empty the dustbin through an auto-empty outlet. This configuration allows the vacuum module to function as a detachable, self-contained cleaning component which can operate as part of an integrated autonomous robotic system. In some embodiments, the robot may be a cleaning robot comprising a detachable washable dustbin as described in the U.S. Non-Provisional patents application Ser. Nos. 14/885,064 and 16/186,499, a mop extension as described in U.S. Non-Provisional patents application Ser. Nos. 14/970,791, 16/375,968, and 15/673,176, and a motorized mop as described in U.S. Non-Provisional patents application Ser. Nos. 16/058,026 and 17/160,859, each of which is hereby incorporated by reference. In some embodiments, the dustbin of the robot may empty from a bottom of the dustbin, as described in U.S. Non-Provisional patent application Ser. No. 16/353,006, which is hereby incorporated by reference.

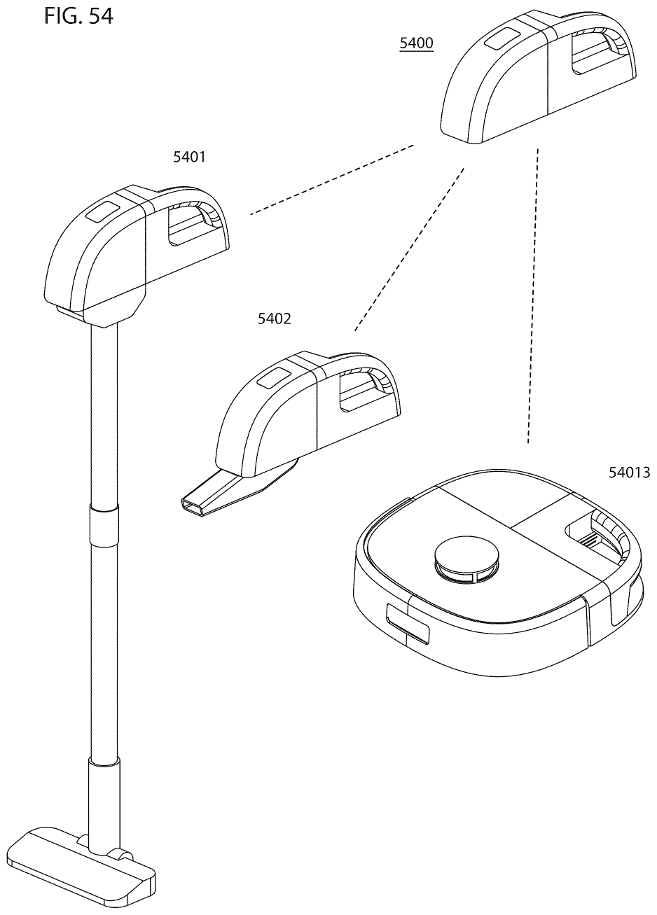

FIG. 54 illustrates a modular vacuum system encompassing multiple configurations. In some embodiments, the vacuum module 5400 can be integrated into various form factors, including a cordless vacuum 5401, a handheld vacuum 5402, and a robot vacuum 5403. In some embodiments, the cordless vacuum configuration enables upright use with an extended handles upright use with an extended handle and floor cleaning head. In some embodiments, the handheld vacuum offers a compact and lightweight form, suitable for small surface areas and quick cleaning tasks. In some embodiments, the robot vacuum configuration includes autonomous navigation capability, enabling automated floor cleaning operations without user intervention. Each configuration utilizes the same core suction and dustbin component, which may include shared internal subsystems such as filters, dust intake, and vacuum motor, etc., thereby allowing manufacturing efficiency and interchangeability across platforms. This design facilitates multifunctional deployment of the same vacuum unit, optimizing component reuse and offering flexibility in use across various household cleaning environments.

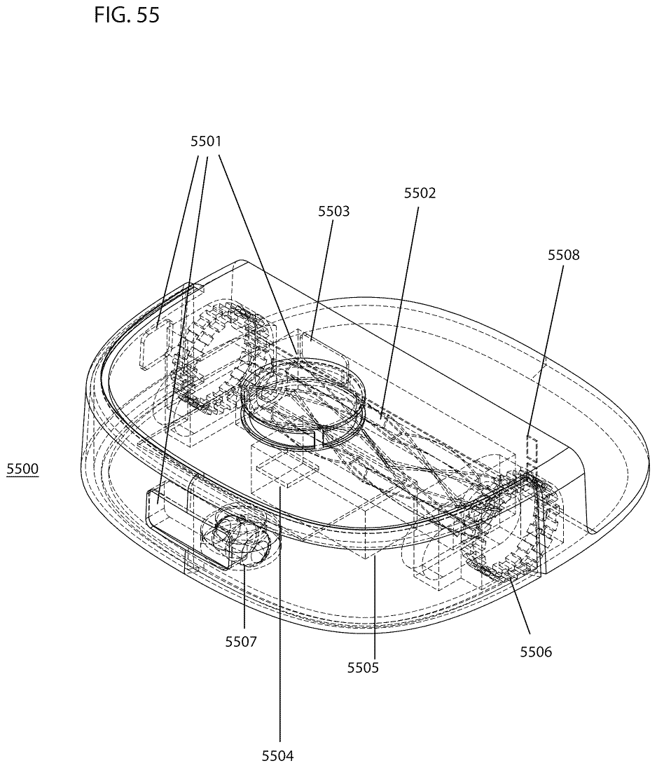

FIG. 55 illustrates an internal structure of the navigation module 5202 in FIG. 52B. In some embodiments, a navigation module 5500 includes sensing components 5501 such as LiDAR, proximity sensors, obstacle detection units, and a camera which assists in navigation, environment mapping, and real-time obstacle avoidance. In some embodiments, the module houses a sweeper 5502, a sweeper mechanism, and an outlet 5503 configured to guide debris into the dustbin of the attached vacuum module 5201. In some embodiments, the internal processor and printed circuit board (PCB) 5504 are responsible for managing navigation, mapping, and obstacle detection algorithms. In some embodiments, at least one battery 5505 is embedded within the chassis to support both propulsion and processing operations. In some embodiments, the module further includes drive wheels for autonomous movement and a caster wheel for directional stability. In some embodiments, the module further includes driving wheels 5506 for autonomous movement and a caster wheel 5507 for directional stability. In some embodiments, electrical connections 5508 between the vacuum module and the robot body are configured to coordinate power and control signal transmission. The integration allows the robot vacuum to operate as a fully dependent until while maintaining compatibility with the modular vacuum components for shared dustbin and suction systems.

FIG. 56 illustrates an integrated docking and auto-emptying station 5600 designated for use in a robot, in this case, a robotic vacuum cleaner. In some embodiments, the docking station comprises a vertical housing that includes a dustbag 5601 for collecting debris, a dust pipe 5602 configured to receive and transfer debris from the robotic vacuum, a filter 5603 to reduce particulate discharge and an auto-empty vacuum motor 5604 for suctioning dirt from the internal dustbin of the robotic vacuum cleaner. The robotic vacuum cleaner docks onto a horizontal platform or a docking plate, where charging plates 5605 are positioned to provide electrical power to both vacuum and navigation modules. In some embodiments, the station automates the debris removal process by transferring the contents from the internal dustbin of the robotic vacuum cleaner into the dustbag of the docking station via the dust pipe. This configuration allows extended operation with minimal human intervention, improving both convenience and cleaning efficiency.

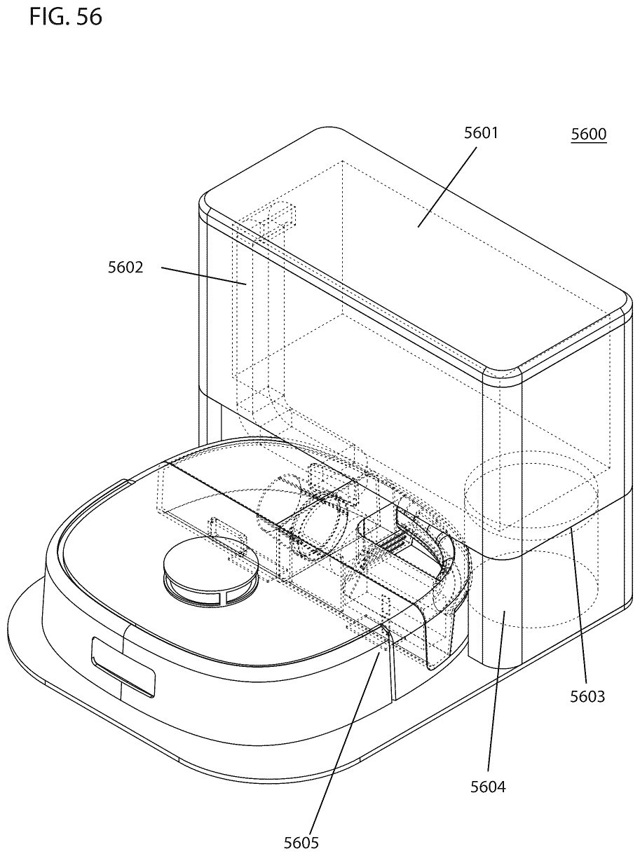

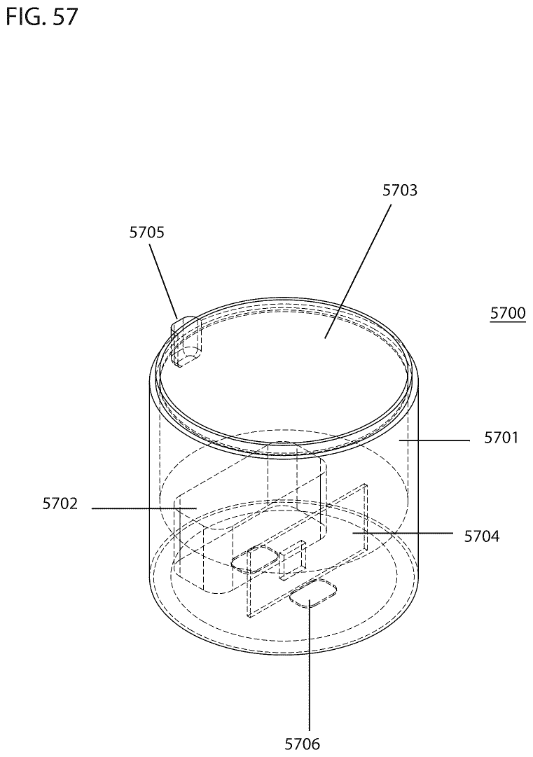

FIG. 57 shows a modular vacuum cartridge or removable vacuum motor assembly 5700 that can be selectively interfaced with either a robotic vacuum platform or a stick vacuum. In some embodiments, the vacuum cartridge comprises a vacuum motor 5701, a battery 5702, a filter 5703, and a PCB with a processor 5704 for managing power and vacuum operations. In some embodiments, an interface connection 5705 is provided to allow the cartridge to detect whether it is connected to a docking station or a mobile vacuum configuration, facilitating context-aware operations. In some embodiments, the cartridge includes electrical connection terminals 5706 for recharging the battery and enabling auto-emptying when docked. This modular structure promotes interchangeability between vacuum formats, facilitating multi-platform use, and simplifying maintenance logistics. In some embodiments, FIG. 58 illustrates the modular vacuum motor cartridge being integrated in different systems. This is configured to be interchangeably docked into multiple external assemblies. In some embodiments, the vacuum motor module is inserted into a stationary docking base. The docking base includes a recessed cavity that aligns with the shape of the vacuum module, enabling physical and electrical coupling. This configuration provides automatic dust disposal, battery charging, and secure storage when the vacuum is not in active use. Charging terminals are positioned to align with matching contract points on the vacuum motor module. In another embodiment, the same vacuum motor module is inserted into a handheld stick vacuum assembly. This integration enables the vacuum module to function as a mobile cleaning apparatus. The mechanical interface between the vacuum module and the stick assembly may include snap-locks or rail-guided slots, ensuring stable attachment during operation. Electrical interfaces allow for signal and power transmission to the motor enabling activation through the handle-mounted controls. This modular approach supports cross-functional usage of the vacuum motor in stationary and handheld modes, optimizing device utility and storage efficiency.

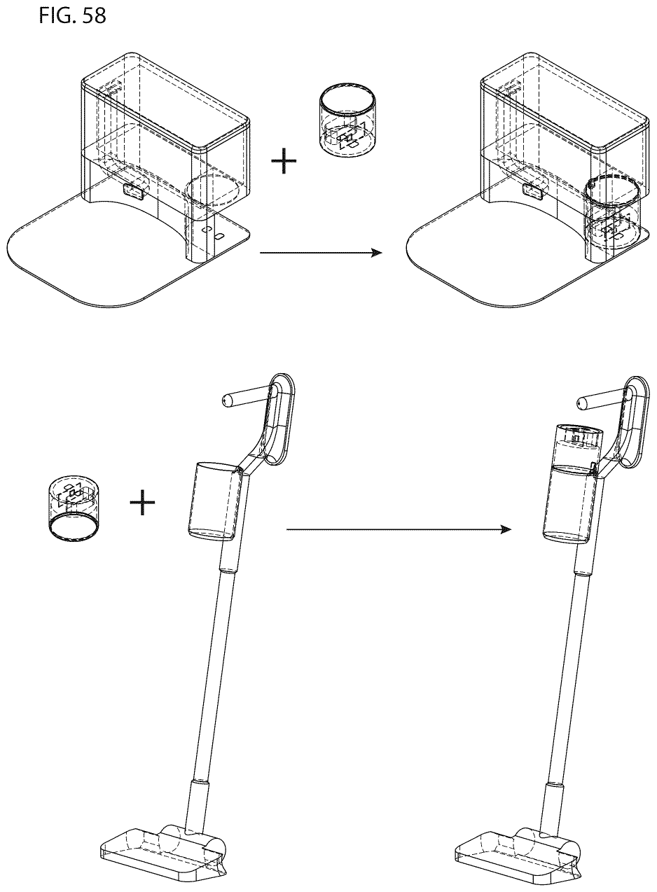

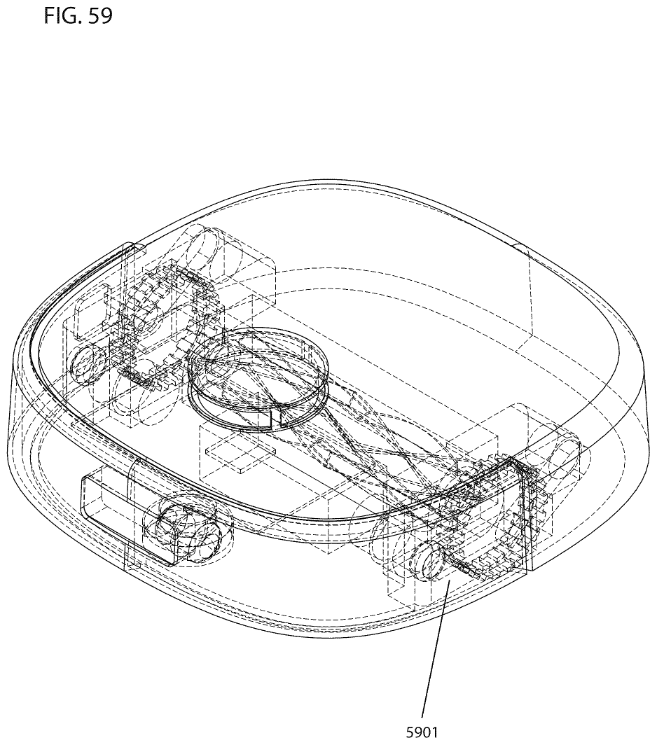

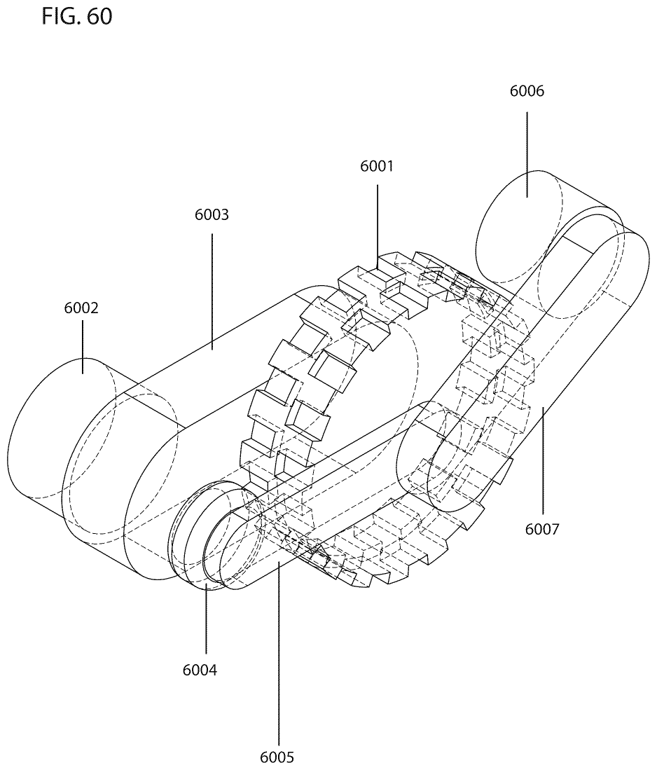

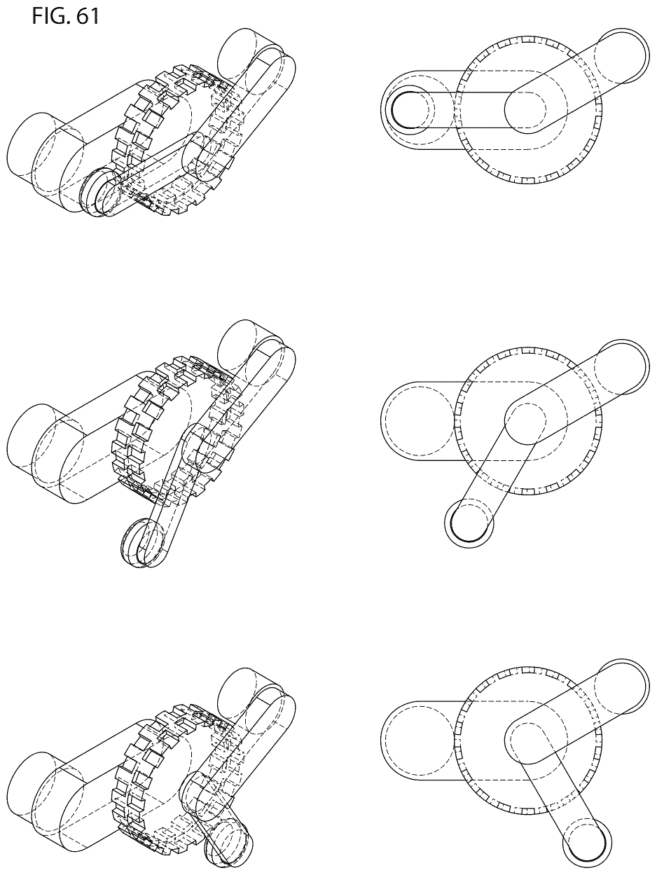

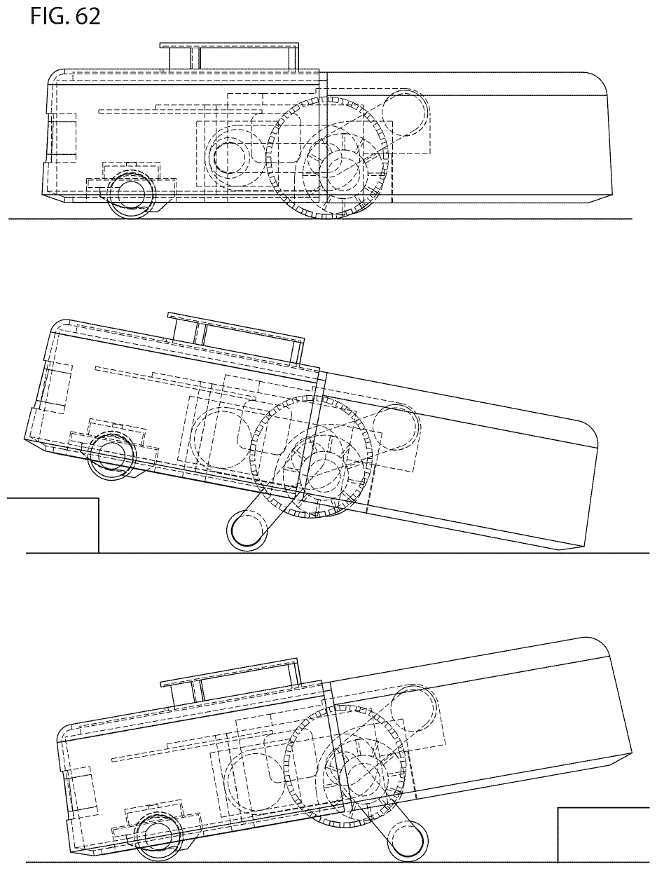

FIG. 59 depicts an internal isometric view of a robotic vacuum cleaner that includes an elbow lift mechanism 5901 integrated with the drive wheel structure. The elbow lift mechanism is mounted to the robot chassis and is configured to adjust the vertical height of the drive wheels. The elbow mechanism permits dynamic changes in ground clearance, allowing the vacuum to respond to surface irregularities such as raised thresholds, thick carpets, or minor obstacles. The elbow lift mechanism may include a pivot arm and a stepper motor or actuator to control its position. The pivot arm is connected between the main robot frame and the drive wheel housing. By rotating the elbow mechanism, the effective vertical displacement of the drive wheels is modified, enabling temporary elevation of the robot chassis during traversal. This capability improves traction, obstacle negotiation, and adaptability to varied indoor environments. FIG. 60 presents a schematic view of the elbow lift mechanism described in FIG. 59. In some embodiments, the system includes a primary drive wheel 6001 mechanically coupled to a drive wheel motor 6002 via a dedicated gear box 6003. In some embodiments, a secondary smaller wheel, referred to as the elbow wheel 6004, is positioned at an offset and is driven indirectly via an elbow gearbox 6005. In some embodiments, the elbow gearbox is mechanically linked to the drive wheel rotation system and transfers torque to the elbow wheel. In some embodiments, a stepper motor 6006, mounted adjacent to the elbow arm, provides angular control over the position of the elbow. The stepper motor is coupled to the stepper motor gearbox 6007 that controls rotational displacement. This arrangement allows the robotic vacuum cleaner to vary the vertical positioning of the wheel module relative to the body, providing controlled lift or drop in response to environmental cues of operational commands. This feature improves terrain compliance, enhances docking precision, and enables adaptive behavior during cleaning operations and tasks. FIG. 61 illustrates various perspectives and views of an elbow lift assembly configured for integration with a robotic cleaning device. In some embodiments, the elbow lift assembly comprises a drive wheel, a smaller secondary wheel, and a rotational linkage structure. The assembly includes a drive wheel motor and gearbox that transmit rotational motion to the elbow joint via an elbow gearbox. The elbow gearbox is mechanically linked to the smaller wheel of the elbow, allowing for synchronized lifting or angular displacement of the wheel. In some embodiments, the stepper motor is connected to the elbow assembly through the stepper motor gearbox, allowing for precise angular positioning of the rotational arm of the elbow. The elbow joint may be actuated to pivot the smaller wheel downward or upward relative to the main drive wheel to enable terrain adaptation, incline climbing or improved floor contact under uneven surfaces. FIG. 62 shows the side view of the robotic cleaning device, demonstrating the dynamic operation of the elbow lift assembly. In a neutral position, both the drive wheel and the elbow wheel are aligned horizontally, maintaining standard ground clearance. In some embodiments, the elbow mechanism is actuated to raise the drive wheel and tilt the housing of the robot at varying angles. This tilting motion enhances surface approach angles and allows for obstacle traversal or gap bridging. In some embodiments, the tilt angle and wheel lift are controlled based on sensor feedback, real-time determination of the environment, or preprogrammed path logical planning.

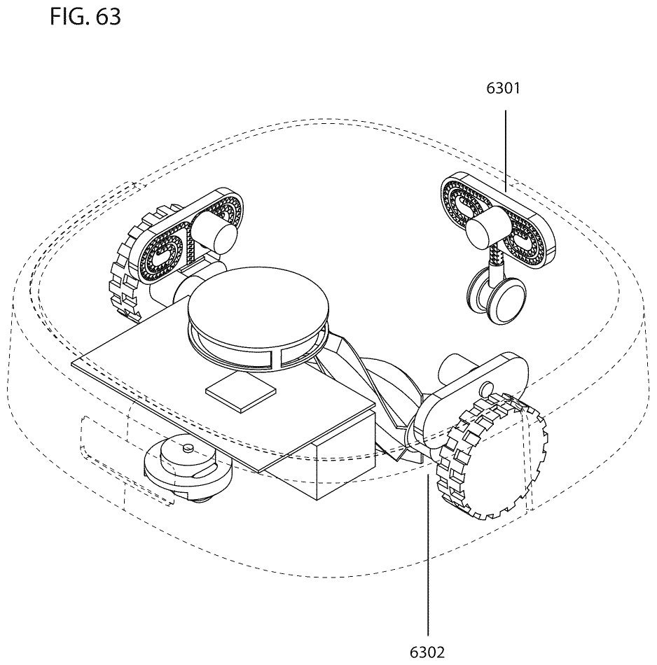

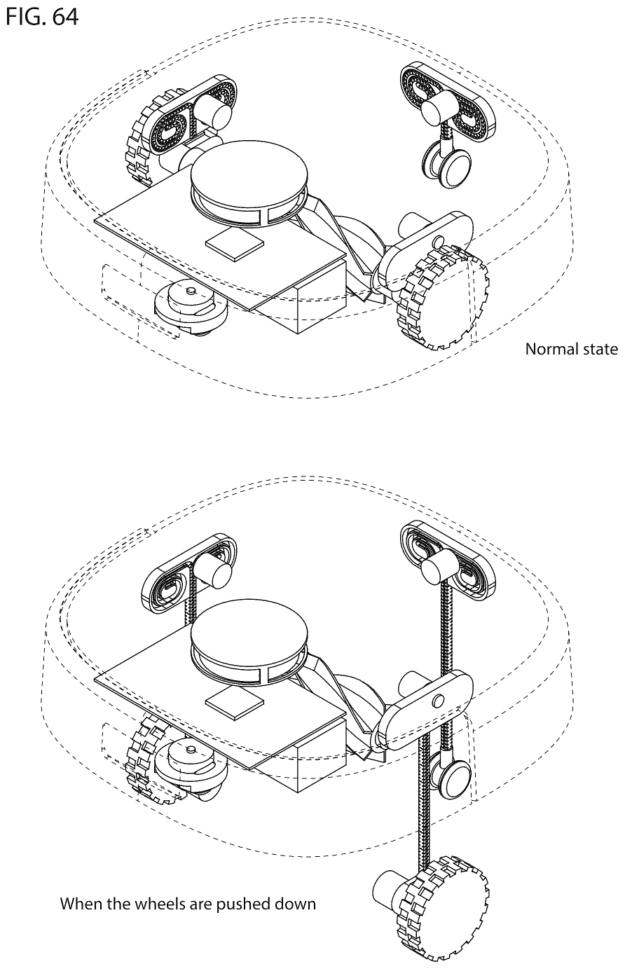

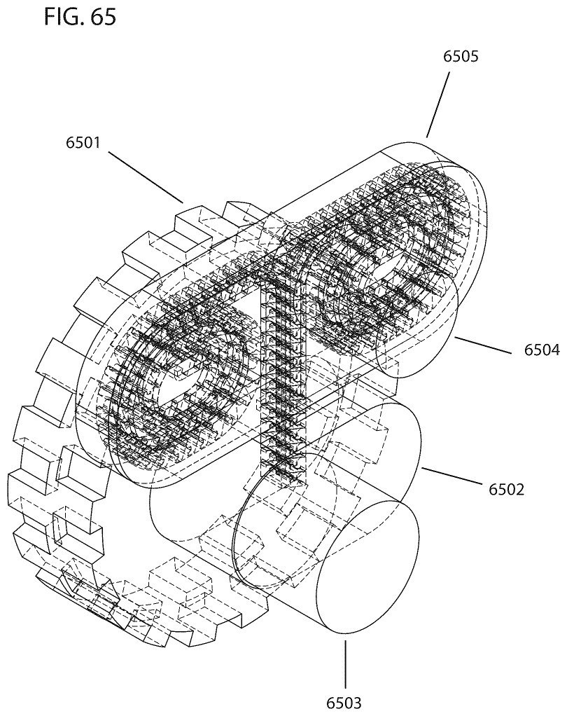

In FIG. 63, a robotic vacuum cleaner is shown equipped with zip chain actuator 6301 mechanisms that are mounted on a caster wheel and zip chain actuator 6302 mechanisms that are mounted on a drive wheel. FIG. 64 illustrates two operational states of the same robotic vacuum: a normal state, where the wheels maintain their default height, and a deployed state, where the zip chain actuators extend to push the wheels downward, allowing for elevated clearance or adaptive suspension. FIG. 65 shows a detailed perspective of the zip chain actuator mechanism associated with the drive wheel. In some embodiments, this includes the drive wheel 6501, a drive wheel gearbox 6502, a drive wheel motor 6503, a stepper or servo motor 6504, and the zip chain mechanism 6505 responsible for linear actuation. FIG. 66 further depicts the actuator system from multiple angles, highlighting the configuration of the zip chain loops and their connection to the drivewheel. The figures collectively describe an advanced robotic mobility system in which the vertical position of each wheel is independently controlled to enhance maneuverability and terrain responsiveness. FIG. 67A-67F illustrates a step-climbing mechanism of a robotic vacuum cleaner employing the zip chain actuators for the drive wheel and the caster wheel assemblies. In view shown in FIG. 67A, the robotic vacuum moves forward on a flat surface toward a downward step. As depicted in view shown in FIG. 67B, upon detecting the step edge, the system engages the zip chain actuators, extending the drive wheels and caster wheels downward to maintain ground contact. In view shown in 67C, both the drive and caster wheels are fully extended, allowing the robot to descend while keeping the chassis level. In view shown in 67D, the robotic vacuum cleaner continues traversing the lower level with extended wheels, maintaining balance and stability. View shown in 67E shows the process of retracting the extended wheels once the robotic vacuum cleaner returns to a flat surface, initiated automatically by internal sensors recognizing level terrain. Finally, in view shown in 67F, the robotic vacuum cleaner resumes normal operation with all wheels retracted, traversing the surface with its default clearance height. This mechanism allows the robotic vacuum cleaner to autonomously negotiate level differences such as steps or ledges while preserving stability propulsion continuity.

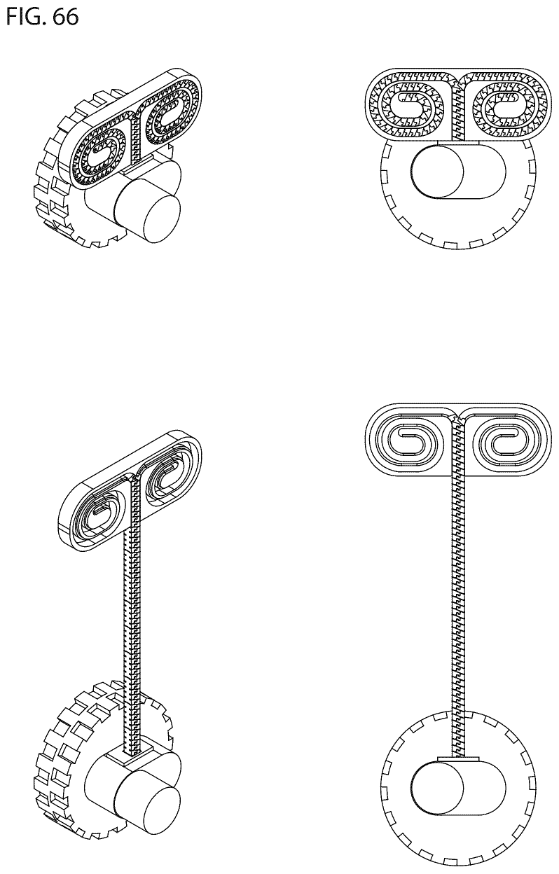

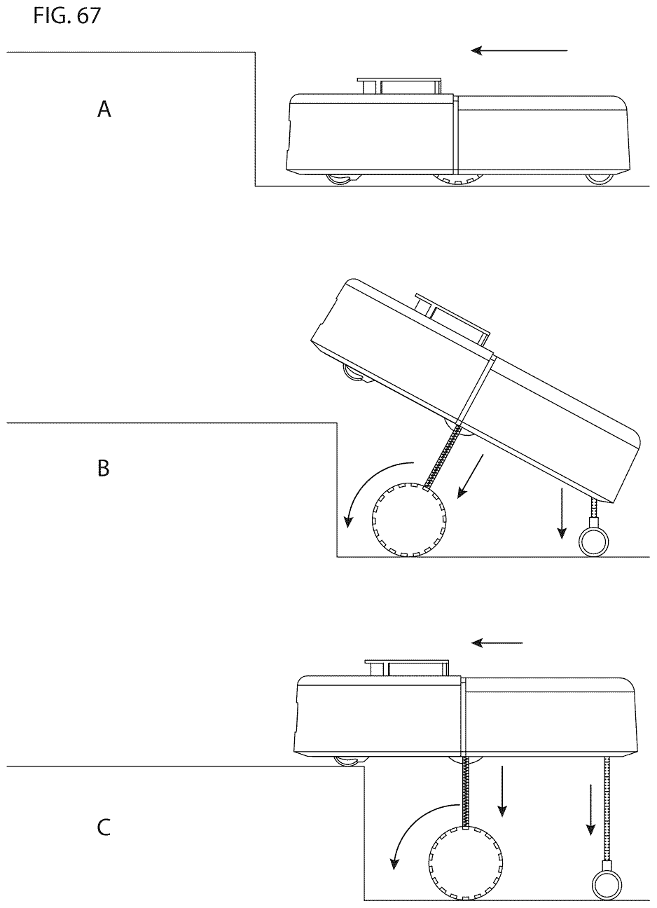

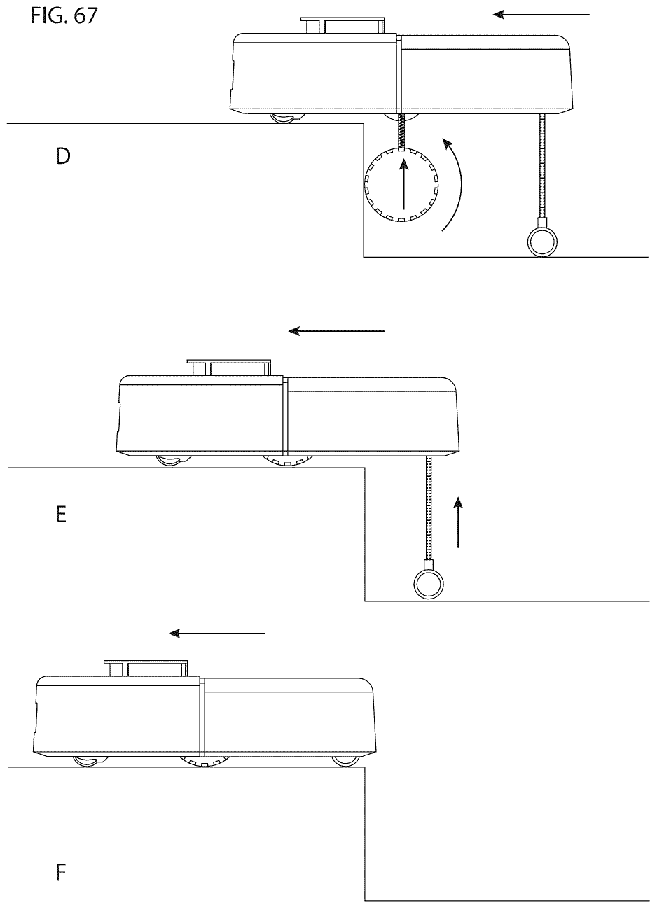

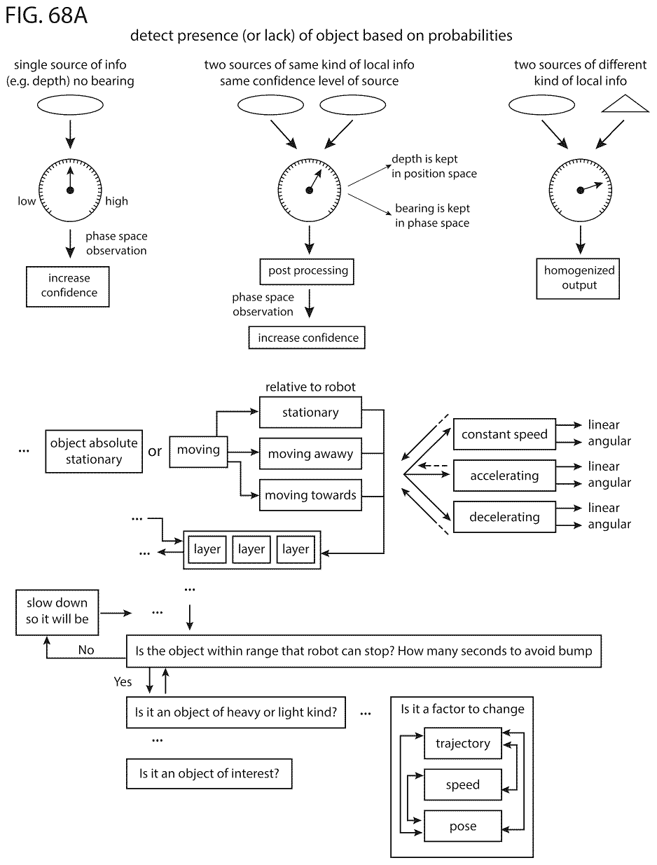

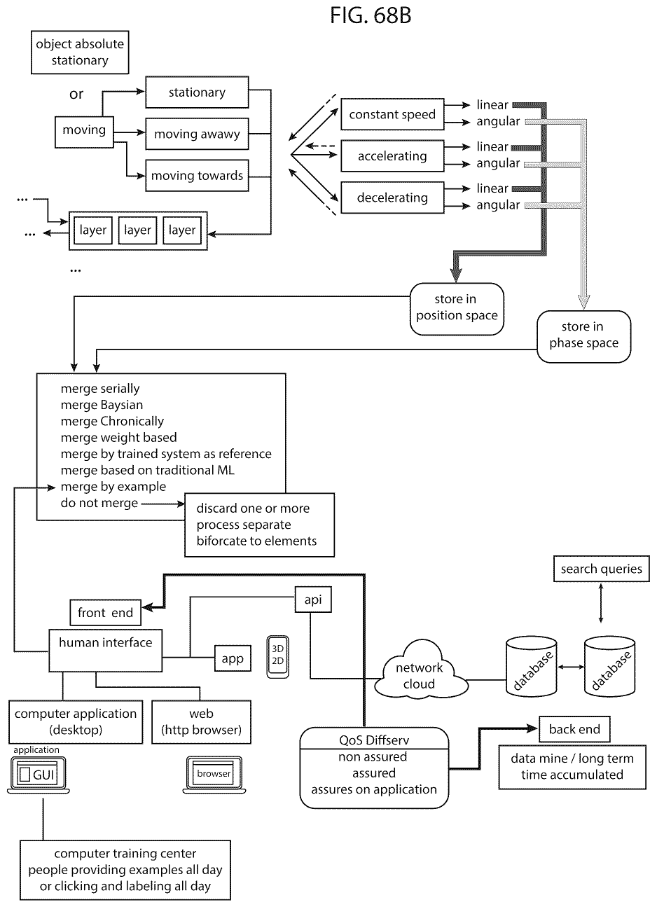

In addition to the embodiments aforementioned above, a robot further comprises sensing and processing systems configured to integrate information from multiple sources, such that it enhances the ability of the robot or robotic devices within a system to perceive, interpret, and interact with its environment, thereby complementing embodiments and features with autonomous functions. FIGS. 68A-73D demonstrate a process of combining information from different combinations of sources, according to some embodiments. The method is configured to detect the presence or the absence of an object within an environment by a robot based on probabilities derived from one or more sources of information. When a single source of local information is available (e.g., depth data without bearing), phase space observation is employed to determine the position of the object, where the confidence level is determined by the depth measurement. In some cases, where two or multiple sources of the same kind of local information are used with the same confidence level, the method applies post-processing. In this case, the depth and the bearing in the position space are kept, further increasing the confidence level for the determination of the position of the object. In other cases where two or multiple sources of different types of local information are available, the method combines the data to produce a homogenous output to improve the detection of the position of the object. Based on the processed and/or combined local information, the method identifies whether the object is absolutely stationary or dynamic. In some embodiments, the method, upon identifying that the object is dynamic or moving, the movement of the object is identified relative to the robot. A dynamic object may be identified as stationary (not moving), moving away, or moving towards the robot's position. The speed of the movement of the object is also determined as either being constant, accelerating or decelerating, and whether these speeds are linear or angular. All this information is layered and is processed to determine other possibilities or other features of the object (i.e., possibility of the object slowing down, weight of the object, type of object, etc.) that is relevant to the factors (i.e., trajectory, speed, and pose) of the robot that may be changed in response to the determined object. FIG. 68B illustrates the tracked movement and speed of the object relative to the position of the object. In some embodiments, the method processes multiple layers of data, including various merging techniques, such as serial, Bayesian, chronological, weight-based, traditional machine learning, reference-trained system, and example merging. The processed or combined data are then stored in either the position or phase space, depending on the type of data (i.e., linear or angular). Additionally, the method includes a human interface that is connected to a computer application, the web, or an application of a mobile device that interacts with a back-end network cloud, which acts as a database, wherein search inquiries and real-time processing are facilitated. Examples of graphical user interfaces are described in U.S. Pat. Nos. 10/496,262 and 12/093,520, and patents application Ser. Nos. 15/949,708, 15/272,752, 18/239,134, and 17/878,725, the entire contents of which are hereby incorporated by reference.

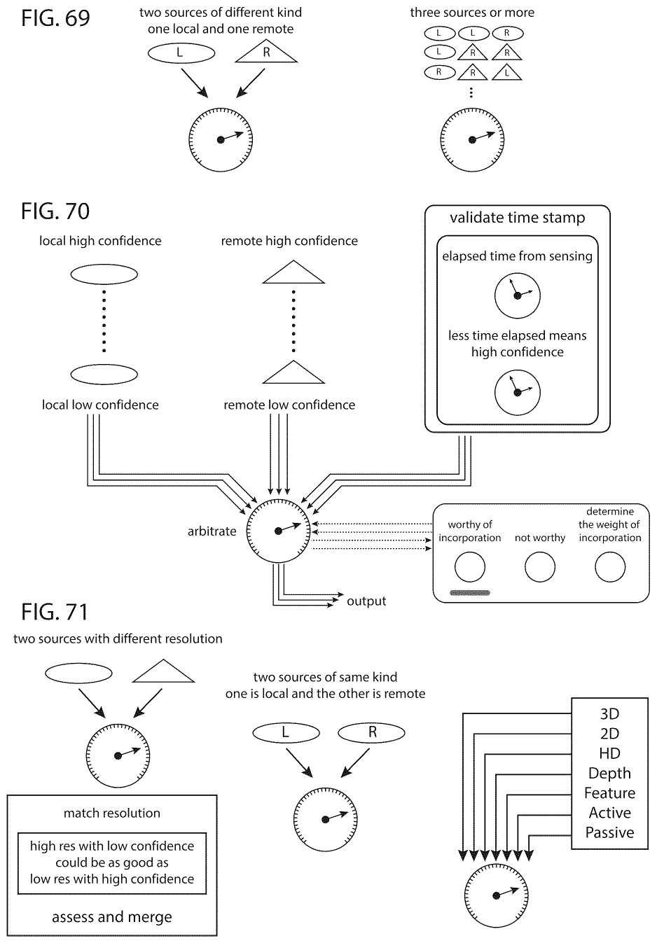

FIG. 69 illustrates that two sources may be from different types of information, which may either be local or remote information. In addition, three or multiple sources may be processed and/or combined together, which could be a mix of both local and remote information. FIG. 70 demonstrates the incorporation of weight assignment of received information during a combination process. In some embodiments, the method is designed to arbitrate between varying confidence levels (i.e., high or low confidence levels/values) from local or remote sources. The local or remote data are processed to validate the time stamp, where the confidence level is inversely proportional to the elapsed time from sensing, specifically, less time elapsed since the sensing event corresponds to a higher confidence. The method uses the time stamp validated information to arbitrate the various sources of data, determines which data is worthy of incorporation, based on the confidence level and time elapsed, and produces the output. FIG. 71 demonstrates other arbitrating cases with data having different resolutions, or a different kind, according to embodiments. In some embodiments, two sources with different resolutions may be processed or arbitrated for match resolution, such that the information which has a high resolution with low confidence are considered to be as good as those of low resolution with high confidence, and may be further assessed and merged. In some embodiments, two sources of the same type wherein one is local and the other is remote. In some embodiments, various types of information (i.e., 3D, 2D, HD, depth, feature, active, and passive data) are, likewise, arbitrated.

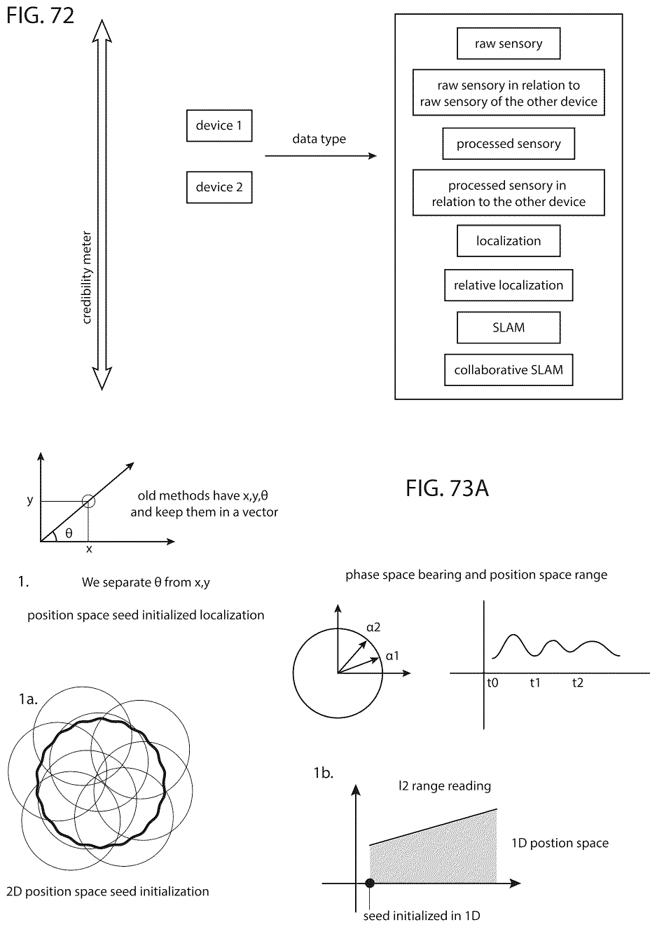

FIG. 72 demonstrates a credibility hierarchy of different types of data when combining data from two devices. These different types of data include raw and processed sensory, alone or in relation to other devices, localization or relative localization, and SLAM or collaborative SLAM. In some embodiments, a first source of temporal data is positioned in the front of the robot to capture readings from the front of the robot, which may align with the direction of movement of the robot. In some embodiments, the sensor may be positioned a bit off center in order to capture a distance that is slightly different than the direction of the movement of the robot. For example, a narrow field or point distance measurement may be captured from a sensor looking at a 1 o'clock or 2 o'clock angle wherein the direction of movement of the robot (unless turning) is 12 o'clock. This arrangement allows overcoming a situation where the robot is moving perpendicular towards a wall, only capturing readings from a single point in front of the robot for as long as it is moving straight. With an off-center arrangement, the robot scans more points of the environment. In some embodiments, a second source of temporal data is positioned on the rear side of the robot to capture data from a field of view that is behind the robot, which may align opposite the direction of the movement of the robot. As such, if the front sensor and the rear sensor return opposite optical flows. In some embodiments, where there is a front narrow field or point sensing in the front, the rear sensor may be the one that is positioned to slightly look at a view that is at an angle that is off-center from the rear or the robot, and the front sensor is positioned at 12 o'clock. In some embodiments, the robot is configured to perform coastal navigation or follow a wall from its right side. In such embodiments, the off center arrangement is ideally leaning to the left side such as 10 o'clock or 11 o'clock if the robot has only one sensor in the front, or alternatively with two sensors, one being at 12 o'clock, the second sensor in the rear could be the one that is off center leaning left, looking at its 7 o'clock or 8′ o'clock. In an embodiment with a first point distance sensor in the front looking at a 12 o'clock view and a second point distance sensor positioned in the off center rear, looking at a 7 o'clock, with each of 180 degrees turn at the end of a boustrophedon linear segment, when the robot is in coverage mode, the robot scans at least 330 degrees out of 360 degrees of its surrounding. In some embodiments, a first point distance sensor may be positioned in the front of the robot looking at a 12 o'clock view and a second point distance sensor positioned in the off center rear, looking at a 8 o'clock, with each of 180 degrees turn at the end of a boustrophedon linear segment, when the robot is in coverage mode, the robot scans at least 300 degrees out of 360 degrees of its surrounding. In another example, when in map building episode, in an embodiment with a first point distance sensor positioned in the front of the robot looking at a 12 o'clock view and a second point distance sensor positioned in the off center rear, looking at a 8 o'clock, as the robot begins to start a turn for scan counter clock wise, readings after completing 120 degrees of rotation, the readings from the front sensor and the off center rear overlap allowing for an iterative closest point equation to be solved. An arrangement of a first point distance sensor in the front, and a second one in the rear side, allows the maximum distance range to increase and overcome the limitations of each individual sensor.

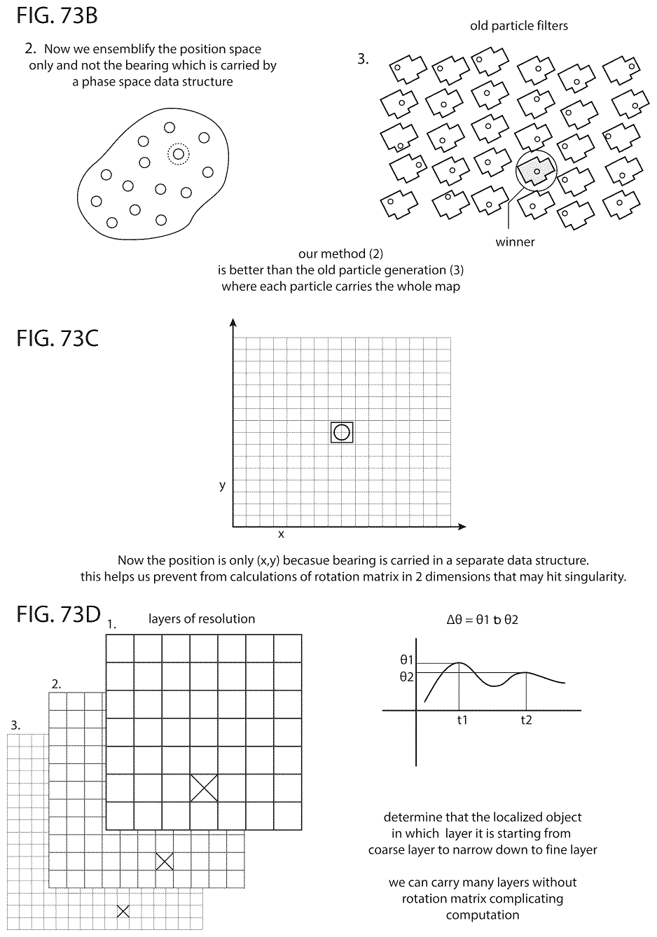

FIGS. 73A-73D demonstrate bifurcation of position related data and bearing related data, each in a separate and distinct data structure, while allowing for temporal merge at any timestep. As shown in FIG. 73A, an embodiment of a localization method of a robotic system, in which an orientation variable (θ) is separated from the x and y position variables to improve computational efficiency and accuracy of localization. Traditional methods represent position and orientation as a combined vector of x, y, and θ. By contrast, the illustrated method used in this invention initializes localization by separating θ from the x, y position space, thereby reducing dimensional coupling between position and orientation. The process begins with a position space seed initialization, in which multiple candidate or possible positions are generated within a 2-Dimensional plane to provide a robust basis for localization. This step ensures that the system has a distributed set of starting points, increasing tolerance to noise or sensory uncertainty. Building upon this initialization, a 2D position space seed distribution (1a) is used, where overlapping circular regions are used to cover the potential localization area. This representation captures a broader range of candidate positions and defines the possible region where the robot may be located. Following the 2D initialization, the system transitions into combining phase space bearings with position space range data as shown in 1b. Here, different bearings angles (a1, a2) are processed alongside range readings over time (t0, t1, t2) to progressively narrow down the candidate positions. Additionally, a one-dimensional (1D) projection of the position space is shown, where range-based seed initialization in 1D allows the system to efficiently map incoming sensor data into position estimates while maintaining accuracy. This stepwise localization refinement process, beginning with position seed initialization, expanding into a 2D distribution, and converging through phrase space and range data integration to achieve reliable robot localization.

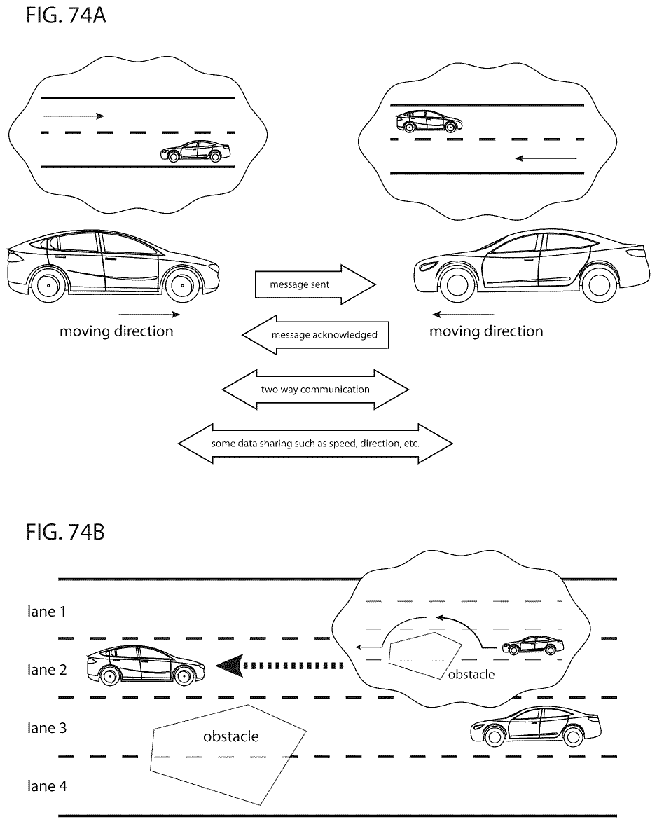

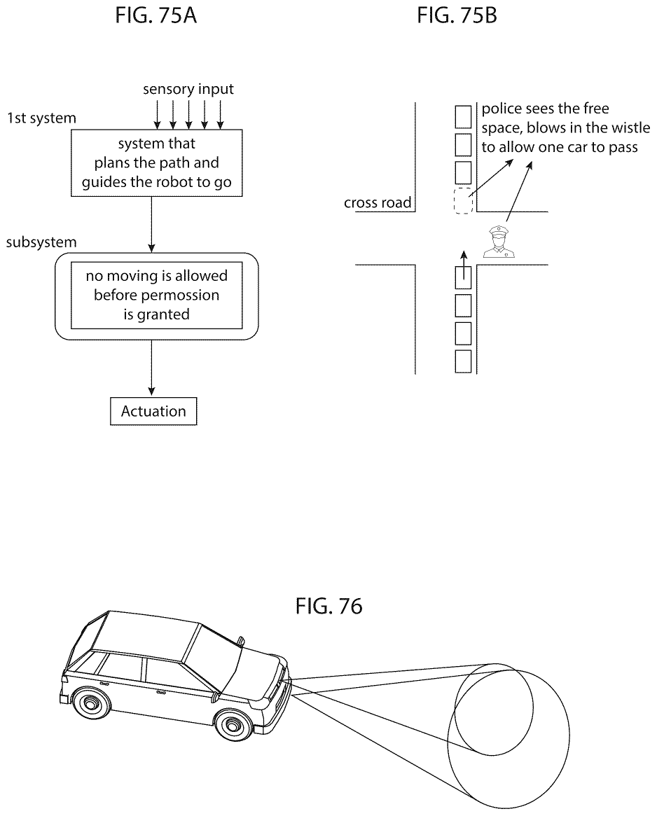

FIGS. 74A-76 illustrate examples of adaptive resolution in interrobot communication to optimize utility and timeliness, according to some embodiments. FIG. 74A illustrates an example of two cars moving in opposite directions, with a communication system enabling message exchange. In this example, one car sends a message to the other car, which is acknowledged upon receipt. Relevant data, such as speed, direction, and other vehicle parameters, is shared between cars to enhance situational awareness, and support real-time coordination, which may be beneficial for autonomous driving, lane changing decisions, and collision avoidance. Examples of collaborative methods are described in U.S. patent application Ser. Nos. 16/418,988, 15/981,643, 15/986,670, 15/048,827, 14/948,620, and 16/185,000, the entire contents of which is hereby incorporated by reference. In some embodiments, each robot considers the map resolution or localization resolution to send to the other side in a way that ensures the data remains useful when it arrives at the destination. In one example, if another robot is moving toward the receiving robot at a speed of 10 m/s, and it takes 0.1 seconds for the data to reach the robot, the other robot could have moved 1 meter in that time. Taking into account jitter in data transmission and noise in motion measurement, this could result in an actual movement of 90 cm or 110 cm. In such cases, sending a map with millimeter resolution may not be practical. In another example, sending a low-resolution map with a 10 cm grid size could be more effective, as it will arrive faster. An example is shown on FIG. 74B, in a scenario where a car in lane 3 intends to take a detour from its lane, this information may not require high resolution but must be transmitted quickly. If the intent reaches a car in lane 2 in time, the car in lane 2 can also take the detour to lane 1 and confirm to the car in lane 3 that it is safe to proceed with the detour. In some embodiments, a nearest neighbor search is performed within the local map to extract clues, such as corners or patterns, and find the closest match in the global map. By identifying associations between the local and global maps, the robot may achieve relocalization. In another example, a secondary subsystem is positioned between the first system and the second system, located at the wheel and responsible for controlling the motor, as shown in FIG. 75A and in an example of this system in FIG. 75B. In some embodiments, the processor localizes the robot within the environment. In addition to the localization and SLAM methods and techniques described herein, the processor of the robot may, in some embodiments, use at least a portion of the localization methods and techniques described in U.S. Non-Provisional patents application Ser. Nos. 16/297,508, 16/509,099, 15/425,130, 15/955,344, 15/955,480, 16/554,040, 15/410,624, 16/504,012, 16/353,019, and 17/127,849, each of which is hereby incorporated by reference.

In some embodiments, the system applies the brake and releases it as needed, with the default action being to engage the brake. The system first clears the path in front of the robot for the amount of space corresponding to the number of pulses it allows the motor to receive. In some embodiments, the system uses two sets of wide FOV sensors, as shown in FIG. 76, which are independent and distinct from the sensors in the first control system. One set consists of ultrasonic or sonic sensors, commonly used in the automotive industry for parking assistance, while the other set includes a camera with a wide-angle lens.

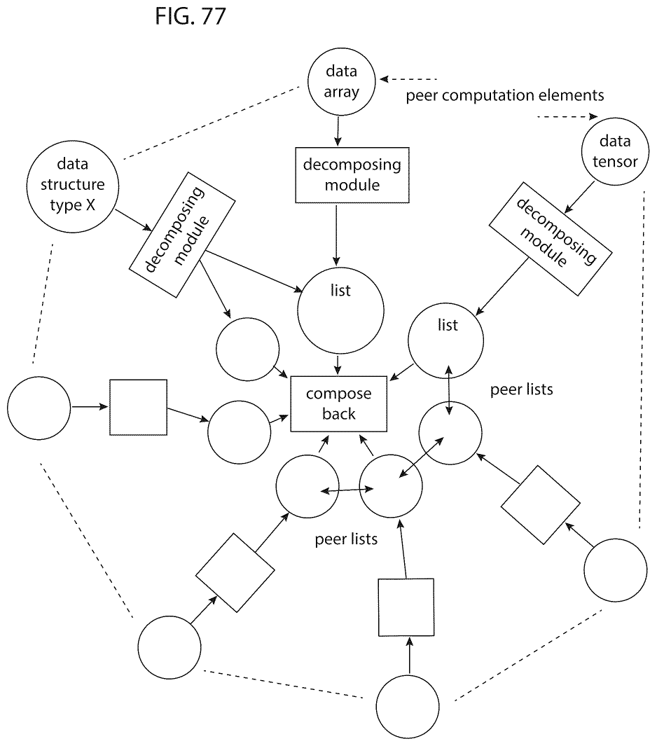

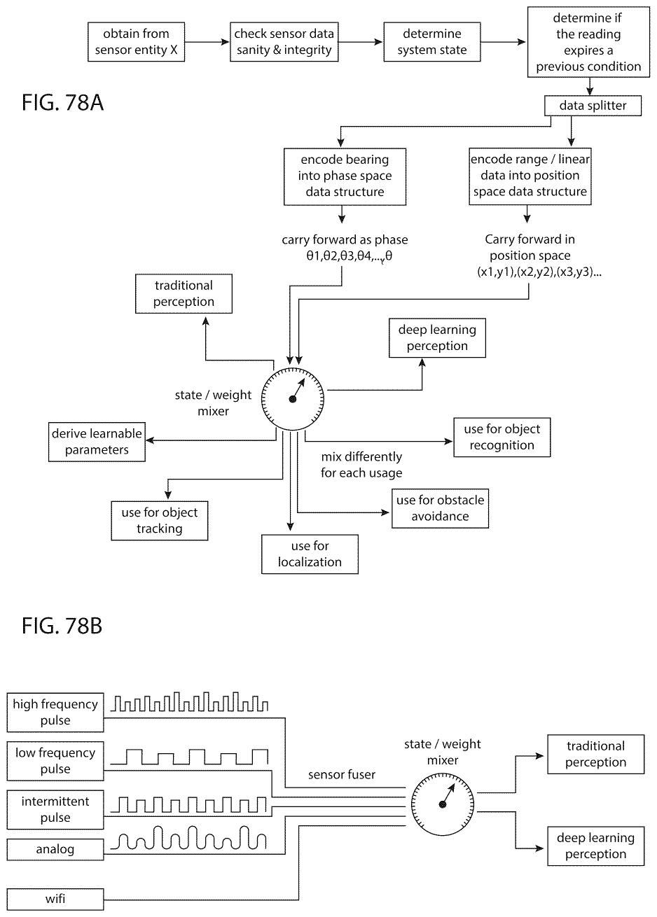

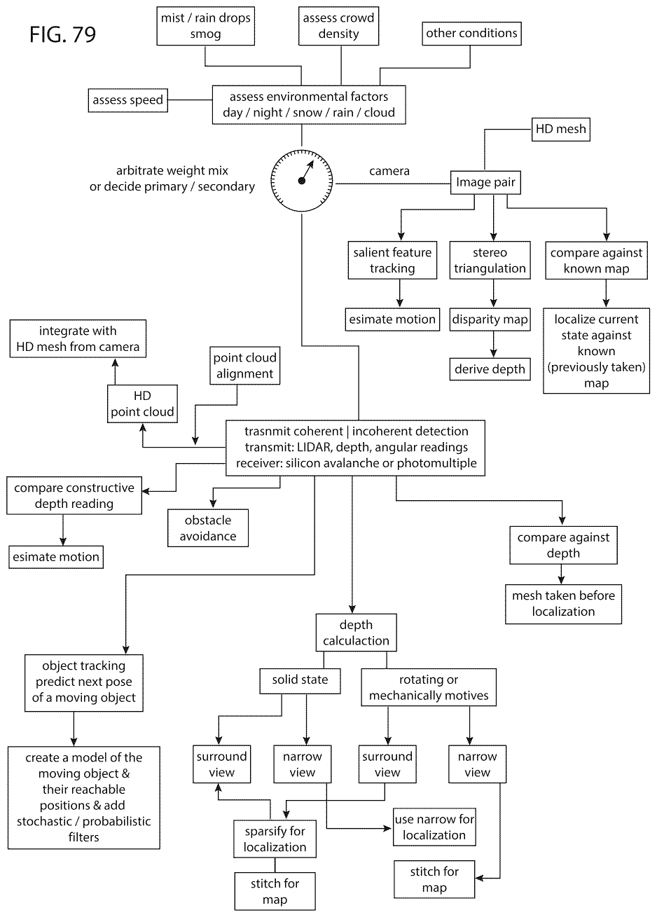

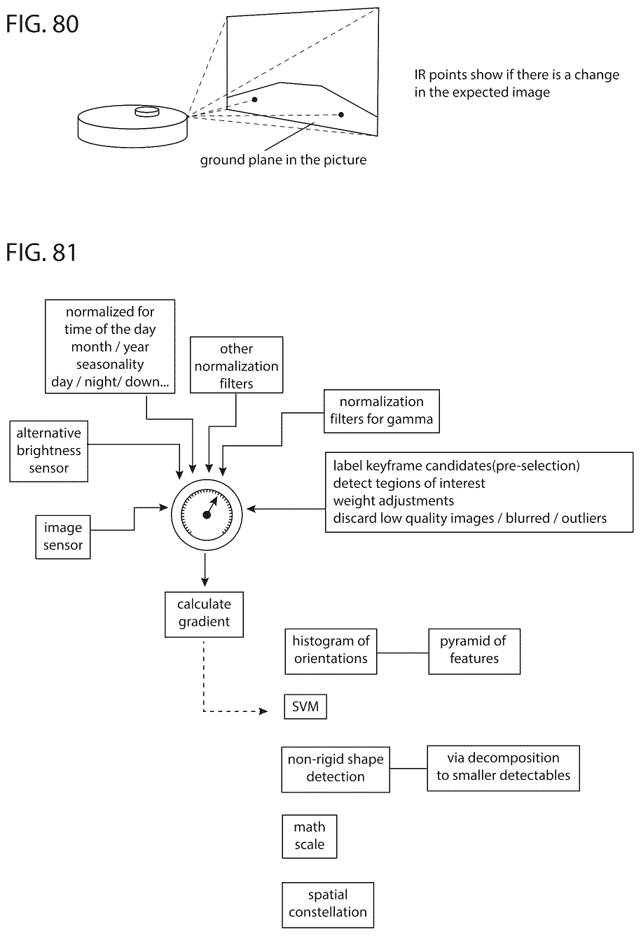

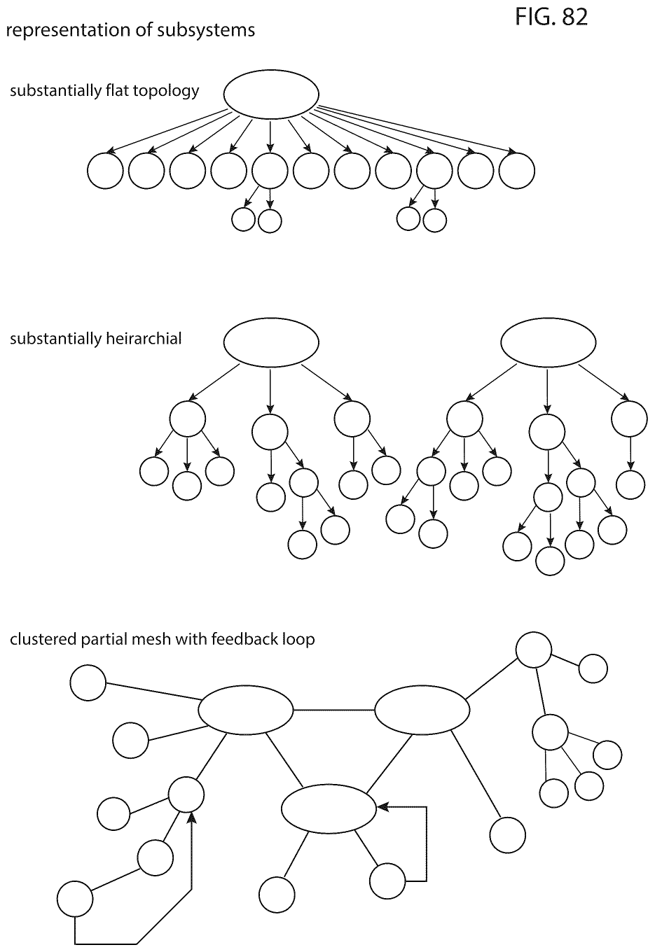

FIGS. 77-83 illustrate multi-entity computing systems, according to some embodiments. In some embodiments, to provide deterministic and mandatory obstacle avoidance, a subsystem intervenes with the electric pulse being sent to the motor unless it can ensure clearance ahead. This differs from ordinary path planning and obstacle avoidance, where the robot plans its route, actuates motors, and reacts to obstacles as they appear. In one example, a previously constructed HD map includes the expected pixel intensities for each pixel that belongs to a grid cell in the path ahead of the robot. When using LiDAR, this same information can be obtained through the reflectance intensities of the gridcell volume in front of the robot. In another example, during a previous training run in environments such as shopping malls, airports, train stations, or commercial spaces, the timing of the training could be selected to minimize or eliminate non-stationary obstacles. For example, training could be conducted during nighttime or after hours in an indoor commercial space where ambient light would not affect the HD map building due to artificial lighting. LiDAR and active range-finding mapping can still be used effectively in areas with insufficient ambient light. For improved results, map matching is employed to integrate information from multiple sensors and runs (or multiple devices), creating a comprehensive spatial representation of the environment. Map matching essentially combines sensor readings from overlapping areas to build a more accurate map. In some embodiments, areas of overlap are referred to as anchor points or key points. The stitching process does not have to rely solely on two consecutive readings from the same sensor (such as LiDAR, camera, or depth camera). It can involve stitching together multiple maps from different runs, whether from the same robot or even different robots. This process may also include combining different data types into a unified data structure that incorporates both data types. For instance, just as sensor readings can be represented as (RGBD), maps and localization data can also be represented in the same format, such as (RGBD) maps and (RGBD) localization. In some embodiments, data alignment is a critical step prior to stitching, as is identifying the overlap with the highest probability of being the best candidate for successful integration. In some embodiments, the number of voltage ticks that allow actuation in relation to the depth cleared of dynamic obstacles can follow a sliding window principle or a dynamic window approach. A reinforcement learning method may govern the expansion or shrinking of the window size. Methods such as Markov Decision Process (MDP), Temporal Difference Learning, or Monte Carlo methods, as elaborated in the above sections in U.S. patent application Ser. Nos. 18/667,997, and 18/612,966 are incorporated by reference.

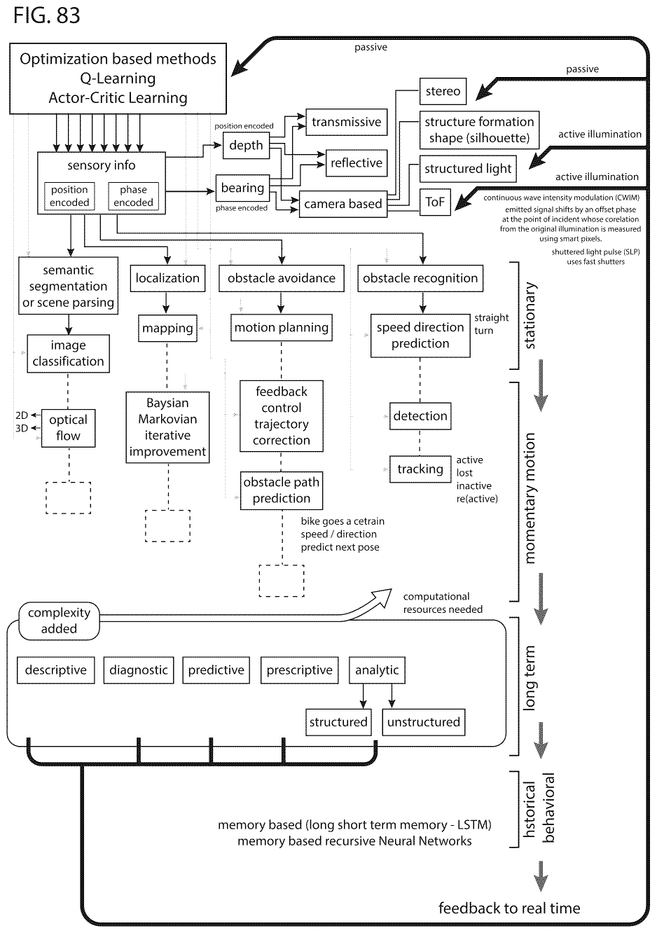

In some embodiments, multi-entity computing systems may be organized in a graph, as shown in FIG. 83. A tamper-evident data storage system may be employed, where deserialized and reserialized data travels along the hardware and system. A condition-expiring event may trigger the robot to enter or exit a state, with triggerable vertices and fuzzy defuzzification mechanisms employed. In some embodiments, cryptographic hash algorithms such as SHA, SHA2, Bcrypt, and Scrypt may be utilized for secure data storage and transmission. The Advanced Message Queuing Protocol (AMQP) is used for reliable communication. Data serialization formats, including JSON, XML, YAML, XOR, HOF, and NetCDF, are employed for data exchange. In some embodiments, an adjacency matrix and spatial multiplexing of sensor noise may be used to optimize data structures and mitigate decoherence in neighboring nodes. A directed graph may be utilized for triggerable vertices, with both head vertices and tail vertices. Additionally, an associative array may be used for efficient data access. Noise mapping generates a data structure from residual variances in sensed data, assuming the environment is static. In some embodiments, a Monte Carlo Tree Search (MCTS) may be employed to generate a sequence based on possible outcomes, with the probabilities of those outcomes summing to one. The outcomes may then be fed into a Bayesian system in an iterative way to generate a new generation of samples. Consequential sampling techniques may be used to create a tree of future generation datasets. The system may employ open-loop dynamic error suppression and closed-loop feedback stabilization to ensure accuracy. Non-orthogonal multiple access (NOMA) is utilized for efficient communication, with binning size optimized for performance.

In some embodiments, a real-time system must respond to events quickly enough to be useful, requiring a lightweight approach to coding mathematical concepts into software. Increasing MCU speed is not always a solution, as flash memory often has an upper speed limit of roughly 50 MHz, and other components may also have their own limits. Using a high-speed MCU may not provide significant benefits if the design forces the MCU to wait for data to flow. A result of reducing computational intensity and applying superior algorithms described in this patent is a reduction in hardware cost per unit, which is particularly beneficial for household robots, such as cleaners. Further, a robot system must be responsive to external stimuli, prioritize critical tasks, and allow for interruptions and preemptions. A full-featured OS like Linux may reduce responsiveness by managing multiple activities, so a robotic system is not expected to reboot when something is not handled reliably. Instead, it should manage itself, be reliable, and include built-in fault handling and self-check capabilities. When an interrupt arrives, the system is expected to wake up from sleep mode through the Nested Vectored Interrupt Controller (NVIC), which is designed to reduce power consumption until an interrupt signals the system to wake up.

In some embodiments, the system may include a processing unit, interrupt controller, one or more debug interfaces, MCU chip flash memory (e.g., 128 KB, 256 KB, 512 KB, 1 MB, 2 MB, 3 MB, 4 MB, 8 MB), MCU chip SRAM, MCU chip ROM, external RAM and ROM, SD RAM, GPIOs, and a high-speed system bus that allows communication between the processing unit, flash, SRAM, ROM, GPIO, internal watchdogs, OMA, wake-up unit, and CRC for communication. The peripheral bus supports interaction with timers such as PWM, low-power timers, periodic interrupt timers, real-time clocks, analog comparators, DACs (digital-to-analog converters), ADCs (analog-to-digital converters), I2C, SPI, UART, USB OTG, 12S, and low/high-frequency oscillators. In some embodiments, the zero (0) logic for a digital input GPIO is defined to be between 0.0 and 0.35, multiplied by the supply voltage, with an error range of ±10%, ±20%, or ±5%. The one (1) logic is electronically designed to be between 0.7 and 1.0, multiplied by the supply voltage. Values between 0.35 and 0.7 are considered undefined and may vary from one design to another. This example is provided for illustrative purposes and is not intended to be limiting. Digital input GPIOs are characterized by high impedance, drawing minimal electrical current, while output digital GPIOs typically provide a supply voltage of 0.5V when signaling a logical 1 and between 0.0 and 0.5V when signaling a logical 0.

In some embodiments, an application may also run concurrently in the same state machine. In other embodiments, an application may be performed on another processing unit. For example, for a cleaning robot, an application may run the brush motors and fan motors. In the case of a telepresence robot, an application may serve as an audio/video call transmitter. In the preferred embodiment, room detection also runs in the same state machine on the same microcontroller, along with SLAM, control, sensing, actuation, battery management, and other operations of the robot. In some cases, it may be suitable to run the application along with the navigational stack inside the same state machine. For example, a robot may have cleaning functions controlled in the same state machine as the navigational stack. In some robots, all processes run on a single MCU that includes a User Interface (UI), Wi-Fi, etc. For other robots, the UI is offloaded to a separate MCU to allow more comprehensive and detailed user interaction as well as capacitive touch sensing and finger slide sensing.

In all three examples above, the same single MCU controls the navigational stack, sensing and actuation, and PID control, as well as an application that controls the brush, water pump, Ultra-Violet (UV) light, side brush, fan motor, and other devices of the robot.

In some embodiments, an application is offloaded to a different subsystem. In embodiments, additional MCUs, CPUs, Graphics Processing Units (GPUs), Neural Processing Units (NPUs), etc. may be used to accommodate the operation of an application. For example, a system of a surveillance and security robot may offload identification of people the robot encounters to upstream subsystems that may be implemented on other processing devices. If the application requires identification of a person from a selected list of candidates, their identification may be executed with minimal overhead more easily than a scenario wherein the user must be identified from an infinite number of possible persons. For example, the system of the robot may only need to identify a person from a group of persons that live in a particular household. A broader list of persons from which the system needs to identify the person may include guests that the robot has observed visiting the residence before. In one embodiment, the list may be developed from a person's connections on social media platforms. However, the list would be broader than the list developed from physical visitors observed visiting their residence. In one embodiment, the system may begin the search to identify the person by searching through persons living at the residence and then progress to broader lists in a hierarchical manner. In some embodiments, the system generates an index of the hierarchy when the robot is not performing any other activities or when the robot is offline. For example, a system of a security robot may have a list indexed of common visitors of a train station. An example of a fast operation for the system of the robot includes identifying whether a person is a common visitor of the train station, and if so, finding a history of past visits and other desired information associated with the person.

In some embodiments, the control system may be distributed to more than one physical processor that collectively form a single conceptual state machine. Multiple physical processing devices or processor cores may collectively be regarded as a single logical unit that transitions from one state to another, wherein no single processing unit has individual control over the system. The distribution may be on the same physical board or on several different boards organized on a single robot. In some embodiments, the distribution of the control system may span multiple physical locations. In embodiments wherein the control system is distributed, each individual system (which itself may have one or more subsystems) may have partial or full autonomy. For example, in a collaborative system of cleaning, described in U.S. patent application Ser. No. 16/185,000, the entirety of which is incorporated by reference herein, each robot has autonomy in its own navigation but contributes to a larger system with a common goal

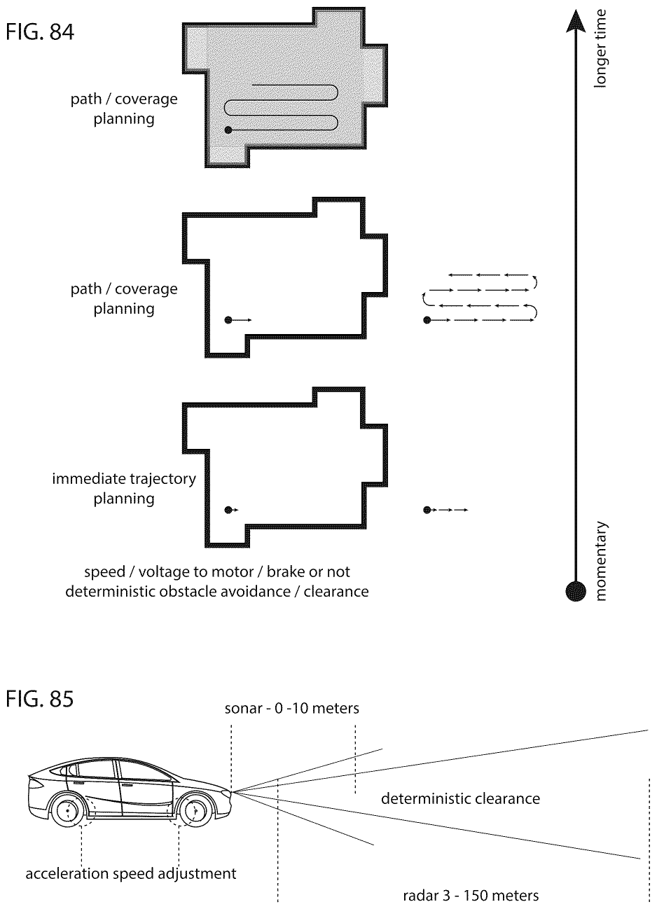

FIGS. 84 and 85 illustrate scenarios for synthetic and individual decision-making in navigation tasks, including escaping routines, obstacle handling, and corner negotiation, according to some embodiments. In some embodiments, global matching and semi-global matching utilize an energy minimization approach, which is solved by dynamic programming, Markov Decision Processes (MDP), belief systems, scene flow, and optical flow. These methods differ from stereo vision due to additional uncertainties, such as motion, reflection, and lighting differences at various positions. Additionally, challenges like transparency, occlusion from different perspectives, and the “aperture problem” must be addressed. The iterative refinement of localization, mapping, and odometry may occur pose-by-pose or over a set of the last x poses, where x is a variable that can dynamically increase or decrease, starting from 1 (pose after pose). This dynamic window can adjust, for instance, with bundle adjustment happening over the last (1, 2, 4, 10, 30, x) images. To improve results, images may be prequalified and excluded from the set that participates in iterative refinement. For stereo bundle adjustment, two sets of images are used to minimize the sum of squared pre-projection errors, denoted as x1 and x2, with each set having its own independent dynamic sliding window size or criteria. Stereo image pairs are obtained simultaneously by two different cameras, whereas optical flow image pairs are captured at consecutive time stamps by the same camera, often supplemented by IMU or odometry as constraints to connect poses.

To track objects and maintain a safe distance by predicting their trajectories, predictions are made based on the temporal evolution of previous positions. These predictions are corrected through observations made at the current time in an iterative process, particularly for objects that are partially or fully occluded. In some embodiments, instead of using least squares difference methods, the Pearson product-moment correlation is applied to measure the linear correlation between two datasets. Covariance between the two variables is divided by the product of their standard deviations, normalizing the covariance to handle missing variables more effectively.

| Systematic error | Non-systematic error |
|---|---|
| Wheel alignment size | Wheel slippage - slippery floor |
| Inflation level (tire pressure) | High friction floor |
| Encoder resolution | Uneven floor |
| Encoder sampling rate | Transition points from one surface |
| Motor actuation | to another |
| | Slippage due to over acceleration |
| | Skidding (fast turn) |
| | External push/pull |
| | Caster wheel |

In some embodiments, a method enables a third-party application to interface with, control, and send data to and receive data from a scheduler through an application programming interface (API). This allows the third party to use its own preferred actuators and sensors while leveraging the real-time SLAM module. In another example, a method enables a third-party augmented reality (AR), virtual reality (VR), or mixed interactive reality system to interact with the SLAM module, utilizing the alignment of data and localization provided by SLAM. The one or more cameras are positioned at predefined baseline distances and angles, with a deep neural network configured to minimize the regret index. The microcontroller performs control and interfacing between hardware components, software components, sensors, and actuators. In some embodiments, the microcontroller may be a microprocessor. In some embodiments, the media transceiver facilitates communication with external devices. The object tracker detects the presence of an object's physical whereabouts, categorizes it as stationary or in motion, and tracks its angular and linear motion in relation to the environment or itself. In addition to the mapping and SLAM methods and techniques described herein, the processor of the robot may, in some embodiments, use at least a portion of the mapping methods and techniques described in U.S. Non-Provisional patents application Ser. Nos. 16/163,541, 16/851,614, 16/418,988, 16/048,185, 16/048,179, 16/594,923, 17/142,909, 16/920,328, 16/163,562, 16/597,945, 16/724,328, 16/163,508, 16/542,287, and 17/159,970, each of which is hereby incorporated by reference.

In some embodiments, when validating runtime readings against a map created during training, deterministic methods may not suffice due to the influence of environmental factors and other errors. Therefore, the map itself could be stored as a data structure with multiple entries taken at each training episode, allowing for a richer representation of the environment. Alternatively, a probabilistic representation could be derived from multiple training episodes to reduce the map size, which would help manage storage and computational complexity. Yet another approach would involve storing all the training episode data in backend data storage, with a probabilistic data structure in the frontend. This structure could be dynamically adjusted and fine-tuned based on the latest data available. In this case, a bias-variance trade-off must be carefully studied and determined to strike a balance between the integrity of original training episodes and the influence of recent findings on the probabilistic model.

In some embodiments, a surface reflectivity map may be used, which could be captured with sensors other than the mapping sensors or from specific elements in sensor readings that correlate with surface reflectivity. This tool can help the robot address uncertainties at runtime, improving performance in varied environmental conditions. In some embodiments, additional data sources like temperature maps, lighting maps, and weather maps could be integrated into the decision-making process, further enhancing the robot's ability to adapt to dynamic environmental conditions. Time delay between sensor observations and actuator responses is referred to as the system's response time. If a long while loop is used, observations made within the loop may not affect actuation until the next iteration. To overcome this limitation, a root function may be utilized to invoke subroutines, enabling more responsive behavior and reducing latency. Stereo and optical flow methods both rely on creating correspondences between pairs of images to estimate disparity. This process could be framed as a classification problem, where the goal is to select from a set of possible image pairs (e.g., 32, 64, 128, 256, etc.). The disparity of the selected image pair is known, and a parameter (w) is learned by minimizing a function, such as cross-entropy, during training. Rule-based behavioral systems could be encoded within finite state machines or hierarchical finite state machines. The rules governing the behavior can be derived from Bayesian probabilistic systems, where decisions are made based on probabilities. The highest probability determines the most likely state or action, and the rules are enforced under the assumption that the highest probability is the correct choice. In this framework, a probabilistic system is translated into a deterministic system, allowing for a structured decision-making process. In some embodiments, each filter in the neural network contains one or more learnable parameters. The layers of the network may include the activation layer, pooling layer (such as max pooling or average pooling), and fully connected layers, which connect all computational nodes to all activations. The pooling layer helps to reduce the number of parameters, making the system more efficient. To quantize an analogue system, a transfer function is employed, as described by the formula:

$$n = round [ \frac{{v}_{in} - {v}_{- ref}}{{v}_{+ ref} - {V}_{- ref}} 2 B ]$$

where: n is the output value in the range of voltages, vin and v-ref is the upper and lower boundary reference voltage (for example, ground and 3.3 volts), B is the number of bits to represent the analogue value, which also determines the resolution. A sampling rate or update rate of the output based on the input allows for accurate signal reconstruction. The lower the sampling rate, the closer the digital representation is to the original analogue signal. As per the Nyquist theorem, which is also applicable in analogue-to-digital conversion, the sampling rate must be sufficiently high to capture all the relevant information. A low-pass anti-aliasing filter can be used to prevent distortion during the conversion. For analogue-to-digital conversion, a transfer function may take the value n as input and produce an output voltage Vout:

$${V}_{out} = n \frac{{v}_{+ ref}}{{2}^{B}}$$

Often, an R-2R ladder or an N-bit resistor ladder is used to divide the voltage between two reference values. This configuration uses 2n resistors of equal value arranged serially between the upper and lower reference voltage. Alternatively, a combination of N resistors with value R and N resistors with value 2R forms a more efficient R-2R ladder structure. In such systems, convolution is often the dominant computational operation. Computing elements are typically orientation-selective and transitionally invariant, allowing them to process input data effectively by detecting patterns and features across different orientations or positions.

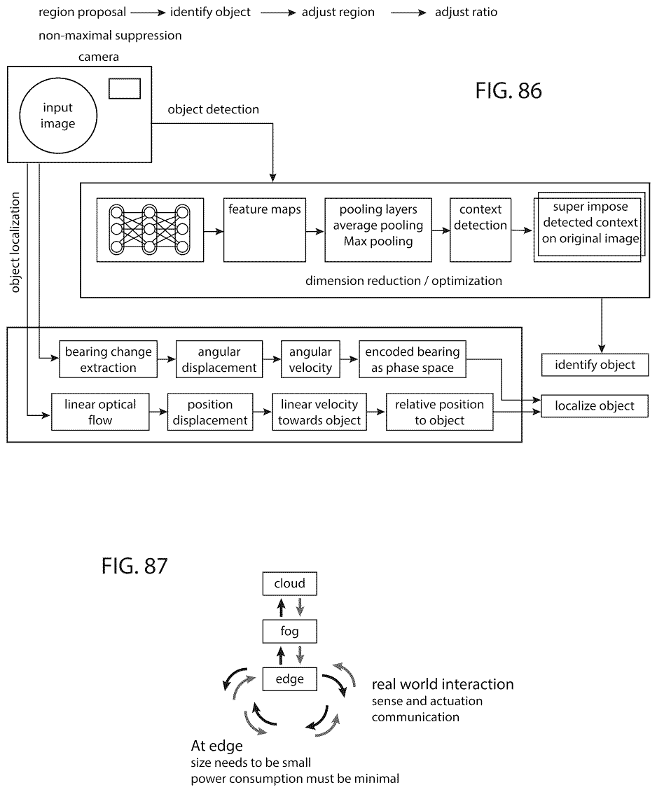

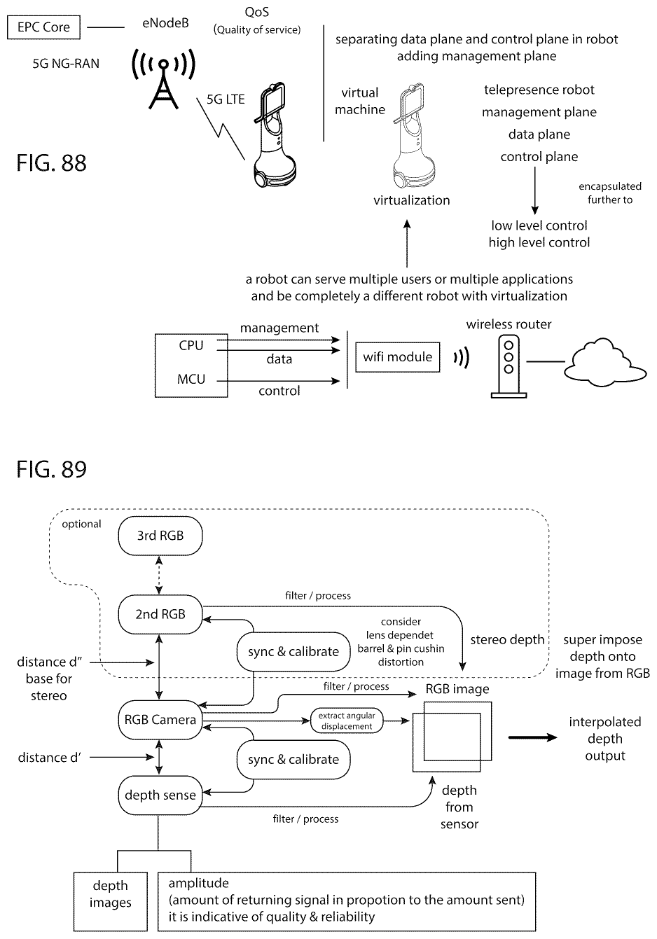

In some embodiments, the Successive Approximation Analog-to-Digital Converter (ADC) performs a comparison to achieve a result for each bit. The sampling cycle begins when the circuit closes and the capacitor begins to charge at the input. Once the capacitor is sufficiently charged, the circuit “triggers,” opening the circuit and measuring the voltage held in the capacitor. The speed at which the ADC sample switch is triggered is controlled by the “conversion clock,” which determines the timing of the sampling process and is typically governed by software. In certain embodiments, a watchdog timer is used to reset the processor or controller if it is not serviced at the expected time interval, which indicates that the program has entered or is in an unknown or uncontrolled state. This feature ensures that the system remains reliable and does not become stuck in an undesired state. Furthermore, the duty cycle of the infrared (IR) emitter can be adjusted to increase the illumination provided to the surroundings. The duty cycle, which is the portion of the period during which the emitter, motor, or any device is active, may be dynamically adjusted based on ambient light levels or the robot's speed. For example, at higher speeds or in low ambient light conditions, the duty cycle of the IR emitter may be increased to provide better detection and performance. The watchdog timer is also designed to be serviced at least once during the startup code execution and at least once during the execution of the operational code. This ensures that the system is actively monitored and remains in a controlled state throughout its operation. FIGS. 86-89 illustrate diagrams showing data processing, transmitting, and mapping for localization, according to some embodiments.

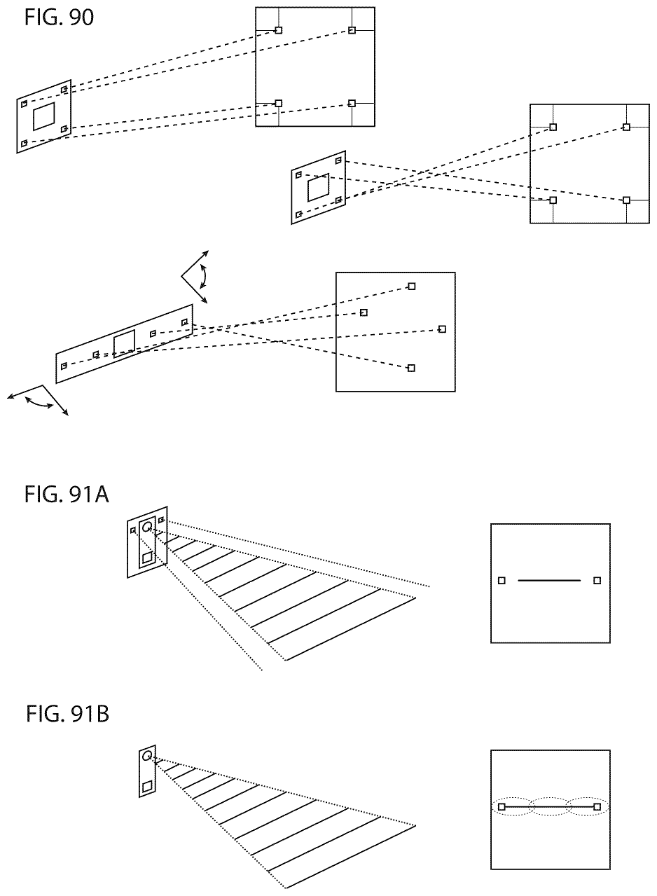

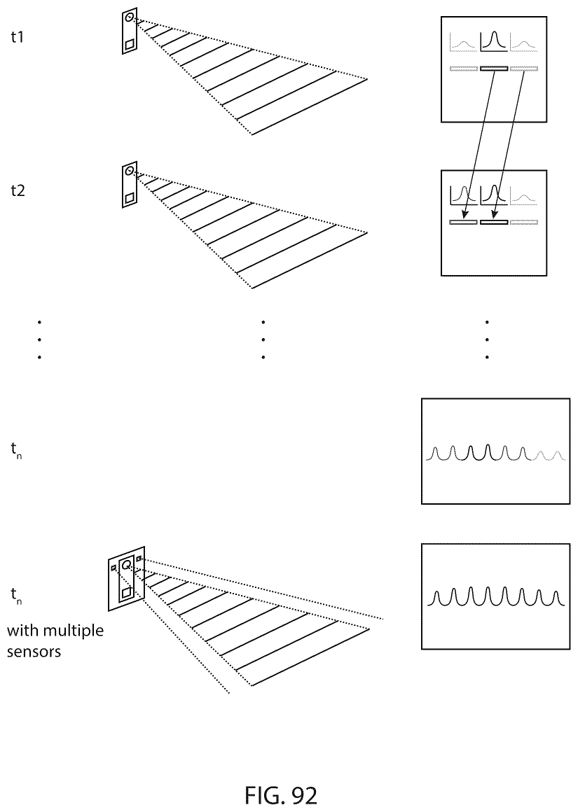

FIGS. 90-92 illustrate examples of adjustments in sensor-camera configurations to capture near and far distances, according to some embodiments. In this system, a previously created (stored or downloaded) full 3D/dense map may be further processed into distinct height layers and content layers, which can include ground and various height point clouds. These layers help to break down the map into more manageable components. When the robot matches its current readings against the pre-stored or downloaded dense map, it may use Iterative Closest Point (ICP) methods to accurately localize itself within the environment. This process matches the current data to the dense map, allowing the robot to determine its position by aligning point clouds and identifying discrepancies. Edges in depth maps or disparity maps often represent object boundaries, which can further define color boundaries. This technique helps in post-processing, such as camera shooting corrections or modifications, which may include eliminating the need for a green screen or enhancing the capabilities of the system in terms of visual effects. To reduce the search space, stereo rectification may be employed, which involves finding two homographies where epipolar lines are made parallel. This simplification allows for more efficient matching of points in stereo images, thereby improving the accuracy of the robot's localization process. Continuous Wave Intensity Modulation (CWIM) is used in certain depth sensing systems where the emitted signal shifts an offset phase due to incidental reflections. The correlation function establishes the relationship between the amplitude of the reflected signal, the phase shift, and the offset, enabling more accurate distance measurements. Multiple measurements are taken, typically at least three, to solve for multiple unknowns. As more data is captured, this sequence of sampling converges towards an accurate distance reading. Alternatively, shuttered light pulse systems emit a Near Infrared (NIR) light pulse for a specific duration. A fast camera shutter captures the discretized reflection, and the intensity of the reflected signal correlates to the distance of interest. However, the reliability of these measurements can be affected by the reflectivity of the surface, which may cause variations of up to several centimeters, making the system sensitive to object color and surface type.

Additionally, the geometry of the sensor and camera plays a significant role in depth sensing. Near distances may not be captured within the field of view (FOV) of the camera, and similarly, distances beyond a certain range may not be represented in the image. By adjusting the geometry of the sensor or utilizing multiple sensors arranged in various configurations, the system can cover a broader range of distances. Just as in structured light sensing, these point sensing sensors could create a specific point of interest in the 2D image taken from the camera's FOV. In some embodiments, structured light, such as a laser light, may be used to infer the distance to objects within the environment using at least some of the methods described in U.S. Non-Provisional patents application Ser. Nos. 15/243,783, 15/954,335, 17/316,006, 15/954,410, 16/832,221, 15/224,442, 15/674,310, 17/071,424, 15/447,122, 16/393,921, 16/932,495, 17/242,020, 15/683,255, 16/880,644, 15/257,798, 16/525,137, each of which is hereby incorporated by reference. This interaction between depth sensors and camera images requires a set of measurement equations that can be used together with the sensor's distance measurements. In this context, various sensor methods, such as Time-of-Flight (ToF), pulse or continuous emission, intensity, and phase shift upon reflection, can be used individually or in combination to improve measurement accuracy. Although the example sensor in this case is the Flight Sense from STMicro, the method is applicable to other sensors capable of similar measurements. In some embodiments, as new sensor readings come in, older readings with low confidence may expire. This can be done via a sliding window approach, where only the most recent data within a defined time or spatial window is retained. In other embodiments, an arbitrator may be used to determine the relevancy and confidence of the readings, asserting different levels of weight or influence over the data based on factors like accuracy or environmental conditions. Alternatively, the expiration process can be statically preset, where readings are discarded after a fixed duration or when predefined conditions are met. In some embodiments, a previously trained system may be used to dynamically assess and expire low-confidence readings. In some embodiments, wide line lasers used for depth sensing may face calibration challenges due to potential misalignments in optical components, especially when aiming for a wide angle of coverage. Narrow line lasers, though easier to calibrate, provide a limited field of view (FOV). To address this, in some embodiments, a time-multiplexing technique may be employed, where structured light emission is alternated with point measurements. This allows the system to maintain a broader FOV while using more easily calibrated narrow line lasers for accurate point measurements. This hybrid approach combines the benefits of both structured light and point measurement technologies, creating a more reliable and robust point cloud for depth sensing applications.

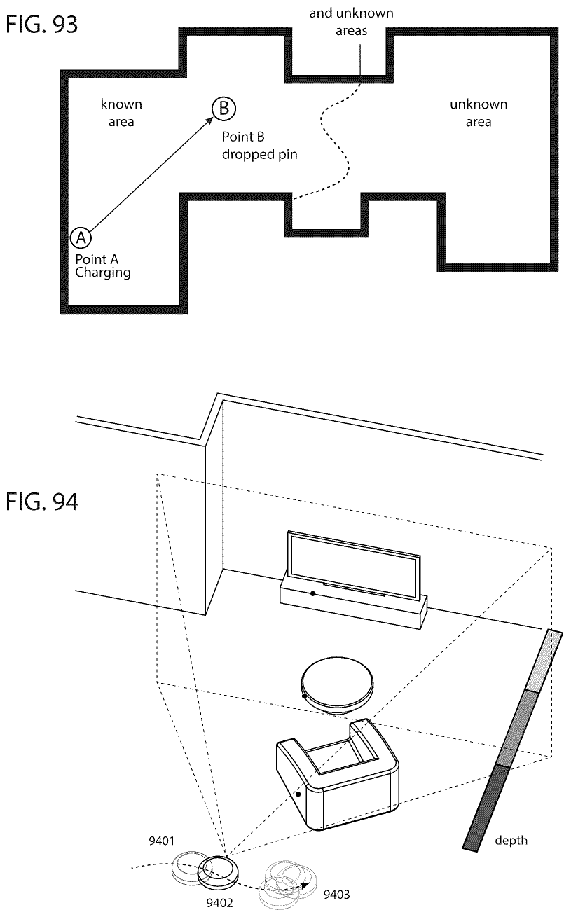

FIGS. 93-106 illustrate methods and examples in exploration in coverage tasks by a robotic device, exemplified by point-to-point movement using SLAM, according to some embodiments. In some embodiments, as new sensor readings are collected, older readings may be retired or discarded. This could be done via a preset expiration time, where readings older than a fixed time threshold (e.g., 10 seconds or 10 times the typical time step) are discarded, especially when new readings do not match the previous data. Alternatively, a dynamic approach could be employed where readings are retained based on their confidence or relevance, and older readings with lower confidence or relevance are retired. In some embodiments, a time decay factor may be applied to readings, where the relevance of a reading diminishes over time. Similarly, a confidence decay factor may be applied to readings, where the confidence in a reading decreases as it becomes outdated. In some cases, both time and confidence decay factors may be combined, where older readings with low confidence are gradually discarded to make room for newer, more reliable data. An arbitrator system may be employed to decide whether new information should replace older readings or whether the older data should be maintained. For example, if a new depth value is inferred but is less accurate than a previously measured depth value, the arbitrator may decide to retain the older value, ensuring the system uses the most reliable information available. In some embodiments, prior training may be used to resolve many situations using learned patterns rather than relying on simple lookup tables. Advanced neural networks or similar models can be trained to optimize decision-making processes and improve performance during runtime. However, the robot can also increase its knowledge and adapt “on the job” by learning from new data as it progresses through its tasks. This dynamic learning capability allows the robot to refine its decisions and enhance its confidence in real-time. In some cases, the robot's primary task may take precedence over collecting confidence data. For instance, while exploring the environment, the robot must balance between increasing its map knowledge and completing its designated task (e.g., cleaning or covering an area). FIG. 93 illustrates an example of where exploration is required to seamlessly move from Point A, representing a charging station, to Point B, representing a dropped pin, without having the entire floor plan discovered in advance. As previously discussed in this patent, exploration should be minimal or seamless, with the robot performing its job while simultaneously updating its map, ensuring that it is always progressing towards its primary goal without excessive delay.

In some embodiments, the processor uses a Convolutional Neural Network (CNN) to process such large amounts of data. CNNs are useful as spaces of a network are connected between different layers. The development of CNNs is based on brain vision function, wherein most neurons in the visual cortex react to only a limited part of the field that is observable. The neurons each focus on a part of the FOV, however, there may be some overlap in the focus of each neuron. Some neurons have larger receptive fields, and some neurons react to more complex patterns in comparison to other neurons. To maintain the height and width of a previous layer, zero padding is used, wherein empty spaces are set as zero. While the layers shown are connected with flat layers in parallel to one another, it is unnecessary that the distance between cells in each layer is the same in every region. When a kernel is applied to an input layer of the CNN, it convolves the input layer with its own weight and sends the output result to the next layer. In the context of image processing, for example, this may be viewed as a filter, wherein the convolution kernel filters the image based on its own weight. For instance, a kernel may be applied to an image to enhance a vertical line in the image.

In embodiments, a kernel may consist of multiple layers of feature maps, each designed to detect a different feature. All neurons in a single feature map share the same parameters and allow the network to recognize a feature pattern regardless of where the feature pattern is within the input. This is important for object detection. For example, once the network learns that an object positioned in a dwelling is a chair, the network will be able to recognize the chair regardless of where the chair is located in the future. For a house having a particular set of elements, such as furniture, people, objects, etc., the elements remain the same but may move positions within the house. Despite the position of elements within the house, the network recognizes the elements. In a CNN, the kernel is applied to every position of the input such that once a set of parameters is learned, it may be applied throughout without affecting the time taken because it is all done in parallel (i.e., one layer).

In some embodiments, the processor implements pooling layers to sample the input layer and create a subset layer. Each neuron in a pooling layer is connected to outputs of some of the neurons in the adjacent layers. In each layer, there may exist several stages of processing. For example, in a first stage, convolutions are executed in parallel and a set of linear activations (i.e., affine transform) are produced. In a second stage, each linear activation goes through a nonlinear activation (i.e., rectified linear). In a third stage, pooling occurs. Pooling over spatial regions may be useful with invariance to translation. This may be helpful when the objective is to determine if a feature is present rather than finding exactly where the feature is.

The architecture of a CNN is defined by how the stacking of convolutional layers (each commonly followed by a ReLu) and the pooling layer are organized. A typical CNN architecture includes a series of convolution, ReLu, pooling, convolution, ReLu, pooling, convolution, ReLu, pooling, and so on. Particular architectures are created for different applications. Some architectures may be more effective than others for a particular application. For example, a Residual Network developed by Kaiming He et al. in “Deep Residual Learning for Image Recognition”, 2015, uses 152 layers and short cut connections. The signal feeding into a layer is also added to the output of a layer located above in the stack architecture. Going as deep as 152 layers, for example, raises the challenge of computational cost and accommodating real-time applications. For indoor robotics and robotic vehicles (e.g., electric or self-driving vehicles), a portion of the computations may be performed on the robotic device and as well as on the cloud. Achieving small memory usage and a low processing footprint is important. Some features on the cloud permit for seamless code execution on the endpoint device as well as on the cloud. In such a setup, a portion of the code is seamlessly executed on the robotic device as well as on the cloud.

In embodiments, a CNN uses less training data in comparison to a DNN as layers are partially connected to each other and weights are reused, resulting in fewer parameters. Therefore, the risk of overfitting is reduced and training is faster. Additionally, once a CNN learns a kernel that detects a feature in a particular location, the CNN can detect the feature in any location on an image. This is advantageous to a DNN, wherein a feature can only be detected in a particular location. In a CNN, lower layers identify features in small areas of the image while higher layers combine the lower-level identified features to identify higher-level features.

In some embodiments, the processor uses an autoencoder to train a classifier. In some embodiments, unlabeled data is gathered. In some embodiments, the processor trains a deep autoencoder using data including labelled and unlabeled data. Then, the processor trains the classifier using a portion of that data, after which the processor then trains the classifier using only the labelled data. The processor cannot put each of these data sets in one layer and freeze the reused layers. This generative model regenerates outputs that are reasonably close to training data.

In some embodiments, DNN and CNN are advantageous as there are several different tools that may be used to a necessary degree. In some embodiments, the activation functions of a network determine which tools are used and which aren't based on backpropagation and training of the network. In embodiments, a set of soft constraints may be adjusted to achieve the desired results. DNN tweaking amounts to capturing a good dataset that is diverse, meaningful, and large enough; training the DNN well; and encompassing activities included but not limited to creative use of initialization techniques; activation functions (ELU, ReLU, leaky ReLu, tanh, logistic, softmax, etc.); normalization; regularization; optimizer; learning rate scheduling; augmenting the dataset by artificially and skillfully linearly and angularly transposing objects in an image; adding various light to portions of the image (e.g., exposing the object in the image to a spot light); and adding/reducing contrast, hue, saturation, color and temperature of the object in the image and/or the environment of the object (e.g., exposing the object and/or the environment to different light temperatures such as artificially adjusting an image that was taken in daylight to appear as if it was captured at night, in fluorescent light, at dawn, or in a candle lit room). For example, proper weight initialization may break symmetries or advantageously choose ELU or ReLu where negative values or those close to a value of zero are important, or use leaky ReLu to advantageously increase performance for a more real-time experience, or use sparsification technique by selecting FTRL over Adam optimization.

An example of a neural network comprises a first layer receives input. A second layer extracts extreme low level features by detecting changes in pixel intensity and entropy. A third layer extracts low level features using techniques such as Fourier descriptors, edge detection techniques, corner detection techniques, Faber-Schauder, Franklin, Haar, surf, MSER, fast, Harris, Shi-Tomasi, Harris-Laplacian, Harris-Affine, etc. A fourth layer applies machine learning techniques such as nearest neighbour and other clustering and homography. Further layers in between detect high level features, and a last layer matches labels. For example, the last layer may output a name of a person corresponding with observation of a face, an age of the person, a location of the person, a feeling of the person (e.g., hungry, angry, happy, tired, etc.), etc. In cases where there is a single node in each layer, the problem reduces to traditional cascading machine learning. In cases where there is a single layer with a single node, the problem reduces to traditional atomic machine learning. An example of a neural network is used for speech recognition. Sensor data is provided to the input layer. The second layer extracts extreme low level features, such as lip shapes and letter extraction based on the lip shapes corresponding to different letters. The third layer extracts low level features such as facial expressions. Other layers in between extract high level features and the last layer outputs the recognized speech.

In some embodiments, the processor uses various techniques to solve problems at different stages of training a neural network. A person skilled in the art may choose particular techniques based on the architecture to achieve the best results. For example, to overcome the problem of exploding gradients, the processor may clip the gradients such that they do not exceed a certain threshold. In some embodiments, for some applications, the processor freezes the lower layer weights by excluding variables below to the lower layers from the optimizer and the output of the frozen layers may then be cached. In some embodiments, the processor may use Nesterov Accelerated Gradient to measure the gradient of the cost function a little ahead in the direction of momentum. In some embodiments, the processor may use adaptive learning rate optimization methods such as AdaGrad, RMSProp, Adam, etc. to help converge to optimum faster without much hovering around it.

In some embodiments, data may be stationary (i.e., time dependent). For instance, data that may be stored in a database or data warehouse from previous work sessions of a fleet of robots operating in different parts of the world. In some embodiments, an H-tree may be used, wherein a root node is split into leaf nodes. In one example, H-tree includes a root node split into three leaf nodes. As new instantiations of classes are received, the tree may keep track of the categories and classes.

In some embodiments, time dependent data may include certain attributes. For instance, all data may not be collected before a classification tree is generated; all data may not be available for revisiting spontaneously; previously unseen data may not be classified; all data is real-time data; data assigned to a node may be reassigned to an alternate node; and/or nodes may be merged and/or split.

In some embodiments, the processor uses heuristics or constructive heuristics in searching for an optimum value over a finite set of possibilities. In some embodiments, the processor ascends or descends the gradient to find the optimum value. However, the accuracy of such approaches may be affected by local optima. Therefore, in some embodiments, the processor may use simulated annealing or tabu search to find the optimum value.

In some embodiments, a neural network algorithm of a feed forward system may include a composite of multiple logistic regression. In such embodiments, the feed forward system may be a network in a graph including nodes and links connecting the nodes organized in a hierarchy of layers. In some embodiments, nodes in the same layer may not be connected to one other. In some embodiments, there may be a high number of layers in the network (i.e., deep network) or there may be a low number of layers (i.e., shallow network). In some embodiments, the output layer may be the final logistic regression that receives a set of previous logistic regression outputs as an input and combines them into a result. In some embodiments, every logistic regression may be connected to other logistic regressions with a weight. In some embodiments, every connection between node j in layer k and node m in layer n may have a weight denoted by w\hat{ }{kn}. In some embodiments, the weight may determine the amount of influence the output from a logistic regression has on the next connected logistic regression and ultimately on the final logistic regression in the final output layer.

In some embodiments, the network may be represented by a matrix, such as an m\\times\ n matrix \left[a_{11}\\cdots\a_{1n}\\vdots\\ddots\\vdotsa_{m1}\\cdots\a_{mn}\\right]. In some embodiments, the weights of the network may be represented by a weight matrix. For instance, a weight matrix connecting two layers may be given by \left[w_{11}(=0.1)\w_{12}(=0.2)\w_{13}(=0.3)\w_{21}(=1)\w_{22}(=2)\w_{2 3}(=3) \\right]\. In embodiments, inputs into the network may be represented as a set x=(x_1,x_2,\ldots,\x_n) organized in a row vector or a column vector x=\left (x_1,x_2,\dots,\x_n\right)\hat{ }T. In some embodiments, the vector x may be fed into the network as an input resulting in an output vector y, wherein f_i,\f_h,\f_o may be functions calculated at each layer. In some embodiments, the output vector may be given by y=f_o (f_h\left (f_i\left (x\right) \right)). In some embodiments, the knobs of weights and biases of the network may be tweaked through training using backpropagation. In some embodiments, training data may be fed into the network and the error of the output may be measured while classifying. Based on the error, the weight knobs may be continuously modified to reduce the error until the error is acceptable or below some amount. In some embodiments, backpropagation of errors may be determined using gradient descent, wherein w_{updated}=w_{old}−\eta\nabla E, w is the weight, leta is the learning rate, and E is the cost function.

In some embodiments, the L_2 norm of the vector x−(x_1,x_2, \dots, \ x_n) may be determined using L_2\left (x\right)=\sqrt {\left (x_1+x_2, \dots+\ x_n\right)}=\left|\left|x\right\right|_2. In some embodiments, the L_2 norm of weights may be provided by Veft/left|w\right/\right|_2. In some embodiments, an improved error function E_{improved}=E_{original}+\left/\left|w\right/\right|_2 may be used to determine the error of the network. In some embodiments, the additional term added to the error function may be an L_2 regularization. In some embodiments, L_1 regularization may be used in addition to L_2 regularization. In some embodiments, L_2 regularization may be useful in reducing the square of the weights, while L_1 focuses on absolute values.

In some embodiments, the processor may flatten images (i.e., two-dimensional arrays) into image vectors. In some embodiments, the processor may provide an image vector to a logistic regression. In one example, flattening a two-dimensional image array into an image vector to obtain a stream of pixels. In some embodiments, the elements of the image vector may be provided to the network of nodes that perform logistic regression at each different network layer. For example, the values of elements of vector array provided as inputs A, B, C, D, . . . into the first layer of the network of nodes that perform logistic regression. The first layer of the network may output updated values for A, B, C, D, . . . which may then be fed to the second layer of the network of nodes that perform logistic regression. The same processor continues, until A, B, C, D, . . . are fed into the last layer of the network of nodes that perform the final logistic regression and provide the final result.

In some embodiments, the logistic regression may be performed by activation functions of nodes. In some embodiments, the activation function of a node may be denoted by S and may define the output of the node given a set of inputs. In embodiments, the activation function may be a sigmoid, logistic, or a Rectified Linear Unit (ReLU) function. For example, a ReLU of x is the maximal value of 0 and x, \rholleft (x\right)=max\funcapply (0,\x), wherein 0 is returned if the input is negative, otherwise the raw input is returned. In some embodiments, multiple layers of the network may perform different actions. For example, the network may include a convolutional layer, a max-pooling layer, a flattening layer, and a fully connected layer. An example is a three layer network, wherein each layer may perform different functions. The input may be provided to the first layer, which may perform functions and pass the outputs of the first layer as inputs into the second layer. The second layer may perform different functions and pass the output as inputs into the second and the third (i.e., final) layer. The third layer may perform different functions, pass an output as input into the first layer, and provide the final output.

In some embodiments, the processor may convolve two functions g\left (x\right) and h\left (x\right). In some embodiments, the Fourier spectra of g\left (x\right) and h\left (x\right) may be G\left (\omega\right) and H\left (\omega\right), respectively. In some embodiments, the Fourier transform of the linear convolution g\left (x\right) \ast h(x) may be the pointwise product of the individual Fourier transforms G\left (\omega \right) and H\left (\omega\right), wherein g\left (x\right) \ast h\left (x\right) \rightarrow G\left (\omega \right) \bullet H (\omega) and g\left (x\right) \bullet h\left (x\right) \rightarrow G\left (\omega\right) \ast H (\omega). In some embodiments, sampling a continuous function may affect the frequency spectrum of the resulting discretized signal. In some embodiments, the original continuous signal g\left (x\right) may be multiplied by the comb function III\left (x\right). In some embodiments, the function value g\left (x\right) may only be transferred to the resulting function g\hat{ }-\left (x\right) at integral positions x=x_i\in Z and ignored for all non-integer positions. An example is a continuous complex function g\left (x\right), the comb function III\left (x\right), the result of multiplying the function g\left (x\right) with the comb function III\left (x\right). In some embodiments, the original wave may be found from the result. In some embodiments, the matrix Z may represent a feature of an image, such as illumination of pixels of the image. The illumination of a point on an object, the light passes through the lens, resulting in image. A matrix may be used to represent the illumination of each pixel in the image, wherein each entry corresponds to a pixel in the image. For instance, point corresponds with pixel of image which corresponds with entry of the matrix.

Based on theorems proven by Kolmogorov and some others, any continuous function (or more interestingly posterior probability) may be approximated by a three-layer network if a sufficient number of cells are used in the hidden layer. According to Kolmogorov g\left (x\right)=\sum_{j=1}\hat{ }{2n+1}\mathrm {\Xi}_j and \mathrm {\Phi}_{ij}\left (\sum_{i=1}{d}\mathrm {\Phi}_{ij}(x_i) \right), given \hat{ }mathrm {\Xi}_j and \mathrm {\Phi}_{ij} functions are created properly. Each single hidden cell (j=1\ to\ 2n+1) receives an input comprising a sum of non-linear functions (from i=1 to i=d) and outputs \mathrm {\Xi}, a non-linear function of all its inputs. In some embodiments, the processor provides various training set patterns to a network (i.e., network algorithm) and the network adjusts network knobs (or otherwise parameters) such that when a new and previously unseen input is provided to the network, the output is close to the desired teachings. In some embodiments, the training set comprises patterns with known classes and is used by the processor to train the network in classification. In some embodiments, an untrained network receives a training pattern that is routed through the network and determines an output at a class layer of the network. The output values produced are compared with desired outputs that are known to belong to the particular class. In some embodiments, differences between the outputs from the network and the desired outputs are defined as errors. In some embodiments, the error is a function of weights of network knobs and the network minimizes the function to reduce the error by adjusting the weights. In some embodiments, the network uses backpropagation and assigns weights randomly or based on intelligent reasoning and adjusts the weights in a direction that results in a reduction of the error using methods such as gradient descent. In some embodiments, at the beginning of the training process, weights are adjusted in larger increments and in smaller increments near the end of the training processor. This is known as the learning rate.

In some embodiments, the training set may be provided to the network as a batch or serially with random (i.e., stochastic) selection. The training set may also be provided to the network with a unique and non-repetitive training set (online) and/or over several passes. After training the network, the processor provides a validation set of patterns (e.g., a portion of the training set that is kept aside for the validation set) to the network and determines how well the network performs in classifying the validation set. In some embodiments, first order or second order derivatives of sum squared error criterion function, methods such as Newton's method (using a Taylor series to describe change in the criterion function), conjugate gradient descent, etc. may be used in training the network. In some embodiments, the network may be a feed forward network. In some embodiments, other networks may be used such as convolutional neural network, time delay neural network, recurrent network, etc.

In some embodiments, the cells of the network may comprise a linear threshold unit (LTU) that may produce an off or on state. In some embodiments, the LTU comprises a Heaviside step function, heaviside\\left (z\right)={0\ if\z<0\1\ if\z\geq0\. In some embodiments, the network adjusts the weights between inputs and outputs at each time step, wherein weight of connection at t+1 between input i and output i+1=\ weight\ of\ i-previous! step\ input\ 1\ and output\i\+\\eta\left ({\hat {y}}_{i+1}−y_{i+1}\right) x_i. \eta is the learning rate, x_i is the ith input value, {\hat {y}}_{i+1} is the actual output, and y_{i+1} is the target or expected output.

In some embodiments, for each training set provided to the network, the network outputs a prediction in a forward pass, determines the error in its prediction, reverses (i.e., backpropagates) through each of the layers to determine the cell from which the errors are stemming, and reduces the weight for that respective connection. In some embodiments, the network repeats the forward pass, each time tweaking the weights to ultimately reduce the error with each repetition. In some embodiments, cells of the network may comprise a leaky ReLU function. In some embodiments, the cells of the network may comprise exponential linear unit (LU) randomized leaky ReLU (RReLU) or parametrical leaky ReLU (PRELU). In some embodiments, the network may use hyperbolic tangent functions, logit functions, step functions, softmax functions, sigmoid functions, etc. based on the application for which the network is used for. In some embodiments, the processor may use several initialization tactics to avoid vanishing/exploding/saturation gradient problems. In some embodiments, the processor may use initialization tactics such as that proposed by Xavier and He or Glorot initialization.

In some embodiments, the processor uses a cost function to quantify and formalize the errors of the network outputs. In some embodiments, the processor may use cross entropy between the training set and predictions of the network as the cost function. In embodiments, entropy may be the negative log-likelihood. In embodiments, finding a method of regularization that reduces an amount of variance while maintaining the bias (i.e., minimal increase in bias) may be challenging. In some embodiments, the processor may use L2 regularization, ridge regression, or Tikhonov regularization based on weight decay. In some embodiments, the processor may use feature selection to simplify a problem, wherein a subset of all the information is used to represent all the information. L1 regularization may be used for such purposes. In some embodiments, the processor uses bootstrap aggregation wherein several network models are combined to reduce generalization error. In embodiments, several different networks are trained separately, provided training data separately, and each provide their own outputs. This may help with predictions as different networks have a different level of vulnerability to the inputs.

In some embodiments, the robot moves in a state space. As the robot moves, sensors of the robot measure x (t) at each tine interval t. In some embodiments, the processor averages the sensor readings collected over a number of time steps to smoothen the sensor data. In some embodiments, the processor assigns more weight to most recently collected sensor data. In some embodiments, the processor determines the average using A\left (t\right)=\int x\left (t\hat{ }\prime\right) \omega \left (t-t\hat{ }\prime\right) dt\prime wherein t is the current time, t′ is the time passed since collecting the data, and \omega is a probability density function. In discrete form, A\left (t\right)=\left(x\\last\omega\right) \left (\right)=\sum_{t\hat{ }\prime=0}\hat{ }{t \hat{ }{\prime=t}x\left (t\hat{ }\prime\right) \omega (t−t\hat{ }\prime), wherein each x and \omega may be a vector of two.

In some embodiments, x is a first function and is the input to the network, \omega is a second function called a kernel, and the output of the network is a feature map. In some embodiments, a convolutional network may be used as they allow for sparse interactions. For example, a floor map with a Cartesian coordinate system with large size and resolution may be provided as input to a convolutional network. Using a convolutional network, a subset of the map may be saved in memory requirements (e.g., edges). In addition to allowing sparse interactions, convolutional networks allow parameter sharing and equivalence. In some embodiments, parameter sharing comprises sharing a same parameter for more than one function in a same network model. Parameter sharing facilitates the application of the network model to different lengths of sequences of data in recurrent or recursive networks and generalizes across different forms. Due to sparse interaction of convolutional networks, not every cell is connected to other cells in each layer. For example, in an image, not every single pixel is connected to the layer as input. In embodiments, zero padding may be used to help reduce computational loss and focus on more structural features in one layer and detailed features in another layer.

Quantum interpretation of an ANN. Cells of a neural network may be represented by slits or openings through which data may be passed onto a next layer using a governing protocol. Take for example, a double slit experiment. The governing rule in this example is particle propagation. A particle is released towards a wall with openings positioned in front of an absorber with a sensitive screen. A probability distribution (P1) representing the case when opening is open, a probability distribution (P2) representing the case when opening is open, and the probability distribution (P12=P1+P2) representing when both are open are shown. In a similar example, however, the governing rule is wave propagation. A wave is propagated from a wave source towards a wall with openings and positioned in front of an absorber with a detecting surface. A probability distribution (I1=| h1|2) representing the case when opening is open, a probability distribution 3016 (I2=| h2|2) representing the case when opening is open, and the probability distribution (I12=| h1+h2|2) representing when both are open are shown. In these examples, the activation function of the neural network switches the propagation rule to particle or wave. For instance, if the activation function is on, then the rules of particle propagation apply, and if the activation function is off, then the rules of wave propagation apply. With training and back propagation knobs are adjusted such that when a signal is passing through one aperture it either acts like a particle without interference or acts as a wave and is influenced by other cells. In a way, each cell may be controlled such that the cell acts independently or in a collective setting.

In some embodiments, an integral may not be exactly calculated and a sampling method may be used. For example, Monte Carlo sampling represents the integral from a perspective of expectation under a distribution and then approximates the expectation by a corresponding average. In some embodiments, the processor may represent the estimated integral s=\int p\left (x\right) f\left (x\right) dx=E□p [fx], as an expectation s□n=1ni=1n□f (xi), wherein p is a probability density over the random variable x and n samples from x1 to xn are drawn from p. The distribution of average converges to a normal distribution with a mean s and variance var\frac{\left[f\left (x\right) \right]}{n} based on the central limit theorem. In decomposing the integrand, it is important to determine which portion of the integrand is the probability p (x) and which portion of the integrand is the quantity f (x). In some embodiments, the processor assigns a wave preference where the integrand is large, thereby giving more importance to some samples. In some embodiments, the processor uses an alternative to importance sampling, that is, biased importance sampling. Importance sampling improves the estimate of the gradient of the cost function used in training model parameters in a stochastic gradient descent setup.

In some embodiments, this decision-making process may involve a trade-off between exploration and exploitation. The robot can use the available map data to execute the task at hand, while using any spare time or computational resources to continue refining the map or collecting additional depth data. The robot can thus prioritize higher-level tasks, ensuring efficiency while still maintaining and improving its environmental knowledge. In some embodiments, the neural network version of the system may utilize reinforcement learning (RL) to determine the optimal navigation path for the robot. This method leverages feedback from the environment, where each movement the robot makes is evaluated based on the reward or penalty it receives. The RL model can be trained to improve its decisions over time, optimizing the robot's ability to navigate in various scenarios. The robot's movements, whether it be transitional and angular, contribute differently to the information it gathers. For example, transitional movement (moving forward in a straight line) may provide direct data regarding the robot's progression through space, with the robot accumulating information about obstacles, surface types, and space layout. Angular movement (turning the robot) provides more valuable information about the layout of the surrounding environment, enabling the robot to map and adapt to corners, edges, and room configurations. In some embodiments, a neural network trained through reinforcement learning can distinguish between these types of movements and assign them different levels of significance based on how much they improve the robot's understanding of its environment. For example, a transition in a highly obstructed or unknown area might bring a higher informational gain than a movement in an already mapped region. The network can also assess whether turning will lead to more effective exploration or optimization of the navigation process. This adaptive approach allows the robot to allocate resources more efficiently, focusing on movements that enhance its understanding of the environment. The reinforcement learning model continually refines its decision-making process, improving both the exploration and exploitation aspects of the navigation task. The robot can also use the feedback from the movements to adjust its path planning and real-time decisions, ultimately improving the efficiency of the overall system.

In some embodiments, robots can identify and classify rooms in real-time without having previously seen the environment, making the exploration phase more efficient. For example, a coverage robot may immediately begin its task of covering an area, such as a rigid box, without waiting for a full map to be generated. This approach ensures that the robot can start performing its work while simultaneously mapping the environment, improving both task efficiency and exploration coverage. Further details of methods for performing work while mapping or mapping seamlessly are described in U.S. Pat. Nos. 11/499,832, 11/835,343, 11/656,082, 11/435,192, 11/215,461, and 10/809,071, and U.S. application Ser. Nos. 18/526,723, 19/171,743, 18/132,882, and 11/274,929, the entire contents of which are hereby incorporated by reference. In some embodiments, the robot may first perform a 360-degree turn or cover a rigid box before starting its primary task. Other models may require different numbers of training runs before the robot can divide rooms or perform its tasks effectively. The robot's ability to perform both exploration and coverage seamlessly is key to its efficiency. This is particularly important in tasks like QSLAM, where the robot can adapt to new environments while still completing its primary task, thus balancing exploration and exploitation. In some embodiments, a trash can robot or similar robotic systems may not be required to explore the entire yard or environment in order to perform its task effectively. Instead, the robot can employ logic to balance between learning depth values for individual pixels and performing higher-level tasks, such as map construction or object identification. For example, the robot may prioritize performing its higher-level task (e.g., collecting trash or emptying the bin) while still gathering relevant depth information in the background.

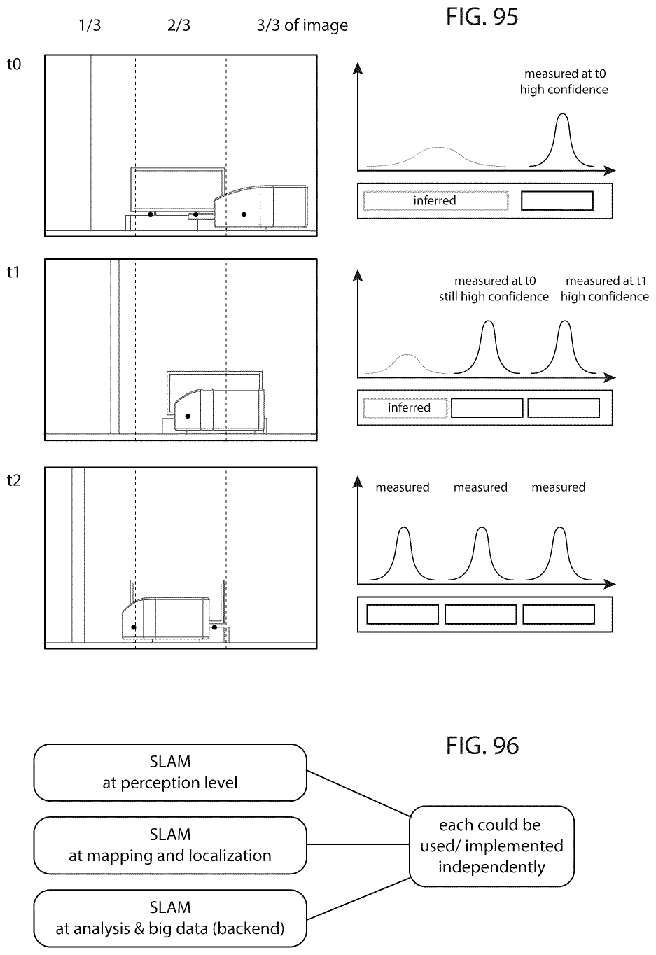

FIG. 94 illustrates an environment with spatial representation of past 9401, present 9402, and possible future 9403 states within an area of the environment with objects, such as a chair, a coffee table, and a television positioned within this scene. The robot captures visual cues for depth perception. In some embodiments, the system may determine that the current depth values and their associated confidences are already sufficient to build an initial map or a part of the map, allowing the robot to proceed with its primary task without needing to wait for complete exploration. In some cases, the robot may employ a dynamic decision-making process, where it switches between refining its map with more depth values (especially for areas where additional confidence is needed) and executing its primary task. If the map already has enough data to perform the task effectively, the robot may focus on completing its mission, such as navigating to the trash can, finding obstacles, or returning to the charging station, instead of continuing to gather more depth values for every pixel. FIG. 95 illustrates the progression of measured data over time as a robot moves through the scene, with data captured at different time steps (t0, t1, t2), wherein corresponding confidence level in the form of probability distributions, with the system's measured data over time demonstrating the continuous update and confirmation of its environment.

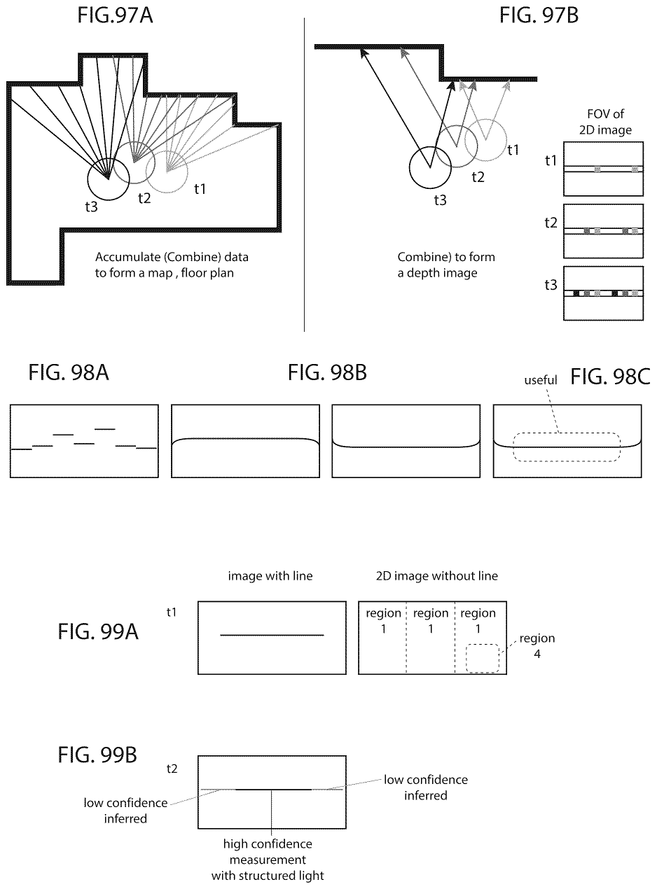

FIG. 96 illustrates how SLAM can be applied at different perception levels being independently implementable. These levels include SLAM at perception level, SLAM at mapping and localization, and SLAM at analysis and big data (backend) level. As the system processes depth data, the system employs iterative accumulation, combining information at different timestamps to build a more accurate representation of the environment. FIG. 97A demonstrates how data can be accumulated and combined to form a map or a floor plan, wherein sensor readings taken at different timestamps (t1, t2, t3) are integrated to generate a complete and refined map of the environment essential for localization. FIG. 97B illustrates the process of combining sensor data to form a 2D image of the FOV taken at different timestamps (t1, t2, t3).

In some embodiments, with the same token, a neural net trained system or a more traditional machine-learned system can be implemented anywhere to enhance the system. For example, instead of a lookup table, a trained system may provide a much more robust interpretation of how structured light is reflected from the environment. The same applies to ToF point readings and their relation to the 2D image and the area of similar colored regions. The use of structured light and fixed geometrical lenses to project a specific shape using a line laser. For example, FIG. 98A demonstrates a line laser projects a FOV line at an angle with a CMOS sensor, producing shiny areas in the captured image. However, calibrating the line laser can be challenging because lenses may have manufacturing and coupling variances, which complicate proper alignment with the imager or CMOS sensor body. As shown in FIG. 98B, when a line is reflected at an angle against a straight wall, the resulting image may appear curved at the edges. This distortion causes readings from the far left to be misleading, which may introduce inaccuracies in the depth data. To solve this, only the middle readings may be used, as shown in FIG. 98C, wherein the distorted side reading is ignored. In such cases where the FOV is too narrow for a point cloud to be useful, the robot can rotate or translate to expand the FOV, thus improving the quality of the depth image and increasing the accuracy of the point cloud for further processing.

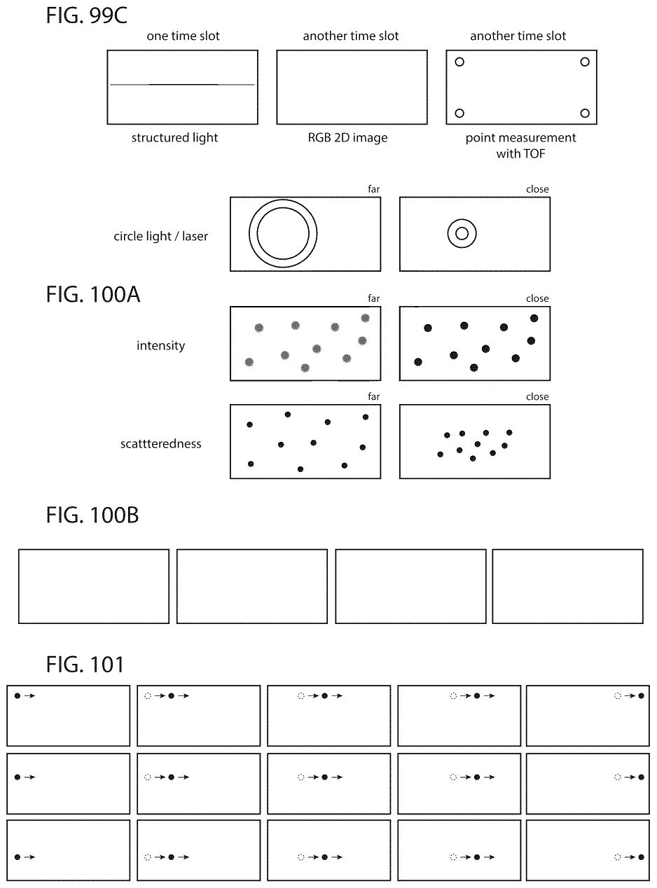

In some embodiments, depth measurements and structured light data can be combined using an image without structured light captured at multiplexed time intervals, as shown in FIG. 99A. In this method, line readings can be extrapolated into other regions based on the pixel intensities and colors (i.e., gray, RGB, or both), as illustrated in FIG. 99B. This concept is similarly applied to point depth measurements. Both depth and image data are then combined as shown on FIG. 99C, to create a more accurate and complete understanding of the environment. To enhance the data, statistics, and probabilistic methods may be used, rather than relying on deterministic look-up tables. Training may be applied to relate these measurements in addition to the lookup tables. In some embodiments, the structured light can be projected dynamically, in a similar manner to how a projector shines an image on a screen or a wall. The light may not have to be in the form of a line or a circle; it can be any shape, such as a pattern, a series of shapes or patterns, or even something as creative as cartoon characters, as shown in FIGS. 100A and 100B. This light projection can be synchronized with the frame rate of the CMOS sensor, allowing it to sweep across the scene and project patterns, such as lines, circles, grids, and a sweep of rows and columns, etc., as seen in FIG. 101.

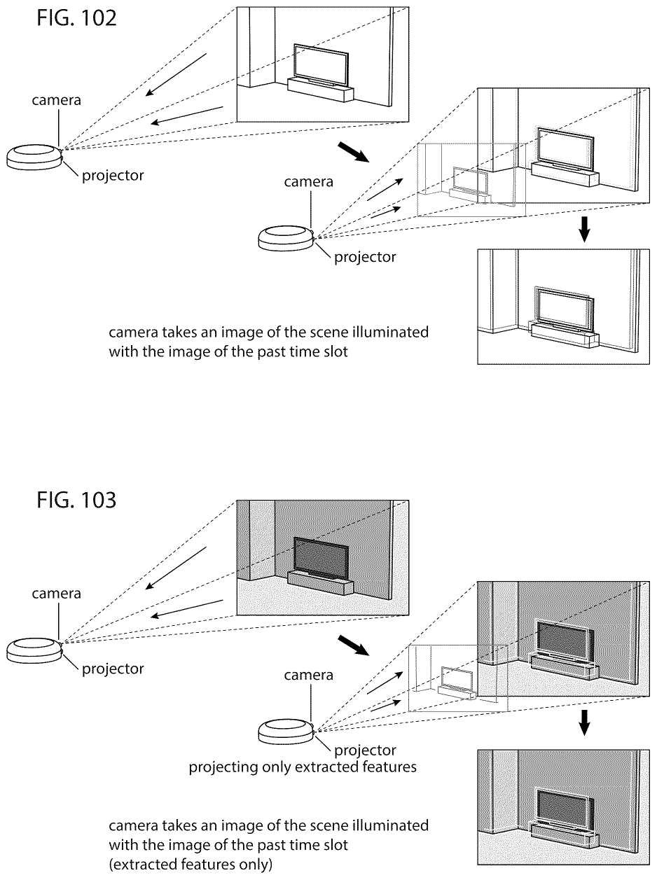

In some embodiments, one useful pattern could involve projecting an image from a moment ago onto the environment. As the robot 10200 moves, projecting with a projector 10201 an image from a split second ago using the camera 10202, or illuminating the environment with an image captured just a moment ago, and comparing the illuminated scene with a new image without illumination, theoretically creates a small discrepant image. This discrepancy may enhance some of its features, as shown in FIG. 102. In some embodiments, it may be possible to project with the projector 10301 the opposite of the image captured by the camera 10302, part of the image, a specific color channel of the image, or, most usefully, may only project the extracted features, as shown in FIG. 103. Features could include the illumination pattern itself, or the features could be kept dark while everything else is illuminated. In some embodiments, a sequence of light illumination could sweep the environment. The system could use a trained neural network (or simpler machine learning models) to interpret an image or its features to understand the environment, and it could also learn to ‘play’ the light pattern to improve its understanding. The system could determine the appropriate sequence, pattern, or resolution to use in specific scenarios or situations to achieve the best results. With a large set of training data points, computation logic is formed that is much more robust than manually crafted lookup tables. Using regressors, the system can select a pattern of measurement that carries a higher probability of being close to the ground truth.

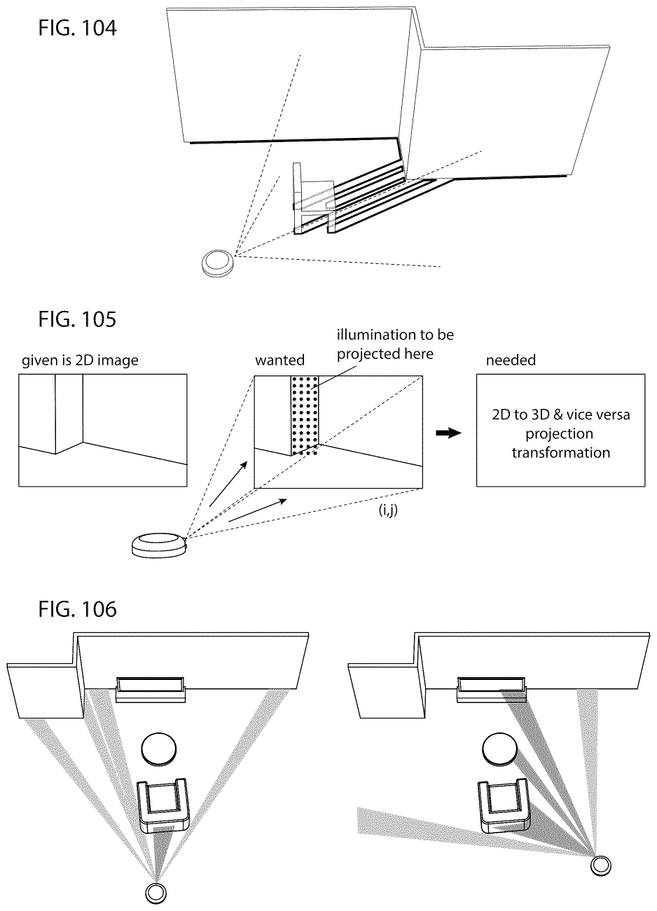

In some embodiments, when observing an environment such as a room with chairs and furniture, the system leverages training data collected from tens of hundreds millions of datasets. In some embodiments, the system is trained to recognize that the perimeter and structural parts of the indoor space typically have low fluctuations in their depth readings, whereas larger fluctuations are possible in internal areas, such as the space occupied by movable objects. For example, if a robot detects an unsmooth perimeter, it can infer that there is likely an obstacle (such as a chair) in the central area, which is occluding the perimeter, as illustrated in FIG. 104. The system uses this inference to help select the most suitable sequence of actions from a set of possibilities, which may include or exclude constraints.

To match real-time observations with training data, the system can employ optimization techniques, such as simulated annealing, to find the most appropriate alignment between the current sensor readings and the previously observed training data. The arrangement of neurons, the type of network used, and the learning methodology will be adjusted according to the needs of the system. For instance, during the factory, development, or research and development phase, the system may predominantly rely on supervised learning methods with labeled examples. During runtime, the system may switch to reinforcement learning, unsupervised methods, or action and classification strategies, depending on the scenario. The runtime may also involve training sessions, which could be user-assisted or not. Training can be used to project light or illumination in a way that enhances depth perception, especially when objects are occluded. In some embodiments, a structural light can be intelligently projected at specific parts of the room to enhance the information about objects such as their tier depth, resolution of the depth, or static or dynamic nature (whether they are obstacles, structural elements, or internal obstacles). The previous captured image of the environment plays a critical role in determining how the light should be projected. A 2D image, when captured, is used to guide the system in projecting light in the 3D world, ensuring that the appropriate pixel in the 2D image corresponds to the desired illumination position, as shown in FIG. 105. Furthermore, the pattern of illumination can vary based on the scene. For example, when the robot or system translates, it must project rays in a manner that adapts to its movement. The system needs to predict the position in space where the light should be projected so that it illuminates the intended region. When the system is stationary, the process is simple; however, when the robot moves, the system must account for the displacement, ensuring that the projected illumination is reflected and appears at the correct location. By utilizing depth and spatial information accumulated from prior timestamps, the system can make more purposeful predictions about where to project light, improving decision-making. For example, if the robot has already visited part of the scene, such as behind a sofa, it can better predict future projections based on its past movement.

FIG. 106 illustrates how the system determines the appropriate illumination needed for depth measurements in relation to the background. The illumination pattern must be targeted to ensure that the depth values of three objects are determined correctly in relation to the background. When the robot rotates in place, the required illumination remains mostly unchanged. However, when the robot translates (or both translates and rotates), the need for illumination changes more significantly. A challenge in depth perception is associating feature maps with geometric coordinates. As demonstrated by examples, such as the Dyson 360, iRobot S9, and QSLAM in an office setting, depth data is critical for creating accurate maps, particularly when object recognition is required. Without depth data, the generated map may be approximate and topological, which can result in poor scalability and less precise object recognition. The robot may create a map of objects and plot a path around them, but the correlation with the surrounding geometric environment may be weak, especially if one or more objects are moving. In some embodiments, the processor of the robot may use at least a portion of the methods and techniques of object detection and recognition described in U.S. patent application Ser. Nos. 15/442,992, 16/832,180, 16/570,242, 16/995,500, 16/995,480, 17/196,732, 15/976,853, 17/109,868, 16/219,647, 15/017,901, and 17/021,175, each of which is hereby incorporated by reference.

In some embodiments, the robot navigates around the environment and the processor generates a map using sensor data collected by sensors of the robot. In some embodiments, the user may view the map using the application and may select or add objects in the map and label them such that particular labelled objects are associated with a particular location in the map. In some embodiments, the user may place a finger on a point of interest, such as the object, or draw an enclosure around a point of interest and may adjust the location, size, and/or shape of the highlighted location. A text box may pop up and the user may provide a label for the highlighted object. Or in another implementation, a label may be selected from a list of possible labels. Other methods for labelling objects in the map may be used.

In some embodiments, the application may present the map of the environment as a 3D perspective view of the environment. In some cases, the application displays the camera view of the robot. In some embodiments, different floor types are displayed in different colors, textures, patterns, etc. For example, the application may display areas of the map with carpet as a carpet-appearing texture and areas of the map with wood flooring with a wood pattern. In some embodiments, the user may drop a virtual barrier in the displayed map. In some embodiments, the robot does not cross the virtual barrier and thereby keeps out of areas as desired by the user.

In some embodiments, the robot captures a video of the environment while navigating around the environment. This may be at a same time as constructing the map of the environment. In embodiments, the camera used to capture the video may be a different or a same camera as the one used for SLAM. In some embodiments, the processor may use object recognition to identify different objects in the stream of images and may label objects and associate locations in the map with the labelled objects. In some embodiments, the processor may label dynamic obstacles, such as humans and pets, in the map. In some embodiments, the dynamic obstacles have a half life that is determined based on a probability of their presence. In some embodiments, the probability of a location being occupied by a dynamic object and/or static object reduces with time. In some embodiments, the probability of the location being occupied by an object does not reduce with time when they are fortified with new sensor data. In such cases, a location in which a moving person was detected and eventually moved away from reduces to zero. In some embodiments, the processor uses reinforcement learning to learn a speed at which to reduce the probability of the location being occupied by the object. For example, after initialization at a seed value, the processor observes whether the robot collides with vanishing objects and may decrease a speed at which the probability of the location being occupied by the object is reduced if the robot collides with vanished objects. With time and repetition, this converges for different settings. Some implementations may use deep/shallow or atomic traditional machine learning or Markov decision process.

When multiple objects move in the environment, the features associated with each object move along its trajectory. Background features remain stationary, and other objects have their own features that evolve along their respective paths. These feature sets are tracked over time using algorithms such as Iterative Closest Point (ICP) or other similar methods. This demonstrates that depth awareness significantly enhances the value and accuracy of the system's perception and understanding of its environment.

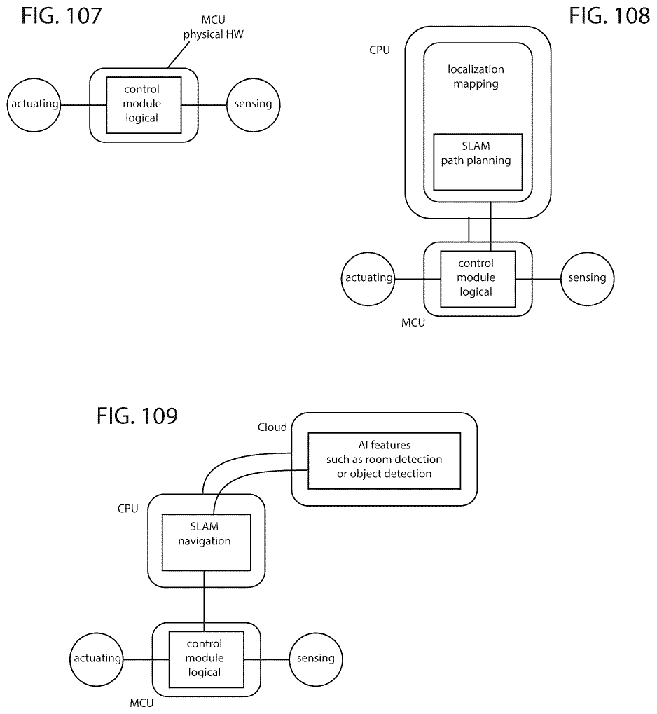

FIGS. 107-112 illustrate diagrams showing control functionalities in a system, according to some embodiments. FIG. 107 illustrates a diagram comparing a control module that interacts with both sensing and actuating components. In some embodiments, the control module includes, but not limited to: reading from sensors, such as obstacle sensors, IR transmitters or receivers, on a device, dock, or remote; reading from odometer or encoder; reading from gyro or Inertial Measurement Unit (IMU); reading from user interface input; select mode of operation; turning on or off various components automatically or per user request; receiving signal from remote or wireless device and send output (i.e., wifi, radio, etc.); self diagnosis systems; programmable input/output (PIO); controlling pulses to motors; controlling voltage; controlling battery and charging; controlling fan motor, sweep motor, etc.; controlling speed; controlling coverage algorithm, which uses Real-Time Operating System (RTOS) or bare metal.

FIG. 108 illustrates a diagram implementing SLAM, path planning, and localization or mapping using various hardware components. With the advancement of SLAM and hardware cost reduction, and path planning, localization and mapping become possible with the use of the Central Processing Unit (CPU), Graphics Processing Unit (GPU), Neural Processing Unit (NPU), etc. However, while hardware capabilities have advanced, the algorithms necessary for real-time performance are not yet mature enough and require significant hardware resources. Despite using powerful CPUs and GPUs, competitor products still experience performance struggles. In state-of-the-art products, a CPU is often tasked with offloading computational work for SLAM, path planning, and other processes. The problem lies in the fact that manu decisions are not made in real-time and are instead sent to the CPI to be processed. These CPUs are typically on Cortex A ARM, which runs with a Linux (desktop) OS and does not have time constraints and perhaps queues the tasks and treats them like a desktop application.

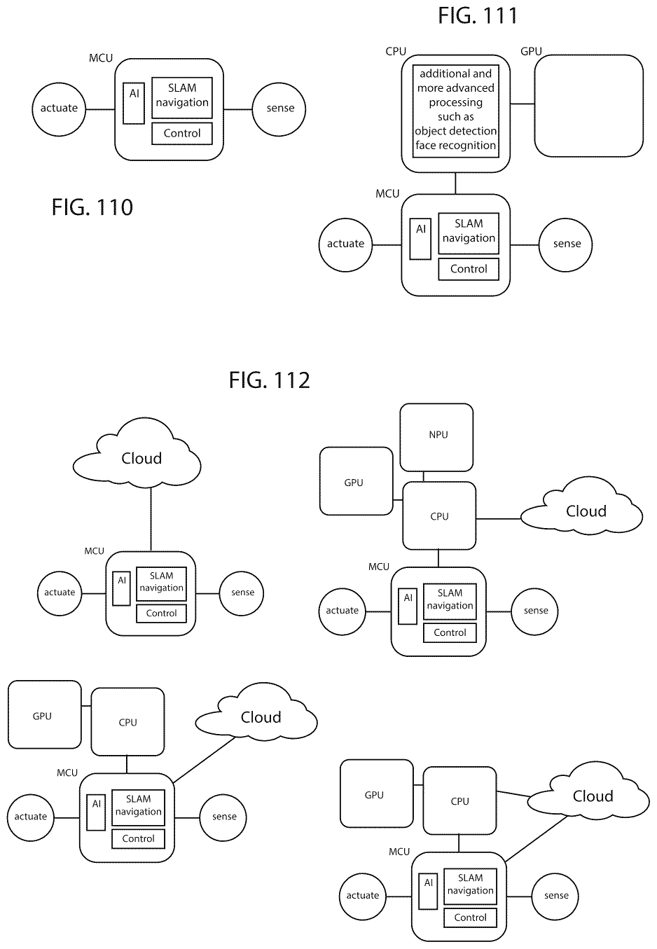

FIG. 109 illustrates a diagram where the CPI handles key computational tasks such as SLAM navigation and cloud-based AI features like room detection and objection. Nowadays, more AI features are capable of autonomously splitting environments into rooms. Further details of methods for dividing an environment into rooms or subareas are described in U.S. patent application Ser. Nos. 14/673,633, 15/676,888, 14/817,952, 15/619,449, and 16/198,393, the entire contents of which are hereby incorporated by reference. With these features piling up to consume more and more CPU power, competitors have resorted to implementing these processes on the cloud, which further increases the delay and moves away from real timeness of operations. Competitor products all present room suggestions at least after one complete run. In some examples, even if the rooms are shown they are not the basis of cleaning (free dynamics LO). In some embodiments, Quantum Simultaneous Localization and Mapping (QSLAM) is designed to be lightweight and real-time, offering a significant advantage over traditional systems. FIG. 110 illustrates a diagram incorporating a MCU that integrates AI and SLAM navigation and control functionalities. In this embodiment, it shows that QSLAM is so lightweight that not only does it handle control and SLAM in one MCU, but it also implements many AI features traditionally considered computationally intensive within the same MCU. Moreover, these tasks are executed in real-time, making QSLAM highly efficient. This design does not prohibit QSLAM from utilizing a CPU in its architecture. In some embodiments, a CPU/GPU can be used to further enhance AI and image processing capabilities, as shown in FIG. 111. Additionally, QSLAM is not limited to only local processing and can leverage cloud processing for certain tasks, as depicted in FIG. 112.

In some embodiments, It can be generally seen that there may be multiple layers of processing that can take place. Some literature categorize the tasks that take place on a mobile robot into a logical front-end and back-end, obviously this categorization is flexible and can span more than just two layers. For example, it can include a middle category or even split the front-end or back-end into multiple logical slices. In general, front-end tasks require more real-time processing, while back-end tasks can be offloaded to higher layers of processing.

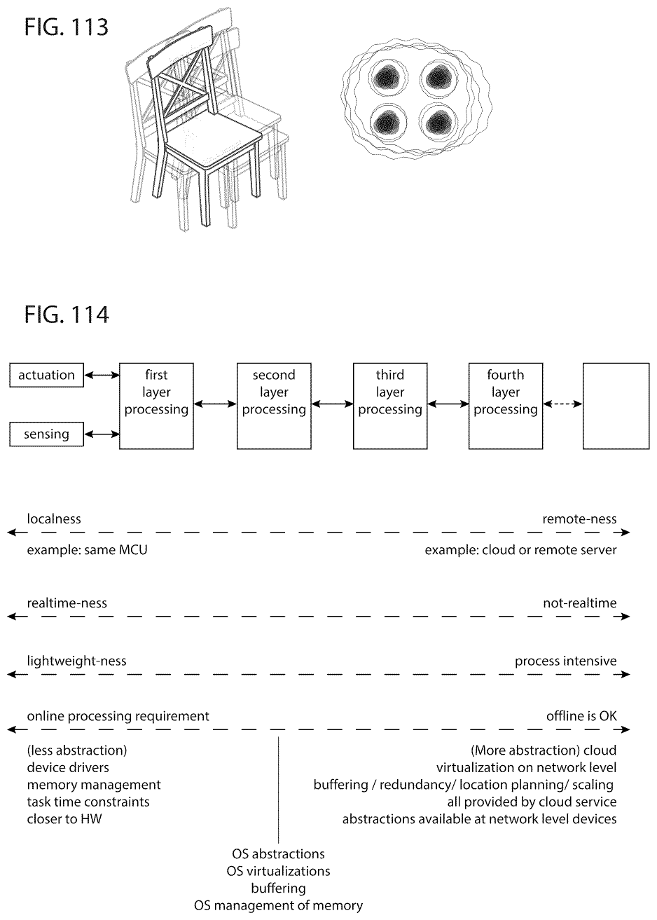

In some embodiments, tasks such as extracting logic from historical runs may be perfectly suitable for processing in the cloud. For instance, tracking the displacement of a dining chair over time, where the chair remains in the same area but moves slightly, may be a task better suited for cloud processing. The robot may track the chair's dynamic range and adjust its behavior based on the accumulated data. It may even reach an equilibrium through iterative reinforcement, adjusting its path based on experience as depicted in FIG. 113. FIG. 114 demonstrates how such data could be processed in the cloud or on the robot when it's resting or charging. All of this can be done safely on the cloud or even on the robot when the robot is resting or charging. In some embodiments, mapping may be pushed to the back-end after an initial map is built, with the task of subsequent runs becoming one of localization within the previously created map. A low-frequency task may run to ensure the map remains consistent and unchanged. For example, some systems create the map using a method different from the one used for localization. In some embodiments, a smartphone with one or more cameras may be used to map the environment orthographically, and the resulting map can then be made available to the robot, which will only need to localize itself. This method may require less expensive sensors or less accuracy. The robot may also use the separately created map to perform one or more simulated runs before an actual run. In the runtime, the map will be available a priori, and the robot will utilize previously perceived metadata, created from surrounding points of interest, such as a TV, fridge, rooms, rugs, and furniture in the house.

In some embodiments, not only can the devices used for creating the map and localization be different, but the methods can also vary. For example, a smartphone may create the map from one or more cameras, processing images to generate the map, while the robot could use a ToF (Time-of-Flight) sensor to localize itself within that map. This process could be reversed as well. The smartphone could also benefit from a hybrid system, as many smartphones now include LIDAR sensors in their cameras. This method is also suitable for autonomous vehicles or larger robots.

For example, we previously provided an example where, to prepare a supermarket for commercial cleaning robots, a discovery robot (or people-driven/equipment-operated devices) equipped with expensive LIDARs and high-resolution cameras maps the environment, including aisles, entrances, exits, cashier points, etc. Once a dense map is created using a combination of automatic and manual methods, the task of the autonomous robot becomes simplified to localization within the previously identified features and distances. The robot can then recognize what to expect at specific points and only needs to verify whether the observed feature matches the expected feature at that location.

In some embodiments, the logical distinction between back-end and front-end tasks does not require that a map be saved from prior runs using different (or more expensive) devices, or manually or semi-autonomously. Instead, it serves as a logical breakdown for better understanding. Even when mapping and localization occur in real-time, without any prior map of the workplace, motion tracking and localization can be considered front-end tasks when compared to map building. This classification is independent of the map's dimensions (2D, 3D, or more) or the map's type (feature map, depth map, geometric map, topological map, resolution map, dynamic obstacle map, structural map, object map, etc.), as well as how the map is created (e.g., depth readings combined, manually crafted feature descriptors from images, images streamed and trained using neural networks, object maps, or depth extracted from images combined with reflections of structured light). This also applies regardless of how motion is tracked (e.g., odometry, IMU, Gyro, optical flow, structure from motion, depth change measurement, etc.).

In all of these situations and embodiments explained, the more tasks that can be performed in the same real-time MCU where perception, actuation, and control occur, the better the system's performance will be. The map and localization data can be used to generate a planning graph, which may contain one or more sequences of candidate motions to perform a task. The best sequence can then be selected as the path, which could be determined based on various constraints. For example, the constraints could include speed, cost, lowest battery consumption, maximizing coverage within time constraints, or how a human would perform the task based on pre-trained examples of a human performing the task in the real world or on a computer interface.

It is important to note that a task is not limited to just a mobile robot moving from point A to point B or performing a coverage task. For example, a path plan could similarly define the movement of a robot arm extending to inject a dose of medicine to a user, extending a food tray to the user, or offering a cup of water. The planned path will consist of a series of movements, planned sequentially, based on the range of motion and degrees of freedom of the joints. Therefore, the application of real-time SLAM extends beyond mobile robots to other devices like navigation devices, real-time headsets, or even tasks like finding and lifting a cellphone and bringing it to the user. It is not necessary for all processing to be done concurrently or at the same speed. For example, odometry and IMU data may be processed at a higher speed. The robot may attempt to solve (estimate) the constraints that connect its pose based on the data gathered from IMU and odometry at a higher frequency. The frequency of processing could be predetermined or based on need. For example, when enough movement is registered from odometry or IMU, it may trigger the need for processing. Another on-demand example could be the use of keyframes or visual data showing a sufficient amount of movement.

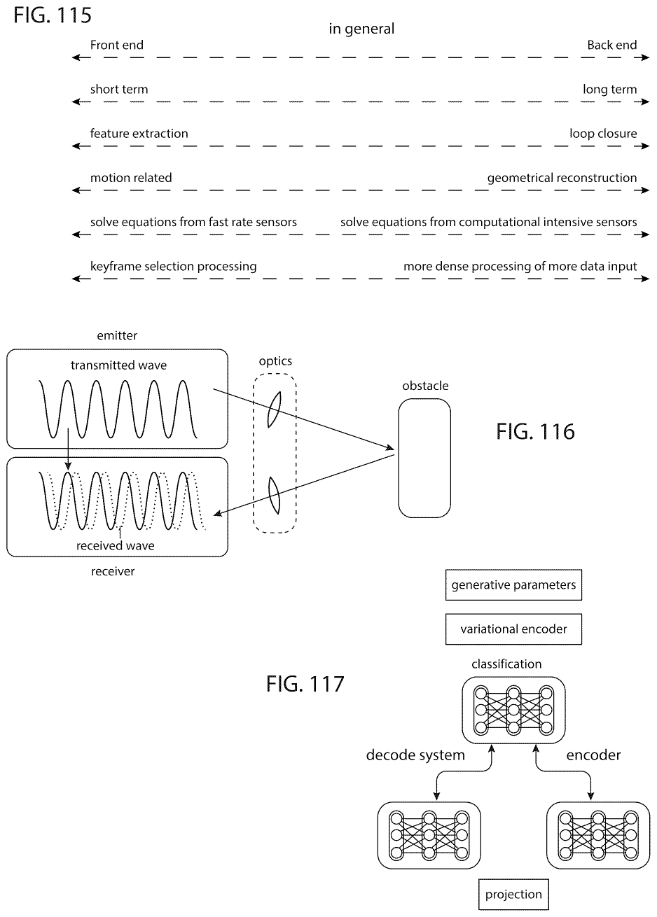

It is also possible to solve constraints from one or two sets of data (odometry and IMU) during runtime and then integrate the missing information after runtime (during rest periods) to increase the density of the map with more data points. Additionally, it is possible to clean up data, the map, or the path planning during rest time (after runtime). It is therefore possible to increase map density during runtime as the robot gathers more information, or even in subsequent runs. What we propose here, which is not seen in prior systems, is to gather information during runtime and use it after runtime during rest or charging periods. Sometimes, approximating the constraints during runtime takes into account a short history of the immediately collected data to reduce the number of equations that need to be approximated. In general, the closer the processing is to the actuation and sensing, the more real-time the system becomes. FIG. 115 illustrates this concept further.

FIG. 116 illustrates a method of estimating the current pose of a robot in an environment consisting of structural perimeters and obstacles, while building a representation of the environment during task execution. The method uses the estimated current pose and the built representation to make decisions on the next actuation to be executed, ensuring that the robot moves in a way that increases the percentage of task completion, while simultaneously monitoring the movement to detect and correct any drift iteratively.

In some embodiments, the robot is expected to move smoothly and in a straight line during the task. All processing, including pose estimation and decision-making, takes place within a single processing unit. This processing unit is a real-time processing unit capable of performing the necessary computations to ensure timely actuation decisions. In some implementations, the task being performed by the robot is cleaning and coverage. The control tasks include managing the robot's fan and wheels, adjusting their speeds by providing varying voltage levels to the components. The same MCU that handles actuation also performs non-linear estimations, such as pose and drift corrections. The pose estimation and task execution are based on depth readings or stored sequentially observed feature descriptors extracted from a stream of images taken during operation. The system detects and minimizes discrepancies between expected and actual movements, addressing challenges like the rate at which data is received and processed when one is faster than the other. In some embodiments, bundle adjustment is used to optimize the robot's trajectory by minimizing discrepancies in the observations. The system is designed to operate with a computing power requirement that is less than X MIPS, ensuring that the processing requirements are within the capabilities of a low-power processing unit.

Gradient descent based class of algorithms may be used to iteratively find local minimum of a least square cost function that is non-linear. However we are looking for a better convergence that those classes can offer. Newton based classes of algorithms benefit from their super linear convergence. This includes Newton's method itself as well as Gauss-Newton or Leven berg-Marquardt. A localization problem may be a robot localization against a frame of reference or an object in relation to the robot, or an object versus the frame of reference of the environment.

Association of set of landmarks m1,m2,m3, . . . ,mi, . . . ,mN where each m (landmark) is observed at a coordinate point x,y,z and at a bearing of 8 in a plane world or more angles in 3D, relative to the robot's local frame of reference (robot is assumed as the center of coordinate). Now when the robot moves m′ is now observed to be at a translated and rotated distance from m:

$${m}^{′} = Rotation Matrix \times m + translation matrix$$

Now the robot moves from a first pose to a second pose, we can calculate the second pose from having the original landmark. The observation at the original point (such as a 2D image scan) and the observation at a second point (such as a second 2D image capture) and the formula that relates m to m′ and minimizing the function. The problem lies in the fact the rotation representation leads to singularity. Motion and structure can be extracted from consecutive image captures which follow the same association formula:

$${m}_{x} = {m}_{( x - 1 )} R + t$$

where R is the rotation matrix and t is the translation matrix. Projection of the landmark on to camera plane is shown by:

$$Projection of m = \frac{m}{{e}_{3}^{T} m}$$

where a set of corresponding image points is known and it is desired to find the displacement of the robot and the world coordinate of the image points applying epipolar constraints.

In some embodiments, Lie Algebra can be used, and the properties of symmetry are exploited. In such cases, operating on a manifold coordinate shows a robot walking on a manifold. For simplicity, we first consider the first-order steepest descent method. Unlike walking in Rn space, taking a step in the steepest decreasing direction would take the robot outside the manifold. Therefore, we define a tangent vector, and the step size is determined by the length of the tangent vector. The direction of the tangent vector would be in the direction of the steepest increase, and the length would be imagined as the inner product of the tangent vector. When the condition of smoothness is met, the manifold is commonly referred to as a Riemannian manifold. A transform function may connect a source coordinate system on a manifold to a destination coordinate system on a corresponding atlas. The transform function may operate according to another coordinate system, which could be stationary, moving at a constant velocity, or accelerating/decelerating. The coordinate system may hold physical items, virtual items, or both. If a robot taking a continuous series of images loses its localization, it may be able to relocalize by comparing the last images taken with the current scene observation. However, this method is not guaranteed to work, especially if the robot is in a non-observed area. Nonetheless, if the state space is limited and the robot revisits locations it has previously seen, this method may be effective. It is noteworthy that comparatory search may occur in one or both of the coordinates. For example, if an image time stamp or serial stamp is to be localized, and thus the device is localized, a previously built track map may be backtracked image by image or in fixed step sizes (e.g., every 10 images), or with a dynamic step size (e.g., trying step size 5 and increasing it) based on the correlation found in the image data. A dynamic step size helps determine how many images can be skipped safely. The algorithm's goal will be to minimize the number of images searched by following clues that help skip less interesting images and follow a trend of increasingly interesting points and data. This means optimal step sizes can help find images more efficiently.

Similarly, it is possible to project 3D images onto 2D planes and compare 2D images, benefiting from computational savings. When similarities are found, the 3D image, now reduced to a smaller set, can be used for further analysis. In some embodiments, going back and forth between the 3D and 2D domains may be modeled using a manifold and an associated atlas.

In some embodiments, the images in a track map may be pre-classified based on similarities or similarity distances. This could be done using a classical database structure that associates images with one or more descriptors. The database may include a column showing a value, with similar images having the same value. For example, any image with a hash value of 1266 means that the descriptors associated with that image are similar and created a hash value of 1266. This value serves as a label for groups of similar images based on their descriptors.

In some embodiments, classical machine learning techniques or trained neural networks could be used to extract a similarity index or distance between descriptors. A hash value may be configured to represent an exact match of the same object in an image, the same object from a different angle, the same object type (class) with a different instance (e.g., different color), or the same object at a different distance, depending on the configuration. When exact matches are assigned the same hash value, the database will contain a large number of groups (sets), with each group having fewer members (elements). When the criteria for assigning the same hash value is relaxed, the number of groups will reduce, but each group will contain more members. The pros and cons of each configuration impact the search process, and an optimal configuration for a specific application can be designed to utilize search methods such as depth-first, breadth-first, or a combination of both in a desired order to achieve the best results. When a match is made on an atlas, a chart will take the result back to the manifold frame, where 3D search could occur or further processing could take place.

In some embodiments, a recommender algorithm may predict a set of images to be considered for search. The process can be repeated in successive image frames in the sequence until image frames containing feature points, which are deemed worthy of further processing, are found. In some embodiments, the worthiness of a feature point is evaluated based on whether it represents a structural construct of the environment, such as walls, doors, or pillars for indoor settings, or billboards, roads, stop lights, etc., for outdoor settings, that do not change within small timeframes.

When a SLAM device, such as a robot, self-driving car, or XR wearable device, encounters a 2D image containing features that represent the structural components of the real world, it will load a chart to transfer from the atlas domain to the manifold and process the closest point from the previously recorded 3D image set or HD multi-dimensional map that serves as the reference for the search. Depending on the resolution of the HD map, 3D image set, and the resolution of the runtime image capturing, there may be slight discrepancies that need to be resolved. The map residing on the manifold may group nearby observations and select a representative point. In this case, only the representative points are transferred from the manifold to the atlas and vice versa. This method is conceptually similar to decomposition methods using histogram filters or discrete Bayes filters, with the difference being that it occurs within a manifold state space that consists of finitely many regions, where the state space is continuous. If we call X our random variable describing the state of a robot on a manifold, we could show that domain of X can be composed as follows:

$$dom ( X ) = {x}_{i} ⋃ {x}_{2} ⋃ {x}_{3} … ⋃ {x}_{n}$$

where n is the number of sub-states which have a bijection onto the Atls domain. For faster search, a runtime image will first be matched to a representative of a group. The image can then be iteratively compared with each member of the group, or sub-representatives of subgroups, if that level of resolution is required, and if the SLAM device has the processing resources available. Once this comparison is complete, a bijection that associates the manifold with the Atlas makes the final association. Each runtime device may operate at different levels of resolution. For example, a lower-priced XR wearable system may only match against a subgroup representative, providing a satisfactory experience. However, a more expensive wearable XR system may continue searching for a closer match, providing a more realistic experience, considering that the more expensive device has greater computational resources. This method enables universal compatibility between devices of various price points, makes, models, and brands, allowing them to share a common domain of examples. More importantly, this enables the sharing of conclusions, classifications, and patterns that emerge from these examples. Traditionally, sets of images captured at different resolutions with varying camera physics and geometries are not compatible with one another.

A major benefit here is the use of these data points for a recommender system, which traditionally suffers from sparse data, data that cannot be conclusively associated with each other, and data that cannot generalize well under current methods. Recommender systems on robots are often localization-sensitive from the spatial perspective and temporally sensitive in the time domain. In some embodiments, sequential pattern mining may be formulated on a manifold, with states forming a Markovian chain. When a bijection carries a state from the space domain on the manifold, it lands on a point on the corresponding Atlas. If a time dimension is added to the manifold, its corresponding space landing may remain the same, with time being treated as a third element, or it may affect the landing point.

In localization-aware recommender systems, time may be observed explicitly as an independent variable. Alternatively, a recency-based system may reduce the importance weight with a decay factor. In either case, time can be treated as the number of runs or episodes or as a periodic, seasonal, or socially important event or factor.

In some embodiments, a Fisher Information Matrix (FIM) may be used as a metric to extract an estimation of hidden parameters in relation to observed information that are treated as random variables. When the FIM is positive, it depicts a Riemannian metric on the N-dimensional parameter space. According to Wilks' theorem, with large samples, the likelihood ratio for observed data can be approximated with desired statistical significance because −2 log (likelihood ratio) asymptotically approaches the Chi-squared distribution. In some embodiments, the Fisher-Rao metric, which is derived from geodesic distance, is used to measure the difference between respective probability distributions: one from the observed data and one from the hidden data. Considering the context of this discussion involves the use of exteroceptive image sensing, we must account for situations where surrounding lighting is beyond the operating range of a sensor. For example, excessive environmental illumination may cause the surrounding area to project an amount of light that exceeds the upper limit of the sensor's working range. On the other hand, in a cloudy environment, the light observed might fall within the desirable and optimal operating range for the sensor. In dark conditions, such as nighttime or unlit indoors, the observed light may fall below the lower marginal operating range of the sensor. While the dynamic range of a sensor is a specification provided by the manufacturer, detailing the ratio between the upper and lower limits of measurable values, the spread of this range is almost always non-linear. This non-linearity must be taken into account when calibrating and processing the sensor data. When a light photon hits a pixel, the corresponding capacitor begins to discharge, releasing electrons from a state of being fully charged, and these electrons flow into the transistor base. This action closes a collector-emitter loop, amplifying the signal. As a result, cross-contamination of pixels, often referred to as “blooming,” is particularly pronounced in cameras on mobile robots. Active illumination in bright environments causes other issues, such as the saturation of pixels, where the sensor may be unable to capture accurate information due to the excess light.

As previously discussed, a trained neural network may be employed to resolve sensor readings to higher accuracy, overcoming issues such as the signal-to-noise ratio, systematic errors introduced by modeling constraints (e.g., simplified correlation functions), phase ambiguities caused by limitations in unambiguous range (0, 2π) for continuous wave signals, differences in the reflectivity of objects, non-linearity in the semiconductor release of electrons, multiple returns and bounced signals, motion blur, foreground/background depth and reflectivity variations, and boundary inconsistencies. In some embodiments, continuous wave intensity modulation is used to measure the difference between an emitted modulated active illumination and its reflection, which is shifted by an offset phase. This measurement technique can be implemented in software or directly on a chip. In some embodiments, a cosinusoidal correlation function associates the emitted and incident waves to each other, which is essential for deriving the necessary sensor data. The output of such a sensor typically consists of an amplitude that helps determine the reliability of the reading, along with a distance measurement, which is used in subsequent processing for localization and object detection. FIG. 116 illustrates this process, showing the relationship between the emitted and reflected light and the resulting signal data.

Foreground and background reflectivity, as well as depth boundaries, can be separated or classified using a support vector machine (SVM), where the data points are considered as p-dimensional vectors. The goal of the SVM is to separate these points using a hyperplane of dimension (P−1). For example, in a 3D spatial environment, the foreground and background can be separated by a 2D plane, with the largest margin between the two classes determined by such a hyperplane. In some embodiments, this technique can be used instead of, or in combination with, a trained model, depending on whether the separation is focused on depth boundaries, reflectivity boundaries, or other factors. An ensemble method may be employed to take advantage of the strengths of each approach in different environmental conditions. For example, parameters may vary depending on whether the sensing is done indoors or outdoors. In many cases, the data is not linearly separable. In these instances, a hinge function may be applied to allow for better classification, ensuring that the SVM can handle more complex separation tasks in non-linear scenarios. A hinge function may be written as:

$$Max ( 0 , 1 - {y}_{i} ( w \cdot {x}_{i} - b )$$

where the function returns zero if x lies on the correct side and returns a value proportional to the distance from the margin where data falls on the wrong side. The use of support vector machines (SVM) or other classifiers enhances the sophistication of pre-filtering processes, such as disregarding outliers or out-of-range readings, and provides better stability for what is known as “flying pixels.” Flying pixels refer to pixels at depth boundaries that may show a reading of the foreground at one timestamp, the background at the next, and sometimes something entirely different. Flying pixels can apply to both 2D image pixels as well as 3D depth pulse-based clouds.

In some embodiments, pulse modulations with known characteristics, such as duration, are generated, and the reflections are captured with a high shutter speed. Multiple shutters may be used with different speeds to capture the shape of the reflection, which helps improve depth interpretation. For example, a reflection from a nearby object will arrive faster than a reflection from a farther object, allowing for more accurate depth analysis. In some embodiments, electronic circuitry may be incorporated into illumination circuits or the camera output system to perform filtering. This filtering manipulates the relative magnitude of various frequency components of a signal or performs rectification, which involves pruning undesired parts of the signal based on criteria such as polarity. Signal readings may then pass through a Fourier transform and be represented in a phase space for further analysis.

Electronic signals emitted by semiconductor-based image sensors often suffer from amplitude distortion, frequency distortion, and phase distortion. Furthermore, ambient light can introduce noise into the reflected illuminator signal, which reduces the signal-to-noise ratio (SNR). This must be accounted for in order to enhance the quality of depth data and ensure more accurate sensor readings.

Amplitude distortion is often non-linear and can be parametrized as an expected single frequency signal [elt)] is often received as:

$${e}_{0} ( t ) = {a}_{1} {e}_{1} ( t ) + {a}_{2} {e}_{i}^{2} ( t ) + {a}_{3} {e}_{i}^{3} ( t ) + …$$

where a1, a2, a3, . . . may be defined as a coefficient of a non-linear transform function.

In addition to amplitude distortion, frequency distortion may occur due to external factors or even as a result of circuit elements that interfere with the signal. While phase distortion is desired and is what enables depth perception, it is also subject to external and internal distortions that are not caused by depth-related factors. It must be noted that motion blur has two distinct instances in mobile robotics. One instance occurs when a standalone sensor, such as a depth camera, captures a scene where an object is moving. In this scenario, derivatives of pixel values in a frame are compared with the next temporal changes, indicating that some pixels have witnessed a moving object during the brief time interval between two frame captures. Various methods can be used to mitigate the effects of motion blur in the affected regions of the image. Another instance of motion blur occurs when the robot itself is in motion. In this case, the robot's sensors move along with it, constantly capturing changes in pixel values. To correct for this, optical flow techniques must be applied to neutralize changes caused by the robot's own movement, ensuring that depth changes caused by moving objects in the scene can be isolated, detected, and corrected.

In some embodiments, the input into the trained network, as well as runtime observations, consists of at least three measurements obtained with at least three different phase shifts. These measurements are, in some cases, acquired simultaneously. The three measurements are then used to estimate the distance, amplitude, and offset of the observed objects. In some embodiments, a loss, error, or cost function is used to evaluate the outcome based on the neural network's model and training through backpropagation. The error is propagated backward through the network. In some embodiments, the sum of squared errors is used to evaluate the error. Hyperparameters may be set with predefined values before the commencement of the learning process. A low learning rate is often desired, where the training model progresses slowly, and updates to the weights are minimally adjusted to prevent divergence due to large updates beyond the threshold.

In some embodiments, batch learning methods may be employed, where the entire data set is fed into the network in batches. One iteration over the entire data set constitutes an epoch. In some embodiments, the data set is fed into the system hierarchically or in a coarse-to-fine organized model. Additionally, in some embodiments, the network may be dynamically scaled based on the task's complexity or computational resources. In some embodiments, a multi-layer perceptron (MLP) is used to infer the opacity and radiance of each point. In some implementations, geometric features, reflectance properties, material characteristics, and lighting conditions are extracted from objects and used to analyze new images. In some cases, a surface is extracted from an image as a mesh, decoupling the objects using decomposition methods.

A trained network may be used instead of, or in combination with, classical Gaussian convolution. Gaussian convolution can utilize techniques such as decreasing the filter kernel size as the spatial distance increases. Sliding window methods can process parts of an image serially or in parallel (using multiple windows), where the windows may overlap or may not. Gaussian methods operate on the assumption that noise is distributed homogeneously; however, we have already discussed that this may not be the case in many scenarios. Gaussian filtering may be applied to monocular or binocular arrangements, with variations such as adaptive weighted filtering, adaptive illumination with feedback circuits, median filtering, and RGB fused boundary determination.

In some embodiments, a ray from objects hitting image points is considered as sample points along the ray, with uncertainty modeled and minimized using a loss function. During training, a foreground or background mask may be used for each epoch. In some embodiments, the learning rate is decayed in the final epochs or in stages. In the final stages, the learning rate curve may be reduced more sharply. It is also noteworthy that depth maps generated from Time-of-Flight (TOF) or common depth cameras (or LIDARs) are radial depth maps. To elaborate, we can visualize that a flat wall in the world frame has a curved equivalent in the camera's frame of reference. In prior art, this is treated by rounding each pixel's depth, assuming it is parallel to the viewing vector. In contrast, our approach models the world with manifolds and utilizes Riemannian optimization directly on manifolds, presenting the final processed data at the desired resolution. In prior systems, iterative optimization algorithms operate on Euclidean vector spaces, with incremental changes determined by first and second derivatives that iteratively minimize a cost function. Our proposed model, however, carries the non-linear structure of the search space inherently, which allows the amount of information to be preserved without rounding before modeling. While approximations still occur in our approach, they happen in a deferred manner, meaning they take place after the integration of data. This modeling approach is closer to reality and gives the implementation the flexibility to decide how much approximation is desired. Operating in Euclidean space, the non-linearity of state transitions and measurements is often handled through linearization at the mean of the Gaussian. However, the degree of local linearity (or non-linearity) of the transition function being linearized at the local peak of the Gaussian is a critical factor in the success of non-linear Kalman filters. Additionally, the original level of certainty in the Gaussian, affected by the transition function, is another crucial factor.

Our approach defers the requirement of local-linearity for the state transition function at the mean of the estimate from the perception stage to the output creation stage. As a result, while a state transition function may not initially appear at the mean of the estimate during limited observation (i.e., relatively raw iteration), it may have a higher chance of achieving local linearity once additional processing is applied to the dataset. For example, after forming and solving a graph-pose matrix, the processed output increases the likelihood of meeting the assumption criteria. In general, approximations occurring in the later stages of the processing pipeline help preserve the details for a longer duration. It is well-established that the positioning of filters has an impact on the final outcome. For instance, in “Denoising of Continuous-Wave Time-of-Flight Depth Images using Confidence Measures” presented in Optical Engineering by Frank et al. Frank et al. (Frank, M, Plaque, M., Hamprecht, F.A. Denoising of Continuous-Wave Time-Of-Flight Depth Images Using Confidence Measures. ‘Optical Engineering’ Vol. 48, No. 7 (July 2009), pp. 1-13) examined various stages of the pipeline and concluded that filtering in the final stage yields the best results. While the filtering methods used in their study—adaptive weighted Gaussian and median filtering are considered basic in comparison to modern advancements, their findings highlight that the positioning of filters plays a crucial role in the final outcome.

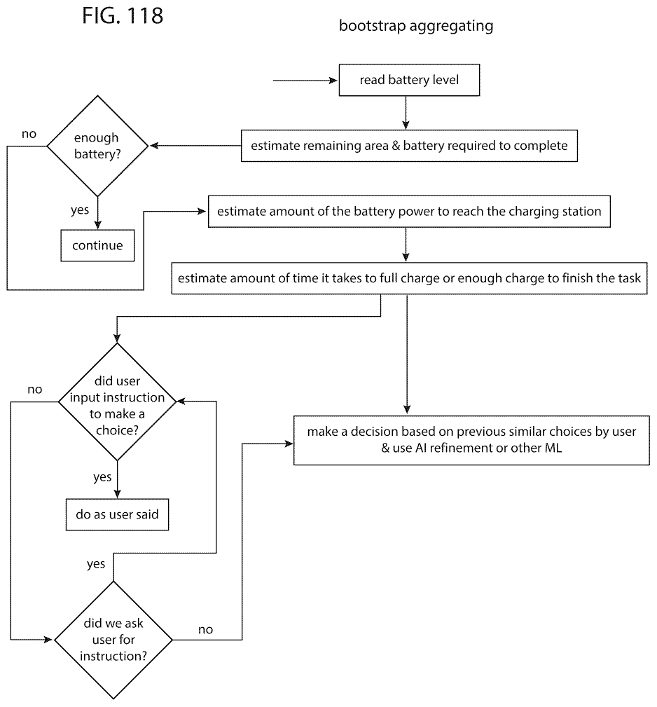

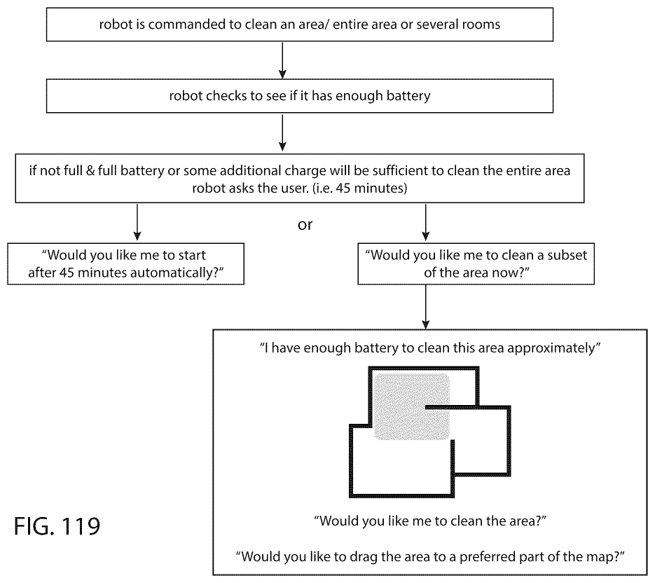

FIG. 117 illustrates a variational encoder that is trained to create a minimization system for posterior approximations when compared to actual real-life posterior measurements. To combat overfitting, some embodiments may prefer a simpler model that reduces variance, the number of variables, and parameters. Further, some embodiments may utilize K-fold cross-validation and regularize parameters that cause overfitting using methods such as LASSO. When a small dataset is used, high bias and low variance may produce better results, while for large datasets, low bias and high variance may be preferred. In some embodiments, a confusion matrix or F1 score may be utilized to evaluate the performance of the trained network. FIGS. 118 and 119 illustrate methods to combat overfitting. In some embodiments, object localization and classification are interleaved with lower-level feature extraction. In some cases, loose or rigid bundle adjustment may occur at fixed or dynamic intervals. Dynamic intervals may be determined by factors such as the quality of signals, degradation of observability, accumulation of noise, or availability of computational resources. A “state” manager may track the system's “state” and make rule-based or machine learning-based decisions to limit or keep the attenuation of state quality under a threshold. The state manager may filter out redundant keyframes or keyframes that do not carry sufficient information, based on entropy metrics.

Keyframes may be evaluated for sufficient difference while ensuring they are not outliers, ensuring optimal processing cost. The similarity between keyframes and their subsequent counterparts, measured by similarity distance, may be used to decide whether to include or exclude a keyframe from bundle adjustment. The decision-making process may weigh 3D map points or 2D images for inclusion or exclusion from bundle adjustment. To identify outliers, methods such as the Huber function or similar techniques may be employed. Intervals of rigid bundle adjustment may include sub-intervals of loose bundle adjustment, where only a subset of keyframes are bundled. The rigid and loose bundle adjustments may use the same or different optimization algorithms, which could include first or second-order optimization techniques such as Newton's method, Trust Region method, Levenberg-Marquardt, or Campbell-Baker-Hausdorff. These methods may be combined or selectively used based on the task's requirements.

A descriptor may be extracted for feature points in an image, providing additional data that increases the associability of feature points across consecutive images, though at the cost of higher computational expense. For optimal alignment of a stream of images, a proper number of feature points and descriptors must be extracted that are computationally lightweight yet provide reasonable results. In some embodiments, the number of features selected for further processing may be fixed. Alternatively, the number of features may be dynamically selected based on factors such as the magnitude of the gradient or other selection methods. Similarly, descriptors may be extracted for either a fixed or dynamic number of features. An algorithm may decide to dynamically extract descriptors for some features while leaving others without descriptors.

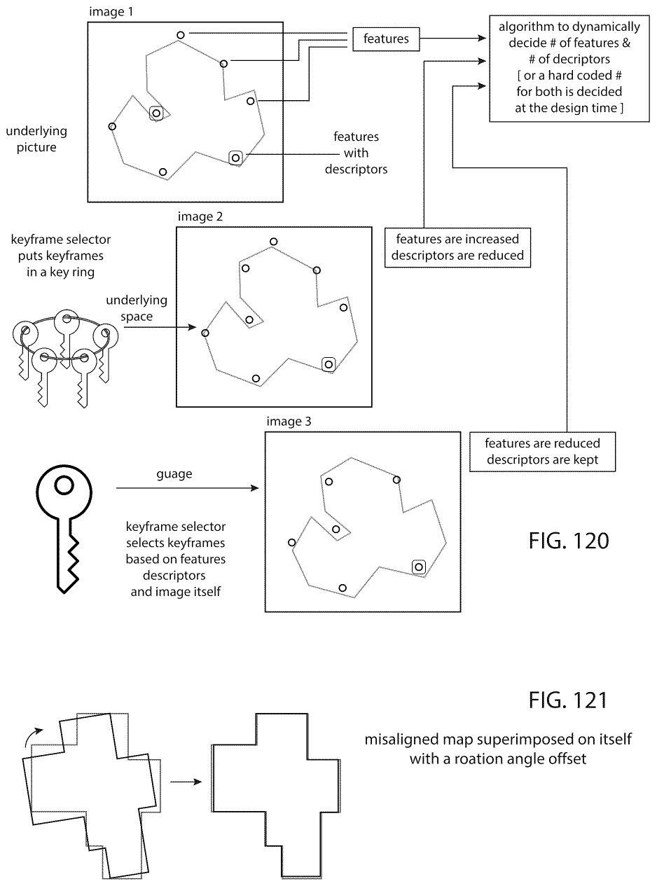

In some embodiments, a descriptor may be extracted for a group of features, as illustrated in FIG. 120. Convolutional neural networks (CNNs) are a type of multi-layer perceptron (MLP) that inherently include regularization. These networks consist of a series of convolution layers followed by ReLU activation functions, pooling layers, and fully connected layers, ultimately resolving inputs such as images into classified outputs (e.g., identifying whether an image contains a giraffe or another animal). A filter or kernel is applied to a subset of pixels of the input image, determined by the kernel size (e.g., 5×5×3), and slides through all pixels of the image. A filter may detect features such as lines and curves. The output of each layer serves as the input for the next layer. The system is initialized by assigning weights to random values or values close to zero. This method represents a significant advancement over traditional machine learning methods, such as the support vector machine (SVM), where a data point is viewed as a P-dimensional vector (a list of “P” numbers), and the goal is to separate these points with a hyperplane of dimension (P−1). While SVM is a classical machine learning method, it can still be used in combination with deep learning, and enhancements can be made, such as choosing the hyperplane to represent the largest separation or margin between classes. The hyperplane is selected to maximize its distance to the nearest data points on each side. Linear kernels, polynomial kernels, radial basis kernels, or sigmoid kernels may be advantageously selected for use in SVM. In some embodiments, data is extracted directly from CMOS sensors. In some cases, a trained network complements the data by applying photon counting techniques to reduce Poisson noise. Photon detection is probabilistic due to current state-of-the-art technology. The trained network may also serve as an a priori model to improve accuracy. In some embodiments, generative adversarial networks (GANs) are utilized to improve performance. In some cases, networks may infer the pose, shape, or texture of objects. Trained networks may also be complemented with various filtering methods, dynamic and selective illumination, sample segmentation, interpolation, Bayesian smoothing, and other techniques.

In some embodiments, decomposition methods may be topological or a hybrid of topological and geometrical approaches. In some embodiments, transient geometry of a passerby object may be extracted. A hybrid of neural networks and traditional machine learning methods may also be employed. In some embodiments, a support vector machine with linear, polynomial, radial basis, or sigmoid kernels is used. In some embodiments, ensemble methods may be incorporated into the hybrid system. In some embodiments, AdaBoost is selected for datasets with low noise. In cases where noise is higher, random forests may be used. Additionally, in some embodiments, the incoming and outgoing light directions may be analyzed using a Bidirectional Reflectance Distribution Function (BRDF). BRDF may be used to quantify, measure, model, or define how light is reflected off surfaces. In some embodiments, BRDF may be modeled using analytical methods such as Lambertian reflectance, in combination with Monte Carlo methods, while accounting for anisotropic reflection and Fresnel effects.

A hierarchical model selection process may be applied in some embodiments. Spherical harmonics form a complete set of orthogonal functions, and each function that operates on the surface of a sphere can be expressed as a sum of spherical harmonics. These functions add to the dimension of periodic functions defined on circles, which, when summed up, form a Fourier series. This increase in dimensionality in the model may require compensation to maintain efficiency. The first epoch of training begins with a forward pass, where the initial kernels of the first layer are initialized with a seed value or a random value. As a result, the output of the first epoch is a uniform distribution of probabilities assigned to each class. Training provides a set of images with labels and a loss function, such as mean squared error:

$${E}_{total} = \sum \frac{1}{2} {( target - output )}^{2}$$

The loss is minimized through optimization by adjusting the weights of the model. Then, through backpropagation, the weights most significantly correlated with the loss are adjusted to reduce the loss. The result of this process is the updated weights of the kernels. Pooling may be employed to reduce the spatial dimensions of the network by sliding a filter over the input. In some embodiments, a trained network may be used in conjunction with polynomial radial and tangential distortion functions to mitigate lens-aperture effects on sensor readings, improving the accuracy of measurements.

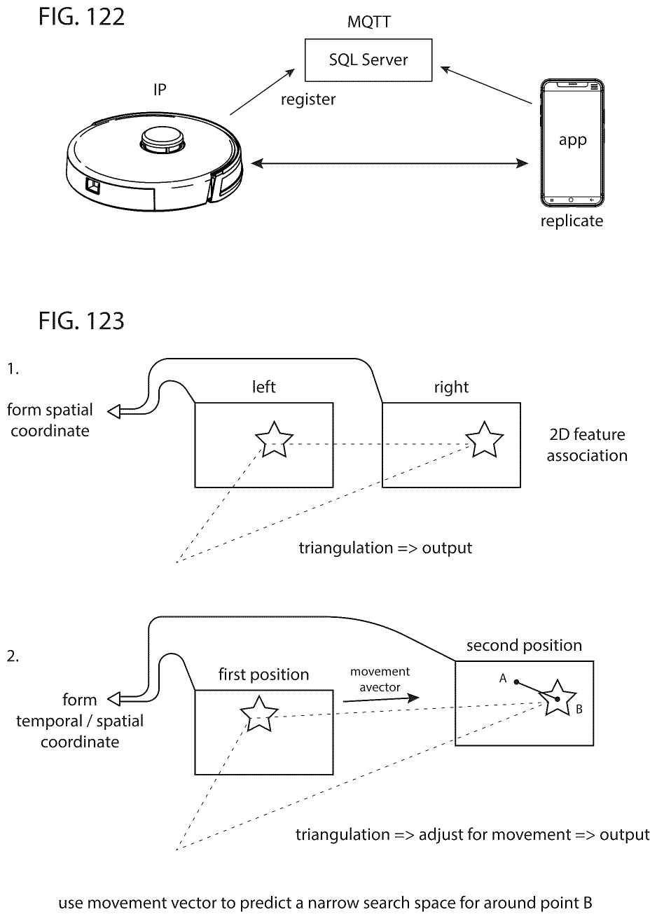

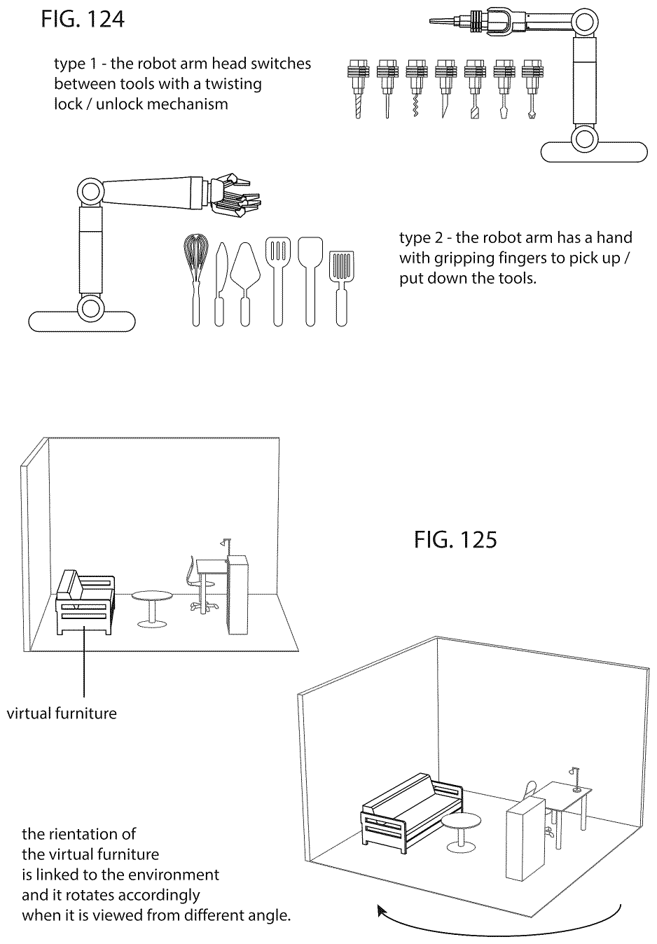

In some embodiments, the battery system must include a mechanism to measure heat. Temperature sensing may be deployed close to the motors. When the motor faces resistance, the current flowing through it increases, which generates heat. In these embodiments, current detection can be used to infer the desired action. Additionally, in some embodiments, heat may be sensed directly. The temperature sensor will provide feedback to the controller, which can take actions such as turning off a brush motor for a few seconds to avoid overheating. Temperature sensors may use the thermocouple effect, where two metal sheets (or other geometric shapes) made from different materials are configured to have different electron reactions to heat. The resulting electromotive force or nonlinear evolution of voltage across the two materials is used to measure heat. A lookup table is created based on the metal used for calibration. For example, PTC (positive temperature coefficient) thermistors may be used on the battery, where resistance increases as the temperature rises. In another embodiment, NTC (negative temperature coefficient) thermistors are used, where resistance decreases as the temperature increases. In some embodiments, current sensors that operate based on the Hall effect are used. These sensors can measure both AC and DC currents and may be implemented in either an open-loop or closed-loop configuration. The Hall effect can also be used for other sensing applications, such as position sensing, magnetometers, rotational velocity sensing, etc. PIR (Passive Infrared) motion detection allows for detecting infrared radiation from humans or other living beings, enabling enhanced environmental awareness and safety. A residual network may be employed, utilizing connections that allow direct feature access from the previous layer to optimize propagation. In some embodiments, a multiple-path architecture may allow for concurrent propagation, enabling the system to process more data in parallel, which can lead to improved performance. In some embodiments, bootstrap aggregating (bagging) processes subsets of data in parallel, and final predictions are made through a voting processor combined with a pruning mechanism to reduce complexity and enhance prediction accuracy. FIGS. 121-123 illustrate extraction of a descriptor for a group of features and methods for alignment of maps, according to some embodiments. FIG. 124 illustrates various configurations of robot arms, according to some embodiments. FIGS. 125 and 126 illustrate position and space awareness, according to some embodiments.

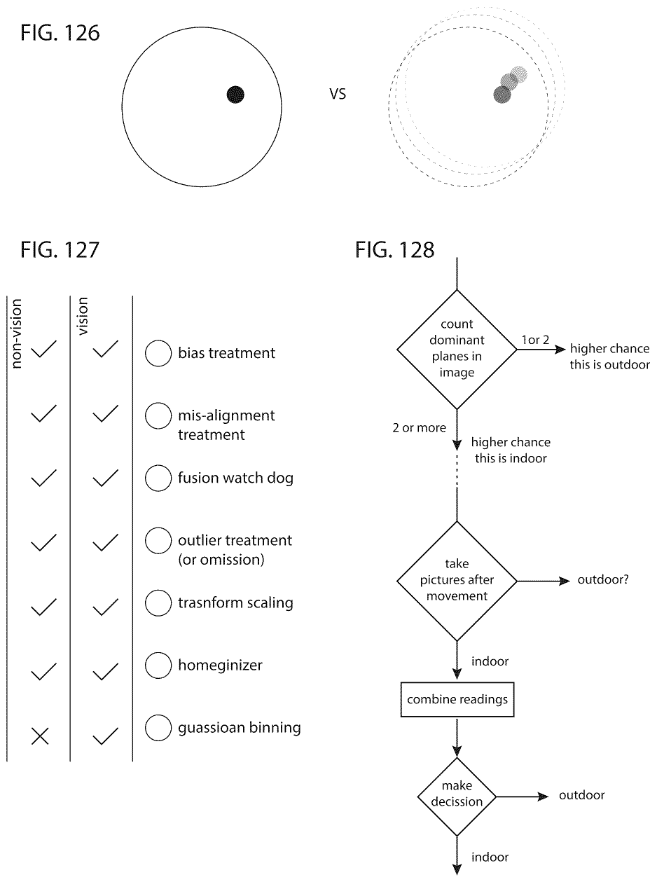

Assuming scale error is corrected via calibration and remains corrected, a non-bias error in acceleration has a linear effect on velocity but a quadratic effect in position space. For phase space, it is likely less than quadratic but more than linear. However, the exact effect in phase space is uncertain. If we assume that for every error in one measurement, there will be a corresponding error balancing the prior errors, we can say the effect is less than quadratic, as illustrated in FIG. 127. Each error component may be tracked with a dedicated cost function or error-measuring function, passing through a dedicated motion model, with corrections applied based on observations. The robot may choose destinations to correct a particular error type. For example, the robot may direct itself to “coast” and perform coastal navigation to correct one or more of the error-measuring functions. In a Wi-Fi-bump-coastal localization, when the error is sufficiently high and the robot does not localize, it may seek its docking station and the respective signals. Temporal collision marks may swarm on a grid map, with the radius of the collision marks increasing over time.

In some embodiments, memory is configured such that new data overwrites previous images to ensure that nothing is stored for privacy reasons. In other embodiments, memory is actively erased by scrambling its content for privacy reasons, as shown in FIG. 128. Signal localization for strength or attenuation may be used to score devices and determine which one should perform a task based on its capabilities list, which may include humanoid robot capabilities such as gripping, climbing stairs, using wheels, vacuuming, or mopping. For example, a humanoid robot can grab a vacuum stick and vacuum, while a robotic sweeper can sweep. Generating virtual reality from camera streams involves having the robot approach a specific location and assume a specific pose for its camera to capture an additional stream of video. This can be used to increase accuracy, field of view, resolution, or dimensions of a virtual rendering.

In some embodiments, variational encoders or generative models may be used in a neural network setup, either deep or shallow, where the system consists of an encoder and decoder with the goal of learning a posterior distribution. Training data consists of previous posteriors of already labeled data, with observations serving as a preconstruct on top of which new observations populate. This approach is advantageous over the prediction step in prior art, where real-time measured motion was used. In prior art, manual constraints were set up to avoid improbable predictions. These manual constraints are rigid and do not generalize well. A variational autoencoder encodes motion characteristics with environmental consideration, allowing the corresponding decoder to synthesize noisy or missing motion data based on environmental factors at runtime. A Fourier transform may be used to carry the equation of motion forward in time.

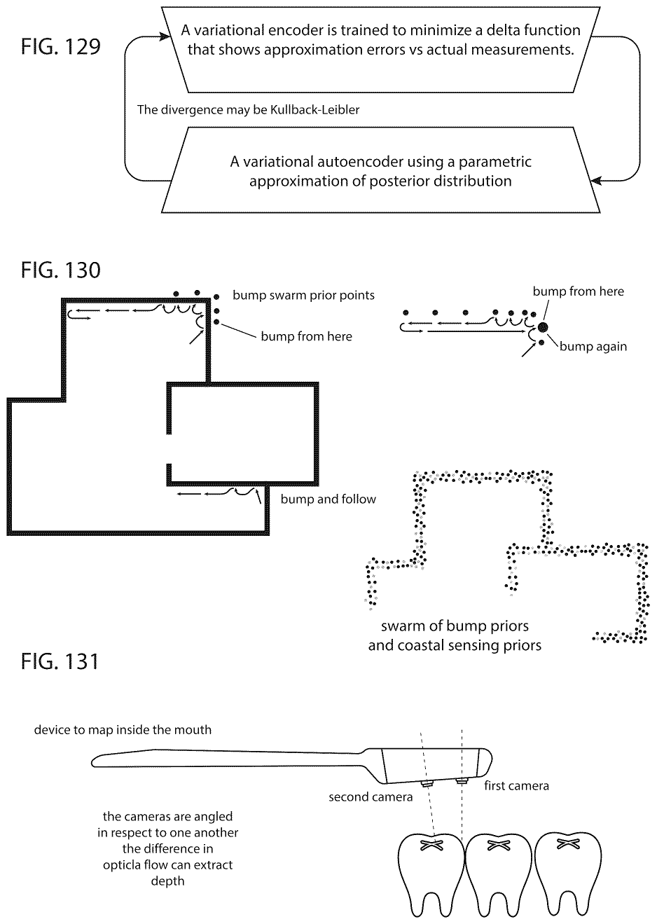

In some prior art, observations made via a camera or LiDAR are incorporated into the motion equation to set constraints on the robot's new position, limiting the search space. In the observation step, the robot's pose is narrowed down to a single best hypothesis. In some embodiments of prior art, numerous instances of localization and mapping are tracked using a Rao-Blackwellized particle filtering method. In other prior art, Rao-Blackwellized particles are weighted at each iteration using observations, which helps eliminate unlikely scenarios, as depicted in FIG. 129.

A linear vector space may be viewed as a linear manifold with Euclidean geometric structure of [n×p] real matrices. In order to optimize a differentiable function ƒ that lives on a manifold, an initial value x (t) is selected as a seed and moves in the direction of steepest descent (or −grad ƒ (x)) until a critical point is reached where (grad ƒ(x)=0). However, when moving on a manifold, the direction of motion is guided by a tangent vector while ensuring that the movement does not leave the surface of the manifold. This is resolved using retraction mapping. A retraction R (x) at (x) preserves the gradient at x by mapping from the tangent space TxM→M. As such, a cost function defined on M around x∈M is mapped to a cost function on the vector space TxM→M (the tangent space).

Bump priors, obstacle-follow priors, and bump and coastal sensing priors form a series of swarm points that can be used in future runs to determine the topology of the workspace, as illustrated in FIG. 130. An image sensor may capture a stream of images in real time and analyze them without storing the images permanently. Instead, the images may be temporarily stored and continuously overwritten in memory for analysis. The conflict between the shortest path and collision prevention is addressed by ensuring mandatory collision clearance. Object localization can be described as identifying an object, determining its position relative to the environment, calculating distances within the frame of reference of the environment or the robot, and classifying the object by type, class, and name. Human activity over multiple runs may be localized within the map, allowing patterns of space usage to emerge.

In some embodiments, the method of refilling the robot's container involves the docking station using a hose connected to the city water supply to automatically refill the container with clean water. In some embodiments, the method of draining the container involves the docking station using a drain hose connected to the sewer system to dispose of the dirty water automatically. The installation method may involve using a hose clamp to secure the hose to a pipe, ensuring a tight and stable connection. In some embodiments, the method of docking involves the robot using a pattern signature to align itself with the dock. This pattern signature may be observed by LiDAR, as shown in FIG. 131.

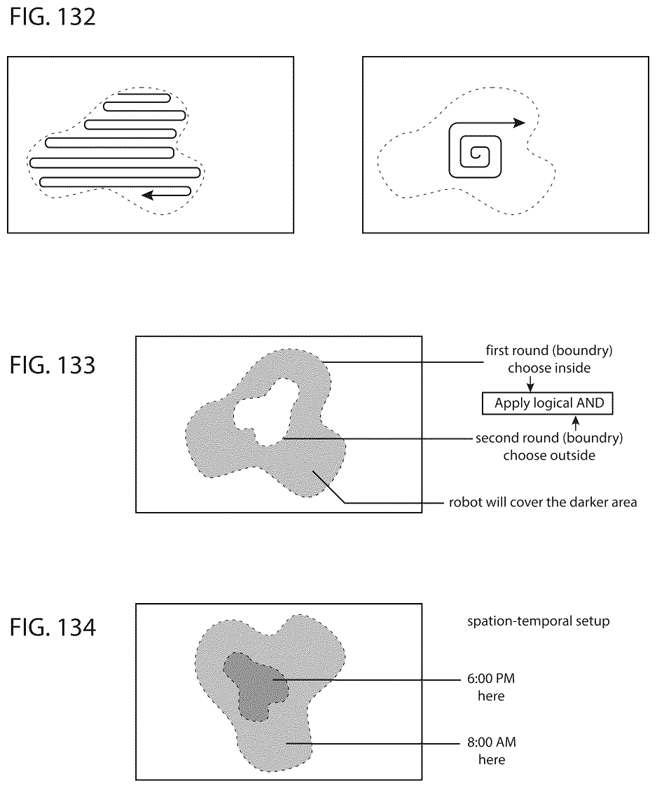

FIGS. 132-140 illustrate workspace boundary training and local mapping, according to some embodiments. In some embodiments, the boundary will be extracted from a line fitting or curve fitting algorithm run through the bounce point swarm. The boundary may be extracted from segments of a certain length, which are then merged together after alignment, as explained in FIG. 130. Split and merge methods or RANSAC may be applied incrementally to gradually enhance the map. When the above extraction indicates a boundary, the robot may perform a coastal navigation routine to follow along the boundary to increase the accuracy of its understanding of shape, length, and topology of the boundary. For example, a coastal navigation routine may be triggered and followed after the first bounce.

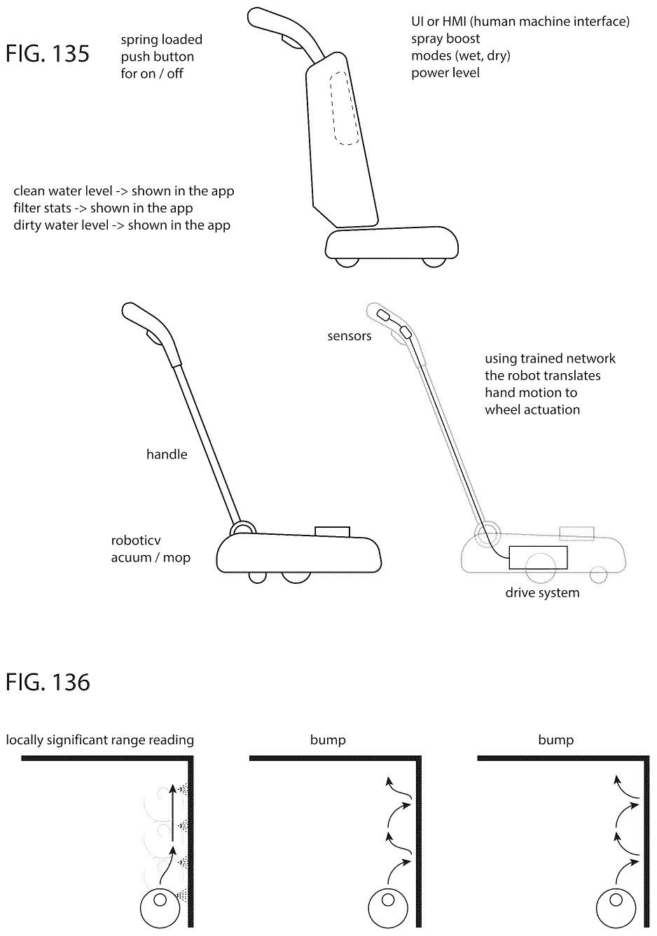

In collaborative SLAM, the coordinate from which the next robot must pick up the work may be communicated to the robot. This coordinate may be where the first robot completed a task or ran out of resources, such as battery, cleaning fluid, or its dustbin becoming full. Map merging of multiple devices must go through a resolution process to address inconsistencies. We propose that 11 dimensions are needed, which correlate to 11 physical dimensions. Collaborative intelligence sharing, whether the robots are running concurrently or at different times, may create conflicts. In some embodiments, workspace boundary training may be performed. As the robot is manually pushed or dragged along the perimeter of a workspace, the snail trail of the robot marks the path that the robot takes within the map. The same training system may be used for training the robot to follow a specific path from point A to B. A training boundary or path may be localized within the robot's current map or a different map made by another robot or by the same robot previously. A boundary training may instruct the robot to cover areas inside or outside the boundary. The robot may be instructed to perform boustrophedon, spiral, or other patterns inside or outside the boundary, as shown in FIG. 132. The robot may be instructed to accept several rounds of boundary training and apply mathematical logic for inclusion or exclusion of interiors and exteriors, as depicted in FIG. 133. The actions may be spatio-temporal, meaning they will belong to both space and time, as illustrated in FIG. 134. Pixel intensity values infer a corner when two large eigenvalues are derived from them, and infer an edge when one large and one small eigenvalue are derived from them. If all eigenvalues are small, they infer no information of interest. The user may provide a cleaning schedule for a group of rooms or areas within rooms and a different schedule for other rooms or areas. The first group of rooms and areas may overlap with the second, and the robot may be instructed to perform different tasks or apply different actuators in each of the schedules. For example, in a self-cleaning robot, the handle can have a grip portion and a button to turn the vacuum on or off, as shown in FIG. 135. Examples of scheduling methods that may be used are described in U.S. patent application Ser. Nos. 16/051,328 and 15/449,660, the entire contents of which are hereby incorporated by reference.

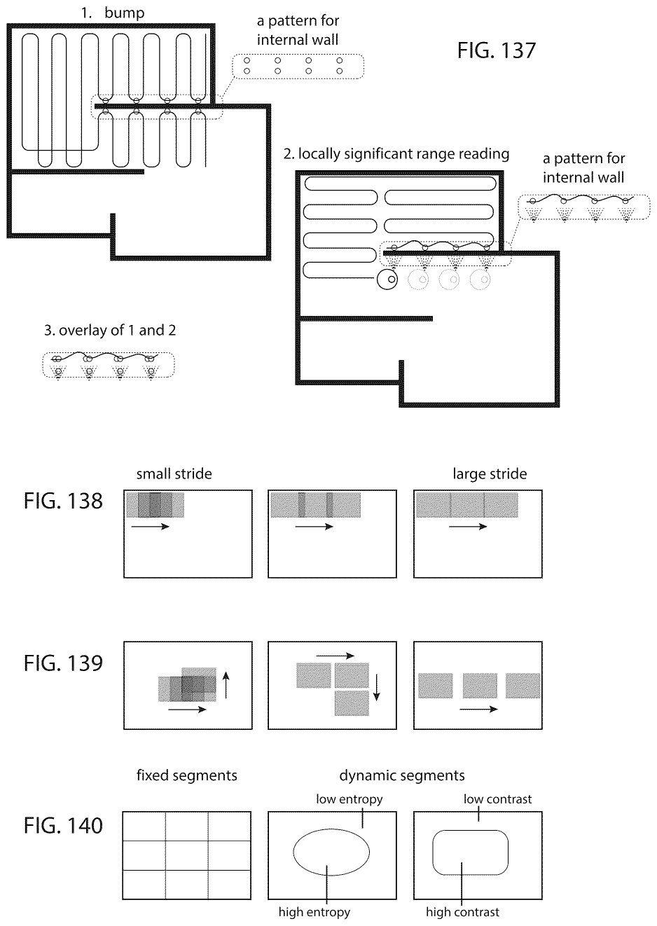

In some embodiments, micro priors consist of small segments where the robot performs coastal navigation against perimeters, keeping a distance while moving with a series of bump-turn-move actions, using local IR sensing to detect the presence or absence of obstacles, or with significant range readings, as depicted in FIG. 136. These prior events may be organized and bundled during the first run to be used in consecutive runs. The consecutive runs may collect more data or swarm points or micro-segment trajectories, which further confirm previous findings, as shown in FIG. 137. Superimposition may occur coincidentally as the robot navigates or may be initiated by the robot when it suspects the existence of a pattern and wants to confirm it. Priors may be superimposed to create better guesses. Segments may be split and merged iteratively, as explained before, to arrive at better perimeter construction. Local mapping may be combined with global mapping or operate independently in lower-priced robots. A local mapping-capable system without global mapping may still provide a certain level of intelligence, such as dividing internal areas into rooms or identifying highly dense obstacle areas.

A local mapping robot without global mapping capabilities may utilize global maps provided by other robots or generated by other means, such as carrying a smartphone around the house to create a map. The local mapping robot will localize within its local map without the global map. A local map may be created during a training run and then further completed or enhanced during consecutive runs. The robot may take an exploratory strategy to confirm hypotheses developed in the same run or during consecutive runs. The robot may select better paths using priors. It may choose a sequence of micro-trajectories to cover a segment based on priors. For example, if priors suggest that a segment is a wall, the robot may trigger coastal navigation at a distance from the perimeter. In handcrafted feature detection, when an image is processed, features may be looked for in a sliding window. The sliding window may have a small stride (moving one, two, or a few pixels) or a large stride, resulting in no overlap with the previous window, as illustrated in FIG. 138. The window may slide horizontally, vertically, or in any other direction.

In another embodiment, the window may start from an advantageous location in the image. For example, it may be beneficial to start from the center, as shown in FIG. 139. In some embodiments, it may be beneficial to segment the image into several sections and process them separately, as shown in FIG. 140. Minimizing the navigation path may involve repeating old lines, such as during hot obstacle drop-ins, hot pin drop-ins, real-time new room discovery, and real-time relocalization. Real-time discovery of lidar blockages or partial blockages may also be considered, including determining what happens if part of the lidar is blocked. The robot does not need to start from the same pose to load the previous map, nor does it need to start from the same location to honor the virtual boundary.

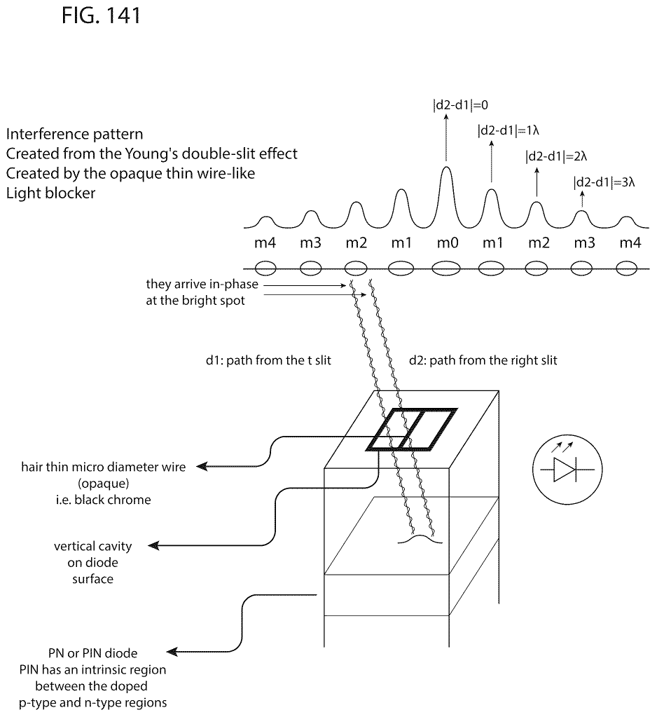

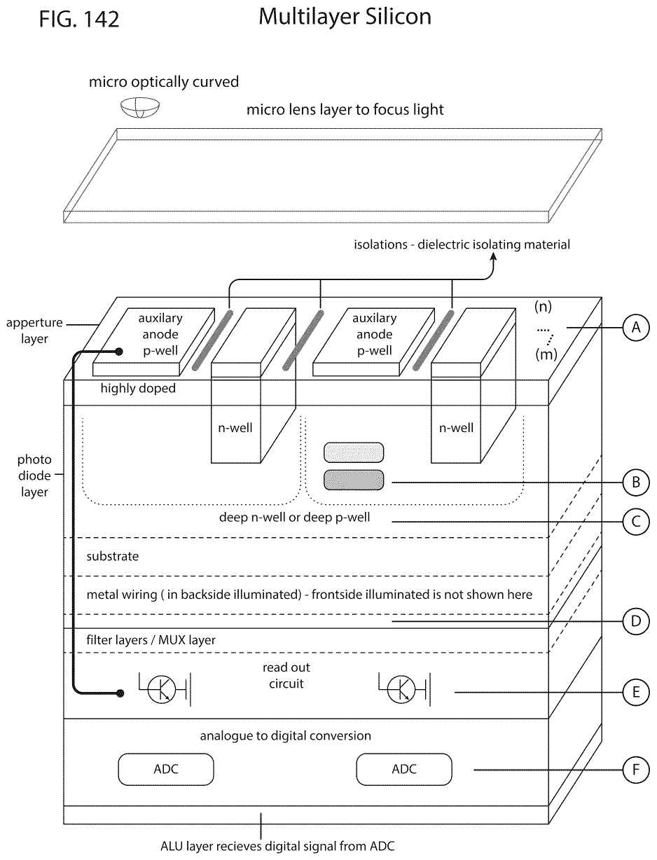

Certain materials, when exposed to photons, absorb the photon and discharge electric current by making an electron-hole pair recombine. Examples of these materials are poly-crystalline lead sulfide (PbS), with wavelength sensitivity ranging from 1 μm to 3.3 μm, and poly-crystalline lead selenide (PbSe), with wave peak sensitivity ranging from 1 μm to 5.2 μm. These materials are shown in FIG. 141, exhibiting photon absorption and electron-hole pair recombination. PN or PIN diodes have an intrinsic region, which is undoped between the p-type doped, and n-type doped, which is the depletion region. A Geiger-mode avalanche effect is created when a voltage higher than i.e 3×10 5 v/cm break is applied to a diode with a high reverse bias, such that when annihilating, more electron carriers are knocked out, creating an avalanche wherein a single photon may create a milli-ampere current in a sub-nanosecond spike. FIG. 142 shows a multilayer silicon equipped with micro-optically curved lens layers in order to focus light. The multilayer silicon includes layers: (A) Array n×m junction of p-n or p-I-n in 2D (or 1D) arrangement; (B) Collection area where carriers and holes come together and provoke a multiplication area; (C) The positions of anode and cathode may be switched from the use of opposite p-type and n-type, and the arrangement may result in multiple logical diodes formed in a semiconductor body; (D): Chip temperature or current sensing including power transistor or current sense transistor and adopted resistor region on the semiconductor die and a toggle circuit, wherein Phase-Locked Loop (PLL) array creates phase offset; (E): Transistor or capacitor pair for each of the active pixel sensors (for sampling, control, or binning); and (F): analog-to-digital converter (ADC) that converts analogue electrical signal into digital signal by creating a step level of electricity determined based on ratio of measured sampled voltage compared with base voltage wherein base voltage may be dynamic and temporally averaged to account for ambient noise. Often, the output was in a digitized string of ones and zeros. In some implementations, a time-to-digital converter (TDC) circuit may be arranged serially before or after the ADC to enable time-correlated single photon counting. In other implementations, a TDC circuit may be implemented in parallel to the ADC. In some embodiments, other layers, not shown in FIG. 142, can be optionally arranged as: (1) Binning layer: simple binning may be done at Arithmetic Logic Unit (ALU) layer or have an elaborate layer of its own; (2) ADC corrective circuit to temporally and dynamically set the base for conversion; (3) Amplification or filtering of noise and minimizing cross talk; and (4) Heat sink or negative-temperature-coefficient (NTC) circuit to control the avalanche effect.

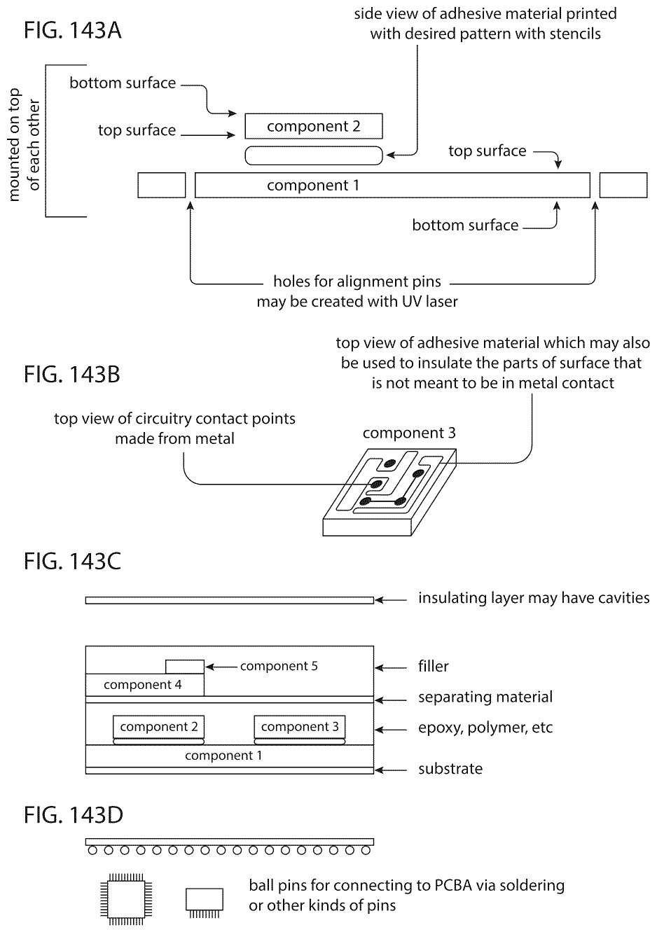

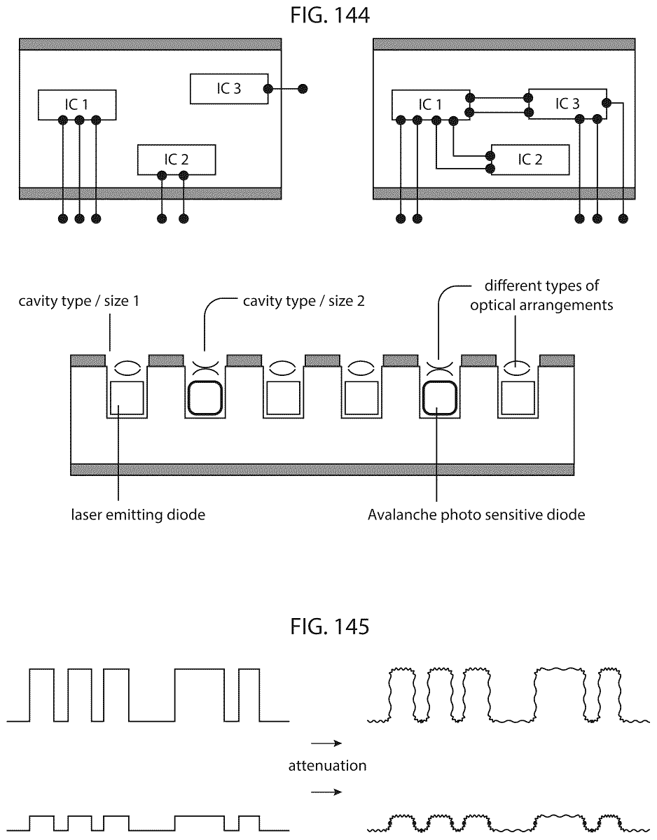

In some embodiments, the Multi-layer CMOS image sensor, as shown in layer (A) of FIG. 142, is an array of 1D or 2D active pixel sensors organized into rows and columns on a plane. Each active pixel may connect to a transistor or capacitor pair to maintain a pixel state, which will be measured by a read-out circuit. Once read, the values may be reset individually, one row at a time, or all at once, such that the frequency of which determines a shutter speed or a frame-rate. Circuit layers communicate with each other via TSV (through-silicon via) in a 3D-SIC or communicate with direct vertical interconnects in monolithic 3D-IC. Alternatively, the 3D packaging may be utilized, such as 3D SiP (System in a Package) or 3D WLP (Wafer Level Package), to take advantage of the Z-dimension and to create a smaller form factor. The sensor, as shown on layer (D) of FIG. 142, may be a monolithic chip with interweaved vertically laser emitting diodes and avalanche detectors, or it can be separate monolithic chips packed together as a single sensor. In some embodiments, multiple 3D chip technologies may be used to produce monolithic embodiments for various kinds of integrated circuits (ICs). For example, a single wafer of silicon or other semiconductor, commonly used in the industry, may be treated with UV lithography to fabricate a repetitive circuitry pattern where the wafer is then cut into “die”, whereas each die will have one circuit pattern. The “die” will be a building block that will then be combined with other dies with different circuit patterns to form more sophisticated circuits. FIG. 143A-143C demonstrates stacking or mounting of various components. The stacking process may comprise iterative warming (baking) to melt the adhesive material or treatment with UV, or etching (such as wet etching), aligning such as passing pins through alignment holes, advanced imaging or other methods such as direct laser imaging, laser drilling (such as CO₂ laser drilling) or thinning process by etching or micro-sanding. FIG. 144 illustrates various examples of the stackings of integrated circuits. On the right side of FIG. 144 an example of an avalanche photo sensitive diodes is shown that may be arranged to have a series of cavities with various cavity types or sizes and on the left side of the figure shows an example of a laser emitting diode shown to have a series of cavities with various cavity types or sizes, and while they are shown in a monolithic arrangement in one silicon, the teachings here is not restricted to an implementation where both of photo sensitive diode and the laser emitting diode being on the same silicon surface, and as such each of the chips may utilize multiple cavities, in a serial, cascading, or any form of arrangement. The use of multiple cavities may apply to silicons with different purposes. In some embodiments, a laser emitting diode and avalanche photo sensitive diode pair may be forged into a single physical component while the silicons are separate. In some embodiments, as shown on the left and middle part of the figure, a cavity type/size 1 is shown that is different and distinct than cavity type/size 2 as well as different micro lens, both of them, applying to a laser emitting diode with a convex optical lens, and further shows a cavity type or size different than type/size 1 and 2 which is configured with a lens for an avalanche photo sensitive diode with a conclave optical lens. The Figure presented here is only for demonstrating the concept of multiple or cascading cavities and it does not imply a restriction that both the laser emitting diode and photon sensitive diode must be on the same silicon, although this teaching discloses such a combined implementation in addition to individual chips. As explained above, combining the separate silicons into one monolithic component is also a subject matter of this teaching. In some embodiments a geometrical arrangement further allows the laser emitting diode to be implemented in a layer beneath a layer of photosensitive diode, as if acting like a backlit arrangement. Various arrangements of silicons (and their respective cavities), and specific shapes and arrangements for maximum efficiency in a small form factor are the subject of this teaching.

In some embodiments, a semiconductor substrate is locally oxidized to form oxide regions above the plane of substrate. In some embodiments, a number of corrugations are created with carveouts of the formed layers with an etchant substance, such as buffered hydrofluoric acid. As such, trenches are created along the length or width (or both) of the substrate. The semiconductor substrate may be laid on a plane of insulator substrate. Examples may be mono-crystalline silicon substrate, a layer of silicon on insulator, or a layer of germanium (Ge) on the insulator. Other examples include materials that are compounded with a silicon wafer or germanium wafer, including but not limited to indium antimonide, indium arsenide, indium phosphide, gallium nitride, gallium arsenide (GaAs), gallium phosphide, indium gallium phosphide, aluminum gallium nitride, aluminum indium nitride, indium gallium arsenide phosphide, cadmium telluride, mercury cadmium telluride, gallium antimonide, lead telluride, etc. Other group-IV compound semiconductor materials, such as silicon carbide (SiC) and silicon germanium, may be used. In some embodiments, the concentration of dopant material varies at various depths of silicon or on the surface of a certain layer in the silicon. A combination of positioning the n-type material and p-type material, and the dope concentration, as well as positioning intrinsic material and insulating barriers, as well as ideal selection of the material, may produce better performance based on the desired outcome of the silicon arrangement. In some embodiments, silicon carbide polytypes with a hexagonal lattice type, such as 6H and 4H, may be used (4h)-SiC has a bandgap of 3.3 eV and provides high thermal conductivity, temperature stability, and may be a good candidate for Schottky barrier implementations. Other common polytypes may be used, such as 2H, 3C, or 15R. A wafer of a single polytype is chosen, and SiC molecules are grown as stacks on top of each other. Dopant materials may be nitrogen, phosphorus, beryllium, boron, aluminum, oxygen, hydrogen, fluorine, or bromine. A process of growing thin films of crystals is referred to as Epitaxy in some contexts. The crystallinity and orientation of grown layers is determined by substrate. In light or laser emitting diodes, a heated flow of gaseous compounds or elements treat the surface of the substrate, during which a crystalline layer is formed. These processes may be broadly referred to as vapor phase epitaxy in some contexts. Other common processes include molecular beam epitaxy, in which a heated metallic solution saturated with desired layer material is exposed to substrate to form a crystalline layer. Liquid phase epitaxy is commonly used in microwave IC. Molecular beam epitaxy of GaAs uses a vacuum system containing liquid gallium (Ga) or solid arsenic (As) as a source to treat the heated substrate with a beam of Ga atoms or molecules of As effusing from an orifice to around 450° C. Before the SiC surface is treated, a mask layer may be created to prevent doping or treatment of certain areas on the wafer surface, or a certain width at the bottom of a trench or a certain height at the walls of the trench (both sides or one side). In certain areas on the surface, a certain surface area on the trench wall at a certain height, a certain surface area at the bottom of a trench, dielectric material may be incorporated to create dielectric regions or dielectric layers. Some examples of dielectric materials commonly used are: Silicon oxide (SiO₂), silicon nitride (Si₃N₄), silicon oxynitride (SiOₙNₘ), zirconium oxide (ZrO₂), tantalum oxide (Ta₂O₅), titanium oxide (TiO₂), hafnium oxide (HfO₂), which can be mixed with each other and can be combined with other materials in desired proportions or stacked different layer thicknesses.

The arrangement of one or more auxiliary anode in addition to the primary anode or vice-versa arrangement on one or more auxiliary cathodes in addition to the primary cathode, wherein the auxiliary cathodes or anodes are placed at a distance from the primary material of the same type doped (at times with different doping concentrations), creates an array of logical diodes within a pixel, wherein each of the diodes creates a current that may be combined to create a higher current reading. A Geiger mode is achieved when a reverse-bias voltage is designed to be above a breakdown voltage. In some embodiments, two pairs of p-n junctions may be connected anti-serrially with proper grading coefficients and are implemented within the silicon to control the avalanche at the chip level integrated in the SiC substrate. Temperature and current sensing may be interleaved inside the die as well as a drain terminal. Sequence and pattern of the emitting diode may be preset or controlled by the input from an environment. For example, the sensing diode may be connected to a feedback circuit that would control the sequence, power, pulse count per second (or in case of modulated signals, frequency), and the like. For example, an incoming signal may be processed to instruct the PLLs in the PLL array to create a modulation with the same frequency as the incoming signal. In different environmental settings, the PLLs may be dynamically instructed to produce frequencies that are different, each with a fixed increment. This means that when they are all sorted synchronously, each will arrive at distances with a phase different from one another, creating a phase space with known phase elements in respect to time. The semiconductor chips explained above may have electrodes on their top surface, bottom surface, or sides to be soldered on the circuit board. The fabrication of semiconductors may allow the current flow vertically in respect to the main surface of the chip or horizontally. The semiconductor may have fillers between its layers or be molded to a monolithic package with filler material such as epoxy, resin, or acrylic. Thermosoftening polymers may be used in techniques such as injection molding, compression molding, in-label molding, etc. Suitable material may be acrylonitrile butadiene styrene (ABS), poly methyl methacrylate (PMMA), polyetherimide (PEI), polyphenylene-sulfide (PPS), polyamide-imide (PAI), polyethylene terephthalate (PET), Polyvinyl chloride (PVC), polypropylene (PP), polyethylene (PE), or polycarbonate (PC). A pre-molded housing may be used to house the silicon components and the filling material. The technologies explained for semiconductor processing are not limited to light emitting/laser/avalanche diodes or CMOS image sensors, photon count detectors, temporal photon counters, phase shift or time of flight or point-cloud semiconductor chips, etc. Other components that may benefit from silicon processing techniques explained herein may be power components such as: power metal insulator semiconductor field effect transistors, power metal oxide semiconductor field effect transistors, IGBT (insulated gate bipolar transistor), junction gate field effect transistors, high electron mobility transistors, power bipolar transistors, power diodes, PIN diodes, Schottky diodes, MOS controlled diode (MCD), etc. Other power related components that may benefit from the silicon processing aforementioned are AC to DC converters, DC-DC converters (to convert the voltage from a battery source to one or more voltages needed to power other electronic components or other parts of circuitry), LDOs, and the like.

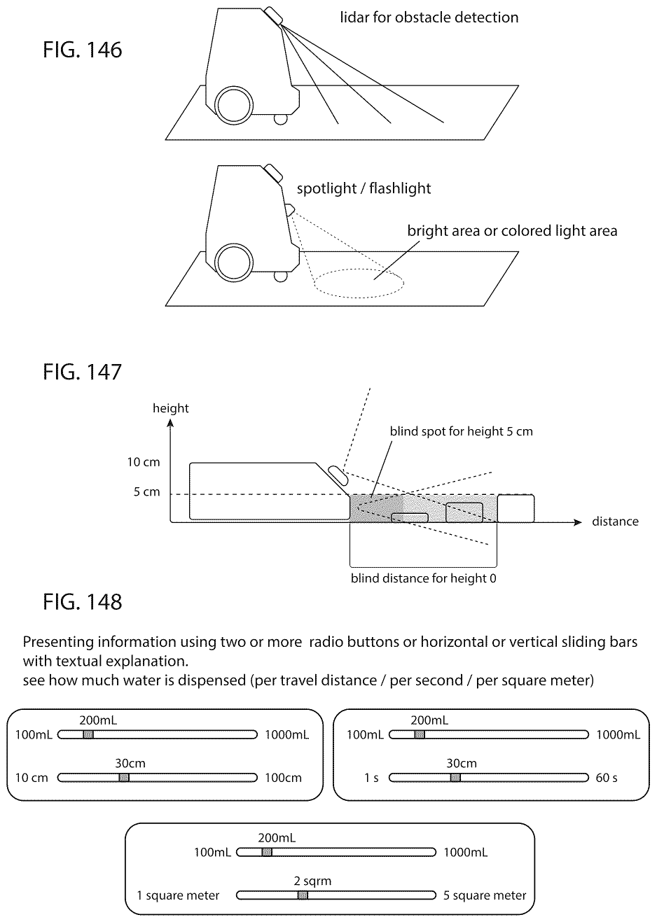

Nyquist rate determines bandwidth at a certain sampling rate and holds frequency pulse≤2 bandwidth (Hz), which means bitrate reaches a maximum upper limit that is twice the sampling rate. Line rate determined by Hartley's law shows the number of pulses that can fit in a time slice without interfering with each other. The higher the pulse voltage, the less chance for two consecutive pulses to be mistaken for another due to attenuation, as shown in FIG. 145. This concept may be expanded to universally describe what sample rate from a continuous natured phenomenon would produce sufficient representation. For example, point cloud samples from a wall or environment are in fact a digitization of a continuous phenomenon or images of an environment sample the continuous nature into pixels with certain resolutions. In the same way that Nyquist sampling may prevent sensor aliasing, it can be used to prevent over sampling. The current state of the art is position space localization of objects, which is based on detecting obstacles in front of the robot perhaps using vision based systems or distance based systems, and the moving robot stops, slows or reacts if a presence of a person or object is detected in the path that the robot is about to take. In contrast to the above system, a deterministic clearance requirement has an independent unit that does not allow the robot to make a move at all if a clearance in the next phase is not guaranteed with a certain degree of certainty. The robot may illuminate the path it is about to take in front of it to softly communicate with people in the surrounding that it intends to take a path as illustrated in FIG. 146. The flash light could be a sequence or an interval of off and on, fast flashing spot light communicates with the people staying away implicitly. Voice or beeps also help. Now, imagine a probability distribution for existence of an obstacle or appearance of a dynamic obstacle. A coordinate system of a third tiled scenario (small file) equals each tile edge length to unity, the medium tile to 2× unity, and the large tile to 3× unity. A vector gradient ∇P of P for the unity tiling is the vector that points in the direction of the greatest increase of function P, and its magnitude is equal to the greatest rate of increase.

$$Δ P = ( \frac{δ P}{δ x} , \frac{δ F}{δ y} )$$

$$or$$

$$Δ P = \frac{δ F}{δ x} i + \frac{δ F}{δ y} j$$

Minimizing power consumption in communication wirelessly or wired is an objective in robotic systems due to geometric and other limitations. As such, power aware communication protocols may be employed. Other methods may utilize sleep mode, deep sleep mode, or standby mode. In some embodiments, the device reduces or eliminates power supply to components, where they may not be immediately used. User interface and LED lighting may also be dimmed or turned off. The system may be awakened by a wifi signal coming in through an app, a button, or a human voice. Convex optimization may formulate the goal of minimizing power consumption. Further, as we explained, such optimization methods may be used for localizing, mapping, navigation, and semantic simultaneous localization and mapping. For contextual mapping and recommending items that may “belong” to an understood map, Naive Bayes methods may be used. Supervised and unsupervised learning algorithms may be used. In some embodiments, conditional independence between items may be assumed. In some embodiments, Maximum A Posterior (MAP) estimation may be used. In some embodiments, a support vector machine may be utilized to overcome scarcity of labeled data. In some embodiments, convex optimization and interior point methods may be used. A convex optimization is formalized as: Minimize f (x) where the condition below is met:

$$fi ( x ) ⩽ bi$$

$$where i = 1 , 2 , … . , n$$

Where functions:

$${f}_{0} , … . , {f}_{n}$$

$${R}^{n} \to R$$

For all and x, y∈Rⁿ and α, β∈R

$$fi ( α x + β y ) ⩽ α fi ( x ) + β fi ( y )$$

This generalizing and unifying framework has many other applications, such as in path planning based on semi-observable constraints, extracting context from wifi sensing, signal attenuation, and strength map observed by hundreds of millions of computers, cellphones, robots, etc., which all operate under different protocols, parameters, standards, etc. In semantic SLAM, data structure becomes an issue as well as scalability. In some embodiments, data observations are considered a set of points that live on a manifold rather than an Euclidean space to reduce computational complexity. Instead of applying gradient based optimization in Euclidean space, they are performed on Riemannian manifolds. As such, the search domain lives on the manifold, and the decision domain associates with the tangent Euclidean space. In this context, the relationships among coordinates (i.e., spherical, cylindrical, affine, polar, cartesian, etc.) will come into light, and the generalization of them as well as the change from one to another becomes the matter at hand. First order methods and second order methods in Euclidean spaces may be generalized to live in Riemannian manifold spaces. This generalization allows sparse data captured with different coordinate systems to find a common world where a mapping from their respective coordinate system will be a bijectional chart that associates their linear world to a manifold from where a different bijectional chart can carry the information to another atlas that is devised based on other assumptions and parameters. These assumptions and parameters could be anything from modeling to camera intrinsics, etc. One simple example is devising relations between large image data sets in the public domain captured with various cameras under various lightings, with many different resolutions, FOV's, qualities and, luminosities, with large data sets from radially outward looking observations, such as those taken from LiDARs or depth cameras. In some embodiments, a method may be employed for detecting pixel areas capturing an illuminated surface in a pixel array. Ultra wide spectral images allow the release of current upon receipt of both the visible spectrum of light as well as the invisible spectrum, showing sensitivity to a wide range of wavelengths. Although they may have different levels of sensitivities at each wavelength, the sensitivity versus wavelength chart may be unimodal with a single peak at a certain wavelength or may be multimodal with two or more peaks.

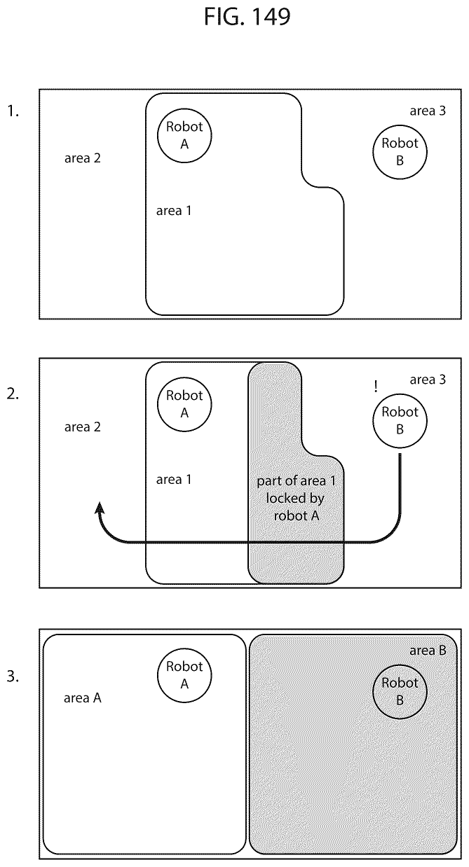

FIG. 147 illustrates the relationship between the height and the distance of a blind spot in a system. For instance, the blind spot extends along a distance from a sensor or device at different height levels. In this example, the height of the object (or the sensor) is between 0 cm and 10 cm. At a height of 5 cm, the blind spot is represented by the dashed lines extending across the distance. Similarly, for a height of 0 cm, the blind spot distance is represented at a shorter distance, indicating a smaller or no detection area at ground level. FIG. 148 illustrates an interface for presenting information with two or more radio buttons, horizontal or vertical sliding bars. In this example, the system has a design to allow the user to control and visualize water dispensing rates (per travelled distance, per second, or per square meter), represented by different units for volume, travel distance, and coverage. FIG. 149 demonstrates collaborative workspace share negotiation among collaborative robots. In case 1, Robot A first claims control of area 1, indicated in the diagram, and locks it to prevent Robot B from entering. Robot A marks the boundaries of area 1, effectively establishing a region it is responsible for. In case 2, when Robot B intends to move towards area 2, it encounters the obstacle of area 1. As a result, Robot B initiates a negotiation process with Robot A. During this negotiation, Robot B proposes that Robot A release the rightmost section of area 1 in exchange for Robot A taking control of area 2, suggesting that this arrangement would make the movement of Robot B easier. In case 3, Robot A agrees to the proposed exchange and releases the rightmost section of area 1, allowing Robot B to lock this released section for its own use. This adjustment is visually represented in the diagram, where Robot B gains control over the released section of area 1. In some embodiments, this cooperative negotiation and real-time adjustment of control areas enable more efficient navigation and task execution in dynamic environments, such as collaborative robotics, where robots must work together while avoiding interference with each other's designated zones.

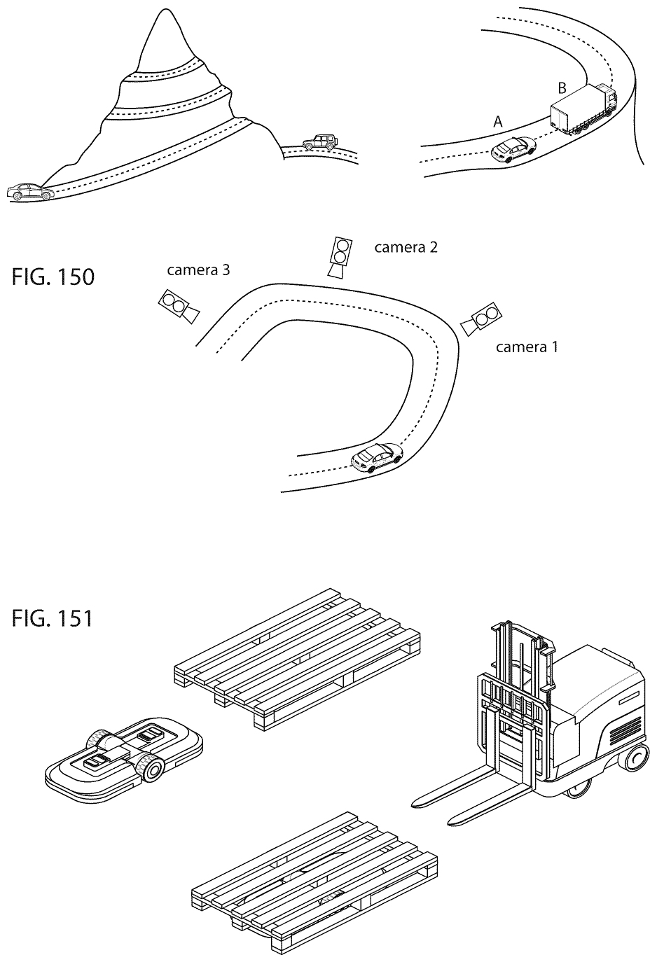

FIG. 150 shows another example of collaborative AI or collaborative SLAM. In a narrow lane situation with one lane in each direction, the maximum visible area to the driver of vehicle A is insufficient to determine whether it is safe to pass the slow moving truck or vehicle B in an uphill terrain. Cameras installed on the path can provide a feed to an app or interface, such as an LCD panel on vehicles. In some embodiments, installed cameras may capture visual data that is processed to provide relevant information such as detected obstacles, road conditions, and other relevant data. For example, cameras may identify the vehicle ahead of it and obstacles that may block the vehicle's path. The processed camera information may allow the system to determine whether it is safe or unsafe to pass the slow-moving truck, considering relevant factors, such as road width, further traffic conditions after the possible pass, speed limitations, etc. If it is unsafe to pass, the system issues a warning to the driver. The system may process the camera information and notify the driver of the last safe chance to pass the truck. In certain situations where the road is narrow and the driver cannot immediately overtake the slow-moving truck, the system may compute the last opportunity for the driver to safely pass. The system may further process the camera information and analyze the current traffic flow, the speed of the vehicle in front of the driver, and the available passing zone, and further process this information to calculate the required speed the driver needs to maintain in order to overtake the truck within the available time and space. In a more advanced system, the vehicle can assist the driver by automatically controlling the steering, acceleration, and parking to perform the overtaking maneuver to pass the vehicle. This can be implemented in semi-autonomous driving systems, wherein driver-assisted systems may be activated or enabled by the driver. In a fully autonomous system, the entire process of overtaking the vehicle is performed by the vehicle without driver intervention, which would involve ranging and detection, decision-making, and execution. Instead of stationary cameras or in addition to the said cameras, the vehicles can collaborate and simultaneously share their location with each other with the use of their respective GPS on an application or on the vehicle. This vital information is relayed and communicated to the other vehicle and may be seen on the application or on the LCD panel of the other vehicle. This enables vehicles to be aware of the position of each other, thus improving the coordination and increasing safety in situations where precise timing and speed are essential. The system may engage complete collaborative SLAM, wherein all the information from the vehicles and environmental sensors may be integrated and enabled to provide accurate mapping and navigation in real-time. The system may allow vehicles to collaborate in order to build and update a shared map of the environment, which may be used to optimize driving decisions and overtaking maneuvers. FIG. 151 shows another example of collaborative SLAM, where a pallet and forklift align with each other. The pallet is positioned on top of the robot, and the robot underneath can move, turn, and spin the pallet. In some embodiments, the pallet can be a robotic chassis that holds a traditional pallet or something dedicated. For example, a robot can move underneath the pallet to control it. The robot can be in sync with the forklift to align and dock with each other. The alignment can be based on an IR receiver and Tx/Rx, or it can be based on geometric identification, or it can use barcodes, QR codes, or other patterns, or a combination of these methods. In some embodiments, autonomous collaboration can be onboard peer-to-peer, central-rule-based, or hybrid. Collaboration can be used for area locking, path locking, lane locking, and intersection locking. Negotiation of paths can occur when there are multiple lanes, and lane negotiation can occur where there is only one lane. Negotiation of intersection blocking can be based on factors such as time of arrival, estimated time of clearing, priority, and physical circumstances, such as whether the route is a main road, highway, or alley. Position circumstances like straight paths, left or right turns, and right of way may also influence negotiation. Other factors, such as the availability of space in auxiliary lanes, side lanes, two-way streets, one-way streets, and margin spaces, can also play a role.

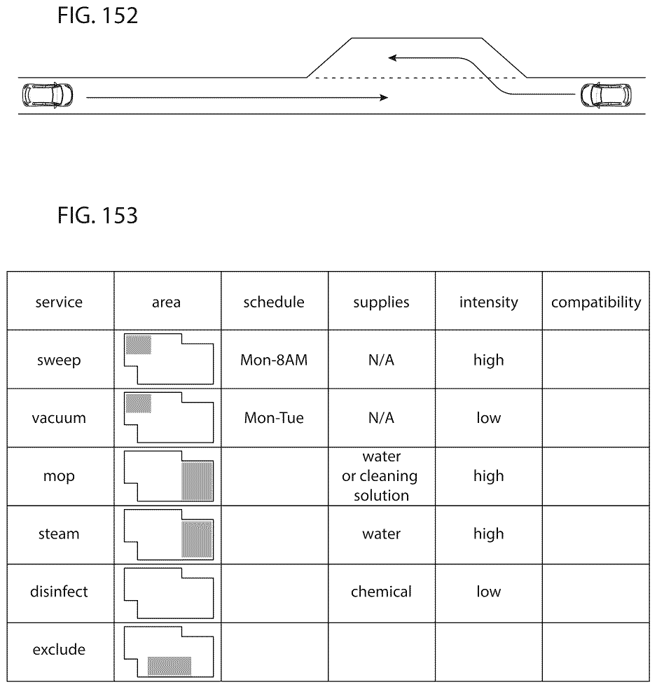

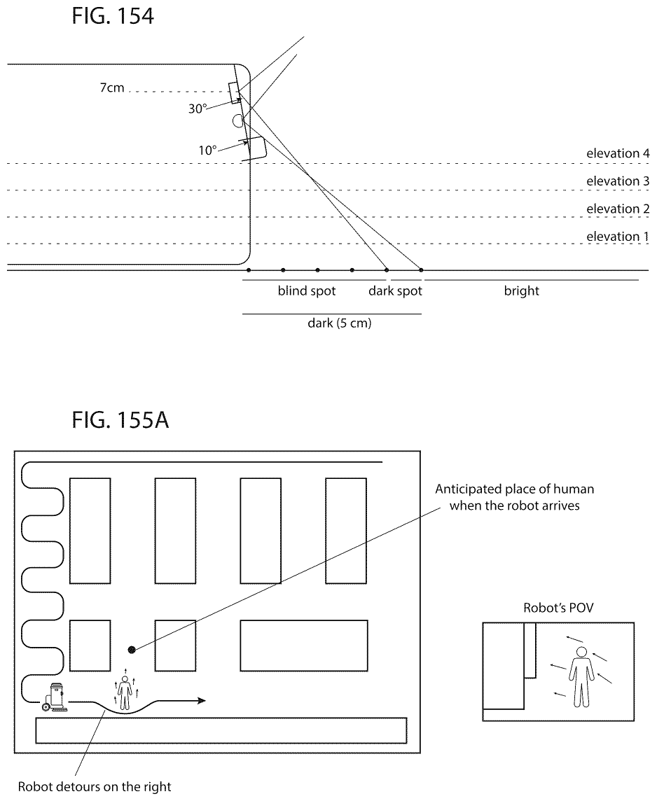

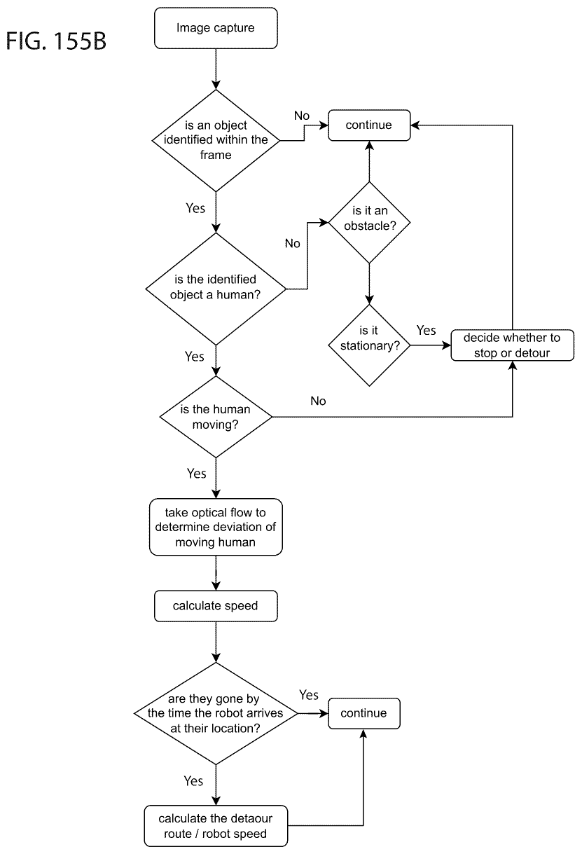

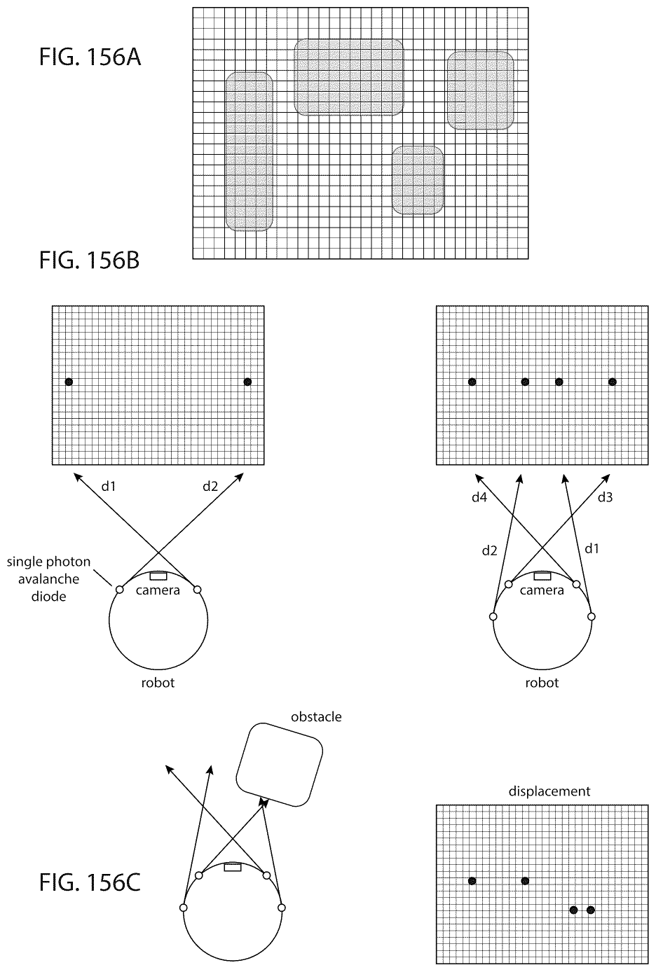

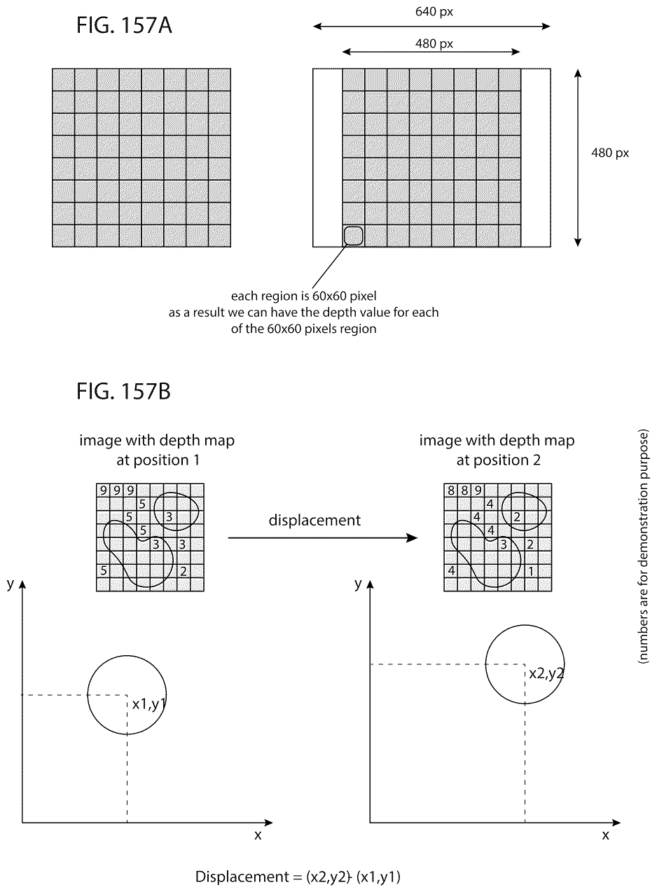

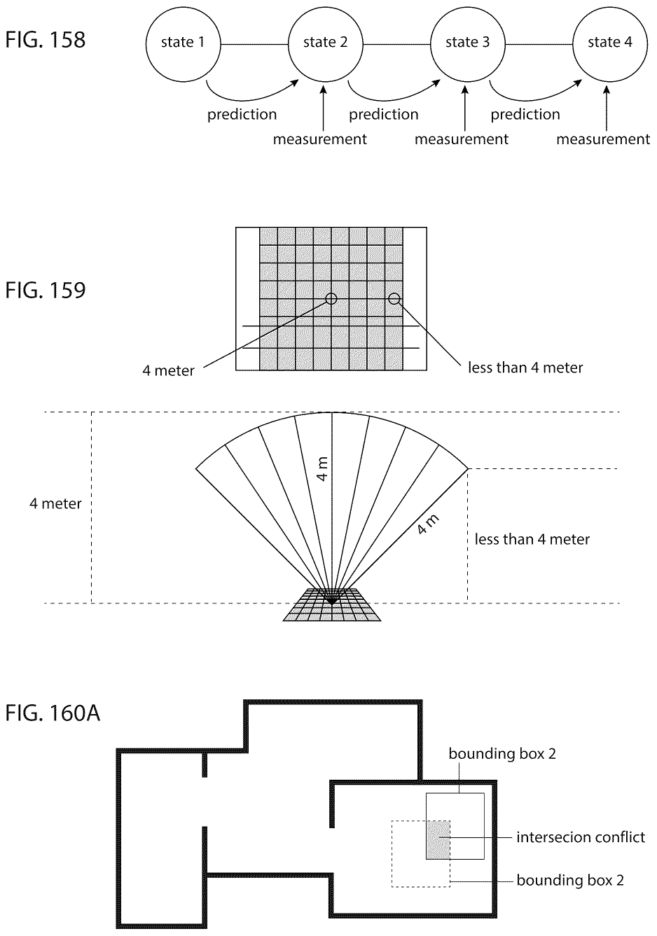

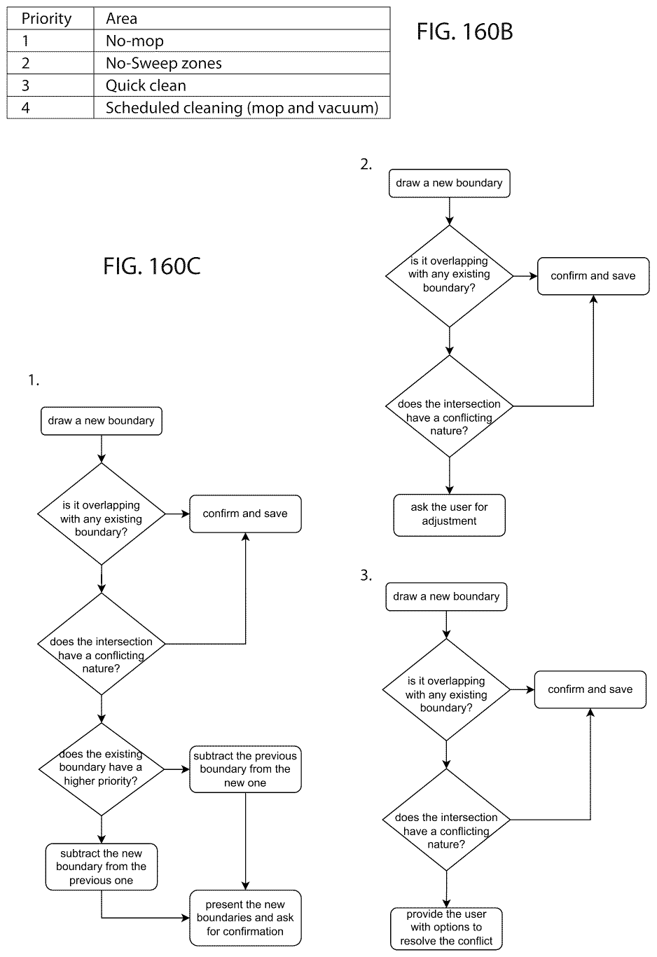

In some embodiments, autonomous negotiation can involve handshake protocols, wireless communication, or peer-to-peer methods. These can include hub-spoke communication or many-to-many negotiation scenarios. FIG. 152 shows a narrow path shared by robots moving in both directions. A side margin area allows robots to pass each other. In some embodiments, Robot A may lock the lane, while Robot B moves to the margin of the road. Negotiation can be based on minimizing total wasted time, considering factors like which robot arrives first, their speed, and whether Robot B can move in the margin area based on its length. Rule-based negotiation can also be applied, where some vehicles, like ambulances, are given priority. The domain of operation can be defined using various parameters such as exclusion areas, limit inclusion, multi-service inclusion, and high-intensity service inclusion areas. FIGS. 153, 154, 155A, and 155B describe systems that combine two types of image sensors in an advantageous geometric setup. A CMOS image sensor captures the amount of light arriving at each pixel within a given time, creating a 2D plane that provides a flat snapshot of the environment as shown in FIG. 156A. A single-photon avalanche diode (SPAD) creates an electric charge upon the arrival of each photon particle, with the resulting data used to measure distances to objects as shown in FIGS. 156B and 156C. In some embodiments, the SPAD measures distances for multiple points in the 3D environment, allowing a connection between the camera's field of view and the spatial world. For example, a multi-zone SPAD, such as the 8×8 VL53L5CX sensor by STM (ST Micro), provides 64 zones with a range of up to 4 meters. In some embodiments, this is combined with a CMOS image sensor with a 640×480 pixel resolution, providing depth values for each 60×60 pixel region as shown in FIG. 157A. In some embodiments, when the robot moves from one position to another, as shown in FIG. 157B, it can predict the depth map at the start of the displacement (prediction step) and correct the map based on updated sensor readings at the end (correction step). FIGS. 158 and 159 illustrate how the system measures distance in 3D space. The maximum distance measured for central pixels may be 4 meters, while for peripheral objects, the distance may be less than 4 meters, depending on their location in the frame. In some embodiments, the system can track objects across multiple frames captured by the same camera or multiple cameras moving in the same or different frames of reference. For example, FIG. 160A shows two boundary boxes defined by the user that may overlap, potentially causing a conflict between a no-mop zone and a full cleaning zone. FIG. 160B presents a priority table of areas within the system, while FIG. 160C shows different options for resolving conflicts, such as system resolution, user notification to adjust boundaries, or providing options to modify boundaries.

In some embodiments, the image capturing system includes a lens placed in front of a photoactive surface arranged in a pixel array. The pixel array measures the amount of electrical photo current accumulated in each pixel capacitor, which is sampled by a transistor at intervals. The light activating the photoactive surface may be ambient light or active illumination, such as white light, IR, or laser. Active illumination may include various forms of structured light, such as spotlights, grid points, or lines. The system may use adaptive filtering to improve dynamic range and noise reduction. In some embodiments, the effects of lens vignetting are corrected using AI/ML-based filters, adjusting for radial darkening at the corners of the frame. For example, continuous and adaptive mean shifting can be used to trace objects as their pose and orientation change, identifying contours and refining object tracking. In some embodiments, the system may use the Parzen-Rosenblatt windowing method for segmentation and object identification, or employ principal component analysis for object training. In some implementations, optical flow may be used to subtract background motion from the object of interest. Segmentation methods can help extract background optical flow, or the system may distinguish between flat objects and volumetric ones based on their movement through the image. For example, objects with volume travel more slowly toward the lower rows of the image than flat objects.

In some embodiments, image segmentation and optical flow may be used to monitor bounding boxes around detected contours. The system can track and compare the optical flow of the bounding box with other regions of the image, helping to identify obstacles in the vicinity of the robot. In some embodiments, different regions of the image may be processed separately for various characteristics, with changes monitored to ensure accurate navigation and obstacle detection. In some embodiments, the rate of change of the subregions or regions against each other may be monitored and compared as the robot moves in the environment. In some optical flow implementations, a next expected concentration of contours or other critical features/points may be predicted using a Kalman filter, with assuming a transition matrix extracted from movement:

$$\{ \begin{matrix}{X}_{i} = {AX}_{i - 1} + {V}_{i - 1} ← state noise \\ {Z}_{í} = {CX}_{i} + {M}_{i} ← measurement noise\end{matrix}$$

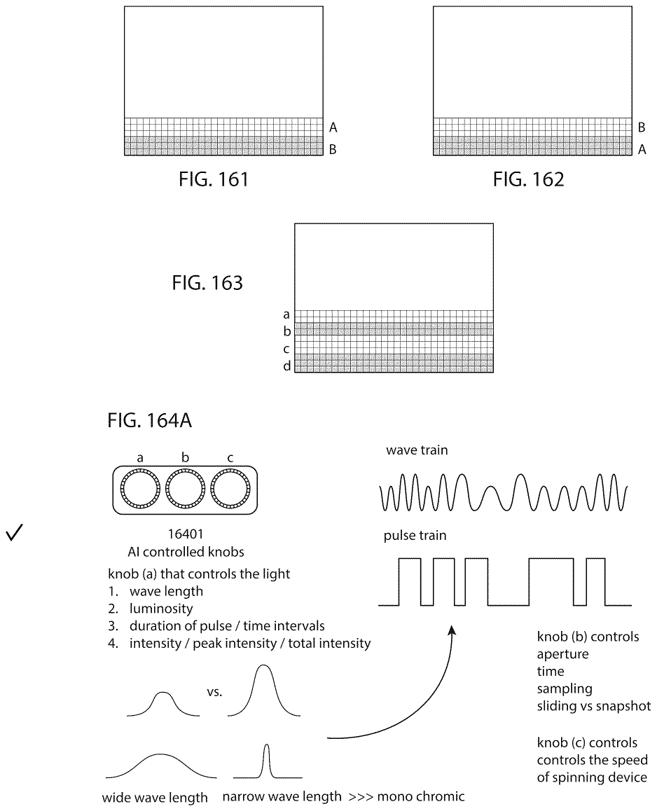

Xᵢ depicts the state vector at each iteration. Zᵢ depicts the measurement vector at the same iteration. The predicted optical flow on camera will be different for a bounding box containing the concentration of contours versus background. The divergence can be extracted with Kullback-Leiber measuring how a probability distribution is different from a second one by measuring statistical distance. In some embodiments, incoming image data or features identified in the image data are indexed using an indexing service or indexing system wherein data is selectively placed in containers. The incoming image stream may be indexed in parallel with multiple indexing threads, each indexing a different aspect of incoming data. New threads may be instantiated when image data carries information that is required to be indexed that is different from the existing indexing threads. When a stream of images cease to contain such information, an indexing thread may be terminated. A virtualized process may separate incoming streams for different processing types. In some embodiments, coarse to fine optical flow is monitored. In some embodiments, two sets of rows may be monitored for optical flow divergence. In some embodiments, it is expected that a flow seen in rows in group (A) remains consistent in the rows in group (B) if a concentration of contours or critical points on the image belongs to a flat pattern or stripes on the floor. FIG. 161 If the optical flow gets significantly disturbed passing from the rows from group (A) to the rows from group (B), we conclude that a 3D object with volume is on the floor. In some embodiments, coarse to fine divergence of probability distribution using statistical distance is used. Stripes on the floor may be extracted from visual clues such as optical flow, feature tracing, background or foreground segmentation tracing, or it can be extracted from radial distance tracking, as well as tracing illumination reflection from surfaces. In some embodiments, a micro lens array may be optically integrated to provide a desired focus on certain portions of pixel arrays which may be different or the same as the rest of the photosensitive pixel plane. In some embodiments, a trained network may be used in conjunction with polynomial radial and tangential distortion function to overcome lens/aperture effects on the sensor readings. A method for distinguishing obstacles on the floor from stripes or patterns on the surface is disclosed. In some embodiments, the side edges of the image are filtered out and are not processed. For example, a VGA standard image with 640×480 resolution may be cropped by 40 pixels columns at each side to effectively leave a 560×480 resolution image. In other embodiments, the upper or lower edge may be cropped out. For example, if 20 pixel rows are cropped from the top and the bottom, a VGA image with 640×480 will turn into 640×440. In some embodiments, top, bottom, right, and left sides or any combination can be cropped out depending on distortion, lens geometry, or the optical arrangement. In some embodiments, instead of tracking optical flow of a concentration of contours, edges, or other critical points may be tracked. For example, a feature may be extracted using sped up robust features, and their change may be compared as they travel through region B and then A as the robot gets closer to them, as illustrated in FIG. 162. In some embodiments, a polynomial or tangential distortion function may be monitored and compared in the two shown regions. It is expected that for a flat pattern or stripes on the floor, the distortion remains constant as the robot approaches them and they move down the image. In some embodiments, luma (Y′) samples are analyzed to determine a shaded area versus a non-shaded area of the workspace. In some embodiments, the R′G′B′ output from a camera or image sensor is converted to luma and chroma. Luma is given by a weighted sum of gamma-compressed R′G′B′ components of a color video, denoted with Y′ symbol. Image streams encoded as video may comprise frames that carry samples of luma and chroma. In some embodiments, the image is divided into segments and analyzed using a different characteristic of an image or a different processing method, and the results are cross-validated. For example, in FIG. 163, rows “a” may be analyzed using Canny edge detection to find a set of critical points or contours. As the robot moves forward into the scene, the contours and edges move to rows “b”. The contours and edges may be tracked in multiple frames. As the robot moves further toward the scene, the contours and edges enter the “c” rows. In some embodiments, the illumination is designed such that areas at a certain distance from the robot are brightened with the illumination source. In some embodiments, the rows in area “d” are designed to be in shadow. At a distance where contours and edges are now supposed to be in rows “c”, a distinction occurs between objects with volume versus patterns and stripes on the floor. For example, first, an object with volume disturbs the line separating the shadowed area and the bright area. Second, the object with volume creates a shadow of itself, making some of the “c” rows darker. Cross-validating the events as the robot moves toward the scene increases accuracy. A neural network system may be designed to make a distinction based on multiple pieces of evidence gathered from prior training data. In some embodiments, a generator and a discriminator may be used. For example, a Canny edge detector may generate a “lead” or a possibility of the existence of an object with volume in the “a” rows. As the robot nears the potential object, a discriminator module may accept or refute the “lead” and make a decision based on more data, such as disturbance of the shadow-bright area line or observation of a shadow behind the object. In some embodiments, rule-based machine learning may be employed. In some embodiments, classic rule-based policies may be applied. During the training phase, the system is fed data in composites of training sets and test sets, and the accuracy is evaluated. The training process is repeated to improve the prediction and confusion matrix. In some embodiments, ensemble methods may be used. In some embodiments, a subset of data is fed into the system, and the final prediction is made through a voting system or an aggregating system. In some embodiments, a decision tree may be implemented, with tree-structured branches leading to a conclusion based on the gathered data and evidence. In some embodiments, the type, shape, and kind of an object are determined based on categorical separations. The first epoch of training starts with a forward pass, wherein the initial kernels of the first layer are initialized with a seed value or a random value. Therefore, the output of the first epoch is a uniform distribution of probabilities assigned to each class. Training provides a set of images with labels and a loss function, such as mean squared error which is calculated as:

$${E}_{total} = \sum \frac{1}{2} 2 {( target - output )}^{2}$$

We then minimize the loss through optimization by adjusting weights. Then, through back propagation, weights that have the most significant correlation with loss are adjusted to decrease the loss. The result is the updated weights of the kernels. Pooling may be used to reduce the spatial dimension of the network by sliding a filter over the input. In some embodiments, pruning of improbable cases may increase predictive accuracy. For example, a customer may be asked via the app, if they have a pet at home and what kind. For example, if the user chooses only cats, this eliminates the possibility of dog bodily waste, which allows the robot to be more risk taking when approaching objects. In some embodiments, a deep learning model may consist of a visible input layer, and a hidden layer. In addition to the above, in some embodiments, the deep learning model may comprise output layers as well as a number of additional hidden layers. In some embodiments nodes may be connected across layers. In some embodiments, the nodes may be connected within the same layer. In some embodiments, the neural network may comprise a feedback loop. In other embodiments, neural networks are feedforward and the direction of propagation is from input to output only. In some embodiments, a recommender system may be utilized. In some embodiments, when an object with volume is identified, its coordinate is labeled. In some embodiments, when a flat surface is identified (i.e., patterns and stripes on the floor surface that are not objects), their coordinate is labeled. In some embodiments, the sensor output is tagged with coordinate stamps or time stamps. In some embodiments, the coordinate aware sensor output is localized within the map. In some embodiments, features recognized in the environment are both temporally and coordinately stamped and stored for the rest of the current run. In some embodiments, temporally and coordinately stamped features are used for future runs. A residual network may use connections that allow direct feature access from the previous layer to optimize propagation. In some embodiments, a multipath architecture may allow for concurrent propagation. In some embodiments, bootstrap aggregating will process subsets of data in parallel, and final predictions go through a voting process or through a pruning mechanism. In some embodiments, a trained network may be used to increase the speed and accuracy of camera calibration. In some embodiments, a trained network may fully automate a calibration process.

Localizing an object is distinct and different from a robot localizing itself within the environment. The device that is localizing an external object may be stationary, may be a fixed (to the environment) robotic device (such as a robotic arm) or a mobile robot. Localizing an object in position space requires determining the angular distance between the robot's orientation and the object. The object itself may have an orientation. For example, if we consider the robot's current heading as frame of reference, and for simplicity ignore that the object may have an orientation, the object may be at an angle:

$$θ - tan \frac{- 1 {y}_{1} - {y}_{2}}{{x}_{1} - {x}_{2}}$$

wherein the robot has a (x₂, y₂) position on a plane and the object has a (x₁, y₁) position on the plane and the object may be at a distance:

$$\sqrt{{( {y}_{1} - {y}_{2} )}^{2} + {( {x}_{1} - {x}_{2} )}^{2}}$$

The angular distance and linear distance form a localization position space. Phase space localization adds a temporal dimension to position space and not only considers positions but also how the positions change temporally. In phase space localization, the orientation and heading of the object can not be simply ignored, as it plays a role in where the object will end up in the next time slot. Phase space localization builds on top of position space concepts that represent the pose of objects in various ways (i.e., origin points and orientation vectors within a frame of reference). The phase space localization of an object may use the center of mass, a volumetric central point or centroid, or a bounding box for localization. The bounding box may be 2D or 3D within a volume (prism or the like), or it could be a sphere. The orientation of the bounding box may determine its next pose. A phase space localization may be based on partial observability of the object, a dimension, or the state space. In some embodiments, hyperparameter values are set before the learning process of a network is initiated. In some embodiments, the structure of the network, hyperparameters, number of hidden units, epochs, etc., are refined to an optimal scenario where the learning rate is not too slow or too high, which may cause divergence. In some embodiments, weights are initialized as zero, close to zero, random, or picked from a provided range (randomly). In some embodiments, the neural net learns long-term dependencies, decides what to forget and what to remember by incorporating a recurrent structure, and applying updates to state values selectively.

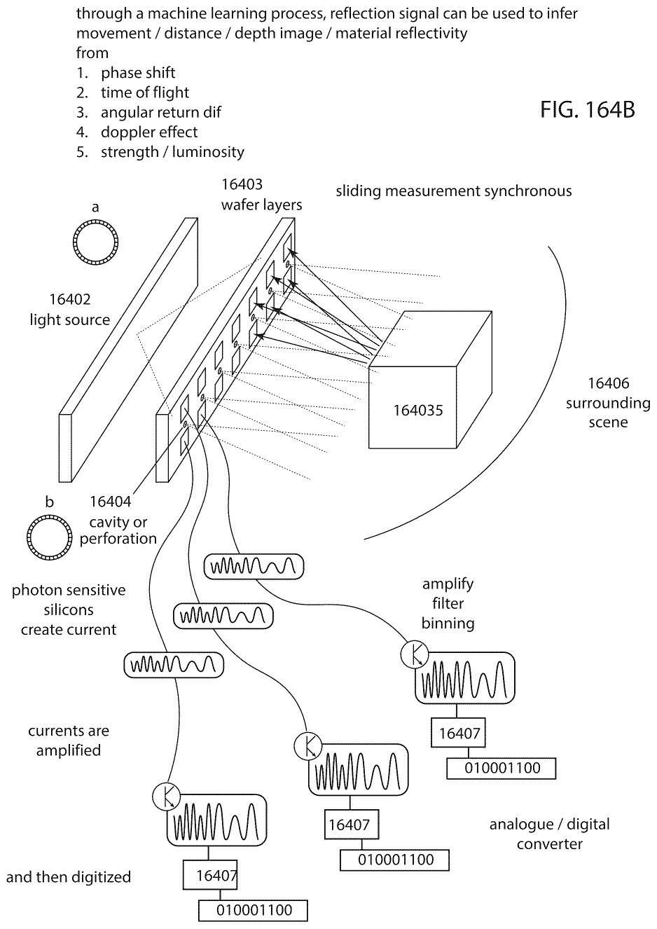

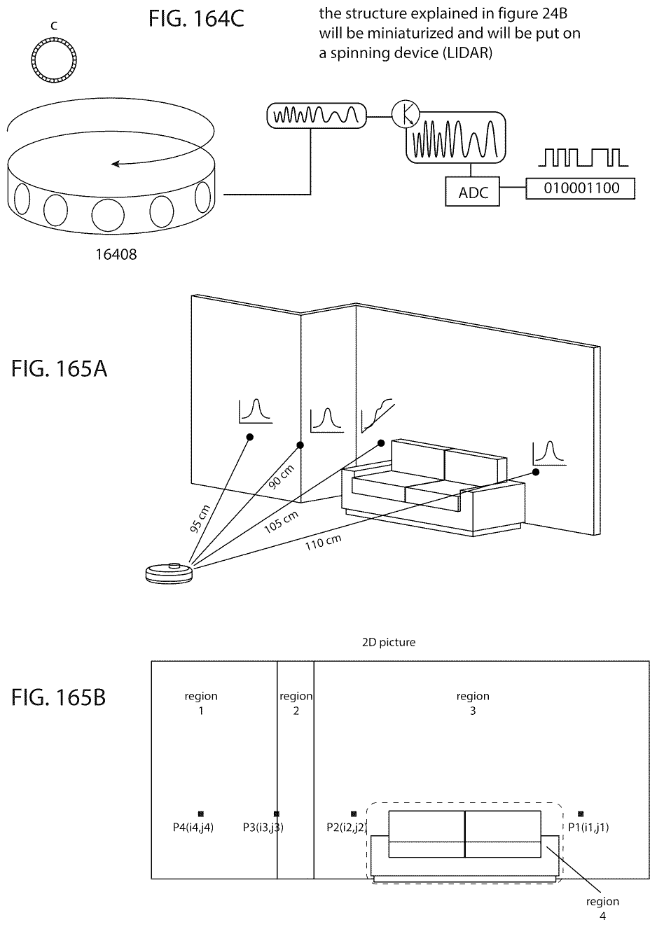

In some embodiments, FIG. 164A illustrates a light modulation control interface, including a plurality of AI-controlled adjustment knobs 16401 designated as (a), (b), and (c), wherein each is responsible for tuning distinct optical parameters associated with a photon's system. In some embodiments, knob (a) is configured to control parameters of light emission, including at least one of: 1. wavelength; 2. luminosity; 3. duration of pulses and time intervals between pulses; and 4. intensity metrics, such as peak intensity, total intensity, etc, which supports the transition between broad spectrum emissions and narrow spectrum or monochromatic light emissions. In some embodiments, knob (a) is configured to regulate characteristics of light emission, specifically controlling the wavelength of emitted light. In some embodiments, adjustment of knob (a) allows the system to shift between a wide wavelength spectrum (broader emission profile) and a narrow wavelength spectrum, resulting in a more monochromatic output. This modulation capability enables precise tuning of spectral properties for applications such as optical filtering, selective reflection, and enhanced contrast imaging. In some embodiments, knob (b) is configured to control optical sampling properties, including aperture size, temporal sampling rate, and acquisition mode (e.g., sliding window versus snapshot mode). Adjustments via knob (b) enable dynamic sampling and acquisition tailored to the environment or the application on the communication device. In some embodiments, knob (c) is configured to control the mechanical or rotational speed of a spinning optical component, which may influence scan rate, spatial coverage, or phase modulation. In some embodiments, FIG. 164B illustrates an optical sensing system that uses a modulated light source directed toward an object in a scene, with reflected signals processed through a machine learning pipeline to extract environment parameters. The system comprises a light source 16402 emitting radiation that passes through wafer layers 16403 including cavities or perforations 16404 to target an object 16405 or surrounding scene 16406. The reflected light is received by an array of photon-sensitive silicon elements, which generate electrical currents, wherein these currents are then amplified, optionally filtered and binned, and processed by analog-to-digital converters (ADCs) 16407. The digitalized output may be used for further analysis. Through machine learning or signal processing, the reflected signals may be analyzed to infer one or more environmental processing, such as: (1) phase shift; (2) time-of-flight; (3) angular return difference; (4) doppler effect; or (5) reflected signal strength luminosity. In some embodiments, the measurement process may be synchronized with the movement of a sliding stage or scanning mechanism, enabling spatially resolved depth or reflectivity imaging. In some embodiments, FIG. 164C illustrates an implementation of the sensing structure as described in FIG. 164B, wherein the system is miniaturized and integrated into a rotating platform for LiDAR based applications. The platform comprises a spinning device 16408, such as a disc, a drum, or a circular structure, onto which a plurality of optical sensing modules are mounted circumferentially.

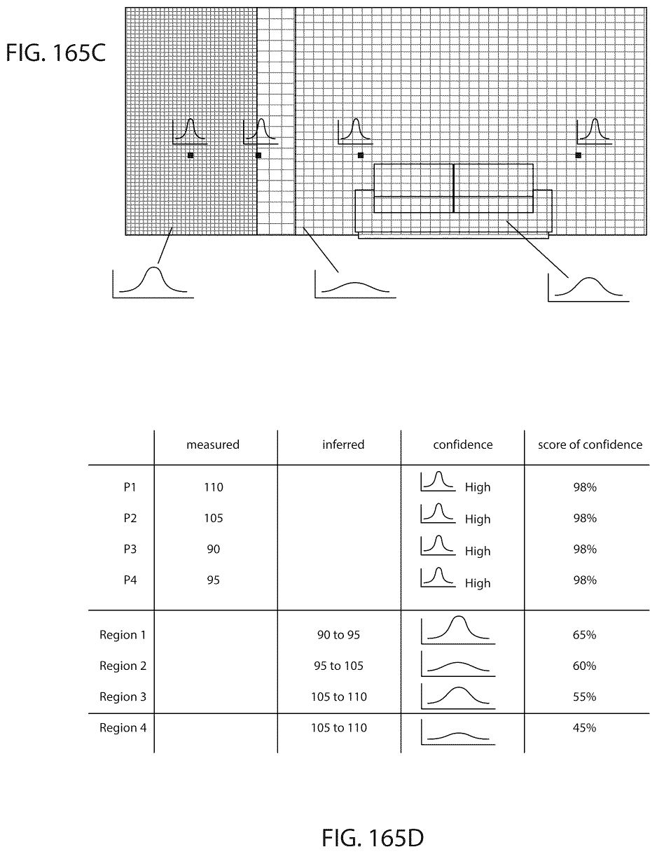

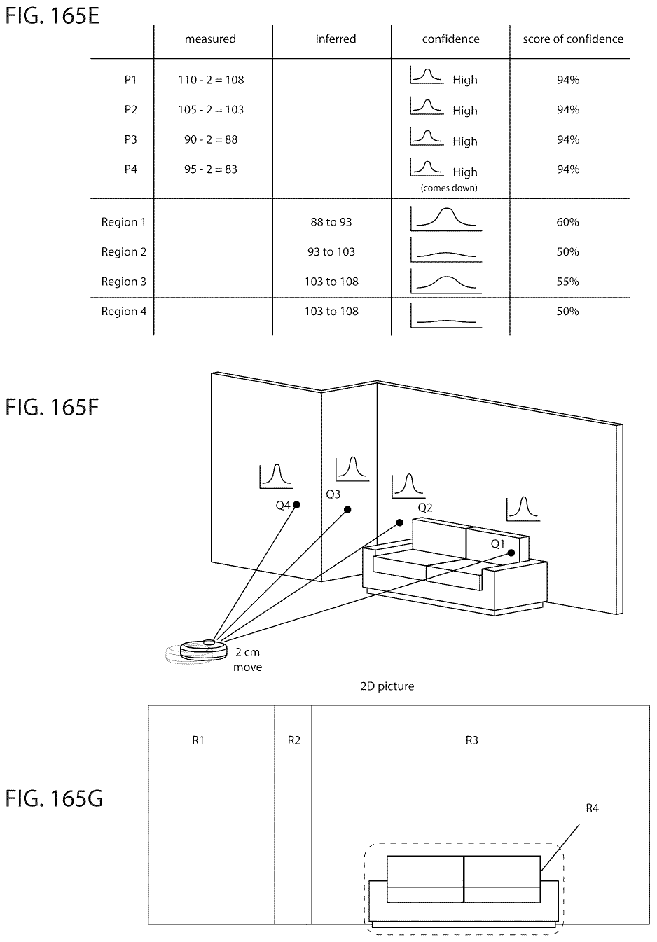

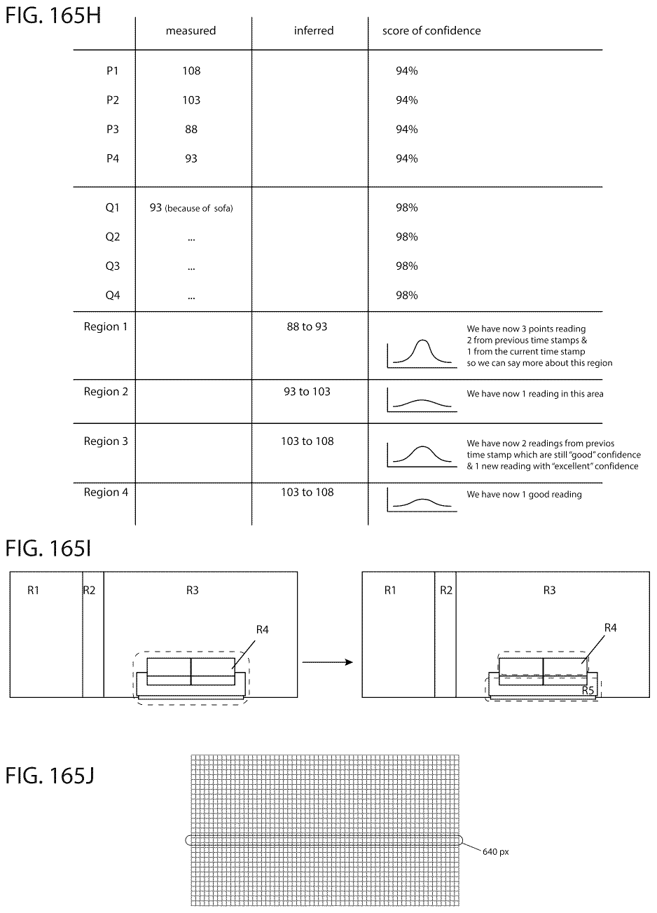

FIG. 165A illustrates a robotic sensing system that captures distance measurements at multiple vertical levels across surfaces within an environment. In some embodiments, a mobile robotic device may be equipped with one or more optical sensors (e.g., LiDAR, infrared, structured light emitters, etc.) configured to project and receive reflection data from various points across walls, furniture and structural features within the environment. The points of measurement may be recorded at varying heights (e.g., 90 cm, 95 cm, 105 cm, 110 cm), and the resulting data may be used to infer surface profiles or perimeter features, identify object contours, and distinguish between solid, soft, or open regions within the environment. In some embodiments, this approach enables the detection of stationary subjects. For instance, when lower-level distance measurements return shorter ranges than upper-level readings, the system may infer the presence of an object partially obstructing a wall of the environment, such as a piece of furniture, based on changes in depth across vertical scanned lines, which facilitates adaptive path planning or cleaning strategies. In another example, the system may detect vertically mounted objects, such as shelves, picture frames, or curtains, by comparing distance gradients across the top and middle portions of the wall. Significant deviations in the top-level readings relative to the lower zones may indicate protrusions or hanging elements, which can be classified as marked for annotation in a map of the environment. In some embodiments, the system may also identify semi-permanent or temporary obstacles, such as the presence of a small child or pet, by detecting recent changes in height-based readings at previously consistent locations. These dynamic obstructions may be flagged in real time, prompting the mobile robotic device to adjust its movement or delay further measurements until the space is clear. In some embodiments, the multi-height sensing system may also be applied to recognize doorways, openings, or alcoves. In some embodiments, the processor detects a door in the environment using at least some of the door detection methods described in U.S. Pat. Nos. 17/240,211, and U.S. Non-Provisional patents application Ser. Nos. 18/912,455, 17/240,211, 16/163,541, and 16/851,614, each of which is hereby incorporated by reference.

In some embodiments, gradual increases in measured depth at all height levels may indicate an open corridor or passage, allowing the system to extend its navigational domain accordingly. Similarly, minor inward deformation in vertical surfaces may reveal recessed structures, such as electrical sockets or wall-mounted control panels. In some embodiments, FIG. 165B illustrates a two-dimensional representation of an indoor scene that is segmented into a plurality of defined regions, designated as region 1, region 2, region 3, and region 4, wherein these corresponding regions correspond to spatial zones autonomously determined by the sensing system used to map, interpret, and analyze the surrounding environment. Each region may be associated with one or more measure points P(x,y), representing spatial coordinates at which distance, reflectivity, or intensity values have been acquired. These points may be captured using direct sensing (e.g., time-of-flight (ToF) or structured light) or inferred from prior measurements and model-based prediction. The measured data within each region may be stored and updated continuously, allowing the system to evaluate the reliability and coverage of the environment and the model of the environment. In some embodiments, the division of the environment into regions allows for localized interference, enabling independent decisions or determinations about occlusion, object presence, or navigability in each zone. For instance, region 1 may encompass a section of a wall with consistent sensor returns while region 4 may include part of a couch that blocked some original or consistent signals, which enables the system to identify not only individual measurements, but also the characteristics and confidence of broader environmental zones. In some embodiments, FIG. 165C illustrates a spatial sensing system that overlays discrete point measurements onto a pixel-based map, enabling the visualization of optical or distance data across a grid-like representation of the environment. The illustrated structure includes a two-dimensional matrix or spatial field, where each point (as illustrated in FIG. 25B) corresponds to a physical location from which data has been obtained by the mobile robotic device. Overlaid on select points are graphical data plots, such as waveform curves, which represent the signal return profile associated with those specific locations, which reflect the ToF return curves, intensity histograms, or data depending on the sensor modality used. The presence and shape of these waveforms enable the system to assess signal quality, noise characteristics, and the likelihood of surface boundaries or occlusion edges. In some embodiments, the grid shown in FIG. 165C is a pixel resolution approximation of a mapped environment, where each cell or pixel is updated based on data received from the measurements. The grid may be used to compute occupancy, surface continuity, or region uniformity based on spatial sampling density. The point markers serve as anchors for further inference steps, where measurements are aggregated by region (as defined in FIG. 165B) and analyzed for consistency, variance, or anomalous behavior. This layered representation supports the fusion of geometric data with statistical signal attributes, enabling more robust environmental modeling. For example, if the waveform profile at a given point shows weak or dispersed return signals, the system may lower the confidence level for that point or apply interpolation from adjacent high-confidence regions. On the other hand, strong and narrow waveforms may suggest clean surface reflections, high data reliability, and minimal occlusion. An optical system for creating a first point cloud and a second point cloud is disclosed herewith. The first point cloud is made out of signal strength lower than a threshold and the second point cloud out of signal strength fitting a strength threshold higher than a certain amount. The first point cloud reconstructing distances to perimeter points and the second point cloud reconstructing distance to closeby obstacles. A device to populate a point cloud by successively adding points while completing a spin, wherein, in subsequent spins, readings are interleaved with the previous readings. At time t₁, we have readings for 4 pixels P1, P2, P3 and P4 at locations (i₁,j₁), (i₂,j₂), (i₃,j₃) & (i₄,j₄) by 4 single photon avalanche diodes. Intuitive explanation P1 reads a distance of 110 cm to the far wall. P2 reads 105 cm (shorter distance) because it has seemingly made a more right angle with the wall. P3 reads 90 cm because the wall is closer. P4 reads 95 because it makes a wider angle with the wall as shown in FIGS. 165A-165C.

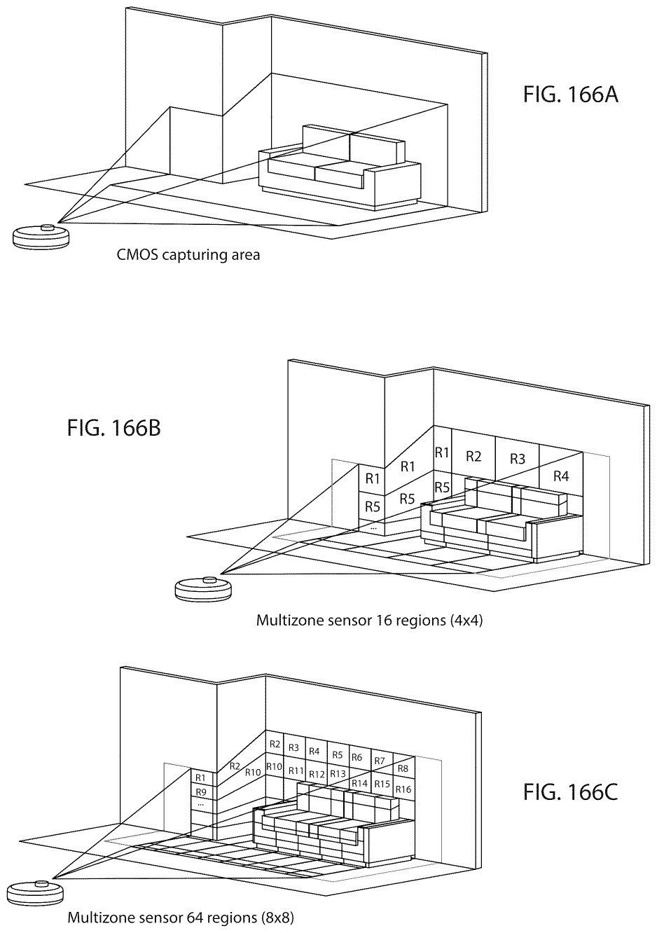

In some embodiments, FIG. 165D illustrates an assignment table, where each spatial region (as defined in FIG. 165B) is mapped to a corresponding confidence level derived from data points shown in FIG. 165C. The confidence table may include entries for regions, each associated with a computed confidence value ranging for low to high. Confidence levels may be calculated based on multiple parameters, including but not limited to, the number of data points with a region, signal strength, waveform sharpness, measurement variance, and temporal stability across multiple scanning passes. For instance, a region with dense, high intensity returns and narrow wave form profiles may be assigned a ‘High’ confidence score, whereas a region with sparse data, low reflectivity, or inconsistent measurements may receive a ‘Low’ or ‘Medium’ score. In some embodiments, the confidence values are used as inputs to downstream interference logic. In some embodiments, the system may prioritize navigation, object detection or identification, or other further measurement updates in low-confidence regions while deprioritizing high-confidence areas unless change is detected. In some embodiments, the confidence table may be stored in a memory and be updated iteratively as new data becomes available. It serves as an intermediate abstraction between raw sensor data (as shown in FIG. 165C) and higher-level environmental inference or decision-making modules. FIG. 165E presents a post-processing inference table that refines the results from raw measurement data by applying correction factors and re-evaluating confidence scores associated with each point and region. The top half of the table illustrates adjusted point measurements, wherein each original value, denoted under the ‘measured’ column, is corrected by subtracting a fixed bias (in this instance, 2 units), resulting in a recalculated inferred value. This correction may be applied to account for known systemic offsets, calibration shifts, or environmental noise. Each measurement point, P1 to P4, is evaluated not only by its inferred value but also by its signal waveform profile, labeled under the ‘confidence’ column with descriptors such as ‘high’ and accompanied by graphical waveforms. These profiles reflect return signal clarity, consistency, and shape (e.g., narrow vs. wide), which are critical in assessing the reliability of sensor data. Despite correction, the individual point confidence levels remain high (as in this case, 94%) across all entries, although a slight decrease in signal strength is noted for P4. The lower half of the table summarizes the religion-based interference, where cumulative data from multiple points within Regions 1-4 is used to estimate the corresponding range of inferred distances. For example, region 1 is inferred to span from 88093, likely derived from P3 and P4. Alongside inferred ranges, each region is assigned a graphical confidence profile and quantitative confidence score (in this case, 60%, 50%, and 55%), reflecting the statistical or probabilistic reliability of the inference. In some embodiments, the corrected data in FIG. 165E serves as an intermediate step for updating environmental models, performing region fusion, or driving decision making. In some embodiments, FIG. 165F shows a repeated measurement cycle with a slight movement of the robotic device (e.g., 2 cm forward), allowing additional data points (Q1-Q4) to be gathered from new angles or positions. These points enhance the precision of region inference. In some embodiments, FIG. 165G updates the region-based segmentation using new potential references (R1-R4). For example, the inclusion of R4 around a piece of furniture supports refinement of occluded areas. FIG. 165H presents a table of new and prior measurements (P1-P4, Q1-Q4) and their associated inferred values. Region-level confidence is updated by aggregating readings from multiple time stamps. For instance, Region 1 includes three-point readings, improving inference certainty. In some embodiments, FIG. 165J presents a high-resolution pixel map of the environment, showing a 640-pixel wide array used to spatially distribute and visualize sensor confidence, allowing the robotic system to adaptively focus on areas with low certainty or high variability. In some embodiments, at time t₁, we have high confidence level readings for P1, P2, P3, and P4. It was indicated before that, based on color shades, we make assumptions about depth. In some embodiments, the information presented in FIG. 165C and FIG. 165D, which shows that Region 4 does not have a direct measurement, but because it is between two measurements from Region 3, we assign the same range with lower confidence. As the robot moves and measures a 2 cm movement using its other sensors (IMU, odometer, OTS, etc.), the table in FIG. 165D will be updated to FIG. 165E. At time t₂, we take measurements for four other pixels, other than P1, P2, P3 and P4, which are represented by Q₁, Q₂, Q₃, and Q₄, as shown in FIG. 165F and FIG. 165G. At time t₂, while we still have good measurements for P1, P2, P3, and P4, which provide some information about R3 and R1, we gain information about Q₁, Q₂, Q₃, and Q₄ with high confidence, which also gives us more data about R4 and R2 that we did not have before. The table will then be updated to FIG. 165H. As time passes and more data points are collected, we can make the area separation more granular. For example, in t1 and t2, we consider the sofa as one color depth region, but now in t3, we can divide it into five regions, and so on, as shown in FIG. 165I. Take, for example, a single photon avalanche diode that takes 50 readings per second, and we have four of them, along with a 640×480 resolution camera. In some embodiments, for the sake of argument, we only care about the width array. We have 640 pixels to find depth for, and each second, we can collect 200 accurate data points (assuming the motion of the robot is ideally arranged to fill the horizontal array with data points, which is not always the case, but often sufficient for approximations), as shown in FIG. 165J. Alternatively, we can combine the CMOS with multi-zone depth sensors. In some embodiments, this would allow for multiple regions to provide readings (16, 64, depending on the sensor's resolution) on each time step, as illustrated in FIGS. 166A-166C. Examples of depth perceiving devices that may be used to measure depth or collect data from which depth to object surfaces may be inferred are described in U.S. patent application Ser. Nos. 15/243,783, 15/954,335, 15/954,410, 15/257,798, 15/674,310, 15/224,442, and 15/683,255, the entire contents of which are hereby incorporated by reference.

In some embodiments, if a power outage occurs, the IR signals from the dock turn off, and the robot will look for the station. To prevent this, we can place a magnet on the station and a Hall effect sensor on the robot, so the robot knows it is docked properly. In some embodiments, self-cleaning systems may use water, steam, UV, heat, ventilation, spray, H₂O₂, or silver ions. A fluid dispensing system delivers clean fluid from a removable cleaning fluid supply tank, while a waste fluid recovery system with a suction nozzle delivers waste fluid to a recovery fluid tank, extracting dirt and debris from the mop attachment. In some embodiments, a robot may minimize its navigation path by avoiding repetition of old paths. This can be achieved by recognizing previously traversed areas and adjusting its path planning accordingly. For example, when a “hot obstacle” or “hot pin” is dropped into the environment, the robot can detect this new obstacle and adjust its path accordingly in real-time, avoiding unnecessary detours while still respecting its mission. This approach also applies to scenarios where the robot needs to adapt dynamically to changes in the environment, such as encountering a new obstacle or obstruction. Further details of a fluid control mechanism for mopping are provided in U.S. patent application Ser. Nos. 15/673,176 and 16/058,026, the entire contents of which are hereby incorporated by reference.

In some cases, real-time room discovery and re-localization are essential to ensure that the robot can adapt to new environments or areas that were previously unknown. The robot may use its sensors and algorithms to continuously discover new areas, update its map, and relocate itself within the map to ensure effective navigation, even in the presence of newly discovered rooms or areas. Additionally, if the robot's LiDAR is temporarily blocked or partially obstructed, it must be able to handle the situation gracefully. In some embodiments, the robot may switch to alternative sensors (e.g., cameras, ultrasonic sensors) or methods (e.g., dead reckoning, vision-based navigation) to continue its task. The robot could also track its own location in a relative manner, adjusting its behavior based on partial data and using a combination of sensing modalities to fill in the gaps where LiDAR data is missing. In some embodiments, the robot does not need to start from the same pose to load a previously generated map. The robot may be able to load or update its map based on new sensor data without requiring an exact starting location. For example, as long as the robot can identify key landmarks, use its sensors effectively, and perform relocalization, it can seamlessly integrate new information into the existing map without needing to restart its task from a fixed pose. Similarly, the robot may not need to start from the same location to honor a virtual boundary. As long as the robot has access to the necessary map data, it can continue to respect and enforce virtual boundaries dynamically, even when returning to a previously mapped environment after a period of time or after changing its location. This allows for flexible navigation and task execution while ensuring that the robot adheres to constraints, such as virtual boundaries, which can be defined based on specific tasks, user preferences, or environmental factors.

In some embodiments, FIGS. 166A-166C illustrate the evolution of scene segmentation and spatial density in a vision-based environmental sensing, deployed by a mobile robotic device. FIG. 166A shows a basic sensing implementation, with at least a sensor on the mobile robotic device, wherein one of the sensors is a Complementary Metal-Oxide-Semiconductor (CMOS) sensor that captures a single, continuous visual or depth field, covering a target scene. In some embodiments, the entire scene is treated as a single uniform detection zone. This configuration may suffice for coarse environmental detection, simple obstacle avoidance, or low resolution mapping applications. In some embodiments, FIG. 166B depicts an upgraded configuration utilizing a multisensor sensor with 16 regions (4×4). The previously uniform scene is now segmented into a grid labeled subregions (e.g., R1, R2, R3, R4, R5, etc.), allowing for finer detection granularity. Each region can be individually analyzed for signal strength, return time, object presence, or classification features. In some embodiments, this configuration enables localized inference and confidence assignment, improving obstacle detection near complex objects, such as furniture or irregular room layouts. In some embodiments, FIG. 26C demonstrates a further refinement of spatial resolution, wherein the sensing system employs a multizone sensor array divided into 64 regions (8×8). In some embodiments, this high-resolution grid allows for further detailed environmental modeling, object shape profiling, and advanced features mapping. Each subregion (e,g. R1 through R64, partially shown as R1-R16) provides independent feedback to the system, enabling depth-aware segmentation, object contour or edge detection, and predictive occlusion compensation. Mapping methods that may be used are further described in the U.S. patent application Ser. Nos. 16/048,179, 16/048,185, 16/163,541, 16/163,562, 16/163,508, and 16/185,000, the entire contents of which are hereby incorporated by reference, may be used in generating a spatial representation of the surroundings.

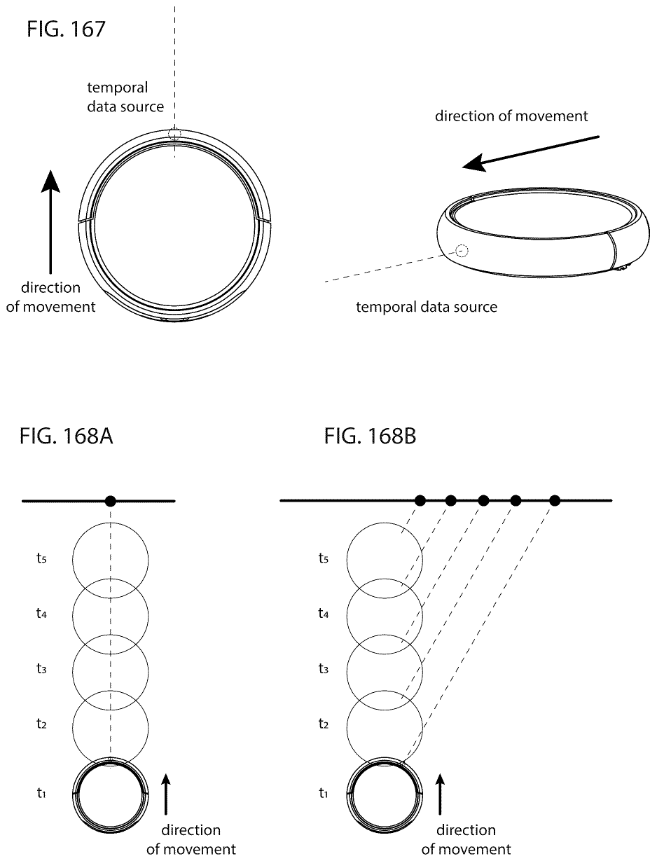

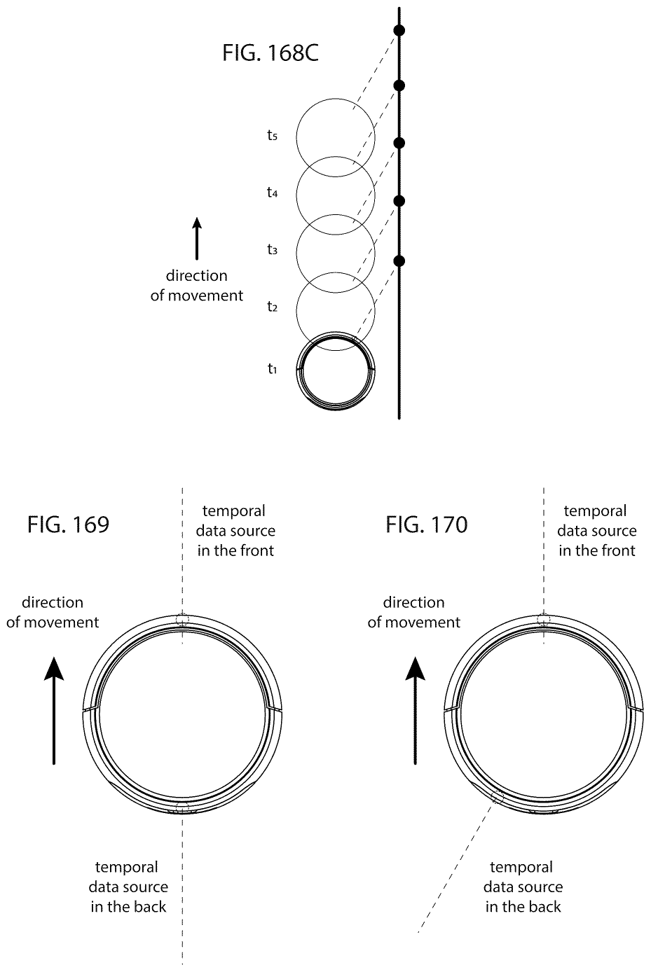

FIG. 167 illustrates a perspective and top view of a robot, in this case, a robotic vacuum cleaner, wherein a temporal data source is placed in front of the robot and aligned with a direction of movement. In some embodiments, a sensor placement helps capture data that corresponds directly to the robot's movement, ensuring that the robot collects relevant temporal information for precise navigation and environmental mapping. In some embodiments, FIG. 168A demonstrates how the sensor captures only one point when the robot is moving perpendicular to the wall, with the sensor aligned with the direction of movement. For example, the sensor's narrow focus restricts the robot's ability to gather surrounding data, capturing only one point that represents the immediate surroundings in the direction of movement at different time points (t₁, t₂, t₃, t₄, and t₅). In some embodiments, this configuration may be used in situations where minimal data collection is needed. In some embodiments, FIG. 168B shows how the sensor captures more points when it is placed at an angle in relation to the robot's movement. In some embodiments, by angling the sensor, the robot's field of view is expanded, allowing the sensor to capture more points from the surrounding environment at different time zones (t₁, t₂, t₃, t₄, and t₅). For example, this setup enables the robot to gain a broader perspective, which can be particularly useful for tasks that require more comprehensive environmental awareness, such as path planning in unknown spaces. In some embodiments, FIG. 168C demonstrates how the sensor captures more points from the surrounding walls when placed in an angled position. In some embodiments, this setup is ideal for environments where lateral obstacles are significant, as it allows the robot to capture data from the sides. For example, if the robot is navigating a hallway, the angled sensor can provide additional information about the walls on the side, improving the robot's ability to navigate confined spaces or avoid obstacles.

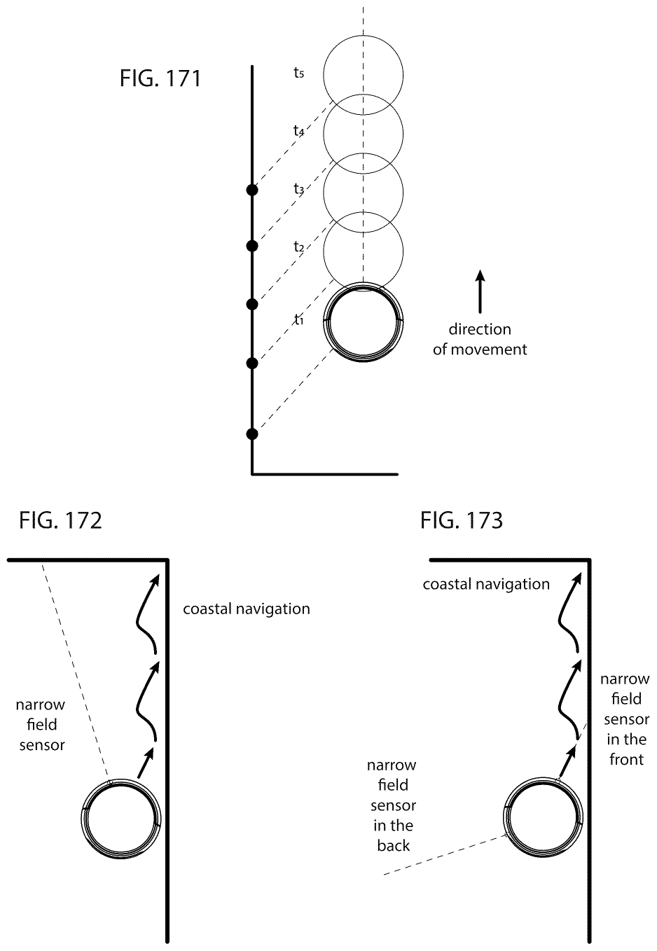

In some embodiments, FIG. 169 illustrates a top view of a robot equipped with two temporal data sources, one placed in front of the robot and another at a rear side of the robot. In some embodiments, these sensors are aligned with the robot's direction of movement, capturing opposite optical flow. For example, the front sensor captures data from obstacles ahead, while the rear sensor captures data from objects behind the robot, allowing for better situational awareness and improved navigation in both directions. In some embodiments, FIG. 170 shows a similar configuration as FIG. 169, but with the rear sensor placed slightly to the left and angled relative to the movement of the robot. In some embodiments, this modification allows the rear sensor to capture more data from the side of the robot, which can be useful for detecting lateral obstacles or monitoring changes in the environment outside the robot's immediate forward path. For example, this could be used in autonomous vehicles to monitor traffic from the side of the vehicle as it moves forward. FIG. 171 further illustrates how the rear sensor captures more data from surrounding walls when it is placed at an angle as the robot moves at different time points. In some embodiments, the angled sensor captures points from the wall on the side, increasing the robot's ability to gather spatial data from areas that would otherwise be outside of the primary field of view. For example, this configuration is particularly useful when navigating in narrow or complex environments where both front and side data are essential.

In some embodiments, FIG. 172 shows a robot performing coastal navigation equipped with a single sensor placed slightly to the left and angled compared to the robot's direction of movement. In some embodiments, this configuration is beneficial in wide open areas where the robot needs to monitor both forward motion and lateral surroundings simultaneously. For example, the robot may be used to map coastlines, where it needs to track changes in both the front and sides while moving along the shoreline. In some embodiments, FIG. 173 shows the same coastal navigation scenario, but now the robot is equipped with two sensors, one placed in the middle of the robot and aligned with its direction of movement, and the other slightly to the left and angled relative to the movement direction. In some embodiments, this setup provides even greater data collection capabilities, capturing information from both the front and the sides, enhancing the ability of the robot to adapt to the environment dynamically. For example, this could be used for robots that map both the coastline and the surrounding environment, collecting data from different perspectives to create a more comprehensive map.

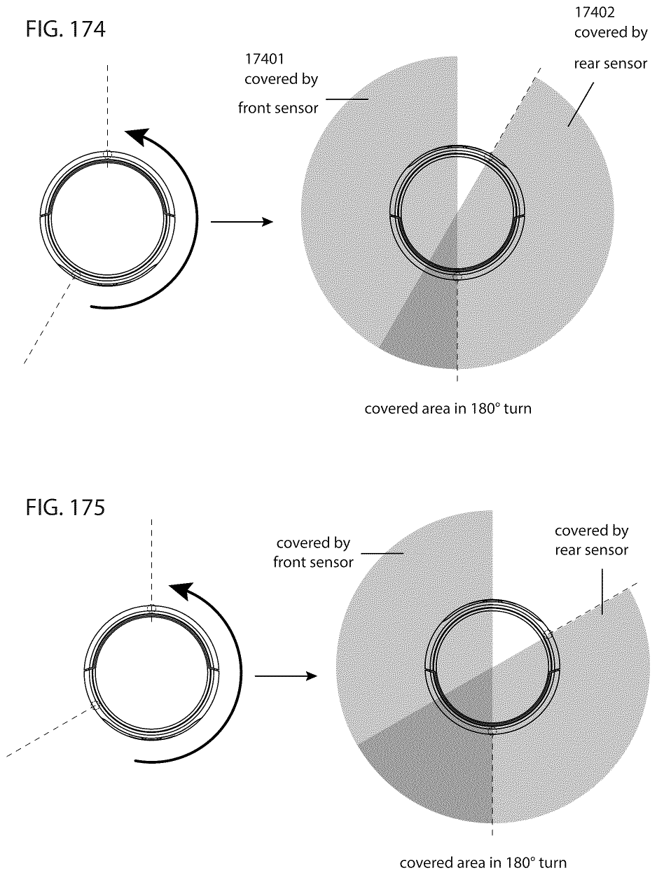

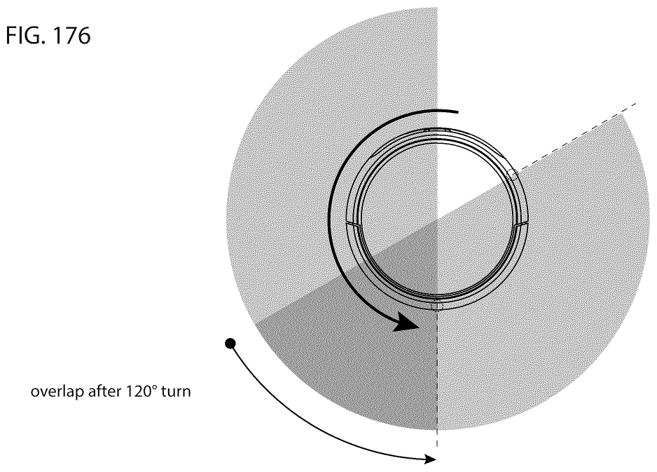

FIG. 174 illustrates a robot with two temporal data sources, one placed in front and one placed at the rear, where the rear sensor is off-center and angled 30 degrees from the robot's direction of movement. In some embodiments, when the robot turns 180 degrees in coverage mode, the sensors collectively scan 330 degrees of the surroundings out of 360 degrees, showing the covered area by the front sensor 17401 and the covered area by the rear sensor 17402. For example, this coverage is ideal for tasks that require the robot to maintain awareness of its entire environment, such as in security surveillance or search and rescue operations. FIG. 175 shows a similar setup to FIG. 174, but with the rear sensor angled 60 degrees from the robot's direction of movement. In some embodiments, the sensors can scan 300 degrees of the surrounding environment during a 180-degree turn. For example, this configuration may be used in applications where slightly less coverage is sufficient but still provides a broad view of the surroundings. FIG. 176 further demonstrates how the rear sensor, angled 30 degrees, captures more data as the robot begins to turn counterclockwise. In some embodiments, after completing 120 degrees of rotation, the readings from the front and rear sensors overlap, allowing for an iterative closest point (ICP) equation to be solved. For example, this overlap is critical for environments where precise localization is required, enabling the robot to integrate data from both sensors to correct its position and continue its task efficiently. In some embodiments, the relation between components forms a service-client relationship. In one example, a cloud service may store and save all previous mapping information and localizations of a robot as history. This history may be provided as a service to clients (e.g., similar to history stored by a web browser), wherein a person may search for data from a specific work session of the robot. In some embodiments, the history may be sent to an application that sorts, organizes and/or analyzes the data. In some embodiments, a data mining client may collect data from the histories of multiple robots (e.g., 100, 1000, 300000, or all robots) over periods of time to deduce large-scale patterns or reasoning. For example, traffic data associated with a particular location, historic number of robot accidents, historic battery use, etc., may be aggregated and used to improve performance of robots. In embodiments, all data aggregate may not be on a physical server and may be geographically spread out. There may be multiple services that are available to multiple clients. In some embodiments, clients may, in part, provide services to other clients and vice versa. In some embodiments, a service provider to one client may itself be a client of one or more services. In some embodiments, the geographic spread of data may be controlled to be limited at a city level, state level, country level, or a country group level to comply with regulations of storing data, preferences of users for privacy reasons, and the like. For example, a user may select through a user interface on the smart gym or an application of a smartphone, that no data is stored, data is stored locally on the smart gym equipment, on servers inside a State, on servers within a country. Limitations and benefits of each selection may be described to the user in the user interface, on the application of the smartphone, or on the web. In some embodiments, the historical data may be stored on a physical memory stick owned by the user, which the user may insert into the smart gym equipment when using the system. In some embodiments, the historical data may be stored on the preferred data storage cloud of the user. For example, the user may choose not to allow the data to be stored on the cloud owned by the company that runs the smart gym equipment but instead, wants the data to be stored by the cloud that the user has a subscription to. The cloud that the user has a subscription to may be a storage cloud from a third-party company or a storage cloud provided by the company that operates or provides services for the smartphone that the user owns or leases.

Some embodiments may use a Microcontroller Unit (MCU) (e.g., SAM70S MC) including built-in 300 MHz clock, 8 MB Random Access Memory (RAM), and 2 MB flash memory. In some embodiments, the internal flash memory may be split into two or more blocks. For example, a lower block may be used as default storage for program code and constant data. In some embodiments, the static RAM (SRAM) may be split into two or more blocks. Some embodiments may use an MCU with part number MIMXRT1041DFP6B, MIMXRT1052, MIMXRT1172DVMAA, and the like from NXP semiconductors. In some embodiments, 16, 32, 64, 128 MB Random Access Memory (RAM) and more may be used according to the specific requirements and functions that are run on MCU. In some embodiments, 2 MB flash memory, 4 MB Flash, 8 MB flash memory may be available onboard a monolithic chip which may be used for storing the executable code, voice files, and other data. In some embodiments, additional external flash memory may be coupled with the processor to store executable code or other data. Each task is scheduled to run on the MCU. Information is received from sensors and is used in real time by AI algorithms. Due to the real-time nature of exercise, actuation decisions of the smart gym equipment must be real-time without any buffer delays that are common on CPU based processing models that run computations in parallel with the objective of maximizing throughput.

For an instantaneous discrimination of objects against surroundings, in a preferred embodiment, a flash of wide beam, such as a spotlight or broad beam light from vertical cavity surface emitting lasers, is emitted for being captured by an array of pixels on a single photon avalanche semiconductor, creating an effect of close objects standing out from the background which discriminates an obstacle. A vertical cavity surface emitting laser is preferred over prior state-of-the-art edge-emitting semiconductors because of its ability to provide a more precise illumination, beam quality combined with less amount of energy usage, enabling a more compact form factor given that the semiconductor in a vertical cavity surface emitting laser semiconductor emits light from a cavity on the top surface of the semiconductor wafer. In some embodiments, a second vertical cavity surface emitting laser is positioned at a proximity of the first one, the first one utilized for a snapshot discrimination of objects against surroundings with broad beam lighting, pulsed lighting, spot lighting, and the second one for additional information regarding the environment such as depth readings from a plurality of points of the environment, whereas the second vertical cavity surface emitting laser is configured to create a distinct illumination pattern (such as grid of points or a stripes of lines) which triggers a targeted avalanche on pixels of the coupled diode outputting depth readings in a number of points in the environment. Triggering targeted avalanche on specific pixels with a geometrically coupled vertical surface emitting laser projecting a grid pattern of point lights, enhances a discrimination of an object from the background by allowing to determine the distance, shape, detailed surface characteristics such as texture, contours, edges, and further allowing to determine the nature of the object which leads to improving its spatial awareness and navigation capabilities such as precisely and softly grasping an object with a pincer or claw attached to a robotic arm.

In some embodiments, the wavelength emissions of vertical cavity surface emitting lasers range from 750 nm to 980 nm. In some embodiments, multiple diodes may be utilized, each with a range of emission that is different than the other diode, while they are all within the range of photon sensitivity of the photon avalanche array imager. In some embodiments a diode may be time multiplexed with other diodes that are coupled with the photon avalanche array such that an orchestrated activation of one or more vertical cavity surface emitting lasers at specific time slots, stimulates an anticipated avalanche of electron releases in specific pixels of the photon avalanche array, wherein the resulting currents are fed into a neural net engine for filtering, curing aliasing, and outputting. In some embodiments, the perception of a robot system may include multiple pairs of vertical surface cavity laser diodes coupled with single photon avalanche diodes. In some embodiments, a pair is positioned in the front of the robot and a pair is positioned in the rear of the robot to create a field of view and an optical flow in opposite directions. A forward looking optical flow subtracted from a rear looking optical flow may be utilized to infer the speed of objects moving in the environment in respect to the stationary background environment. It can further be utilized to infer depth values from 2D images.

In some embodiments, the vertical cavity surface emitting lasers are paired with a depth imager and an RGB and grey scale imager separately or implemented monolithically. A monolithic Complementary Metal-Oxide-Semiconductor CMOS chip may incorporate both image sensing and depth sensing with different resolutions. In some embodiments, two separate monolithic Complementary Metal-Oxide-Semiconductor CMOS chips may be utilized, each positioned at a geometrically ideal distance from one another, and from the one or more vertical surface cavity diodes.

In some embodiments, efficiency of a semiconductor laser is improved for maximal power conversion, wherein in a vertical cavity surface emitting laser, multiple junction cascading may be used to allow maximizing the overall duty cycle of emission, which in turn allows lower power at peak. An overall duty cycle is given by multiplying the burst duty cycle by the pulse duty cycle and multiplying the result by the result obtained from multiplication of burst number by burst period divided by frame length. To elaborate, a number of bursts that are configured to occur in a frame length (a fixed time period) is referred to as a burst number, wherein in each burst, the burst width is the duration in milliseconds that a series of nano second pules are emitted and burst period is the sum of the period in which nano second pulses are sent and a quiet duration when no pulses are sent. A burst duty cycle is given from division of a burst width by the burst period, and the pulse duty cycle is given by division of pulse width by pulse period. In some embodiments, with a burst duty cycle of 50 percent, with a burst width of 0.4 ms (within a burst period of 0.8 ms), 4 pulses are emitted, a pulse lasting for 6 ns with a pulse period of 18 seconds, with a pulse duty cycle of 33 percent. In one example of an implementation with these parameters, the triple vertical surface cavity laser array has an 8 watt high peak power operating at 940 nm. In other embodiments, the high peak power is 10, 12 watts. In some embodiments, a pulse may last for 12 ns with a pulse period of 36-40 ns, with a pulse duty cycle of 33%. Other examples may be pulse for 10 or 9 nanoseconds, with pulse period of 30 or 27 nanoseconds. In some embodiments, the die sheet has a height of 80 to 120 micrometers, and a width and length of between 600 and 1200 micrometers. In some embodiments, two layers of tunnel n+/p+ junctions are sandwiched by 3 layers of active (p-i-n) junctions. In a multi-micro cavity silicon, high reflectivity mirrors formed by distributed Bragg filters or reflectors are grown at the bottom, top, or side of the silicon in order to increase a round-trip gain to balance the reduction of round-trip gain as the result of the reduction of the size of the cavity.

In some embodiments, N-type distributed Bragg Reflectors are layered at the bottom of the silicon, and P-type distributed Bragg Reflectors are layered on top, with a series of oxide layers and tunnel junction pairs in the middle, each pair sandwiching a layer where the quantum well effect occurs. In some embodiments, derivatives and variations of cavity surface emitting lasers, such as topological cavity surface emitting lasers and antireflective vertical cavity surface emitting lasers, may be utilized. In some embodiments, a modulating driver may be integrated onto the semiconductor laser to create a monolithic electronic component. In other embodiments, the modulating driver may be a separate monolithic chip with a footprint of 1-2 millimeters of width and length, which are typically coupled with the semiconductor component on a printed circuit board, providing a modulation frequency of 100 to 300 MHz.

In some embodiments, processing of depth values are embedded in the chip. In other embodiments, the raw values are processed to present depth values. In both of the circumstances, for depriving spatial interpretations from depth values, further processing by a simultaneous localization and mapping method is required. It is an objective of QSLAM to perform the computing close hardware in order for the output to be presented from a compact sensor module. In our trademarked QSLAM implementation, processing of the depth values to present data to be used for navigational purposes, or presented for a visual render, may have multiple sources with multiple levels of confidence. For example, two illumination sources may be coupled with the photon sensitive semiconductor, each with different illumination patterns. In one embodiment, a first and a second illumination may be a modulated LED light, and a laser emitted diode. In other embodiments, both may be LED or Laser diodes. In another embodiment, the first illumination may be stripes of light, and the second illumination may be broad beam illumination. In some embodiments, the illumination from two sources may be time multiplexed. In some embodiments, a first illumination may be a pulsed broad beam illumination, and a second illumination may be a laser grid point. In some embodiments, the broad beam illumination may illuminate a wider field of view or have a higher height of illumination with a wider vertical field of view. As such, depending on the field of view of a photon-sensitive semiconductor, all or some of its field of view may be illuminated. For example, a semiconductor with pixel array of 240 columns, 180 rows, with 43K resolution when illuminated with with grids spots with a vertical view of 12 degrees, and horizontal field of view of 100 degrees, with illuminating spot grids organized 6 rows of with 100 equally spaced horizontal spots (1 degree each), and the rows 2 degrees of vertical angle in between, produces 600 spots of depth resolution which is a subset of the 43k resolution that the pixel array provides. A low density grid illumination provides higher confidence readings for a lower number of measurement points. To overcome that, an additional illumination source may produce 43K dense points in a field of view of 45 degrees vertical, and 100 degrees horizontal with a lower confidence for each measurement. Other embodiments may utilize a powerful short pulse of broad beam or wide beam illumination that is not organized in a grid format, which would create an approximate depth map. In such embodiments, there may be no need for RGB processing, which addresses privacy concerns.

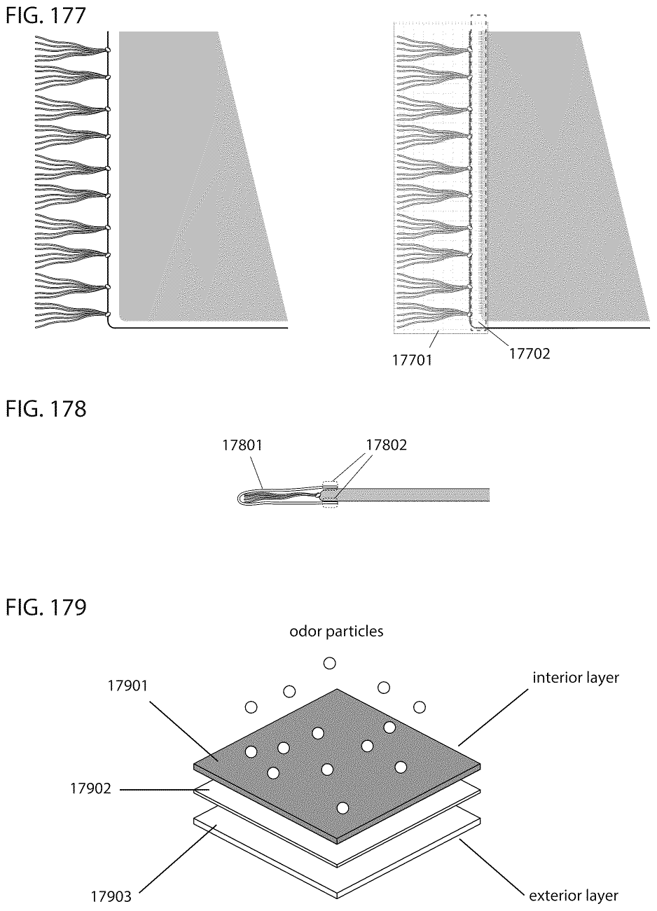

FIG. 177 illustrates carpet fringes covered by fringe protector tape. To protect carpet and area rug fringes 17701 from getting tangled in robot vacuum brushes, fringe protector tape 17702 can be applied to the fringe section of the carpet or area rug as shown in FIG. 177. In some embodiments, the fringe protector tape is a mesh or clear vinyl stripe that goes under and over the fringe, creating a smooth protective layer wherein the edges of the fringe protector tape are adhesive and stick to the back and top of the carpet in the fringe area, as illustrated in FIG. 178. FIG. 178 further illustrates a side view of the fringe 17802 protector around carpet fringes 17801. The tape holds the fringe flat in a way that reduces tangling and snagging, and allows the fringe to be somewhat visible due to the mesh or clear material that it is made out of.

FIG. 179 illustrates a 3-layer fabric consisting of non-woven fabric, melt-blown fiber, and activated carbon cloth for odor filtering vacuum cleaner dust bags. Activated carbon cloth is a unique form of activated carbon that is processed into a textile structure. It possesses several key characteristics that make it highly effective for various applications, particularly adsorption and filtration. Several techniques can be used to bond the activated carbon cloth to the inner surface of the dust bag material, including laminating, thermal bonding, using adhesive, and stitching. Thermal bonding is a common method for joining activated carbon cloth to other fabrics, utilizing heat and pressure to create a strong adhesive bond. This method is particularly effective for bonding activated carbon cloth to polyester fabrics or other heat-stable materials. The process typically involves placing the activated carbon cloth and the other fabric together, applying heat and pressure, and allowing the materials to bond. The specific temperature and pressure required depend on the materials involved and the desired bond strength. In some embodiments, activated carbon cloth 17901 can be bonded to various fabrics or areas with adhesive 17902, including non-woven fabrics 17903, polyester, Polypropylene and other materials used to make vacuum dust bags as shown in FIG. 179. FIG. 179 further illustrates that in some embodiments, an intermediary layer of melt-blown non-woven fabric 17903 is used for extra filtration. Melt-blown fabric is a type of non-woven fabric created by a process where melted polymer is forced through small nozzles and blown into fine fibers by high-velocity hot air. These fibers then form a random web, creating a material with small pores and a unique structure suitable for filtration.

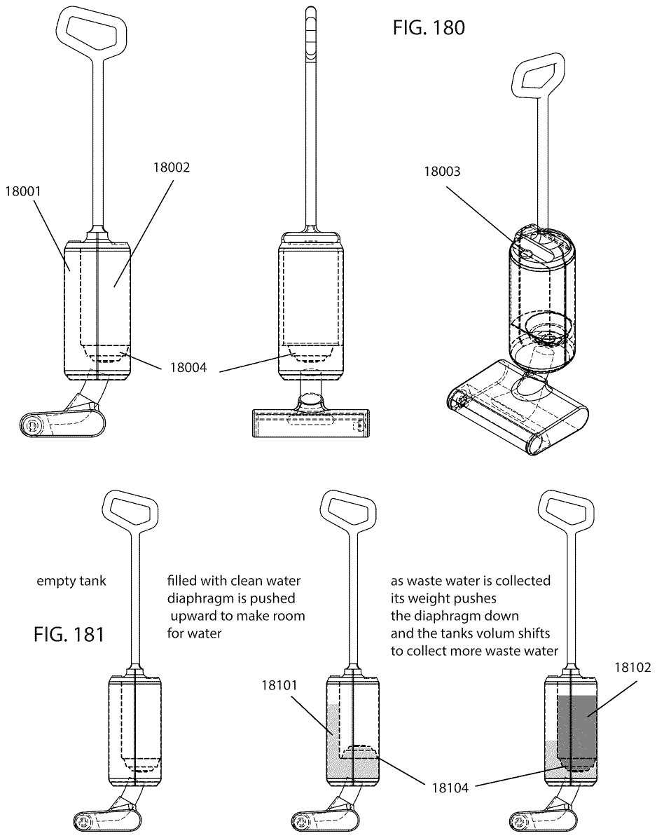

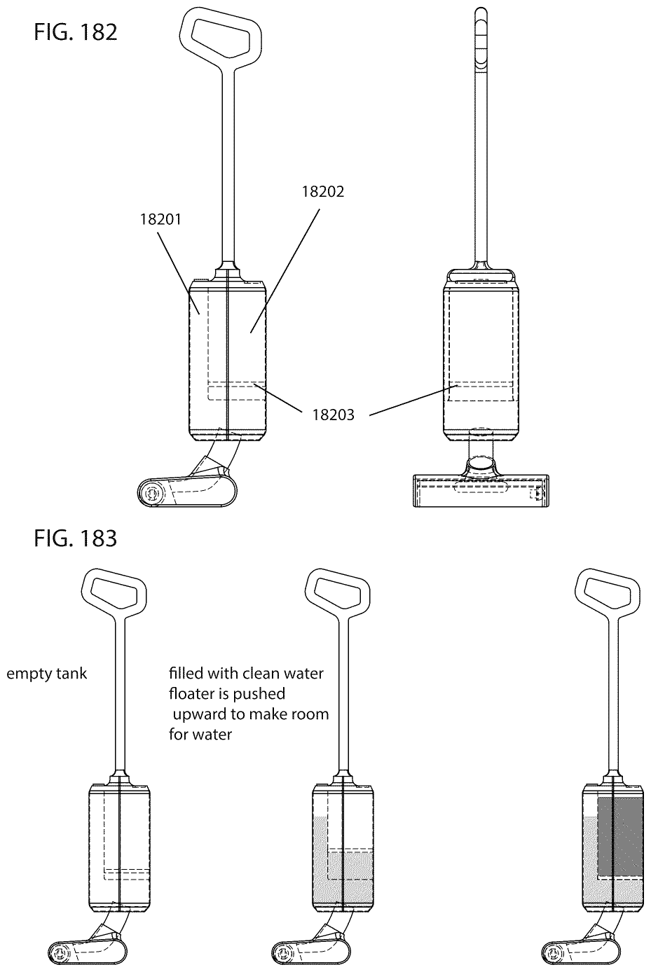

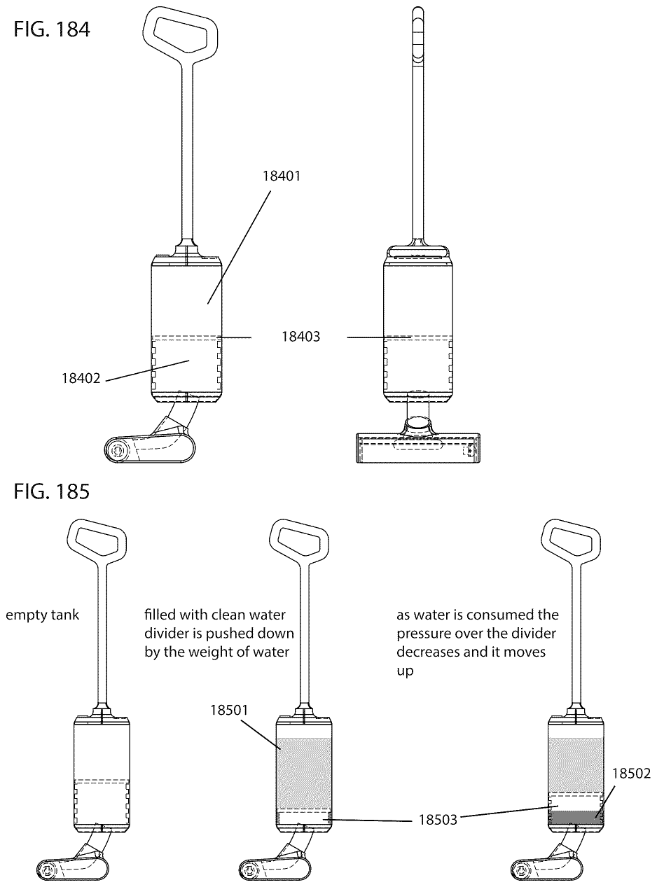

FIG. 180 illustrates a stick mop and vacuum with a 2-in-1 water tank divided into two sections using a flexible diaphragm. Stick mops and vacuums are usually equipped with 2 separate water containers. One is to store clean water used for mopping, and the other is to collect dirty water after mopping by vacuuming it. In some embodiments, these two containers may be combined into 1. The 2-in-water container may be utilized to reduce the product's footprint and overall size, or store more water for cleaning in the same footprint of two separate containers. In some embodiments, the water tank of the vacuum is divided into two sections, one for clean water 18001 and another for the wastewater 18002. Clean water can be poured into the 2-in-1 water tank and covered with the clean water section cap 18003, the two sections may be separated by a flexible diaphragm 18004. FIG. 181 illustrates a stick mop and vacuum with a 2-in-1 water tank at different stages of being empty, filled with clean water, and filled with a combination of clean and waste water. FIG. 181 demonstrates how once the clean water section 18101 is filled with water, the flexible diaphragm 18103 expands to the wastewater collecting section 18102 to provide more space for clean water. As the stick mop operates, clean water is dispensed and less volume is needed to store it. On the other hand, the weight of the collected wastewater pushes the diaphragm towards the clean water section 18101 and provides more room for the collected dirty water. FIG. 182 illustrates a stick mop and vacuum with a 2-in-1 water tank divided into two sections using a moving floater. In some embodiments, the water tank may be divided into two sections, the clean water tank 18201 and the wastewater tank 18202, using a moving floater 18203 as shown in FIG. 182. FIG. 183 illustrates the stick mop and vacuum with a 2-in-1 water tank at different stages of being empty, filled with clean water, and filled with a combination of clean water and wastewater. The moving floater 18303 operates, as illustrated by FIG. 183, such that when the clean water section 18301 is filled with water, the moving floater 18303 moves up to make room for the clean water and as the volume of clean water decreases due to operation, the floater goes down to make room for waste water in the waste water collecting section 18302. FIG. 184 illustrates a stick mop and vacuum with a 2-in-1 water tank divided into two sections using a spring-loaded divider. In another embodiment, the divider between clean water and wastewater is spring loaded. FIG. 184 illustrates a setup wherein the clean water section 18401 is situated on the top and the wastewater collecting section 18402 is situated beneath it, wherein when the clean water section 18401 is filled with water, the weight of water pushes the spring-loaded divider 18403 down. FIG. 185 demonstrates how as the water in the clean water section 18501 is consumed, the weight pressure on the spring-loaded divider 18503 is decreased and the divider moves up, freeing more room to collect wastewater in the wastewater section 18502 and decreasing the volume of the clean water section 18501. FIG. 185 illustrates a stick mop and vacuum with a 2-in-1 water tank divided by a spring-loaded divider at different stages being empty, filled with clean water, and filled with a combination of clean and wastewater.

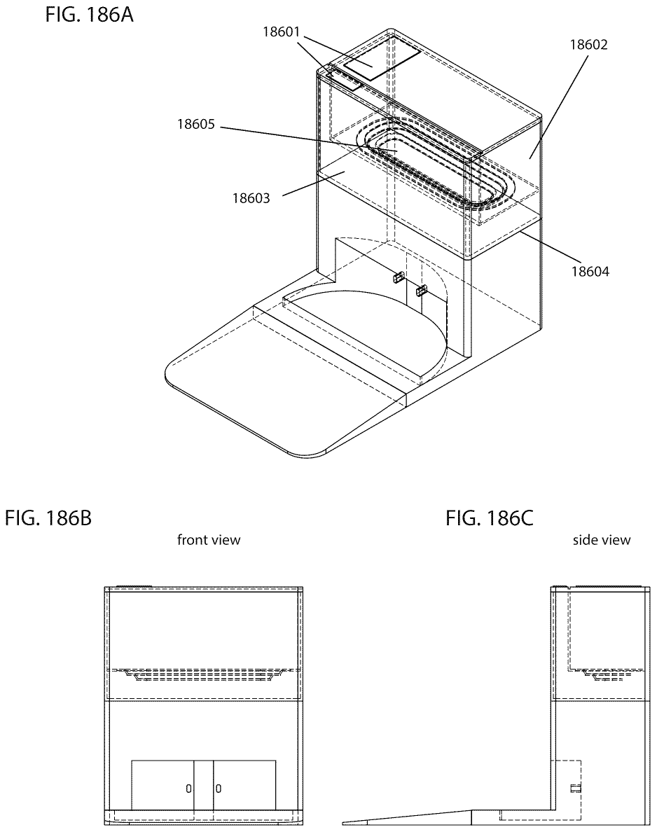

FIGS. 186A-186C illustrates a robotic vacuum charging station with a 2-in-1 water tank divided by a flexible diaphragm in perspective, front, and side views. Some robot vacuum cleaners and mops have stations with auto-refill and self-cleaning mop features. The station in this case is usually equipped with two separate water containers, one for the supplied clean water and another for collecting wastewater from the robot mop container and cleaning the mop attachment. In some embodiments, these two containers are combined into one to reduce the footprint or increase the water capacity of the station within the same footprint. In some embodiments, the water container on the station is divided into two sections, one for storing clean water and another for collecting the dirty water. Similar to a stick mop and vacuum, this container can be divided by various means. In some embodiments, the robotic vacuum charging station with a 2-in-1 water tank comprising a wastewater section 18602 and clean water section 18603, divided by a flexible diaphragm 18605. Water can be filled and drained through the refill and drain caps 18601 on the top of the charging station as shown in FIG. 186A. In other embodiments, the divider in the container is motorized to allocate proper volume for each section.

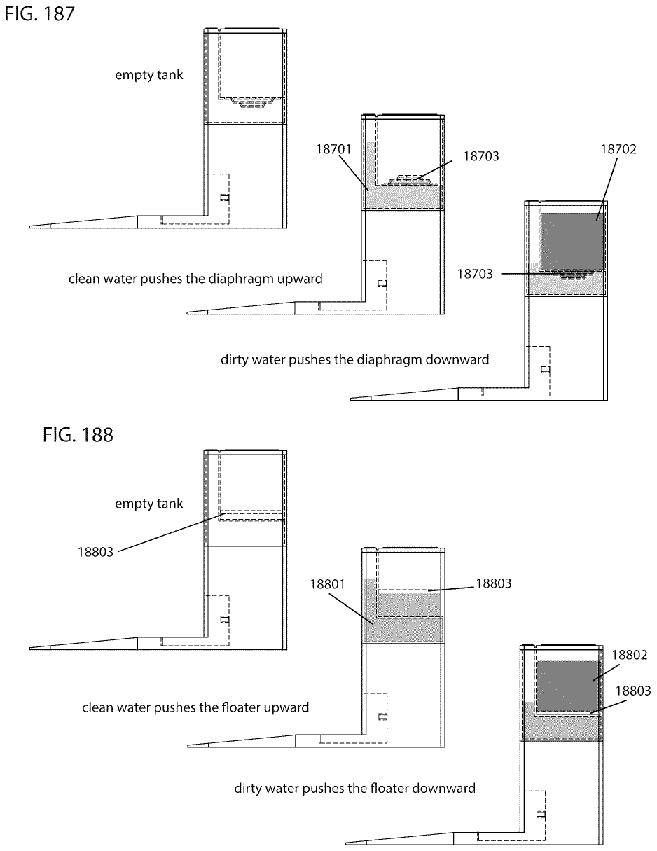

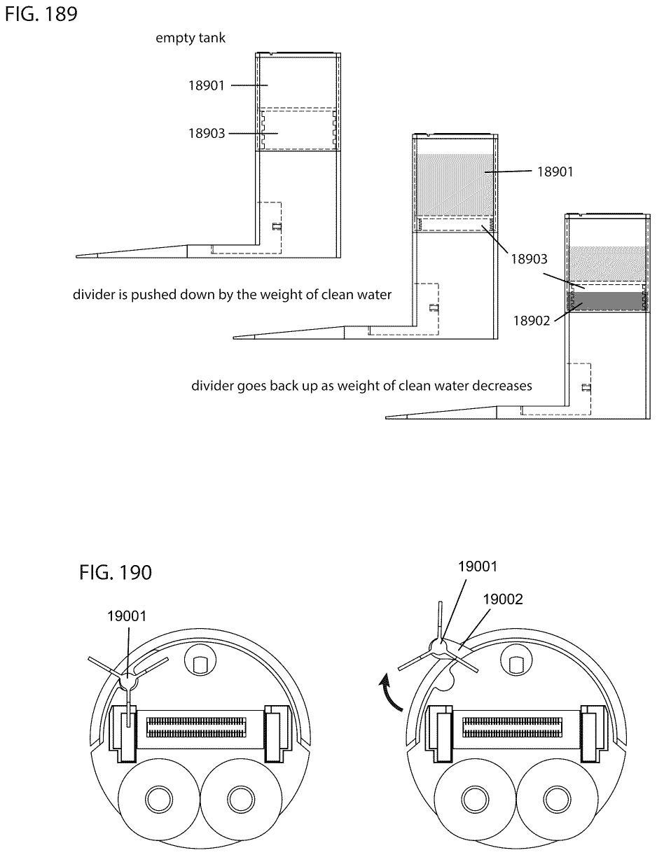

FIG. 187 illustrates a robotic vacuum station with a 2-in-1 water tank divided by a flexible diaphragm at different stages of being empty, filled with clean water, and filled with a combination of clean and wastewater. FIG. 187 demonstrates how once the clean water section 18701 is filled with water, the flexible diaphragm 18703 expands to the wastewater collecting section 18702 to provide more space for clean water. As wastewater is collected in the wastewater collecting section 18702, the weight of the collected wastewater pushes the diaphragm towards the clean water section 18701 and provides more room for the collected dirty water, as demonstrated in FIG. 187. FIG. 188 illustrates a robotic vacuum station with a 2-in-1 water tank divided by a moving floater at different stages of being empty, filled with clean water, and filled with a combination of clean water and wastewater. In some embodiments, the container is divided by a moving floater. The moving floater 18803 operates, as illustrated by FIG. 188, such that when the clean water section 18801 is filled with water, the moving floater 18803 moves up to make room for the clean water, and as the volume of clean water decreases due to operation, the floater goes down to make room for waste water in the waste water collecting section 18802. FIG. 189 illustrates a robotic vacuum station with a 2-in-1 water tank divided by a spring-loaded divider at different stages of being empty, filled with clean water, and filled with a combination of clean water and wastewater. In other embodiments, the container is divided by a spring-loaded divider. FIG. 189 demonstrates a robotic charging station with a 2-in-1 water tank divided by a spring-loaded divider. As the water in a clean water section 18901 of the water tank is consumed, the weight pressure on the spring-loaded divider 18903 is decreased, and the divider moves up, freeing more room to collect wastewater in the wastewater section 18902 and decreasing the volume of the clean water section 18901 as demonstrated in FIG. 189.

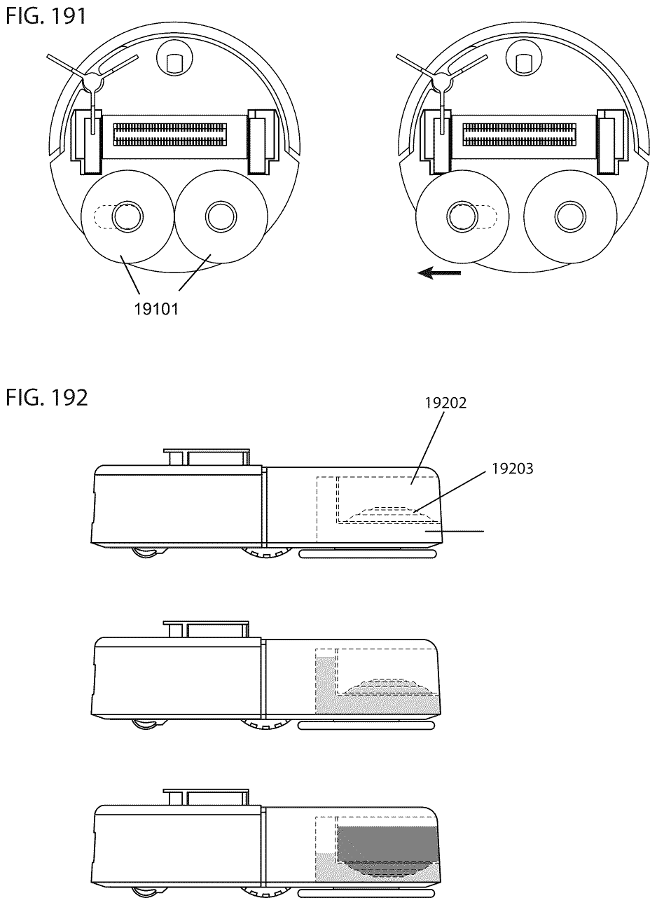

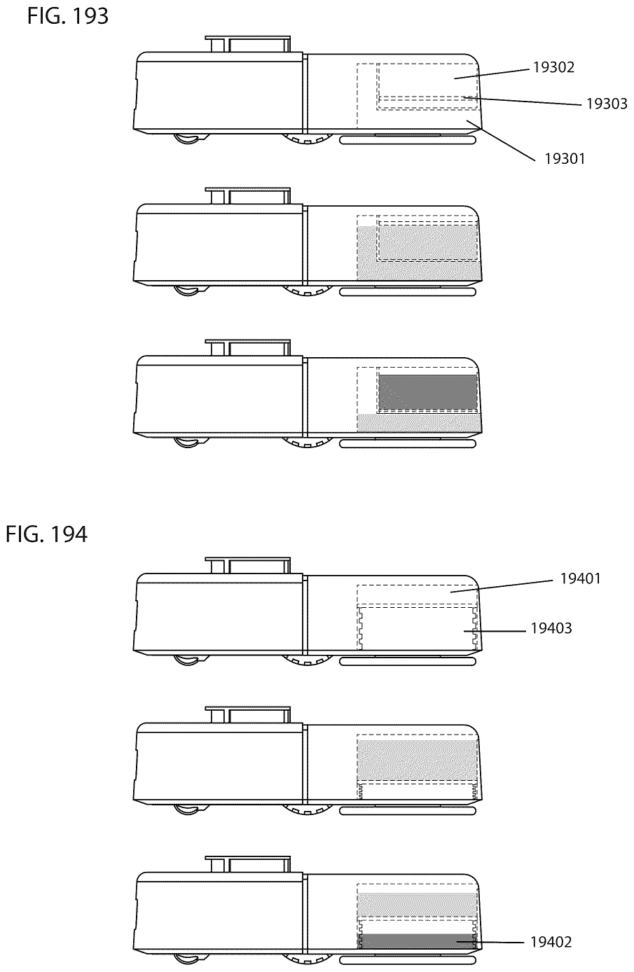

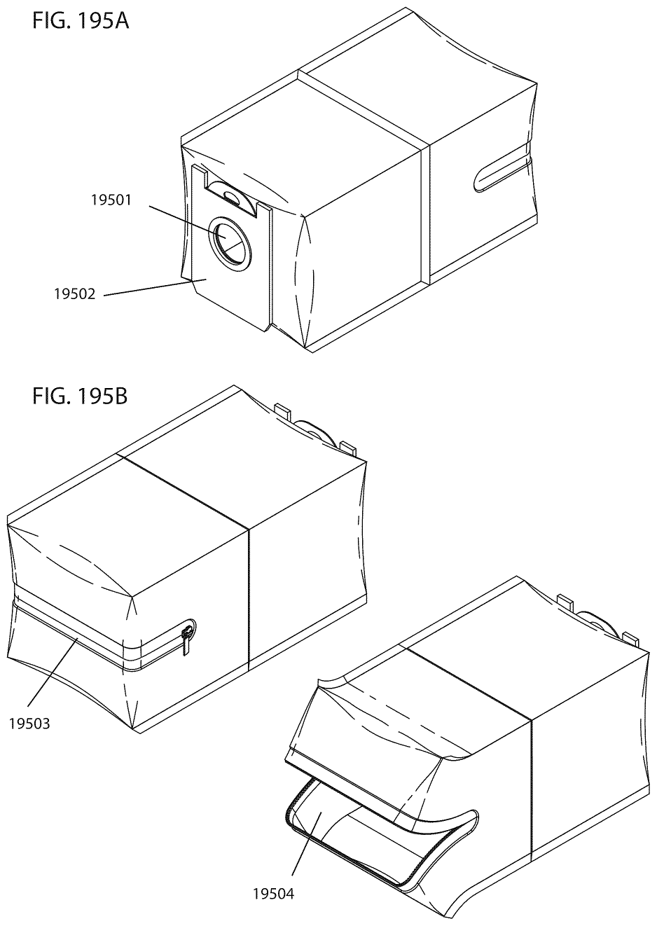

FIG. 190 illustrates a bottom view of a robot vacuum cleaner with an extendable side brush. In some embodiments, robotic vacuum cleaners may be equipped with one or two extendable side brushes. As demonstrated in FIG. 190, a side brush 19001 is placed at the end of an extendable arm 19002, which is normally tucked in on the side of the robotic vacuum cleaner. When the robot approaches a corner, the arm rotates outward to extend the side brush reach. Examples of side brushes are described in U.S. patent application Ser. Nos. 15/924,176, 16/024,263, and 16/203,385, the entire contents of which are hereby incorporated by reference. FIG. 191 illustrates a bottom view of a robot vacuum cleaner with an extendable mop attachment. In some embodiments, robotic vacuum cleaners may be equipped with dual spinning mops. In some embodiments, one or both spinning mops 19101 can move laterally to extend the mop coverage as the robot follows along the walls, as shown in FIG. 191. An example of a spinning cleaning tool subsystem is described in U.S. patent application Ser. Nos. 14/922,143 and 15/878,228, the entire contents of which are hereby incorporated by reference. FIG. 192 illustrates different stages of a robotic vacuum with a mop attachment that has a liquid container divided into two sections by a flexible diaphragm. In some embodiments, from top to bottom, a robotic vacuum with a mop attachment and a liquid container divided into two sections with a flexible diagram, empty, filled with clean water, and filled with a combination of clean water and wastewater. Once the clean liquid section 19201 is filled with water, the flexible diaphragm 19203 expands to the wastewater collecting section 19202 to provide more space for clean water. As wastewater is collected in the wastewater collecting section 19202, the weight of the collected wastewater pushes the diaphragm towards the clean water section 19201 and provides more room for the collected wastewater, as demonstrated in FIG. 192. FIG. 193 illustrates different stages of a robot vacuum with a mop attachment that has a liquid container divided into two sections by a moving floater. In some embodiments, from top to bottom, a robotic vacuum with a mop attachment has a liquid container divided into two sections by a moving floater, empty, filled with clean water, and filled with a combination of clean water and wastewater. The moving floater 19303 operates such that when the clean water section 19301 is filled with water, the moving floater 19303 moves up to make room for the clean water and as the volume of clean water decreases due to operation, the floater goes down to make room for wastewater in the wastewater collecting section 19302. FIG. 194 illustrates different stages of a robot vacuum with a mop attachment that has a liquid container divided into two sections by a spring-loaded divider. In some embodiments, from top to bottom, a robotic vacuum with a mop attachment has a liquid container divided into two sections by a spring-loaded divider, empty, filled with clean water, and filled with a combination of clean and waste water. As the water in a clean water section 19401 of the water tank is consumed, the weight pressure on the spring loaded divider 19403 is decreased and the divider moves up, freeing more room to collect wastewater in the wastewater section 19402 and decreasing the volume of the clean water section 19401, as demonstrated in FIG. 194. Further details of a mop attachment are described in U.S. patent application Ser. No. 16/440,904, the entire contents of which is hereby incorporated by reference.

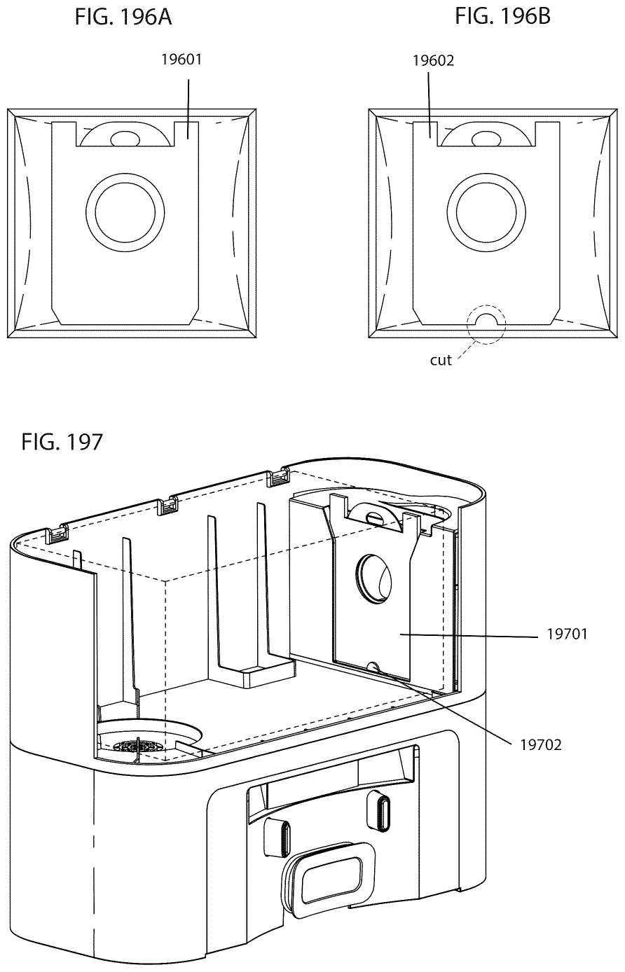

FIG. 195A illustrates a reusable dust bag in front perspective. FIG. 195B illustrates a reusable dust bag in rear perspective in two stages of closed and opened. Some robot vacuum cleaners have stations with a self empty feature. The self empty feature consists of a vacuum motor, filters, a dustbag and an air pipe connecting the robot's dustbin into the dust bag of the station. In some embodiments disposable dust bags are used which will be thrown away after they get full. Some embodiments use reusable dust bags. These bags have an opening on the rear side which is accessible by a zipper. FIGS. 195A and 195B demonstrate a reusable dust bag wherein dust and debris, collected in the bag through a dust bag intake 19501 on a sliding dust intake card 19502, can be emptied through an opening in the back of the reusable dust bag that has been opened using a zipper on the back of the reusable dust bag 19503. This bag can be re-inserted into the station. FIG. 195B further shows an interior layer of activated carbon cloth within the reusable dust bags for odor filtering which will prolong the usability of the bag. FIG. 196A illustrates a sliding card in front of a dust bag with no cut at the bottom. FIG. 196B illustrates a sliding card in front of a dust bag with a small cut at the bottom. In some embodiments, the dust bag has a sliding card which is used to align the bag with the air pipe connecting the robot's dustbin to the dust bag's intake. FIGS. 196A and 196B illustrate the difference of a sliding card in front of the dust bag with no cut at the bottom, compared to a sliding card in front of the dust bag with a small cut 19602 at the bottom.

FIG. 197 illustrates the corresponding protrusion to the cut on the dust bag's sliding card, on the station's side. In some embodiments, to ensure insertion of only a specific bag type (e.g., bags with an odor-filtering activated carbon cloth layer) into the station. In some embodiments, a bag's sliding card 19701 with a first keying feature, such as a cut or indentation, and a complementary second keying feature 19702, such as a matching extrusion configured to mate with the first keying feature within the station.

FIG. 198 illustrates combining additive chemicals with Bio-sourced material to enhance material properties. In some embodiments, the bio-sourced material is prepared based on a blend with chemical additives to inhibit or delay the degradation of bio-polymer to protect against heat, oxidation, and UV light, or to create a more rigid form of the material with certain desirable mechanical properties, increase a melting temperature, hardening time or temperature, and/or molecular weight. In some embodiments, natural fibers are compounded to allow incorporation of finely milled bio-renewable biomass (e.g., wood flour, cellulose fibers, bamboo fibers, rice husks, etc.). These compound fibers may act as reinforcements or fillers, modifying the composite material's properties. Examples include cellulose, hemicellulose, and lignin, which are incorporated into thermoplastic polymer matrices.

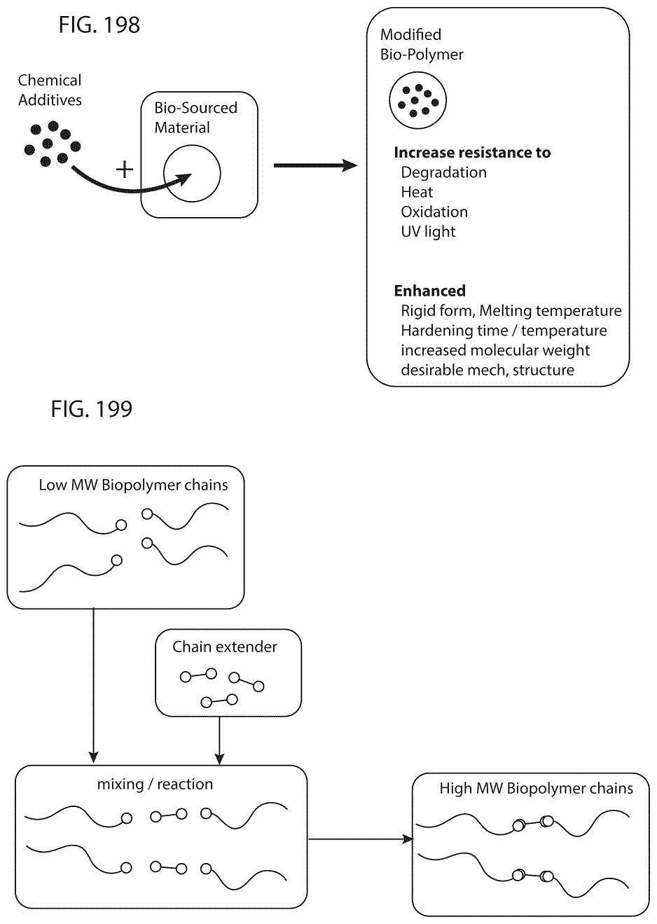

FIG. 199 illustrates a process where low molecular weight Bio-polymer chains are linked together using chain extenders to form larger, more complex structures. Molecular weight, also referred to as average or mean molecular weight, is commonly defined as the weight of a sample divided by the number of moles in the sample. Mechanical properties such as stiffness or strength are often correlated with the molecular weight. In contrast, the thermal degradation decreases as the molecular weight increases. It is often a matter of balancing the various mechanical properties, such as flow properties, time required for the polymer to flow through an injection molding runner system, and the like.

In some embodiments, the bio polymer is prepared through a process of adhering low molecular weight substances together with chain extenders to produce higher molecular weight derivatives, as demonstrated in FIG. 199. Alternatively or in combination, a cross-linking process with or without the presence of a cross-linking agent such as sulfur or the like, may bond one polymer chain to another in a curing process of resins to form covalent bonds or ionic bonds. In some embodiments, to improve interfacial adhesion between the typically hydrophilic natural fibers and the often hydrophobic polymer matrices, surface treatments or compatibilizers may be used. Some examples are maleic anhydride-grafted polymers. While bio-based and relatively easy to process, utilizing polymers like Polylactic Acid (PLA) typically exhibits a lower glass transition temperature (Tg≈50-60° C.) and heat deflection temperature (HDT) compared to engineering polymers like PC (Tg≈140-150° C.) or ABS (Tg≈105° C.). Other bio-based polymers like Polyhydroxyalkanoates (PHAs) or Polybutylene Succinate (PBS) with varying property profiles may also fall into this category. In some embodiments, composite materials or polymers may utilize a crafted blend derived from renewable biomass and content sourced from post-consumer recycled (PCR) or post-industrial recycled (PIR) plastic waste streams. In some embodiments, composite materials or polymers may utilize a well-crafted blend derived from renewable biomass and a petroleum-based source. For example, a well-crafted blend of Bio-PC with PCR PC, or a polymer system using bio-derived plasticizers, impact modifiers, or other additives compounded with a recycled base polymer may be utilized. In another example, in a multi-pronged approach, a well-crafted blend of a bio-sourced material and ABS may be strategically engineered and used in combination with a specific molding process and setting to achieve the desired outcome.

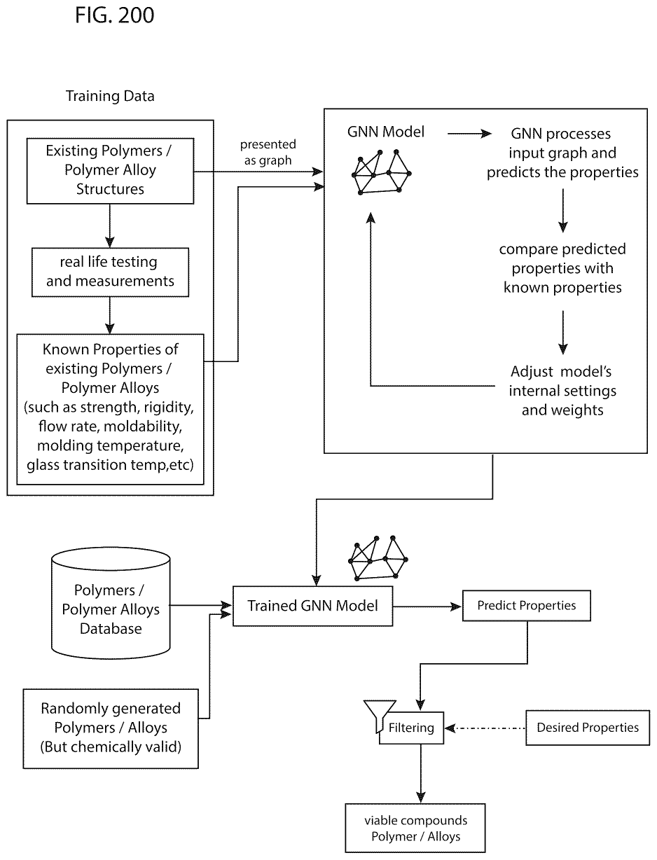

FIG. 200 illustrates a schematic diagram that demonstrates a system utilizing a trained graph neural network model. In some embodiments, Graph Neural Networks (GNNs) and predictive modeling is utilized and trained supervised learning approach on a dataset to iteratively extract a pattern from a graph structure where repeating monomer units, polymer chain segments, atoms and molecules are modeled as nodes with certain attributes charge, hybridization state, etc, and where covalent bonds, monomer unit linkers or connection properties, non-covalent interactions, phase boundaries will be modeled as edge with attributes such as bond order, bond length, or interaction type. FIG. 200 demonstrates how the formulation of the modeled graph serves as an input, and the simulated material properties (output) may be validated with empirically measured data to refine the network's internal parameters to minimize a cost function, which represents the prediction error during the training process. In each step of validation, the dataset could be added to serve as a data point for further prediction. During this process, a trained model will narrow down the future material design flow instead of blind try and errors as a large library of potential polymer structures, alloy compositions, or compound formulations can be considered and simulated with the trained GNN, and only high-performing candidates in the simulation will be considered for physical testing, property of which will be again validated and used to further minimize the cost function.

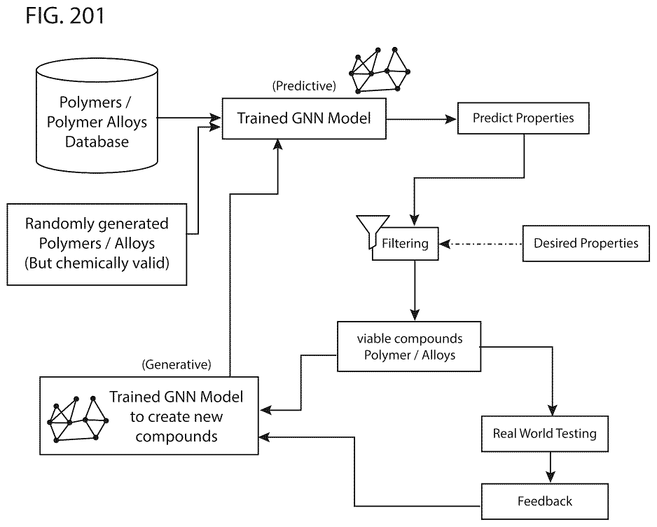

FIG. 201 illustrates a schematic diagram that demonstrates a process for training and utilizing a graph neural network model. In some embodiments, feedback loops are utilized for training. FIG. 201 demonstrates the use of a trained GNN model in a feedback loop for such training. In some embodiments, generative GNN models, Graph Variational Autoencoders, and Graph Generative Adversarial Networks are utilized. In some embodiments, one or more models are utilized in combination, in order, or separately, but in parallel. In some embodiments, reinforcement learning, supervised learning, and unsupervised learning may be used in a combination of traditional machine learning implementation or in a neural network setting to arrive at a target material/process combination from a set of desired properties in a back propagation process. Learning through back propagation, in a deep network arrangement comprising several layers allows for the range of properties to be provisioned as search space and input with a broad domain, including but not limited to tensile strength, Young's modulus (rigidity), elongation at break, impact strength, flexural modulus, glass transition temperature (Tg), melting temperature (Tm), crystallization temperature (Tc), heat deflection temperature (HDT), coefficient of thermal expansion (CTE), melt flow index (MFI), viscosity curves, moldability, dielectric constant, dissipation factor, surface/volume resistivity, density, flammability characteristics (e.g., UL ratings), chemical resistance, etc.

In one embodiment, input images are cropped to a region of interest which within the context of this paragraph is the expected path of the robot or where the robot is expected to be in the next timestamps. If the robot is a coverage robot and the robot mostly moves in straight lines, at least for the duration that it is expected to drive straight, identifying the pixel columns that depict the straight front of the robot has a reasonable computational cost because the forward path of the robot is within a certain number of central columns. Therefore, a number of columns on the right margin and left margin can be readily cropped out of being processed. It is also can be readily known that the number of columns that represent the forward path is a bigger number for near distances and a smaller number for farther distances. For example, depending on the resolution of the image and dimensions of the robot, for near distances X number of pixel columns depict the forward path of the robot, and for far distances Y number of pixel columns depict the forward path of the robot where Y is smaller than X. As such in some embodiments the region of interest depicting the forward path of the robot maybe a trapezoid shape where the lower base of the trapezoid is in the lower part of the image.

In the example below the lower base roughly represents the width of the robot. Also, the upper base roughly represents the width of the robot. A trapezoid shape bounding box or region of interest lowers the required computational cost.

In other words, the higher up rows in the image will have a lower number of columns depicting the forward path of the robot. In embodiments, the cropping may not be a trapezoid shape, and a rectangular region of interest may be processed. In addition to the above general rule that may be applied to limit the number of pixel columns that are being processed, a similar but different intuition may be used to limit the number of pixel rows that are processed. However, for the sake of maintaining simplicity in our explanation, we consider a fixed number of rows.

In a sequence of time steps, images are taken (test frames), and the region of interest is recorded in the test frames, and we start with an unproven hypothesis that our chosen region of interest in the test frames represents a drivable surface with no obstacles. Obviously, our hypothesis is purely based on assumption, and we do not have much confidence that it will be true. However, in an indoor space, unless the floor of the space is densely cluttered, chances of it being true is not negligible. Similarly, in an outdoor space, unless there is a sort of bumper-to-bumper congestion, the chance of our hypothesis being true is not negligible. If in the next time steps (and after a certain amount of time), the hypothesis proves to be true (some embodiments of how it is proven is explained below), then the ROI of the test frames may be used to establish a baseline. Specifically in the next time steps the ROI of incoming frames can each be compared with ROI of the test frames (from the previous time steps) that are now known to represent spaces that are free of obstacles and are drivable. In embodiments an enhanced aggregate of test frames may be utilized. In embodiments a handcrafted set of features and attributes may be used, or a neural network may be utilized. In embodiments a combination of handcrafted set of features and attributes and a neural net may be used in a Bayesian set-up. In embodiments a combination of handcrafted set of features and attributes may serve as nodes in a neural net in addition to nodes that act on raw image data. The comparison may yield a similarity index or a simple true/false output. If the degree of resemblance is high, or it is determined that the ROI of the incoming images is similar (enough) to the ROI of test frames, then it can be predicted (instead of random assumption) that the space that the ROI of the new incoming image is representing is also drivable/traversable. At this point this is a prediction with a degree of confidence that is at least a better prediction than the initial assumption.

The process can iterate continuously, with incoming frames simultaneously serving as test frames for the time steps after. In embodiments, an aggregate of several frames may be used for continuous iteration. In embodiments in addition to an aggregate, each frame is independently used to serve as the test frame for the timesteps after. In embodiments frames may be filtered based on the image quality or other factors. In embodiments a number of default resolution test frame images may be integrated to create a higher resolution baseline. In embodiments a number of test frame images may be integrated to compensate for each other's defects (i.e. due to motion blur or a lighting change, etc.), unclear parts of the image, momentary blind spots, and the like.

In embodiments, an optical flow similarity index may be calculated for certain pixels within an ideally selected region of interest. As indicated above, each test frame that represents a space that its drivability turns out to be true, may be fed back into the system and the confidence of the baseline can be increased over timesteps. Iterating through this process will yield an acceptable confidence of baseline in a very short time (compared to run time of the robot in an entire session). In determining if the hypothesis is true or false, various methods may be utilized. In a simple example we visualize an autonomous car where the driver initiates the driving by manually driving for a certain amount of time or until the car prompts that autonomous mode is available for being selected. In this scenario while test frames are being captured and examined, the driver is manually driving the car and if an ROI of a test frame represents an obstacle, a brake will be applied by the driver. If a brake is not applied within a certain amount of time, given the car knows its own speed, it can conclude that the region of interest in the test frames have passed the drivability hypothesis and are good to be used as a baseline for new incoming images. At this point the car may prompt the human driver that they can select an autonomous mode to take over.

In one embodiment, a method for testing the hypothesis, LED lights are configured to illuminate a distance away from the floor thus creating a shadow in the bottom rows of a picture taken from immediately in front of the robot in the image, where the line separating the shadow from illuminated pixel rows indicate a known distance in front of the robot and a disturbance in the separating line indicates an obstacle on the path thus disproving the hypothesis.

If the line is not disturbed, the hypothesis is proven. In some embodiments the range of pixel rows that the shadow/illumination line is expected to form is known in advance and the region of interest may be a certain number of pixel rows above the known expected separation line. In some embodiments, the pixel rows of interest may be selected with a dynamic method (with or without a seed value) and the number of selected rows may also be dynamic (increased/decreased with some criteria). However, when an incoming frame does not pass a similarity test (and the robot slows down or prepares to apply brakes, etc.) it still may represent a drivable surface which will be proved in a short period of time. For example, in the example above, the separation line will not be disturbed when the robot gets closer.

In some embodiments the range of pixel rows that the shadow/illumination line is expected to form is known in advance and the region of interest may be a certain number of pixel rows above the known expected separation line. In some embodiments, the pixel rows of interest may be selected with a dynamic method (with or without a seed value) and the number of selected rows may also be dynamic (increased/decreased with some criteria). In some embodiments the rows of interest may be increased, thus iteratively expanding the region of interest (vertically in the image) in increments of one or more rows, or in increments equal to the initial number of rows of interest until a point where the similarity index shows a sudden decrease or a gradual decrease reaching a below a threshold. The range of rows on the image where the similarity ends/drops/lowers, may be interpreted to represent the ending of a drivability horizon. i.e. areas in the environment that may have a higher chance of not being drivable/traversable perhaps because the pixels represent an obstacle, wall, a different floor type, etc. We define the drivability horizon to be a space in front of the robot or a car where the robot can continue driving at the current speed with confidence that applying the brake will stop the robot before hitting the end of the horizon. The image representation of the drivability horizon are those pixel rows that a similarity index indicates a change. As such pixel rows up to those rows where the similarity changes, may be assumed to represent a drivable area. Similarly, pixel rows above those rows where the similarity changes, may be assumed to represent not drivable areas.

In embodiments it is not necessary for the metric distance of the drivability horizon to be known. In embodiments it is sufficient to know that the drivability horizon is faraway enough that at a “foreseeable” future number of timesteps it is safe to continue to drive.

In embodiments a drivability horizon may be limited to spaces on the sides of the robot which are not drivable. In applying pixel filtrations to crop out unnecessary parts of image, the geometry of the robot, its speed, and drive system may be considered. For example, a car with a differential drive system has to drive a certain amount towards the X direction to achieve a displacement in the y direction.

In one embodiment, in an alternative (or an additional) method for testing the hypothesis, a second camera may be used to create a separation line at a certain known distance ahead of the robot. In one geometric configuration, a first camera is placed in front of the robot or car to have a field of view of the space immediately in front of a robot or car similar to what is shown in the figure. A second camera will be geometrically configured to purposefully have a blind volume and have a field of view that begins at a distance away from the immediate front of the robot.

In one example, the first camera will have a field of view shown on the left. The ruler in the middle is a 30 cm marked ruler with 1 cm margin unmarked. The second camera is purposefully designed to have a field of view that sees spaces 30 cm out, where 1 cm unmarked margin of the ruler is visible. With a first camera only, there is no way of knowing which pixel row represents 30 cm ahead of the robot. However, with the robot moving forward, any physical space that exits from the bottom of the image stream of the second camera corresponds to 30 cm ahead of the robot. Recalling the trapezoid nature of image representation of the space ahead of the robot, we will see that the red rectangle in the right image from the second camera corresponds with the red rectangle in the middle image below taken by the first camera.

In embodiments, each of the first camera and the second camera have a stream of frames for which a number of test frames may serve as a baseline for the incoming frames to be compared with for similarities in the image, in the flow, or both. We also recall that a flat surface demonstrates a different flow than a flat surface with objects on the floor. Similarly, a free space in front of a car that is drivable shows a different flow than if it had a 3D object on it. We also note that when images are taken with a second camera, as the robot approaches a 3D obstacle in front of it, a lower height obstacle exits the bottom of the image at a farther physical distance than a higher height obstacle. As such an object of a height that is high enough may linger in the image for a long time and until the robot comes very near to it, or with a certain higher height may never leave the image. As such a flat temporal change of the image is different for flat surfaces and flat surfaces with objects on them.

Building on top of the concept we explained so far based on a variety embodiment above, we now explain another embodiment where there is no illumination and the known separation line in the first camera is where the second camera's field of view starts.

In this embodiment on the right, we have the second camera with having a field of view at 6 cm in front of the robot. The pixel rows at the bottom of the right figure correspond with a known number of rows and columns of the first camera (shown in the middle). As mentioned above, test frames are captured, an assumption is made that the path is clear (i.e. no obstacle), and the assumption will prove to be true within 1 second with knowing that our robot has a fixed speed of 30 cm per second (with a variable speed robot, and a known speed, the time required to attain certainty can be calculated. In this example, we will have to rely on a different source for confirming the truth of the hypothesis. In a robot that we are showing, this certainty can be attained with a bumper event or in an example where there is a driver in a car, the certainty is attained by the driver not hitting on the brake pedal for a sufficient period of time.

For heavier robots such as commercial sized cleaners that are used to clean shopping malls and airports, additional cameras may be utilized to predict chances of a human cutting the way of the robot or detecting it when it happens. As seen above, presence of an object in a camera and disappearing from that camera and remaining in field of view of a different camera that has an overlap of field of view combined by the known geometry of cameras allows for strategically confining region of interest and use their correspondence with the physical world to determine presence of an object on a surface allows for discriminatory determination of obstacles and 3D objects from the flat surrounding. In another embodiments, we examine adding two cameras for seeing peripheral view of the robot at an angle with the two front facing cameras shown with the two triangles. In one embodiment the second camera is configured to not have a field of view overlap with the peripheral cameras which renders it blind to the area where the first camera overlaps with the right and left peripheral camera.

We now imagine a small cat walking by on the right side of the path of the robot, and the robot must react if the cat ends up cutting into the path ahead of the robot. For such discriminative determination, we remove a requirement that the cat is identified to be an object that is classified as a cat (with a classification method) in the interest of prioritizing real-time discrimination of its other property, i.e. 3D-moving-object-ness that may cause an accident. We argue that in a vehicle moving with constant certain speed in respect to surroundings, an optical flow of stationary and constant surroundings has an “optical flow signature” that is different from that of an accelerating vehicle moving in the same scene. We acknowledge that from scene to scene, and certain speed to another certain speed this signature is different. However, moving in the same scene at a constant certain speed, creates a signature in the parts of the image that represent stationary parts of the environment. If the entire scene is stationary and our vehicle is the only stationary object in the surrounding, this could be equally viewed as if the vehicle was stationary and the entire scene was moving. Measuring the optical flow i.e. where the pixels (or pixel groups) of previous time stamps end up in a consecutive timestep, or better said, how pixels (or pixel groups) move in the image in correlation with the speed, an expected next scene may be predicted. However, a moving object within the scene i.e. a person that is moving along the sidewalk disturbs such predictions because the speed and direction of the movement of the person is not connected either to frame of reference of the car or the environment. While how this disturbance will cause prediction of the next scene is non-trivial, the fact of existence of the disturbance in one or more regions of the image is feasible—especially if certain parts of the image are looked at (region of interest). In other words, in a vehicle moving with constant speed in respect to surroundings, a change in the scene (i.e. a cat entering the scene) will cause local disturbances in the said “optical flow signature”. To expand on laying the groundwork, we also recall that an optical flow of a 3D object (that is the subject of being discriminated against) has a different and distinct signature than that of a flat surface drivable surface. We acknowledge that computing all that optical flow for discrimination of a cat from its surrounding is tremendously expensive computation-wise. We acknowledge that the said signatures are different from scene to scene which is a problem that in this teaching we attempt to solve. To solve the problem at hand, we use an advantageous geometrical arrangement such as shown in figures above. In one embodiment we only examine a certain region of interest in images from one camera for presence (or lack of) disturbances in the optical flow, and then in the next time step examine if that same kind of disturbance will appear in a certain region of interest of a different camera. Since we have limited the region of interest in both cameras, and the only criteria we are examining is if a certain disturbance observed by a first camera will be observed by a second camera, again in a specific region of interest, we reduce the problem to a much less computationally demanding problem.

As discussed above, with the first camera and second camera having different fields of views (the second camera having a blind region in front of the robot), upon a proven drivability hypothesis, we benefited from comparing a similarity index of bottom pixel rows of the second camera with the first camera starting from bottom pixel rows and incrementally working to upper pixel rows. We also noted that upon a proven drivability hypothesis, the lower rows of the image taken in the timestamps from beginning of setting the base line up to the timestamp that the vehicle moves a distance greater than the blind distance of the second camera provide a high confidence base line.

We also noted that this base line may be compared to higher up pixel rows to determine a pixel row that represents the drivability horizon. We also acknowledged that a distance for the drivability horizon remains unknown based on what we explained so far. We also noted that the path in front of the robot is represented by lesser number of columns as we go up in the pixel rows, but we do not know exactly in which proportion meaning that we will always have to examine a larger number of columns that are representation of the path ahead of the robot so we do not end up losing information that is necessary. In a special case where we have reliable lane markings, the path ahead of the robot may be determined with a large set of pre-trained data for extracting the lane marking from the rest of the image. If lane markings are reliable, this even allows for dynamic selection of rows and pixels to be examined, even if the path ahead is curved. This is advantageous in comparison to the case above where we picked a set of trapezoids without knowing a real boundary for them and even worse, would only be useful if the path ahead was assumed to be straight. As such when lane markings are presented for determining the drivability horizon the problem reduces to comparing the established baseline in the new incoming images, starting from the bottom pixel rows within the columns that represent the lane markings, and working our way up row by row. We acknowledge that the lane markings may not be present due to an obstacle blocking the line of sight of the camera, but that does not frustrate the method here because we are only establishing what could be ascertained that is within the drivability horizon. Any pixel that is not ascertained to be within the drivable horizon is not marked as a representative of area within the drivability horizon—regardless of the reason the ascertainment failed.

We noted that at a near distance, especially with a second camera with a blind spot up to a known distance in front of the robot (only when on a flat surface), we could have some insight into distance values. However, we acknowledge that the circumstances that are assumed may not be the case of real environments. For example, while for an indoor robot (i.e. commercial cleaner for shopping malls and airports), the driving surfaces may be reliably flat while for an autonomous car, the flat surface in front of the robot may be uphill or downhill which distorts the insight we assumed for distances. As such for each of the different scenarios we present some extra techniques to employ for adding insight to our data. For example, in an indoor robot with a flat surface assumption, measurements to perimeter points of the environment taken from a Lidar may be used to establish an upper threshold and lower threshold for how the pixels in the image may relate to distances. In an ideal case that there are reliable lane markings, as explained above, the width of the lane is represented by the pixels between where the lanes are detected in the image. The width of the lane usually has a lower and upper threshold and in some places is subject to certain standards. Further, it is not difficult to collect geo-stamped lane width measurements in advance. As such, knowing the width of the lane provides yet one additional data point. When this is combined with known blind distance of the second camera, and when an image taken by the first camera is cropped to retain the non-overlapping area, which is then confined by the lane markings produces a region of interest that correlates to a known physical surface or area. Going back to establishing a drivability horizon, the area within the image in addition to providing textural information for comparison with upper pixel rows, provides geometrical information.

We also note that in establishing the drivability horizon, we need not know an exact distance. What we need to know is simply if a realistically possible cut-in (i.e. by a car from a neighboring lane, or a bike, or a human pedestrian each subject to a physical constraint i.e. a human pedestrian cannot go faster than a certain speed, and a car in the neighbor lane has to have a curved path into our lane) occurs, the robot or the car would be able to stop having traversed a distance that (ideally less than) a human driver could have managed to stop. We also note that for establishing the drivability horizon the requirement is not necessarily radial distances to obstacles from the frame of reference centered at the place of the car. The information inferred from geometrical relations as discussed above may be used to create a three-dimensional perception of the environment in a frame of reference that is not attached to the robot or car. Detailed disclosures have been discussed in respect to relations of frames of reference in patent Ser. No. 16/048,179, 16/048,185, 16/163,541, 16/163,562, 16/163,508, and 16/185,000 incorporated by reference herein.

In setting up the cameras in a geometrically advantageous way, the second camera is placed at a higher height than the first camera. Viewing the scene at two heights provides yet more information that can yield better results in discriminating 3D objects from the flat surfaces. For example, a camera placed at a height of the ceiling of the car views the disturbances, caused by 3D objects on the driving surface differently than a second one placed to the bottom surface of the car. This provides both complementary advantages and redundancy advantages. The difference in the view angle of the same space provides additional insight to dimensionality of the space in front of the robot.

In one embodiment, we arrange the cameras geometrically to have complementary fields of view without an overlap. In the example above, in the right peripheral camera, we only examine the X number of left pixel columns, and in the second camera with narrow field of view, we examine X number of right pixel columns. Once a baseline is established for how a drivable surface looks like, a cat entering the path of the robot ahead, (or the robot having a path ahead that will make it occupy the space where the cat is), the disturbance observed in the right peripheral camera in the X number of left pixels (event 1) will be temporally followed observance of similar disturbances by the second camera (front facing narrow FOV), specifically in the X number of right column pixels (event 2). The discrimination of 3D objects from flat surroundings will be the result of observing “event 2” after occurrence of “event 1”. This produces a high confidence, especially when treated in a probabilistic way i.e. Bayesian.

In embodiments, the disturbances in the optical flow need not be handcrafted. A central neural network trained with sample data collected over a period of time by a fleet of robots (or cars) will produce a global signature. Training data used for training may be geographically stamped by a source of information such as Global Navigation Satellite Systems (GNSS). In embodiments employing methods such as RTK (RealTime Kinematics) with a fixed ground truth may enhance geographical stamps to achieve high accuracy to a desired level. Geographical stamping of training data will allow for the global signature to be relevant to the same location that the robot (or car) is expected to discriminate the 3D object from the surrounding. A connected vehicle may download and buffer relevant geographically stamped global signatures ahead of time. For example, if a connected car is driving along a freeway, it may download the Global signatures that pertain to a certain area ahead of it i.e. all of the freeway lanes till a bit after the next exit and the exit itself. Global signatures may also be temporally stamped meaning that the signature itself may incorporate the occurrences of past event 2s after event 1s, as well as non-occurrences of events 2s when an event 1 had occurred. The pre-training pertaining to global signature in a central way, is distinct and different from a real-time baseline establishment which may also utilize a neural network.

In one embodiment, only upon discriminatory detection of the 3D object against the surrounding, yet another neural network is invoked to determine the type of the 3D object such as it being a cat, a bicycle, or a pedestrian. This saves a tremendous amount of compute.

In one embodiment, features from the bottom pixel rows of the images taken by the second camera are correlated against the pictures taken from the first camera, and due to geometric relation of the two cameras, the distance that those features represent will be known or estimated.

In one embodiment, features from the left pixel columns of the images taken by the right peripheral camera are correlated against the right pixel columns of pictures taken from the front facing camera.

In one embodiment, features from the right pixel columns of the images taken by the left peripheral camera are correlated against the left pixel columns of pictures taken from the front facing camera.

In one embodiment, features from the top pixel rows of the images taken by the second camera are correlated against the pictures taken from the first camera, and due to geometric relation of the two cameras, the distance that those features represent will be known or estimated.

In one embodiment, features from the top pixel rows of the images taken by the first camera are correlated against the pictures taken from the second camera, and due to the geometric relation of the two cameras, the distance that those features represent will be known or estimated.

In embodiments, one or modules or sensor combinations may be positioned in a rear portion of the robotic device comprising to have a field of view opposite of the moving direction of the robot or vehicle. In embodiments the differential of the optical flow in different directions yields a flow signature that may be utilized to discriminate an object. For example, points in the scene that are stationary create a flow that is reversely or inversely related to one another when a moving object is approaching them and is moving away from them and looked at from the rear. Further the points of scene that are stationary when viewed from side remain somewhat constant regardless of if they are viewed with a side rear facing camera or a side forward facing camera. With a large volume of data sets in a central training (such as crowd sourced images) as well as real-time neural net with established basis, a signature pertaining to a particular object, a particular movement, or a particular movement of a particular object may be detected.

In addition to methods discussed above, a few additional embodiments will be discussed. In one embodiment, in an alternative (or an additional) method for testing the hypothesis, other sensors may be used to substitute the shadow/illuminated separation line discussed in the embodiment described above. For example, a lidar measuring distances to a wall shows lower readings as the robot approaches the wall while moving in a straight line. If the Lidar is measuring the distances in a two-dimensional plane (i.e. parallel to the driving surface at a height above the driving surface, the measured distances have a blind spot (blind-volume). For example, in a car that has a lidar installed on top of it, a short height target obstacle may be present but not detectable. However, the readings from the lidar may be utilized (alone or in combination with yet other methods) to prove the hypothesis discussed above or contribute to proving the hypothesis by a weight factor, etc. For example, at a certain traveled distance by the robot not having hit/encountered an obstacle (I.e. no activation of a tactile or near field IR sensor), the chance of the hypotheses being true may be increased with a certain probabilistic weight applied to this sensor information.

In one embodiment, in an alternative (or an additional) method for testing the hypothesis, other sensors such as such as a TOF distance sensor, a TOF imaging sensor, a range finder, a tactile sensor, an IR sensor, an ultrasonic sensor, a lidar, a radar, a range finder, etc may be utilized to replace/complement/improve the hypothesis examination above. It is also understood that other sensors such as a TOF distance sensor, a TOF imaging sensor, a range finder, a tactile sensor, an IR sensor, an ultrasonic sensor, a lidar, a radar, a range finder, etc may be utilized to make other contributions to the overall navigation of the robot individually or in combination with the methods disclosed above.

In embodiments, in addition to vision sensing, additional sensors may be utilized to provide a depth snapshot of the environment or capture a 3D model of the spaces surrounding the robot. Such sensors may be utilized for revising the hypothesis of drivability within a drivable horizon as discussed above.

In embodiments, a laser emitting semiconductor diode with one or more vertical cavities on a surface of a silicon wafer is configured to project an illumination pattern.

An additional laser emitting semiconductor diode with one or more vertical cavities on the surface of a second silicon wafer, maybe configured to project a second illumination.

At a nearby distance on a module, on the same monolithic electronic chip, or in a separate monolithic chip but integrated or fused together to form a single component, a semiconductor diode comprising an array of photon-sensitive pixel elements, organized in rows and columns, is configured to have a field of view such that a reflection of the laser emissions would cause
each pixel element to release an avalanche of electrons in response to receiving at least a single photon reflected from a point of incidence of the laser emissions with the environment.

In embodiments, the avalanche of electron movements in response to reflections from the first laser-emitting semiconductor diode creates a microcurrent pattern that is different from the one created by the second one.

For example, when processed by the processor, one pattern could translate to a depth snapshot of the environment utilized to discriminate objects from the background of the environment and the avalanche of electron movements in response to reflections from the second laser emitting semiconductor diode creates a microcurrent pattern, that when processed by the processor, translates to a set of distance readings to a set of points in the environment utilized to replicate the spatial quintessence of the environment.

As such the emissions of the first laser emitting semiconductor diode creates a first illumination pattern, and the emissions of the second laser emitting semiconductor diode create a second illumination pattern.

In embodiments, the beams may be different of nature such as one could be a broad beam illumination, a narrow beam illumination, or a plurality of beams that upon incidence on a plane, would create certain patterns such as a grid of homogeneous (or variously sized) point illumination, stripes of lines, etc.

In embodiments, a time-of-flight computation may be utilized to calculate depth or distance. In embodiments a plurality of silicon chips may be utilized in one module or a plurality of modules, wherein one chip would capture a narrow but long-distance reading, and another would capture a near distance but wide distance readings from multiple points providing a depth of scene reading.

In embodiments, depth of scene readings may be integrated together to form a spatial quintessence of the environment with methods such as disclosed in MAPPING CIP patent incorporated by reference herein.

Embodiments of this invention include but are not limited to modules with advantageous geometric coupling of the illuminating semiconductors with the avalanche semiconductors, the electronic coupling of the illuminating semiconductors with the avalanche semiconductors, the timing coupling of illuminating semiconductors with the avalanche semiconductors, and the components that materialize those couplings. For example, the component that maintains the clock frequency of the coupling is included in the aspects of this invention, as well as the circuitry board, the computing chip and algorithms, and the physical embodiment of the module. In embodiments the couplings may not be implemented in a module that has a physical independence but instead they are integrated with the embodiment of robot subject to the couplings that are advantageous and disclosed herein, and therefore logical couplings (including geometric) remain the subject of this invention.

In embodiments, the module is physical and comprises a housing with a structure to hold a plurality semiconductor component organized in a geometric relationship with a protective optically transparent window, a circuit board, and a set of connection points for connecting the module to other circuit boards.

In other embodiments, instead of a physical housing the embodiment of the robot is used as a structure to hold a plurality semiconductor component organized in a geometric relationship. In these embodiments a protective optically transparent window may be directly attached to the robot embodiment. The electronic components will have a set of connection points or pins that may be routed within the embodiment of the robot's embodiments similar to how flex printed circuit boards accommodate electronic components. In embodiment a comprehensive network of flex printed circuit boards are routed through the physical embodiment of the robot. In embodiments the network of printed circuit boards are a part of seamless design of the embodiment of the robot.

In embodiments, a combination of wafers with doped silicon of different material for different purposes are packaged into a monolithic electronic component or chip. Certain materials, like polycrystalline lead sulfide (PbS) and lead selenide (PbSe), generate current after absorbing photons, enabling sensitivity to specific wavelengths. PIN diodes feature an undoped intrinsic region between p- and n-type layers, forming a depletion region. Applying a strong reverse bias creates a Geiger-mode avalanche effect, where one photon can trigger a large, rapid current spike. An n×m size array of p-n or p-i-n junctions, may comprise a carrier collection, configurable anode/cathode positions, and integrated sensing/transistor areas. In embodiments ADCs convert analog signals to digital values. In embodiments, TDC circuits are employed for time-correlated photon counting. In embodiments, additional steps of signal processing may be employed such as Binning, Dynamic ADC correction, Noise filtering, Signal amplification. Multi-layer CMOS image sensors arrange 1D/2D active pixel sensors in arrays, each with supporting circuits for state maintenance and readout. Communication occurs via TSV or vertical interconnects, with alternatives like 3D SiP or WLP for compactness. Sensors may be monolithic chips with both laser emitters and detectors or packed as modules. For 3D chip fabrication methods such as UV lithography, die stacking, and various etching or alignment techniques may be employed as well as stacking processes involving one or multiple rounds of heating, UV treatment, laser drilling, and thinning processes, In embodiments localized oxidation are used for creating trenches such as with use of etchants like buffered hydrofluoric acid, employing substrates like silicon, germanium, or their compounds (e.g., InSb, InAs, GaN, GaAs, etc.). Additional materials that may be employed in one or more steps of process include nitride, aluminum indium nitride, indium gallium arsenide phosphide, cadmium telluride, mercury cadmium telluride, gallium antimonide, lead telluride, etc.

In embodiments, the concentration of dopant material varies at various depths of silicon or on the surface of a certain layer in the silicon. A combination of positioning the n-type material and p-type material and the dope concentration as well as positioning intrinsic material and insulating barriers as well as ideal selection of the material may produce better performance based on the desired outcome of the silicon arrangement.

In embodiments, silicon carbide with hexagonal lattice type such as 6H and 4H may be used (4h)-SiC with a bandgap of 3.3 eV providing high thermal conductivity, temperature stability. A wafer of a single polytype is chosen and SiC molecules are grown as stacks on top of each other. Dopant materials may be nitrogen, phosphorus, beryllium, boron, aluminum, oxygen, hydrogen, fluorine or bromine.

A process of growing thin films of crystals (Epitaxy) may favor crystallinity with an orientation of grown layers based on the substrate. In light/laser emitting diodes, a heated flow of gaseous compound elements treat the surface of substrate during which a crystalline layer is formed. In embodiments vapor phase epitaxy or molecular beam epitaxy i.e. with a heated metallic solution saturated with desired layer material exposed to substrate is utilized to form a crystalline layer. Liquid phase epitaxy may be utilized for microwave IC whereas molecular beam epitaxy of GaAs using a vacuum system containing liquid Ga or solid As may be used for other ICs.

In embodiments, before the SiC surface is treated, a mask layer may be created to prevent doping or treatment of certain areas on the wafer surface, or a certain width at the bottom of a trench or a certain height at the walls of the trench (both sides or one side). In certain areas on the surface, a certain surface area on the trench wall at a certain height, a certain surface area at the bottom of a trench, dielectric material may be incorporated to create dielectric regions or dielectric layers. Examples of dielectric materials commonly used are:

Silicon oxide (SiO2), silicon nitride (Si3N4), silicon oxynitride (SiOnNm), zirconium oxide (ZrO2), tantalum oxide (Ta2O5), titanium oxide (TiO2), hafnium oxide (HfO2) which can be combined with each other and other materials in desired proportions or stacked different layer thicknesses.

The arrangement of one or more auxiliary anodes in addition to the primary anode, or alternatively, one or more auxiliary cathodes alongside the primary cathode—where these auxiliary electrodes are placed at a distance from the main material of the same type, sometimes with different doping concentrations-creates an array of logical diodes within a pixel. Each diode generates a current that may be combined for higher current readings. Geiger mode is achieved when the reverse-bias voltage exceeds the breakdown voltage. In certain cases, two pairs of p-n junctions may be connected anti-serrially with appropriate grading coefficients and integrated within silicon to manage avalanche effects at the chip level, on a SiC substrate. Temperature and current sensing can be incorporated within the die as well as at the drain terminal.

The sequence and pattern of the emitting diode may be preset or influenced by environmental inputs. For instance, a sensing diode may connect to a feedback circuit that regulates the sequence, power, pulse count per second, or frequency for modulated signals. Incoming signals can guide phase-locked loops (PLLs) in the PLL array to generate modulation matching the detected frequency or, in other scenarios, produce incremented frequencies for each PLL, creating distinct phase arrivals and establishing a known phase space over time.

Semiconductor chips can have electrodes on their top, bottom, or sides for soldering to circuit boards. Their fabrication may support either vertical or horizontal current flow relative to the primary surface. Fillers may be used between layers or components may be encased in a monolithic package using materials like epoxy, resin, acrylic, or thermosoftening polymers such as ABS, PMMA, PEI, PPS, PAI, PET, PVC, PP, PE, or PC. Pre-molded housings may also serve to contain silicon elements and filler material.

The semiconductor processing technologies described apply beyond light-emitting, laser, avalanche diodes, or CMOS image sensors, including photon count detectors, temporal photon counters, and phase shift or time-of-flight/point-cloud chips. Other components benefiting from these silicon processes include power devices i.e. Power metal insulator semiconductor field effect transistors (MISFETs), Power metal oxide semiconductor field effect transistors (MOSFETs), Insulated gate bipolar transistors (IGBTs), Junction gate field effect transistors (JFETs), High electron mobility transistors (HEMTs), Power bipolar transistors, Power diodes, PIN diodes, Schottky diodes, MOS controlled diodes (MCDs), etc.

Additional power-related elements include AC to DC converters, DC-DC converters, LDOs, and related circuitry.

When humans negotiate spaces, at times it is done at a subconscious level. As humans we talk, sip on our drink while we do not bump into other people, moving objects, or fixed objects, and allow one another to be the first to walk out of an elevator. We set aside the times that this is deliberately negotiated with explicit words or explicit gestures for the purpose of social values i.e. politeness, culture, etc. noting that if explicit negotiations would not have occurred, no one would bump to anything or anyone.

However, such negotiations do not come naturally with a humanoid robot interaction with a human or another humanoid robot. Negotiations can factor in action times, estimated clearances, priorities, physical and position circumstances, and space availability. Autonomous negotiations may involve handshakes, wireless communications, and peer-to-peer or hub-spoke formats, and factors to negotiate between two humanoid robots may be right-of-way for example or reserving and negotiating access to workspace areas. While criteria for negotiations such as minimizing the total wasted time, or the first one to have arrived, speed, etc., seem very basic, a humanoid intending to pass a Turing test (i.e. behaving as a human would), must factor in many other parameters. Examples include that humans give the right of way to elderly or in another example slow down while walking behind children (or elderly), or maintain a larger distance.

In embodiments, a digital workspace system may allow the training to occur with multiple participants. Digital workspace will provide a variety of tools for the adopter to configure various aspects of the humanoid's usage. The digital workspace may have a front-end which is on an APP or application of a computer, smartphone, or a tablet. For example, the adopter may set the amount, type, and duration of the information that is shared in the workspace for view or access of human operator or specialty AGI. For example a certain adopter may allow certain data to be shared for a certain period when an error occurred or a behavior was unexpected. The certain data could be various levels and types. For example logs generated by the system may be verbose or selectively given permission to. Similarly, the videos can be allowed to be replayed to either a remote human operator or a form of specialty AI or AGI for troubleshooting. In embodiments the initial troubleshooting may be done by the form of specialty AI or AGI before being escalated to a human operator. In embodiments, the adopter may purchase various levels of access to human operator help based on their subscription and SLA (service level agreement). In embodiments, escalations may be expedited, or a human operator may be at all times on-call. In embodiments the adopter may have a medical question and a nurse, doctor, or a human healthcare professional may be accessible to view the question. In embodiments the question may be accompanied by bio data collected from the adopter to the extent that is available in a home environment i.e. blood pressure, body temperature, oxygen level, etc.

Above, we explained organic movements of the robot as a human would move which would be achieved through a large data set of human movements in different scenarios performing different activities. What under the hood a neural network would extract from such a large data set is an elastic set of constraints of how the joints of the human body move proportional to each other in various scenarios. In a humanoid this is then mimicked to move the robot joints in the limited degrees of freedom that each of the joints have in a proportionality that a human would. The least beneficial side effect of this is that it prevents or reduces the need for accounting singularity conditions. The second beneficial side effect is that it allows for the motion of the robot to be modeled in a phase space as any of the states the robot may end up in may be viewed and associated with state in the phase space. The inventors of this invention have previously disclosed a phase space SLAM and motion in U.S. patent application Ser. No. 17/494,251 now U.S. patent Ser. No. 12/399,501, which is incorporated herein by reference.

In explaining the core initiated movement of the humanoid it is pointed out that before a limb or leg moves, the weight of the humanoid is shifted to the stationary leg. This concurrently occurs with the rotation of the hip, moving the swing leg at the at its joint point with him ahead of the humanoid. It is only then when the leg is moved with a rotation of an actuator forward, a side of effect of which is the leg lifting tangential from the floor due to that fact that a center of rotation being fixed, and the length of the leg is fixed. At this point the heel is the closest point with the floor (surface of the workspace), and as the leg is shifted forward, the center of mass of the robot shifts forward which will facilitate the landing of the swing leg on the floor which will be smoothened with the movement of the ankle

In embodiments, joints that require rotation in one direction, utilize an advantageous gear like connection points in a way that hills of teeth of a first gear have a conductive material that correlates with valleys of a second tooth. This allows that as joints move in relation to one another, in each time stamp (and configuration of gears in relation to one another) a certain number of hills of the first gear be in contact with a certain number of valleys of the second gear allowing a continuous flow of electricity.

The Nyquist rate sets bandwidth limits for a given sampling rate, stating that pulse frequency should not exceed twice this bandwidth for optimal bitrate usage. Hartley's law determines line rate, indicating how many pulses fit within a time period without interference—higher pulse voltages reduce signal confusion from attenuation.

This concept generalizes to represent sample rates needed to adequately model continuous phenomena (e.g., point clouds or images as digital samples). Adhering to the Nyquist theorem prevents sensor aliasing and oversampling.

Currently, position localization of objects often relies on detecting obstacles via vision or distance-based systems; robots respond to detected obstacles by adjusting speed or stopping. Alternatively, a deterministic clearance requirement uses an independent system that only allows movement if adequate clearance is assured.

Contextual mapping and item classification may employ Naïve Bayes, supervised, or unsupervised learning algorithms, assuming conditional independence or applying MAP estimation and support vector machines. Optimization methods such as convex and interior point techniques may also be implemented.

This framework extends to applications such as path planning under semi-observable conditions, context extraction from wireless sensing, and collaborative data analysis across diverse devices. In semantic SLAM, managing data structures and scalability is significant, with data modeled as points on manifolds rather than in Euclidean space to improve computational efficiency. Optimization processes may operate on Riemannian manifolds, linking search domains on manifolds to decision-making in tangent Euclidean spaces. Coordinate systems (e.g., spherical, cylindrical, affine, polar, Cartesian) and their transformations become important considerations. Both first- and second-order optimization methods may be adapted accordingly.

Such generalizations enable the integration of sparse data from different coordinate systems into unified representations, supporting information transfer across diverse frameworks. This is illustrated by associating heterogeneous image datasets and integrating data from various sources like lidars or depth cameras.

One example involves methods for detecting illuminated surfaces within a pixel array. Ultra-wide spectral imaging enables detection across visible and invisible spectra, with response characteristics varying by wavelength-potentially yielding unimodal or multimodal sensitivity profiles.

In block diagrams, illustrated components are depicted as discrete functional blocks, but embodiments are not limited to systems in which the functionality described herein is organized as illustrated. The functionality provided by each of the components may be provided by specialized software or specially designed hardware modules that are differently organized than is presently depicted; for example, such software or hardware may be intermingled, conjoined, replicated, broken up, distributed (e.g., within a data center or geographically), or otherwise differently organized. The functionality described herein may be provided by one or more processors of one or more computers executing specialized code stored on a tangible, non-transitory, machine-readable medium. In some cases, notwithstanding the use of the singular term “medium,” the instructions may be distributed on different storage devices associated with different computing devices, for instance, with each computing device having a different subset of the instructions, an implementation consistent with the usage of the singular term “medium” herein. In some cases, third-party content delivery networks may host some or all of the information conveyed over networks, in which case, to the extent information (e.g., content) is said to be supplied or otherwise provided, the information may be provided by sending instructions to retrieve that information from a content delivery network.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to cost constraints, some techniques disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X'ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Features described with reference to geometric constructs, like “parallel,” “perpendicular/orthogonal,” “square”, “cylindrical,” and the like, should be construed as encompassing items that substantially embody the properties of the geometric construct, e.g., reference to “parallel” surfaces encompasses substantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct. The terms “first”, “second”, “third,” “given” and so on, if used in the claims, are used to distinguish or otherwise identify, and not to show a sequential or numerical limitation.

1. A home appliance system for autonomously cleaning surfaces of a home environment, comprising:
a robotic stationary device, comprising:
a frame structure;
at least one sensor;
at least one actuator;
a processor;
a dust intake port, a vacuum motor, an exhaust, a filter, a dustbag, and charging contacts;
at least a component configured for attaching to a permanent water supply of the home environment;
a memory storing instructions that, when executed by the processor of the robotic stationary device, effectuate operations comprising:
actuating, with the processor of the robotic stationary device, at least a motor of the robotic stationary device to autonomously supply water to a robotic roaming device;
a robotic roaming device, comprising:
a chassis;
a set of wheels;
a motor to drive the set of wheels;
at least one sensor;
at least one actuator;
a component for navigation;
a processor;
a first set of components for a first data communication mechanism;
a second set of components for a second data communication mechanism,
different from the first data communication mechanism;
a memory storing instructions that, when executed by the processor of the robotic roaming device, effectuate operations comprising:
receiving and transmitting data from and to the robotic stationary device with the first data communication mechanism;
receiving and transmitting data from and to a wireless network connected to the internet with the second data communication mechanism;
wherein the home appliance system is configured to autonomously clean at least one component of itself with an actuated rubbing motion between a component of the robotic stationary device and a component of the robotic roaming device.

2. The home appliance system of claim 1, wherein the home appliance system is configured to be installed within the home environment, wherein the at least one component of the robotic stationary device for attaching to the permanent water supply of the home environment is affixed to a plumbing system of the home environment with a plastic hose.

3. The home appliance system of claim 1, wherein the home appliance system is configured to be seamlessly installed within the home environment as a built-in component of the home environment.

4. The home appliance system of claim 1, wherein the robotic stationary device further comprises at least a component for attaching the robotic stationary device to a sewage system of the home environment.

5. The home appliance system of claim 4, wherein the processor of the robotic stationary device effectuates operations further comprising:
actuating, with the processor of the robotic stationary device, the at least the motor of the robotic stationary device to dispose of dirty water from the robotic stationary device to the sewage system of the home environment.

6. The home appliance system of claim 2, wherein the processor of the robotic stationary device effectuates operations further comprising:
actuating, with the processor of the robotic stationary device, the at least the motor of the robotic stationary device to supply clean water to the robotic stationary device from the plumbing system of the home environment.

7. The home appliance system of claim 2, wherein the home appliance system is configured to operate without a need for installation within the home environment.

8. The home appliance system of claim 1, wherein the first data communication mechanism is optic-based, and the second communication mechanism is radio-based.

9. The home appliance system of claim 1, wherein the first data communication mechanism is configured for task coordination between the robotic stationary device and the robotic roaming device.

10. The home appliance system of claim 1, wherein the second data communication mechanism is configured for interaction between the home appliance system and a user.

11. The home appliance system of claim 1, wherein the second data communication mechanism is configured to display a mesh of triangles representing a three-dimensional spatial quintessence of the home environment on an application executed on a communication device associated with the home appliance system.

12. The home appliance system of claim 11, wherein the three-dimensional spatial quintessence of the home environment is digitally sculptured from sensor readings of the robotic roaming device.

13. The home appliance system of claim 12, wherein the sensor readings of the robotic roaming device comprise a time-of-flight computation of a beam emitted perpendicular to a wafer surface of a semiconductor captured by an avalanche diode.

14. The home appliance system of claim 13, wherein the avalanche diode is a single-photon avalanche diode.

15. The home appliance system of claim 13, wherein the beam emitted perpendicular to the wafer surface of the semiconductor is emitted by a surface vertical cavity surface-emitting laser.

16. The home appliance system of claim 13, wherein the time-of-flight computation comprises comparing electron avalanche signals with data prepared from a deep neural network.

17. The home appliance system of claim 13, wherein the time-of-flight computation comprises comparing the electron avalanche signals to overcome at least a sensor aliasing effect.

18. The home appliance system of claim 1, wherein:
the dustbag of the robotic stationary device is configured to collect debris from the robotic roaming device;
the dustbag is secured to the robotic stationary device with a locking mechanism to securely contain debris; and
the dustbag of the robotic stationary device is removable and replaceable.

19. The home appliance system of claim 1, wherein the charging contacts of the robotic stationary device are configured to recharge a battery of the robotic roaming device.

20. The home appliance system of claim 1, wherein the at least one sensor is a time-of-flight sensor.
